(19) United States
(12) Patent Application Publication
(10) Pub. No.: US 2017/0348854 A1
(43) Pub. Date: Dec. 7, 2017

(54) ROBOTIC MANIPULATION METHODS AND SYSTEMS FOR EXECUTING A DOMAIN-SPECIFIC APPLICATION IN AN INSTRUMENTED ENVIRONMENT WITH CONTAINERS AND ELECTRONIC MINIMANIPULATION LIBRARIES

(71) Applicant: MBL LIMITED, Jersey (JE)

(72) Inventor: Mark OLEYNIK, Monaco (MC)

(21) Appl. No.: 15/382,369

(22) Filed: Dec. 16, 2016

Related U.S. Application Data
(60) Provisional application No. 62/268,131, filed on Dec. 16, 2015.
(60) Provisional application No. 62/288,854, filed on Jan. 29, 2016.
(60) Provisional application No. 62/322,118, filed on Apr. 13, 2016.
(60) Provisional application No. 62/399,476, filed on Sep. 25, 2016.
(60) Provisional application No. 62/425,531, filed on Nov. 22, 2016.

(51) Int. Cl. B25J 9/16; A47B 77/16; A47B 77/08; A47J 47/02; B25J 11/00; B65D 81/18

(52) U.S. Cl. CPC B25J 9/1605; B25J 11/0045; B65D 81/18; A47B 77/08; A47J 47/02; A47B 77/16; G05B 2219/45111

(57) ABSTRACT

This disclosure discloses various technical features for creating robotic humanoid movements, actions, and interactions with tools and the instrumented environment by automatically building movements for the humanoid; actions and behaviors of the humanoid based on a set of computer-encoded robotic movement and action primitives. The primitives are defined by motions/actions of articulated degrees of freedom that range in complexity from simple to complex, and which can be combined in any form in serial/parallel fashion. These motion-primitives are termed to be minimanipulations and each has a clear time-indexed command input-structure and output behavior/performance profile that is intended to achieve a certain function. Minimanipulations comprise a new way of creating a programmable-by-example platform for robots. The minimanipulation electronic libraries provide a large suite of higher-level sensing-and-execution sequences that are common building blocks for complex tasks, such as cooking, taking care of the infirm, or other tasks performed by robots.

### CROSS REFERENCE TO RELATED APPLICATIONS

This application claims priority to U.S. Provisional Application Ser. No. 62/268,131, filed on 16 Dec. 2015 and entitled “Methods and systems for computationally operating customized containers with associated heating and cooling elements in robotic kitchen modules”, U.S. Provisional Application Ser. No. 62/288,854, filed on 29 Jan. 2016 and entitled “Methods and systems for computationally operating customized containers with associated heating and cooling elements in robotic kitchen modules”, U.S. Provisional Application Ser. No. 62/322,118, filed on 13 Apr. 2016 and entitled “Methods and systems for computationally operating customized containers with associated heating and cooling elements and a rotatable oven in robotic kitchen modules”, U.S. Provisional Application Ser. No. 62/399,476, filed on 25 Sep. 2016 and entitled “Robotics automated methods and systems for computationally operating customized containers with associated heating and cooling elements and a rotatable oven in robotic kitchen modules”, and U.S. Provisional Application Ser. No. 62/425,531, filed on 22 Nov. 2016 and entitled “Methods and systems for computationally operating customized containers with associated heating and cooling elements in robotic kitchen modules”, the subject matter of all of the foregoing disclosures is incorporated herein by reference in their entireties.

### TECHNICAL FIELD

The present disclosure relates generally to the interdisciplinary fields of robotics and artificial intelligence (AI), more particularly to computerized robotic systems employing electronic libraries of minimanipulations with transformed robotic instructions for replicating movements, processes, and techniques with real-time electronic adjustments.

### BACKGROUND ART

Research and development in robotics have been undertaken for decades, but the progress has been mostly in the heavy industrial applications like automobile manufacturing automation or military applications. Simple robotics systems have been designed for the consumer markets, but they have not seen a wide application in the home-consumer robotics space, thus far. With advances in technology, combined with a population with higher incomes, the market may be ripe to create opportunities for technological advances to improve people's lives. Robotics has continued to improve automation technology with enhanced artificial intelligence and emulation of human skills and tasks in many forms in operating a robotic apparatus or a humanoid.

The notion of robots replacing humans in certain areas and executing tasks that humans would typically perform is an ideology in continuous evolution since robots were first developed many decades ago. Manufacturing sectors have long used robots in teach-playback mode, where the robot is taught, via pendant or offline fixed-trajectory generation and download, which motions to copy continuously and without alteration or deviation. Companies have taken the pre-programmed trajectory-execution of computer-taught trajectories and robot motion-playback into such application domains as mixing drinks, welding or painting cars, and others. However, all of these conventional applications use a 1:1 computer-to-robot or tech-playback principle that is intended to have only the robot faithfully execute the motion-commands, which is usually following a taught/pre-computed trajectory without deviation.

Gastronomy is an art of eating well, where a gourmet recipe blends subtly high quality ingredients and flavor appealing to all our senses. Gourmet cooking follows rules based on techniques that can be very elaborate, requiring expertise and technique, and lengthy training in some cases. In the past few years, demand for gourmet food has grown tremendously because of fast rising incomes and a generational shift in culinary awareness. However, diners still need to visit a certain restaurant or venue for gourmet dishes made by a favored chef. It would be rather advantageous to see a chef preparing your favorite dish live in action or experience a dish preparation reminiscent of a childhood dish made by your grandmother.

Accordingly, it would be desirable to have a system and method to have a chef's gourmet dish made and served conveniently to consumers in their own homes, without the necessity to travel to each restaurant around the world to enjoy specific gourmet dishes.

### SUMMARY OF THE DISCLOSURE

According to one aspect of the present invention, there is provided a storage arrangement for use with a robotic kitchen, the arrangement comprising: a housing incorporating a plurality of storage units; a plurality of containers which are each configured to be carried by one or the respective storage units, wherein each container comprises a container body for receiving an ingredient and each container is provided with an elongate handle which is configured to be carried by a robot, wherein the elongate handle facilitates orientation and movement of the container by a robot.

Preferably, the plurality of containers are different sizes. Conveniently, each handle comprises at least one support leg having a first end which is carried by the container body and a second end which is coupled to a handle element such that the handle element is spaced apart from the container body.

Advantageously, at least one of the containers carries a machine readable identifier.

In one embodiment, the machine readable identifier is a bar code. In another embodiment, the machine readable identifier is a radio-frequency (RFID) tag.

Preferably, at least one of the containers carries a computer-controlled signaling light.

Conveniently, a locking arrangement is provided on at least one of the storage units, the locking arrangement being configured, when activated, to lock a container at least partly within one of the storage units.

Advantageously, the at least one locking arrangement is configured to lock the container at least partly within one of the storage units for a predetermined period of time.

Preferably, the arrangement further comprises: a cooling system for cooling at least one of the storage units to cool at least part of a container positioned within the storage unit.

Conveniently, the cooling system is configured to cool at least one of the rear and the underside of the storage unit.

Advantageously, the cooling system comprises: a cooling unit; and a plurality of elongate heat transfer elements, each heat transfer element being coupled at one end to a respective one of the storage units and coupled at the other end to the cooling unit such that the heat transfer elements transfer heat away from the respective storage units to the cooling unit to lower the temperature within the storage units.

Preferably, at least one of the heat transfer elements comprises an electronically controlled valve, the electronically controlled valve being configured, when activated, to permit heat to be transferred from a storage unit along part of a respective heat transfer element and configured, when not activated, to restrict the transfer of heat from a storage unit along part of a respective heat transfer element.

Conveniently, the arrangement comprises a heating system which is configured to heat at least one of the storage units to raise the temperature of at least part of a container within the storage unit.

Advantageously, the heating system comprises a heating element which is positioned adjacent to part of a storage unit.

Preferably, the arrangement further comprises a temperature control unit which is configured to control at least one of the heating and cooling systems, wherein at least one of the storage units is provided with a temperature sensor which is coupled to the temperature control unit such that the temperature control unit can detect the temperature within a storage unit and control the temperature within the storage unit by activating at least one of the heating and cooling systems.

Conveniently, at least one of the storage units is provided with a humidity sensor to sense the humidity within the storage unit.

Advantageously, at least one of the storage units is coupled to a steam generator such that the steam generator can inject steam into the storage unit to humidify the storage unit.

Preferably, at least one of the containers comprises a volume indicator which indicates the volume of an ingredient within the container.

Conveniently, at least one of the containers is a bottle for holding a liquid, the bottle having an opening which is configured to be closed selectively by a closure element.

Advantageously, the arrangement further comprises a moveable support element which is moveable relative to the housing, the moveable support element comprising at least one storage unit which is configured to receive a respective one of the containers.

Preferably, the moveable support element is rotatable relative to the housing, the moveable support element having a plurality of sides with at least one of the sides comprising at least one storage unit, the moveable support element being configured to rotate to present different faces of the moveable support element to an operative.

According to another aspect of the present invention, there is provided a storage arrangement for use with a robotic kitchen, the arrangement comprising: a housing incorporating a plurality of storage units; a rotatable mounting system coupled to the housing to enable the housing to be rotatably mounted to a support structure, the housing comprising a plurality of sides with at least one side comprising a plurality of storage units that are each configured to carry a container, the housing being configured to rotate to present a different side of the plurality of sides to an operative.

Preferably, at least one of the plurality of sides has a shape which is one of the square and rectangular.

Conveniently, the housing comprises three sides.

Advantageously, the housing comprises four sides.

Preferably, at least part of the housing has a substantially circular side wall, each one of the plurality of sides being a portion of the substantially circular side wall.

Conveniently, the storage arrangement is configured to store one or more of cook wares, tools, crockery, spices and herbs.

Advantageously, at least one of the containers comprises: a first part which carries the handle; and a second part which is moveably mounted to the first part such that when the second part of the container is moved relative to the first part of the container, the second part of the container acts on part of a foodstuff within the container to move the foodstuff relative to the first part of the container.

According to another aspect of the present invention, there is provided a container arrangement, the arrangement comprising: a first part which carries a handle; and a second part which is moveably mounted to the first part such that when the second part of the part of the container is moved relative to the first part of the container, the second part of the container acts on part of a foodstuff within the container to move the foodstuff relative to the first part of the container.

Preferably, the second part carries a further handle to be used to move the second part relative to the first part.

Conveniently, the second part comprises a wall that at least partly surrounds a foodstuff within the container.

Advantageously, the first part comprises a planar base which is configured to support a foodstuff within the container.

Preferably, the second part is configured to move in a direction substantially parallel to the plane of the base such that the second part acts on the foodstuff to move the foodstuff off the base.

Conveniently, the base is a cooking surface which is configured to be heated to cook a foodstuff positioned on the base.

According to another aspect of the present invention, there is provided a cooking arrangement, the arrangement comprising: a support frame; a cooking part which incorporates a base and an upstanding side wall that at least partly surrounds the base; and a handle which is carried by the side wall, wherein the cooking part is configured to be rotatably mounted to the support frame so that the cooking part can be rotated relative to the support frame about an axis to at least partly turn a foodstuff positioned on the base.

Preferably, the cooking part is releasably attached to the support frame.

Conveniently, the arrangement comprises a locking system which is configured to selectively lock and restrict rotation of the cooking part relative to the support frame.

Advantageously, the support frame is configured to receive the container arrangement and the cooking part, wherein the rotation of the cooking part relative to the support frame turns a foodstuff positioned on the base of the cooking part onto at least part of the container arrangement.

Preferably, the arrangement comprises a further storage housing that incorporates a substantially planar base and at least one shelf element, the at least one shelf element being fixed at an angle relative to the plane of the base.

Conveniently, the at least one shelf element is fixed at an angle between 30° and 50° relative to the plane of the base.

Advantageously, the arrangement comprises a plurality of spaced apart shelf elements which are each substantially parallel to one another.

According to another aspect of the present invention, there is provided a storage arrangement for use with a robotic kitchen, the arrangement comprising: a further storage housing which comprises a substantially planar base and at least one shelf element, the at least one shelf element being fixed at an angle relative to the plane of the base.

Preferably, each shelf element is fixed at an angle of between 30° and 50° relative to the plane of the base.

Conveniently, the arrangement comprises a plurality of spaced apart shelf elements which are each substantially parallel to one another.

According to another aspect of the present invention, there is provided a cooking system, the system comprising: a cooking appliance having a heating chamber; and a mounting arrangement having a first support element that is carried by the cooking appliance and a second support element that is configured to be attached to a support structure in a kitchen, the first and second support elements being moveably coupled to one another to permit the first support element and the cooking appliance to move relative to the second support element between a first position and a second position.

Preferably, the cooking appliance is an oven.

Conveniently, the oven is a steam oven.

Advantageously, the cooking appliance comprises a grill.

Preferably, the support elements are configured to rotate relative to one another.

Conveniently, the first support element is configured to rotate by substantially 90° relative to the second support element.

Advantageously, the support elements are configured to move transversely relative to one another.

Preferably, the system comprises an electric motor which is configured to drive the first support element to move relative to the second support element.

Conveniently, the cooking system is configured for use by a human when the cooking appliance is in the first position and for use by a robot when the cooking appliance is in the second position, and wherein the cooking appliance is at least partly shielded by a screen when the cooking appliance is in the second position.

According to another aspect of the present invention, there is provided a container arrangement for storing a cooking ingredient, the arrangement comprising: a container body having at least one side wall; a storage chamber provided within the container body; and an ejection element which is moveably coupled to the container body, part of the ejection element being provided within the storage chamber, the ejection element being moveable relative to the container body to act on a cooking ingredient in the storage chamber to eject at least part of the cooking ingredient out from the storage chamber.

Preferably, the container body has a substantially circular cross-section.

Conveniently, the ejection element is moveable between a first position in which the ejection element is positioned substantially at one end of the storage chamber to a second position in which the ejection element is positioned substantially at a further end of the storage chamber.

Advantageously, the ejection element comprises an ejection element body which has an edge that contacts the container body around the periphery of the storage chamber.

Preferably, the ejection element is provided with a recess in a portion of the edge of the ejection element body, and wherein the recess is configured to receive at least part of a guide rail protrusion provided on the container body within the storage chamber.

Conveniently, the ejection element is coupled to a handle which protrudes outwardly from the container body through an aperture in the container body.

Advantageously, the container body comprises an open first end through which the cooking ingredient is ejected by the ejection element an a substantially closed section end which retains the cooking ingredient within the storage chamber.

Preferably, the second end of the container body is releasably closed by a removable closure element.

Conveniently, the container body is provided with an elongate handle which is configured to be carried by a robot.

According to another aspect of the present invention, there is provided an end effector for a robot, the end effector comprising: a grabber which is configured to hold an item; and at least one sensor which is carried by the grabber, the at least one sensor being configured to sense the presence of an item being held by the grabber and to provide a signal to a control unit in response to the sensed presence of the item being held by the grabber.

Preferably, the grabber is a robotic hand.

Conveniently, the at least one sensor is a magnetic sensor which is configured to sense a magnet provided on an item.

Advantageously, the magnetic sensor is a tri-axis magnetic sensor which is configured to sense the position of a magnet in three axes which is relative to the magnetic sensor.

Preferably, the grabber comprises a plurality of magnetic sensors which are provided at a plurality of different positions on the grabber to sense a plurality of magnets provided on an item.

According to another aspect of the present invention, there is provided a recording method for use with a robotic kitchen module, the robotic kitchen module comprising a container, the container being configured to store an ingredient and the container being provided with a sensor to sense a parameter indicative of a condition within the container, wherein the method comprises: a) receiving a signal from a sensor on the container indicative of a condition within the container; b) deriving parameter data from the signal which is indicative of the sensed condition within the container; c) storing the parameter data in a memory; and d) repeating steps a-c over a period of time to store a parameter data record in the memory that provides a data record of the condition within the container over the period of time.

Preferably, the method comprises receiving a signal from a temperature sensor on the container indicative of the temperature within the container.

Conveniently, the container is provided with a temperature control element to control the temperature within the container and method further comprises recording temperature control data which indicates the of the control of the temperature control element over the period of time.

Advantageously, the method comprises receiving a signal from a humidity sensor on a container indicative of the humidity within the container.

Preferably, the container is provided with a humidity control device to control the humidity within the container and method further comprises recording humidity control data which indicates the of the control of the humidity control device over the period of time.

Conveniently, the method further comprises: recording the movement of at least one hand of a chef cooking in the robotic kitchen over the period of time.

Advantageously, the period of time is the period of time required to prepare an ingredient for use when cooking a dish in accordance with a recipe.

Preferably, the period of time is the period of time required to cook a dish in accordance with a recipe.

Conveniently, the method further comprises: integrating the parameter data record with recipe data and storing the integrated data in a recipe data file.

Preferably, the method further comprises: transmitting the recipe data file via a computer network to a remote server.

Conveniently, the remote server forms part of an online repository that is configured to provide the recipe data file to a plurality of client devices.

Advantageously, the online repository is an online application store.

According to another aspect of the present invention, there is provided a computer readable medium storing instructions which, when executed by a processor, cause the processor to perform the method of as recited in the claims.

According to another aspect of the present invention, there is provided a method of operating a robotic kitchen module, the robotic kitchen module comprising a container, the container being configured to store an ingredient and the container being provided with a sensor to sense a parameter indicative of a condition within the container and a condition control device which is configured to control the condition within the container, wherein the method comprises: receiving a parameter data record which provides a data record of the condition within the container over the period of time; receiving a signal from a sensor on a container indicative of a condition within the container; deriving parameter data from the signal which is indicative of the sensed condition within the container; comparing using the robotic kitchen engine module the parameter data with the parameter data record; and controlling a condition control device to control the condition within the container so that the condition within the container at least partly matches the condition indicated by the parameter data record.

Preferably, the method comprises receiving a signal from a temperature sensor on the container indicative of the temperature within the container.

Conveniently, the method comprises controlling a temperature control element provided on the container to control the temperature within the container to at least partly match a temperature indicated by the parameter data record.

Advantageously, the method comprises receiving a signal from a humidity sensor on the container indicative of the humidity within the container.

Preferably, the method comprises controlling a humidity control device provided on the container to control the humidity within the container to at least partly match a humidity indicated by the parameter data record.

Conveniently, the method comprises storing a prepared ingredient in the container over a period of time and controlling the condition within the container over the period of time to at least partly match a predetermined storage condition for the ingredient.

Advantageously, the method comprises storing a prepared ingredient in the container over a period of time and controlling the condition within the container to prepare the ingredient for use in a recipe according to a predetermined preparation routine.

Preferably, the method comprises receiving a recipe data file and extracting the parameter data record from the recipe data file.

According to another aspect of the present invention, there is provided a robotics system comprising: a computer; and a robotic hand coupled to the computer, the robotic hand being configured to receive a sequence of movement instructions from the computer and perform a manipulation according to the sequence of standardized movement instructions, wherein the robotic hand is configured to perform at least one intermediate movement during the manipulation in response to at least one intermediate movement instruction received from the computer, wherein the intermediate movement modifies the trajectory of at least part of the robotic hand during the movement sequence.

Preferably, the robotic hand comprises a plurality of fingers and a thumb and the system is configured to modify the trajectory of a tip of at least one of the fingers and thumb in response to the intermediate movement instruction.

Conveniently, the intermediate movement instruction causes the robotic hand to perform an emotional movement which at least partly mimics an emotional movement of a human hand.

According to another aspect of the present invention, there is provided a computer-implemented method for operating a robotic hand, the method comprising: identifying a movement sequence for a robotic hand to perform a manipulation; providing movement instructions to the robotic hand to cause the robotic hand to perform the manipulation; and providing at least one intermediate movement instruction to the robotic hand to cause the robotic hand to perform at least one intermediate movement during the manipulation, the intermediate movement being a movement of the robotic hand which modifies the trajectory of at least part of the robotic hand during the manipulation.

Preferably, the method comprises providing at least one intermediate movement instruction to the robotic hand to cause the robotic hand to modify the trajectory of a tip of at least one of a finger and thumb of the robotic hand.

Conveniently, the intermediate movement instruction causes the robotic hand to perform an emotional movement which at least partly mimics an emotional movement of a human hand.

According to another aspect of the present invention, there is provided a computer implemented object recognition method for use with a robotic kitchen, the method comprising: receiving expected object data indicating at least one predetermined object that is expected within the robotic kitchen; receiving shape data indicating the shape of at least part of an object; receiving predetermined object data indicating the shape of a plurality of predetermined objects; determining a subset of predetermined objects by matching at least one predetermined object identified by the predetermined object data with the at least one predetermined object identified by the expected object data; comparing the shape data with the subset of predetermined objects; and outputting real object data indicative of a predetermined object in the subset of predetermined objects that matches the shape data.

Preferably, the shape data is two-dimensional (2D) shape data.

Conveniently, the shape data is three-dimensional (3D) shape data.

Advantageously, the method comprises extracting the expected object data from recipe data, the recipe data providing instructions for use within the robotic kitchen module to cook a dish.

Preferably, the method comprises outputting real object data to a workspace dynamic model module which is configured to provide manipulation instructions to a robot within the robotic kitchen module.

Conveniently, the predetermined object data comprises standard object data indicating at least one of a 2D shape, 3D shape, visual signature or image sample of at least one predetermined object.

Advantageously, the at least one predetermined object is at least one of a dish, utensil or appliance.

Preferably, the predetermined object data comprises temporary object data indicating at least one of a visual signature or an image sample of at least one predetermined object.

Conveniently, the at least one predetermined object is an ingredient.

Advantageously, the method comprises storing position data indicative of the position of an object within the robotic kitchen relative to at least one reference marker provided within the robotic kitchen.

According to another aspect of the present invention, there is provided a computer implemented object recognition method for use with a robotic kitchen, the method comprising: receiving shape data indicating the shape of a plurality of objects; storing the shape data in a shape data library with a respective object identifier for each of the plurality of objects; and outputting recipe data comprising a list of the object identifiers.

Preferably, the shape data comprises at least one of 2D shape data and 3D shape data.

Conveniently, the shape data comprises at shape data obtained from a robotic hand.

According to another aspect of the present invention, there is provided a robotic system comprising: a control unit; a robotic arm configured to be controlled by the control unit; an end effector coupled to the robotic arm, the end effector being configured to hold an item; and a sensor arrangement coupled to part of the robotic arm, the sensor arrangement being configured to provide a signal to the control unit which is indicative of a modifying force acting on the robotic arm that is caused by the mass of an item being held by the end effector, wherein the control unit is configured to process the signal and to calculate the mass of the item using the signal.

Preferably, the sensor arrangement comprises at least one of a strain gauge, load cell or torque sensor.

Conveniently, the signal provided by the sensor arrangement indicates at least one of a linear force, acceleration, torque or angular velocity of part of the robotic arm.

Advantageously, the sensor arrangement is provided at a base carrying the robotic arm.

Preferably, the sensor arrangement is provided on the robotic arm at a joint between two moveable links of the robotic arm.

Conveniently, sensor arrangement comprises a current sensor which is coupled to an electric motor which controls the movement of the robotic arm, the current sensor being configured to output the signal to the control unit, with the signal being indicative of a current flowing through the electric motor, wherein the control unit is configured to calculate the torque of the electric motor using the signal from the current sensor and to use the calculated torque when calculating the mass of the item held by the end effector.

Advantageously, the control unit is configured to calculate the mass of a container held by the end effector and configured to calculate a change in the mass of the container as the container is moved by the robotic arm when part of an ingredient is tipped out from the container by the robotic arm.

Preferably, the end effector is configured to sense the presence of at least one marker provided on an item when the item is being held by the end effector.

Conveniently, the control unit is configured to use the sensed presence of the marker to detect whether the end effector is holding the item in a predetermined position.

Advantageously, the end effector is a robotic hand comprising four fingers and a thumb.

According to another aspect of the present invention, there is provided a method of sensing the weight of an item held by an end effector coupled to a robotic arm, the method comprising: receiving a signal from a sensor arrangement which is indicative of a modifying force acting on the robotic arm that is caused by the mass of an item being held by an end effector coupled to the robotic arm; and processing the signal to calculate the mass of the item using the signal.

Preferably, the sensor arrangement comprises at least one of a strain gauge, load cell or torque sensor.

Conveniently, the signal provided by the sensor arrangement indicates at least one of a linear force, acceleration, torque or angular velocity of part of the robotic arm.

Advantageously, sensor arrangement comprises a current sensor which is coupled to an electric motor which controls the movement of the robotic arm, the current sensor being configured to output the signal to the control unit, with the signal being indicative of a current flowing through the electric motor, and the method comprises: calculate the torque of the electric motor using the signal from the current sensor; and using the calculated torque when calculating the mass of the item held by the end effector.

Preferably, the method further comprises: calculating the mass of a container held by the end effector; and calculating a change in the mass of the container as the container is moved by the robotic arm when part of an ingredient is tipped out from the container by the robotic arm.

According to another aspect of the present invention, there is provided a robotic kitchen module comprising: a control unit for controlling components of the robotic kitchen module; an intrusion detection sensor which is coupled to the control unit, the intrusion detection sensor being configured to receive a sensor input and to provide the sensor input to the control unit, wherein the control unit is configured to: determine if the sensor input is an authorized sensor input and, if the sensor input is an authorized sensor input to enable the robotic kitchen module for use by a user, and if the sensor input is not an authorized sensor input to at least partly disable the robotic kitchen module.

Preferably, the robotic kitchen module comprises at least one robotic arm and the robotic kitchen module is configured to disable the robotic kitchen module by disabling the at least one robotic arm.

Conveniently, the robotic kitchen module is configured to disable the robotic kitchen module by preventing user access to a computer in the robotic kitchen module.

Advantageously, the intrusion detection sensor is at least one of a geo-position sensor, a fingerprint sensor or a mechanical intrusion sensor.

Preferably, the robotic kitchen module is configured to provide an alert signal to a remote location in response to the control unit determining that the sensor input is not an authorized sensor input.

Conveniently, the robotic kitchen module is configured to destroy physical or magnetic elements of the robotic kitchen module to at least partly disable the robotic kitchen module.

Embodiments of the present disclosure are directed to methods, computer program products, and computer systems of a robotic apparatus with robotic instructions replicating a food dish with substantially the same result as if the chef had prepared the food dish. In a first embodiment, the robotic apparatus in a standardized robotic kitchen comprises two robotic arms and hands that replicate the precise movements of a chef in the same sequence (or substantially the same sequence). The two robotic arms and hands replicate the movements in the same timing (or substantially the same timing) to prepare a food dish based on a previously recorded software file (a recipe-script) of the chef's precise movements in preparing the same food dish. In a second embodiment, a computer-controlled cooking apparatus prepares a food dish based on a sensory-curve, such as temperature overtime, which was previously recorded in a software file where the chef prepared the same food dish with the cooking apparatus with sensors for which a computer recorded the sensor values over time when the chef previously prepared the food dish on the cooking apparatus fitted with sensors. In a third embodiment, the kitchen apparatus comprises the robotic arms in the first embodiment and the cooking apparatus with sensors in the second embodiment to prepare a dish that combines both the robotic arms and one or more sensory curves, where the robotic arms are capable of quality-checking a food dish during the cooking process, for such characteristics as taste, smell, and appearance, allowing for any cooking adjustments to the preparation steps of the food dish. In a fourth embodiment, the kitchen apparatus comprises a food storage system with computer-controlled containers and container identifiers for storing and supplying ingredients for a user to prepare a food dish by following a chef's cooking instructions. In a fifth embodiment, a robotic cooking kitchen comprises a robot with arms and a kitchen apparatus in which the robot moves around the kitchen apparatus to prepare a food dish by emulating a chef's precise cooking movements, including possible real-time modifications/adaptations to the preparation process defined in the recipe-script.

A robotic cooking engine comprises detection, recording, and chef emulation cooking movements, controlling significant parameters, such as temperature and time, and processing the execution with designated appliances, equipment, and tools, thereby reproducing a gourmet dish that tastes identical to the same dish prepared by a chef and served at a specific and convenient time. In one embodiment, a robotic cooking engine provides robotic arms for replicating a chef's identical movements with the same ingredients and techniques to produce an identical tasting dish.

The underlying motivation of the present disclosure centers around humans being monitored with sensors during their natural execution of an activity, and then, being able to use monitoring-sensors, capturing-sensors, computers, and software to generate information and commands to replicate the human activity using one or more robotic and/or automated systems. While one can conceive of multiple such activities (e.g. cooking, painting, playing an instrument, etc.), one aspect of the present disclosure is directed to the cooking of a meal: in essence, a robotic meal preparation application. Monitoring a human chef is carried out in an instrumented application-specific setting (a standardized kitchen in this case), and involves using sensors and computers to watch, monitor, record, and interpret the motions and actions of the human chef, in order to develop a robot-executable set of commands robust to variations and changes in an environment that is capable of allowing a robotic or automated system in a robotic kitchen prepare the same dish to the standards and quality as the dish prepared by the human chef.

The use of multimodal sensing systems is the means by which the necessary raw data is collected. Sensors capable of collecting and providing such data include environment and geometrical sensors, such as two- (cameras, etc.) and three-dimensional (lasers, sonar, etc.) sensors, as well as human motion-capture systems (human-worn camera-targets, instrumented suits/exoskeletons, instrumented gloves, etc.), as well as instrumented (sensors) and powered (actuators) equipment used during recipe creation and execution (instrumented appliances, cooking-equipment, tools, ingredient dispensers, etc.). All this data is collected by one or more distributed/central computers and processed by a variety of software processes. The algorithms will process and abstract the data to the point that a human and a computer-controlled robotic kitchen can understand the activities, tasks, actions, equipment, ingredients and methods, and processes used by the human, including replication of key skills of a particular chef. The raw data is processed by one or more software abstraction engines to create a recipe-script that is both human-readable and, through further processing, machine-understandable and machine-executable, spelling out all actions and motions for all steps of a particular recipe that a robotic kitchen would have to execute. These commands range in complexity from controlling individual joints, to a particular joint-motion profile over time, to abstraction levels of commands, with lower-level motion-execution commands embedded therein, associated with specific steps in a recipe. Abstraction motion-commands (e.g. “crack an egg into the pan”, “sear to a golden color on both sides”, etc.) can be generated from the raw data, refined, and optimized through a multitude of iterative learning processes, carried out live and/or off-line, allowing the robotic kitchen systems to successfully deal with measurement-uncertainties, ingredient variations, etc., enabling complex (adaptive) minimanipulation motions using fingered-hands mounted to robot-arms and wrists, based on fairly abstraction/high-level commands (e.g. “grab the pot by the handle”, “pour out the contents”, “grab the spoon off the countertop and stir the soup”, etc.).

The ability to create machine-executable command sequences, now contained within digital files capable of being shared/transmitted, allowing any robotic kitchen to execute them, opens up the option to execute the dish-preparation steps anywhere at any time. Hence, it allows the option to buy/sell recipes online, allowing users to access and distribute recipes on a per-use or subscription basis.

The replication of a dish prepared by a human is performed by a robotic kitchen, which is in essence a standardized replica of the instrumented kitchen used by the human chef during the creation of the dish, except that the human's actions are now carried out by a set of robotic arms and hands, computer-monitored and computer-controllable appliances, equipment, tools, dispensers, etc. The degree of dish-replication fidelity will thus be closely tied to the degree to which the robotic kitchen is a replica of the kitchen (and all its elements and ingredients), in which the human chef was observed while preparing the dish.

In addition, embodiments of the present disclosure are directed to methods, computer program products, and computer systems of a robotic apparatus for executing robotic instructions from one or more libraries of minimanipulations. Two types of parameters, elemental parameters and application parameters, affect the operations of minimanipulations. During the creation phase of a minimanipulation, the elemental parameters provide the variables that test the various combinations, permutations, and the degrees of freedom to produce successful minimanipulations. During the execution phase of minimanipulations, application parameters are programmable or can be customized to tail or one or more libraries of minimanipulations to a particular application, such as food preparation, making sushi, playing piano, painting, picking up a book, and other types of applications.

Minimanipulations comprise a new way of creating a general programmable-by-example platform for humanoid robots. The state of the art largely requires explicit development of control software by expert programmers for each and every step of a robotic action or action sequence. The exception to the above are for very repetitive low level tasks, such as factory assembly, where the rudiments of learning-by-imitation are present. A minimanipulation library provides a large suite of higher-level sensing-and-execution sequences that are common building blocks for complex tasks, such as cooking, taking care of the infirm, or other tasks performed by the next generation of humanoid robots. More specifically, unlike the previous art, the present disclosure provides the following distinctive features. First, a potentially very large library of pre-defined/pre-learned sensing-and-action sequences called minimanipulations. Second, each mini-manipulation encodes preconditions required for the sensing-and-action sequences to produce successfully the desired functional results (i.e. the postconditions) with a well-defined probability of success (e.g. 100% or 97% depending on the complexity and difficulty of the minimanipulation). Third, each minimanipulation references a set of variables whose values may be set a-priori or via sensing operations, before executing the minimanipulation actions. Fourth, each minimanipulation changes the value of a set of variables to represent the functional result (the postconditions) of executing the action sequence in the minimanipulation. Fifth, minimanipulations may be acquired by repeated observation of a human tutor (e.g. an expert chef) to determine the sensing-and-action sequence, and to determine the range of acceptable values for the variables. Sixth, minimanipulations may be composed into larger units to perform end-to-end tasks, such as preparing a meal, or cleaning up a room. These larger units are multi-stage applications of minimanipulations either in a strict sequence, in parallel, or respecting a partial order wherein some steps must occur before others, but not in a total ordered sequence (e.g. to prepare a given dish, three ingredients need to be combined in exact amounts into a mixing bowl, and then mixed; the order of putting each ingredient into the bowl is not constrained, but all must be placed before mixing). Seventh, the assembly of minimanipulations into end-to-end-tasks is performed by robotic planning, taking into account the preconditions and postconditions of the component minimanipulations. Eighth, case-based reasoning wherein observation of humans performing end-to-end tasks, or other robots doing so, or the same robot's past experience can be used to acquire a library of reusable robotic plans form cases (specific instances of performing an end-to-end task), both successful ones to replicate, and unsuccessful ones to learn what to avoid.

In a first aspect of the present disclosure, the robotic apparatus performs a task by replicating a human-skill operation, such as food preparation, playing piano, or painting, by accessing one or more libraries of minimanipulations. The replication process of the robotic apparatus emulates the transfer of a human's intelligence or skill set through a pair of hands, such as how a chef uses a pair of hands to prepare a particular dish; or a piano maestro playing a master piano piece through his or her pair of hands (and perhaps through the feet and body motions, as well). In a second aspect of the present disclosure, the robotic apparatus comprises a humanoid for home applications where the humanoid is designed to provide a programmable or customizable psychological, emotional, and/or functional comfortable robot, and thereby providing pleasure to the user. In a third aspect of the present disclosure, one or more minimanipulation libraries are created and executed as, first, one or more general minimanipulation libraries, and second, as one or more application specific minimanipulation libraries. One or more general minimanipulation libraries are created based on the elemental parameters and the degrees of freedom of a humanoid or a robotic apparatus. The humanoid or the robotic apparatus are programmable, so that the one or more general minimanipulation libraries can be programmed or customized to become one or more application specific minimanipulation libraries specific tailored to the user's request in the operational capabilities of the humanoid or the robotic apparatus.

Some embodiments of the present disclosure are directed to the technical features relating to the ability of being able to create complex robotic humanoid movements, actions and interactions with tools and the environment by automatically building movements for the humanoid, actions, and behaviors of the humanoid based on a set of computer-encoded robotic movement and action primitives. The primitives are defined by motion/actions of articulated degrees of freedom that range in complexity from simple to complex, and which can be combined in any form in serial/parallel fashion. These motion-primitives are termed to be Minimanipulations (MMs) and each MM has a clear time-indexed command input-structure, and output behavior-/performance-profile that are intended to achieve a certain function. MMs can range from the simple (‘index a single finger joint by 1 degree’) to the more involved (such as ‘grab the utensil’) to the even more complex (‘fetch the knife and cut the bread’) to the fairly abstract (‘play the 1^{st} bar of Schubert's piano concerto #1’).

Thus, MMs are software-based and represented by input and output data sets and inherent processing algorithms and performance descriptors, akin to individual programs with input/output data files and subroutines, contained within individual run-time source-code, which when compiled generates object-code that can be compiled and collected within various different software libraries, termed as a collection of various Minimanipulation-Libraries (MMLs). MMLs can be grouped in to multiple groupings, whether these be associated to (i) particular hardware elements (finger/hand, wrist, arm, torso, foot, legs, etc.), (ii) behavioral elements (contacting, grasping, handling, etc.), or even (iii) application-domains (cooking, painting, playing a musical instrument, etc.). Furthermore, within each of these groupings, MMLs can be arranged based on multiple levels (simple to complex) relating to the complexity of behavior desired.

It should thus be understood that the concept of Minimanipulation (MM) (definitions and associations, measurement and control variables and their combinations and value-usage and -modification, etc.) and its implementation through usage of multiple MMLs in a near infinite combination, relates to the definition and control of basic behaviors (movements and interactions) of one or more degrees of freedom (movable joints under actuator control) at levels ranging from a single joint (knuckle, etc.) to combinations of joints (fingers and hand, arm, etc.) to ever higher degree of freedom systems (torso, upper-body, etc.) in a sequence and combination that achieves a desirable and successful movement sequence in free space and achieves a desirable degree of interaction with the real world so as to be able to enact a desirable function or output by the robot system, on and with, the surrounding world via tools, utensils, and other items.

Examples for the above definition can range from (i) a simple command sequence for a digit to flick a marble along a table, through (ii) stirring a liquid in a pot using a utensil, to (iii) playing a piece of music on an instrument (violin, piano, harp, etc.). The basic notion is that MMs are represented at multiple levels by a set of MM commands executed in sequence and in parallel at successive points in time, and together create a movement and action/interaction with the outside world to arrive at a desirable function (stirring the liquid, striking the bow on the violin, etc.) to achieve a desirable outcome (cooking pasta sauce, playing a piece of Bach concerto, etc.).

The basic elements of any low-to-high MM sequence comprise movements for each subsystem, and combinations thereof are described as a set of commanded positions/velocities and forces/torques executed by one or more articulating joints under actuator power, in such a sequence as required. Fidelity of execution is guaranteed through a closed-loop behavior described within each MM sequence and enforced by local and global control algorithms inherent to each articulated joint controller and higher-level behavioral controllers.

Implementation of the above movements (described by articulating joint positions and velocities) and environment interactions (described by joint/interface torques and forces) is achieved by having computer playback desirable values for all required variables (positions/velocities and forces/torques) and feeding these to a controller system that faithfully implements them on each joint as a function of time at each time step. These variables and their sequence and feedback loops (hence not just data files, but also control programs), to ascertain the fidelity of the commanded movement/interactions, are all described in data-files that are combined into multi-level MMLs, which can be accessed and combined in multiple ways to allow a humanoid robot to execute multiple actions, such as cooking a meal, playing a piece of classical music on a piano, lifting an infirm person into/out-of a bed, etc. There are MMLs that describe simple rudimentary movement/interactions, which are then used as building-blocks for ever higher-level MMLs that describe ever-higher levels of manipulation, such as ‘grasp’, ‘lift’, ‘cut’ to higher level primitives, such as ‘stir liquid in pot’/‘pluck harp-string to g-flat’ or even high-level actions, such as ‘make a vinaigrette dressing’/‘paint a rural Brittany summer landscape’/‘play Bach's Piano-concerto #1’, etc. Higher level commands are simply a combination towards a sequence of serial/parallel lower- and mid-level MM primitives that are executed along a common timed stepped sequence, which is overseen by a combination of a set of planners running sequence/path/interaction profiles with feedback controllers to ensure the required execution fidelity (as defined in the output data contained within each MM sequence).

The values for the desirable positions/velocities and forces/torques and their execution playback sequence(s) can be achieved in multiple ways. One possible way is through watching and distilling the actions and movements of a human executing the same task, and distilling from the observation data (video, sensors, modeling software, etc.) the necessary variables and their values as a function of time and associating them with different minimanipulations at various levels by using specialized software algorithms to distill the required MM data (variables, sequences, etc.) into various types of low-to-high MMLs. This approach would allow a computer program to automatically generate the MMLs and define all sequences and associations automatically without any human involvement.

Another way would be (again by way of an automated computer-controlled process employing specialized algorithms) to learn from online data (videos, pictures, sound logs, etc.) how to build a required sequence of actionable sequences using existing low-level MMLs to build the proper sequence and combinations to generate a task-specific MML.

Yet another way, although most certainly more (time-) inefficient and less cost-effective, might be for a human programmer to assemble a set of low-level MM primitives to create an ever-higher level set of actions/sequences in a higher-level MML to achieve a more complex task-sequence, again composed of pre-existing lower-level MMLs.

Modification and improvements to individual variables (meaning joint position/velocities and torques/forces at each incremental time-interval and their associated gains and combination algorithms) and the motion/interaction sequences are also possible and can be effected in many different ways. It is possible to have learning algorithms monitor each and every motion/interaction sequence and perform simple variable-perturbations to ascertain outcome to decide on if/how/when/what variable(s) and sequence(s) to modify in order to achieve a higher level of execution fidelity at levels ranging from low- to high-levels of various MMLs. Such a process would be fully automatic and allow for updated data sets to be exchanged across multiple platforms that are interconnected, thereby allowing for massively parallel and cloud-based learning via cloud computing.

Advantageously, the robotic apparatus in a standardized robotic kitchen has the capabilities to prepare a wide array of cuisines from around the world through a global network and database access, as compared to a chef who may specialize in one type of cuisine. The standardized robotic kitchen also is able to capture and record favorite food dishes for replication by the robotic apparatus whenever desired to enjoy the food dish without the repetitive process of laboring to prepare the same dish repeatedly.

The structures and methods of the present disclosure are disclosed in detail in the description below. This summary does not purport to define the disclosure. The disclosure is defined by the claims. These and other embodiments, features, aspects, and advantages of the disclosure will become better understood with regard to the following description, appended claims, and accompanying drawings.

### BRIEF DESCRIPTION OF THE DRAWINGS

The disclosure will be described with respect to specific embodiments thereof, and reference will be made to the drawings, in which:

FIG. 1 is a system diagram illustrating an overall robotic food preparation kitchen with hardware and software in accordance with the present disclosure.

FIG. 2 is a system diagram illustrating a first embodiment of a food robot cooking system that includes a chef studio system and a household robotic kitchen system in accordance with the present disclosure.

FIG. 3 is system diagram illustrating one embodiment of the standardized robotic kitchen for preparing a dish by replicating a chef's recipe process, techniques, and movements in accordance with the present disclosure.

FIG. 4 is a system diagram illustrating one embodiment of a robotic food preparation engine for use with the computer in the chef studio system and the household robotic kitchen system in accordance with the present disclosure.

FIG. 5A is a block diagram illustrating a chef studio recipe-creation process in accordance with the present disclosure; FIG. 5B is block diagram illustrating one embodiment of a standardized teach/playback robotic kitchen in accordance with the present disclosure; FIG. 5C is a block diagram illustrating one embodiment of a recipe script generation and abstraction engine in accordance with the present disclosure; and FIG. 5D is a block diagram illustrating software elements for object-manipulation in the standardized robotic kitchen in accordance with the present disclosure.

FIG. 6 is a block diagram illustrating a multimodal sensing and software engine architecture in accordance with the present disclosure.

FIG. 7A is a block diagram illustrating a standardized robotic kitchen module used by a chef in accordance with the present disclosure; FIG. 7B is a block diagram illustrating the standardized robotic kitchen module with a pair of robotic arms and hands in accordance with the present disclosure; FIG. 7C is a block diagram illustrating one embodiment of a physical layout of the standardized robotic kitchen module used by a chef in accordance with the present disclosure; FIG. 7D is a block diagram illustrating one embodiment of a physical layout of the standardized robotic kitchen module used by a pair of robotic arms and hands in accordance with the present disclosure; FIG. 7E is a block diagram depicting the stepwise flow and methods to ensure that there are control or verification points during the recipe replication process based on the recipe-script when executed by the standardized robotic kitchen in accordance with the present disclosure; and FIG. 7F depicts a block diagram of a cloud-based recipe software for facilitating between the chef studio, the robotic kitchen and other sources.

FIG. 8A is a block diagram illustrating one embodiment of a conversion algorithm module between the chef movements and the robotic mirror movements in accordance with the present disclosure; FIG. 8B is a block diagram illustrating a pair of gloves with sensors worn by the chef for capturing and transmitting the chef's movements; FIG. 8C is a block diagram illustrating robotic cooking execution based on the captured sensory data from the chef's gloves in accordance with the present disclosure; FIG. 8D is a graphical diagram illustrating dynamically stable and dynamically unstable curves relative to equilibrium; FIG. 8E is a sequence diagram illustrating the process of food preparation that requires a sequence of steps that are referred to as stages in accordance with the present disclosure; FIG. 8F is a graphical diagram illustrating the probability of overall success as a function of the number of stages to prepare a food dish in accordance with the present disclosure; and FIG. 8G is a block diagram illustrating the execution of a recipe with multi-stage robotic food preparation with minimanipulations and action primitives.

FIG. 9A is a block diagram illustrating an example of robotic hand and wrist with haptic vibration, sonar, and camera sensors for detecting and moving a kitchen tool, an object, or a piece of kitchen equipment in accordance with the present disclosure; FIG. 9B is a block diagram illustrating a pan-tilt head with sensor camera coupled to a pair of robotic arms and hands for operation in the standardized robotic kitchen in accordance with the present disclosure; FIG. 9C is a block diagram illustrating sensor cameras on the robotic wrists for operation in the standardized robotic kitchen in accordance with the present disclosure; FIG. 9D is a block diagram illustrating an eye-in-hand on the robotic hands for operation in the standardized robotic kitchen in accordance with the present disclosure; and FIGS. 9E-9I are pictorial diagrams illustrating aspects of deformable palm in a robotic hand in accordance with the present disclosure.

FIG. 10A is block diagram illustrating examples of chef recording devices which a chef wears in the robotic kitchen environment for recording and capturing his or her movements during the food preparation process for a specific recipe; and FIG. 10B is a flow diagram illustrating one embodiment of the process in evaluating the captured chef's motions with robot poses, motions, and forces in accordance with the present disclosure.

FIGS. 11A-11B are pictorial diagrams illustrating one embodiment of a three-fingered haptic glove with sensors for food preparation by the chef and an example of a three-fingered robotic hand with sensors in accordance with the present disclosure; FIG. 11C is a block diagram illustrating one example of the interplay and interactions between a robotic arm and a robotic hand in accordance with the present disclosure; and FIG. 11D is a block diagram illustrating the robotic hand using the standardized kitchen handle that is attachable to a cookware head and the robotic arm attachable to kitchen ware in accordance with the present disclosure.

FIG. 12 is a block diagram illustrating the creation module of a minimanipulation database library and the execution module of the minimanipulation database library in accordance with the present disclosure.

FIG. 13A is a block diagram illustrating a sensing glove used by a chef to execute standardized operating movements in accordance with the present disclosure; and FIG. 13B is a block diagram illustrating a database of standardized operating movements in the robotic kitchen module in accordance with the present disclosure.

FIG. 14A is a graphical diagram illustrating that each of the robotic hand coated with an artificial human-like soft-skin glove in accordance with the present disclosure; FIG. 14B is a block diagram illustrating robotic hands coated with artificial human-like skin gloves to execute high-level minimanipulations based on a library database of minimanipulations, which have been predefined and stored in the library database, in accordance with the present disclosure; FIG. 14C is a graphical diagram illustrating three types of taxonomy of manipulation actions for food preparation in accordance with the present disclosure; and FIG. 14D is a flow diagram illustrating one embodiment on taxonomy of manipulation actions for food preparation in accordance with the present disclosure.

FIG. 15 is a block diagram illustrating the creation of a minimanipulation that results in cracking an egg with a knife, an example in accordance with the present disclosure.

FIG. 16 is a block diagram illustrating an example of recipe execution for a minimanipulation with real-time adjustment in accordance with the present disclosure.

FIG. 17 is a flow diagram illustrating the software process to capture a chef's food preparation movements in a standardized kitchen module in accordance with the present disclosure.

FIG. 18 is a flow diagram illustrating the software process for food preparation by robotic apparatus in the robotic standardized kitchen module in accordance with the present disclosure.

FIG. 19 is a flow diagram illustrating one embodiment of the software process for creating, testing, validating, and storing the various parameter combinations for a minimanipulation system in accordance with the present disclosure.

FIG. 20 is a flow diagram illustrating one embodiment of the software process for creating the tasks for a minimanipulation system in accordance with the present disclosure.

FIG. 21A is a flow diagram illustrating the process of assigning and utilizing a library of standardized kitchen tools, standardized objects, and standardized equipment in a standardized robotic kitchen in accordance with the present disclosure.

FIG. 21B is a flow diagram illustrating the process of identifying a non-standardized object with three-dimensional modeling in accordance with the present disclosure.

FIG. 21C is a flow diagram illustrating the process for testing and learning of minimanipulations in accordance with the present disclosure.

FIG. 21D is a flow diagram illustrating the process for robotic arms quality control and alignment function process in accordance with the present disclosure.

FIG. 22 is a block diagram illustrating the general applicability (or universal) of a robotic human-skill replication system with a creator recording system and a commercial robotic system in accordance with the present disclosure.

FIG. 23 is a software system diagram illustrating the robotic human-skill replication engine with various modules in accordance with the present disclosure.

FIG. 24 is a block diagram illustrating one embodiment of the robotic human-skill replication system in accordance with the present disclosure.

FIG. 25 is a block diagram illustrating a humanoid with controlling points for skill execution or replication process with standardized operating tools, standardized positions, and orientations, and standardized equipment in accordance with the present disclosure.

FIG. 26 is a simplified block diagram illustrating a humanoid replication program that replicates the recorded process of human-skill movements by tracking the activity of glove sensors on periodic time intervals in accordance with the present disclosure.

FIG. 27 is a block diagram illustrating the creator movement recording and humanoid replication in accordance with the present disclosure.

FIG. 28 depicts the overall robotic control platform for a general-purpose humanoid robot at as a high-level description of the functionality of the present disclosure.

FIG. 29 is a block diagram illustrating the schematic for generation, transfer, implementation, and usage of minimanipulation libraries as part of a humanoid application-task replication process in accordance with the present disclosure.

FIG. 30 is a block diagram illustrating studio and robot-based sensory-Data input categories and types in accordance with the present disclosure.

FIG. 31 is a block diagram illustrating physical-/system-based minimanipulation library action-based dual-arm and torso topology in accordance with the present disclosure.

FIG. 32 is a block diagram illustrating minimanipulation library manipulation-phase combinations and transitions for task-specific action-sequences in accordance with the present disclosure.

FIG. 33 is a block diagram illustrating one or more minimanipulation libraries, (generic and task-specific) building process from studio data in accordance with the present disclosure.

FIG. 34 is a block diagram illustrating robotic task-execution via one or more minimanipulation library data sets in accordance with the present disclosure.

FIG. 35 is a block diagram illustrating a schematic for automated minimanipulation parameter-set building engine in accordance with the present disclosure.

FIG. 36A is a block diagram illustrating a data-centric view of the robotic system in accordance with the present disclosure.

FIG. 36B is a block diagram illustrating examples of various minimanipulation data formats in the composition, linking, and conversion of minimanipulation robotic behavior data accordance with the present disclosure.

FIG. 37 is a block diagram illustrating the different levels of bidirectional abstractions between the robotic hardware technical concepts, the robotic software technical concepts, the robotic business concepts, and mathematical algorithms for carrying the robotic technical concepts in accordance with the present disclosure.

FIG. 38 is a block diagram illustrating a pair of robotic arms and hands, and each hand with five fingers in accordance with the present disclosure.

FIG. 39 is a block diagram illustrating performing a task by robot by execution in multiple stages with general minimanipulations in accordance with the present disclosure.

FIG. 40 is a block diagram illustrating the real-time parameter adjustment during the execution phase of minimanipulations in accordance with the present disclosure.

FIG. 41 is a diagrammatic view of a kitchen module of one embodiment in accordance with the present disclosure.

FIG. 42 is a diagrammatic view of a kitchen module of one embodiment in accordance with the present disclosure.

FIG. 43 is a diagrammatic view of a kitchen module of one embodiment in accordance with the present disclosure.

FIG. 44 is a diagrammatic view of a kitchen module of one embodiment in accordance with the present disclosure.

FIG. 45 is a diagrammatic view of a kitchen module of one embodiment in accordance with the present disclosure.

FIG. 46 is a diagrammatic view of a kitchen module of one embodiment in accordance with the present disclosure.

FIG. 47 is a diagrammatic view of a kitchen module of one embodiment in accordance with the present disclosure.

FIG. 48 is a diagrammatic view of an extractor system of a kitchen module of one embodiment in accordance with the present disclosure.

FIG. 49 is a diagrammatic view of a storage arrangement of one embodiment in accordance with the present disclosure.

FIG. 50 is a diagrammatic view of a storage unit of one embodiment in accordance with the present disclosure.

FIG. 51 is a diagrammatic view of part of a storage unit of one embodiment in accordance with the present disclosure.

FIG. 52 is a diagrammatic view of a storage arrangement of one embodiment in accordance with the present disclosure.

FIG. 53 is a diagrammatic view of a storage arrangement of one embodiment in accordance with the present disclosure.

FIG. 54 is a diagrammatic view of a storage arrangement of one embodiment in accordance with the present disclosure.

FIG. 55 is a diagrammatic view of a storage arrangement of one embodiment in accordance with the present disclosure.

FIG. 56 is a diagrammatic view of a container of one embodiment in accordance with the present disclosure.

FIG. 57 is a diagrammatic view of a storage unit of one embodiment in accordance with the present disclosure.

FIG. 58 is a diagrammatic view of a cooling system of one embodiment in accordance with the present disclosure.

FIG. 59 is a diagrammatic view of a container arrangement of one embodiment in accordance with the present disclosure.

FIG. 60 is a diagrammatic view of a container arrangement of one embodiment in accordance with the present disclosure.

FIG. 61 is a diagrammatic view of a container arrangement of one embodiment in accordance with the present disclosure.

FIG. 62 is a diagrammatic view of a storage arrangement of one embodiment in accordance with the present disclosure.

FIG. 63 is a diagrammatic view of a storage arrangement of one embodiment in accordance with the present disclosure.

FIG. 64 is a diagrammatic view of a container of one embodiment in accordance with the present disclosure.

FIG. 65 is a diagrammatic view of a container of one embodiment in accordance with the present disclosure.

FIG. 66 is a diagrammatic view of a container of one embodiment in accordance with the present disclosure.

FIG. 67 is a diagrammatic view of a storage arrangement of one embodiment in accordance with the present disclosure.

FIG. 68 is a diagrammatic view of a storage arrangement of one embodiment in accordance with the present disclosure.

FIG. 69 is a diagrammatic view of a storage arrangement of one embodiment in accordance with the present disclosure.

FIG. 70 is a diagrammatic view of a storage arrangement of one embodiment in accordance with the present disclosure.

FIG. 71 is a diagrammatic view of containers of one embodiment in accordance with the present disclosure.

FIG. 72 is a diagrammatic view of containers of one embodiment in accordance with the present disclosure.

FIG. 73 is a diagrammatic view of a storage arrangement of one embodiment in accordance with the present disclosure.

FIG. 74 is a diagrammatic view of a storage arrangement of one embodiment in accordance with the present disclosure.

FIG. 75 is a diagrammatic view of a storage arrangement of one embodiment in accordance with the present disclosure.

FIG. 76 is a diagrammatic view of a rotatable oven of one embodiment in accordance with the present disclosure.

FIG. 77 is a diagrammatic view of a rotatable oven of one embodiment in accordance with the present disclosure.

FIG. 78 is a diagrammatic view of a rotatable oven of one embodiment in accordance with the present disclosure.

FIG. 79 is a diagrammatic view of a rotatable oven of one embodiment in accordance with the present disclosure.

FIGS. 80A-80B is a diagrammatic view of a rotatable oven of one embodiment in accordance with the present disclosure.

FIGS. 81A-81B is a diagrammatic view of a rotatable oven of one embodiment in accordance with the present disclosure.

FIG. 82 is a diagrammatic view of a container of one embodiment in accordance with the present disclosure.

FIG. 83 is a diagrammatic view of a container of one embodiment in accordance with the present disclosure.

FIG. 84 is a diagrammatic view of a container of one embodiment in accordance with the present disclosure.

FIG. 85 is a diagrammatic view of a container of one embodiment in accordance with the present disclosure.

FIG. 86 is a diagrammatic view of a container of one embodiment in accordance with the present disclosure.

FIG. 87 is a diagrammatic view of a container of one embodiment in accordance with the present disclosure.

FIG. 88 is a diagrammatic view of a container of one embodiment in accordance with the present disclosure.

FIG. 89 is a diagrammatic view of a support frame of one embodiment in accordance with the present disclosure.

FIG. 90 is a diagrammatic view of a container of one embodiment in accordance with the present disclosure.

FIG. 91 is a diagrammatic view of a support frame of one embodiment in accordance with the present disclosure.

FIG. 92 is a diagrammatic view of a container of one embodiment in accordance with the present disclosure.

FIG. 93 is a diagrammatic view of a container of one embodiment in accordance with the present disclosure.

FIG. 94 is a diagrammatic view of a container of one embodiment in accordance with the present disclosure.

FIG. 95 is a diagrammatic view of a container of one embodiment in accordance with the present disclosure.

FIG. 96 is a diagrammatic view of a container of one embodiment in accordance with the present disclosure.

FIG. 97 is a diagrammatic view of a container of one embodiment in accordance with the present disclosure.

FIG. 98 is a diagrammatic view of a container of one embodiment in accordance with the present disclosure.

FIG. 99 is a diagrammatic view of a container of one embodiment in accordance with the present disclosure.

FIG. 100 is a diagrammatic view of a container of one embodiment in accordance with the present disclosure.

FIG. 101 is a diagrammatic view of a container of one embodiment in accordance with the present disclosure.

FIG. 102 is a diagrammatic view of a container of one embodiment in accordance with the present disclosure.

FIG. 103 is a diagrammatic view of a container of one embodiment in accordance with the present disclosure.

FIG. 104 is a diagrammatic view of a container of one embodiment in accordance with the present disclosure.

FIG. 105 is a diagrammatic view of a container of one embodiment in accordance with the present disclosure

FIG. 106 is a diagrammatic view of a container of one embodiment in accordance with the present disclosure.

FIG. 107 is a diagrammatic view of a robotic hand of one embodiment in accordance with the present disclosure

FIG. 108 is a diagrammatic view of a robotic hand of one embodiment in accordance with the present disclosure.

FIG. 109 is a diagrammatic view of part of a robotic hand of one embodiment in accordance with the present disclosure.

FIG. 110 is a diagrammatic view of part of a robotic hand of one embodiment in accordance with the present disclosure.

FIG. 111 is a diagrammatic view of sensor of one embodiment in accordance with the present disclosure.

FIG. 112 is a diagrammatic view of part of a robotic hand of one embodiment in accordance with the present disclosure.

FIG. 113 is a diagrammatic view of part of a robotic hand of one embodiment in accordance with the present disclosure.

FIG. 114 is a block diagram of a robotic cooking system of one embodiment in accordance with the present disclosure.

FIG. 115 is a block diagram of a robotic cooking system of one embodiment in accordance with the present disclosure.

FIG. 116 is a flow diagram of a robotic cooking system of one embodiment in accordance with the present disclosure.

FIG. 117 is a flow diagram of a robotic cooking system of one embodiment in accordance with the present disclosure.

FIG. 118 is a flow diagram of a robotic cooking system of one embodiment in accordance with the present disclosure.

FIG. 119 is a flow diagram of a robotic cooking system of one embodiment in accordance with the present disclosure.

FIG. 120 is a flow diagram of a robotic cooking system of one embodiment in accordance with the present disclosure.

FIG. 121 is a flow diagram of a robotic cooking system of one embodiment in accordance with the present disclosure.

FIG. 122 is a flow diagram of a robotic cooking system of one embodiment in accordance with the present disclosure.

FIG. 123 is an illustration of a cooking system structure of one embodiment in accordance with the present disclosure.

FIG. 124 is an illustration of a cooking system structure of one embodiment in accordance with the present disclosure.

FIG. 125 is a flow diagram of a robotic cooking system of one embodiment in accordance with the present disclosure.

FIG. 126 is a schematic diagram of a robotic cooking system of one embodiment in accordance with the present disclosure.

FIG. 127 is an illustration of a cooking system structure of one embodiment in accordance with the present disclosure.

FIG. 128 is an illustration of a cooking system structure of one embodiment in accordance with the present disclosure.

FIG. 129 is an illustration of a cooking system structure of one embodiment in accordance with the present disclosure.

FIG. 130 is a flow diagram of part of a robotic cooking system of one embodiment in accordance with the present disclosure.

FIG. 131 is an illustration of a manipulation in a cooking system of one embodiment in accordance with the present disclosure.

FIG. 132 is an illustration of a manipulation in a cooking system of one embodiment in accordance with the present disclosure.

FIG. 133 is an illustration of a manipulation in a cooking system of one embodiment in accordance with the present disclosure.

FIG. 134 is an illustration of a manipulation in a cooking system of one embodiment in accordance with the present disclosure.

FIG. 135 is a diagrammatic view of a kitchen module of one embodiment in accordance with the present disclosure.

FIG. 136 is a diagrammatic view of a kitchen module of one embodiment in accordance with the present disclosure.

FIG. 137 is a diagrammatic view of a kitchen module of one embodiment in accordance with the present disclosure.

FIG. 138 is a flow diagram of part of an object recognition process of one embodiment in accordance with the present disclosure.

FIG. 139 is a flow diagram of part of an object recognition process of one embodiment in accordance with the present disclosure.

FIG. 140 is a flow diagram of an object recognition process of one embodiment in accordance with the present disclosure.

FIG. 141 is a flow diagram showing the operation of a weight sensing system of a robotic kitchen module of one embodiment in accordance with the present disclosure.

FIG. 142 is a flow diagram showing the operation of a weight sensing system of a robotic kitchen module of one embodiment in accordance with the present disclosure.

FIG. 143 is a flow diagram showing the operation of a weight sensing system of a robotic kitchen module of one embodiment in accordance with the present disclosure.

FIG. 144 is a flow diagram showing the operation of a weight sensing system of a robotic kitchen module of one embodiment in accordance with the present disclosure.

FIG. 145 is a flow diagram showing the operation of a weight sensing system of a robotic kitchen module of one embodiment in accordance with the present disclosure.

FIG. 146 is a diagrammatic illustration of a handle of one embodiment in accordance with the present disclosure.

FIG. 147 is a diagrammatic illustration of a handle of one embodiment in accordance with the present disclosure.

FIG. 148 is a diagrammatic illustration of a customized appliance of one embodiment in accordance with the present disclosure.

FIG. 149 is a diagrammatic illustration of a customized appliance of one embodiment in accordance with the present disclosure.

FIG. 150 is schematic diagram of robotic kitchen of one embodiment in accordance with the present disclosure.

FIG. 151A is schematic diagram of robotic arm of one embodiment in accordance with the present disclosure.

FIG. 151B is schematic diagram of robotic arm of one embodiment in accordance with the present disclosure.

FIG. 151C is schematic diagram of robotic arm of one embodiment in accordance with the present disclosure.

FIG. 151D is schematic diagram of robotic arm of one embodiment in accordance with the present disclosure.

FIG. 152A is schematic diagram of a weight sensing process of one embodiment in accordance with the present disclosure in accordance with the present disclosure.

FIG. 152B is schematic diagram of a weight sensing process of one embodiment in accordance with the present disclosure.

FIG. 152C is schematic diagram of a weight sensing process of one embodiment in accordance with the present disclosure.

FIG. 153A is a flow diagram of a weight sensing process of one embodiment in accordance with the present disclosure.

FIG. 153B is a flow diagram of a weight sensing process of one embodiment in accordance with the present disclosure.

FIG. 154 is a flow diagram of a weight sensing process of one embodiment in accordance with the present disclosure.

FIG. 155 is a flow diagram of a weight sensing process of one embodiment in accordance with the present disclosure.

FIG. 156 is a flow diagram of a weight sensing process of one embodiment in accordance with the present disclosure.

FIG. 157 is a flow diagram of a weight sensing process of one embodiment in accordance with the present disclosure.

FIG. 158 is a flow diagram of a weight sensing process of one embodiment in accordance with the present disclosure.

FIG. 159 is a flow diagram of a weight sensing process of one embodiment in accordance with the present disclosure.

FIG. 160 is a flow diagram of a weight sensing process of one embodiment in accordance with the present disclosure.

FIG. 161 is a flow diagram of a weight sensing process of one embodiment in accordance with the present disclosure.

FIG. 162 is a flow diagram of an object interaction process of one embodiment in accordance with the present disclosure.

FIG. 163 is a flow diagram of an object interaction process of one embodiment in accordance with the present disclosure.

FIG. 164 is a flow diagram of an object interaction process of one embodiment in accordance with the present disclosure.

FIG. 165 is a flow diagram of an object interaction process of one embodiment, and

FIG. 166 is a flow diagram of security process of one embodiment in accordance with the present disclosure.

FIG. 167 is a block diagram illustrating an example of a computer device on which computer-executable instructions perform the robotic methodologies discussed herein and which may be installed and executed.

### DETAILED DESCRIPTION

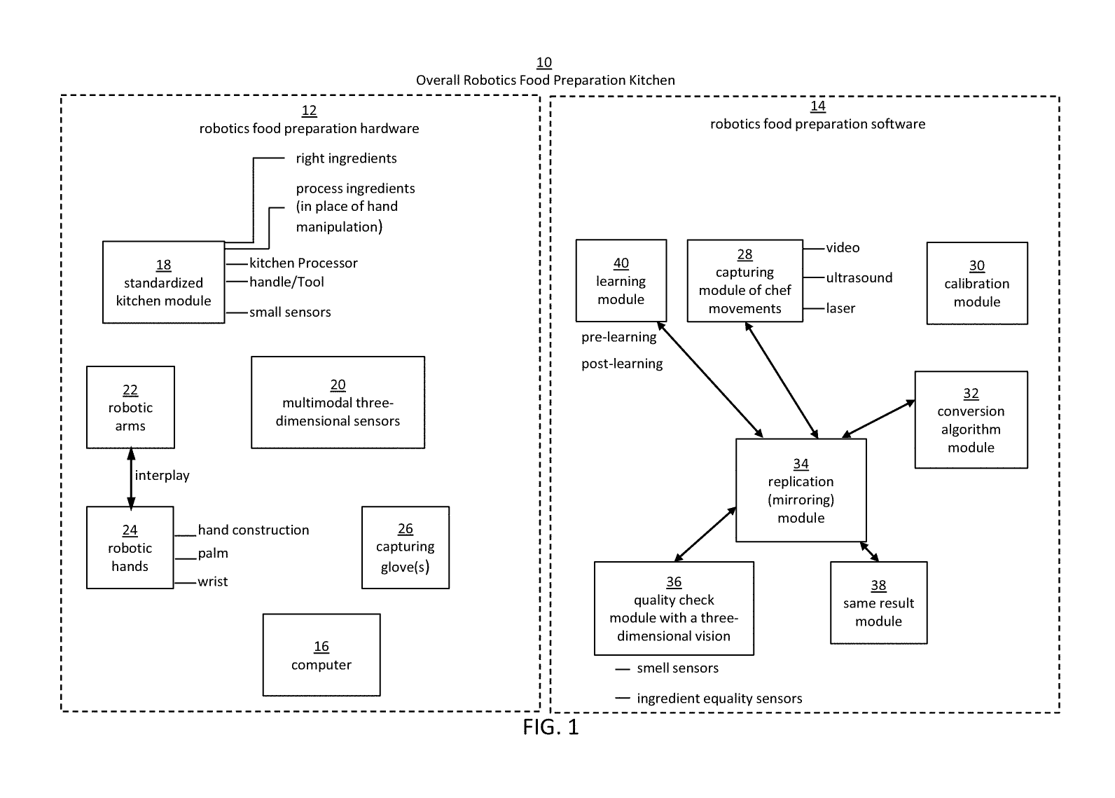

A description of structural embodiments and methods of the present disclosure is provided with reference to FIGS. 1-167. It is to be understood that there is no intention to limit the disclosure to the specifically disclosed embodiments but that the disclosure may be practiced using other features, elements, methods, and embodiments. Like elements in various embodiments are commonly referred to with like reference numerals.

The following definitions apply to the elements and steps described herein. These terms may likewise be expanded upon.

Abstraction Data—refers to the abstraction recipe of utility for machine-execution, which has many other data-elements that a machine needs to know for proper execution and replication. This so-called meta-data, or additional data corresponding to a particular step in the cooking process, whether it be direct sensor-data (clock-time, water-temperature, camera-image, utensil or ingredient used, etc.) or data generated through interpretation or abstraction of larger data-sets (such as a 3-Dimensional range cloud from a laser used to extract the location and types of objects in the image, overlaid with texture and color maps from a camera-picture, etc.). The meta-data is time-stamped and used by the robotic kitchen to set, control, and monitor all processes and associated methods and equipment needed at every point in time as it steps through the sequence of steps in the recipe.

Abstraction Recipe—refers to a representation of a chef's recipe, which a human knows as represented by the use of certain ingredients, in certain sequences, prepared and combined through a sequence of processes and methods, as well as skills of the human chef. An abstraction recipe used by a machine for execution in an automated way requires different types of classifications and sequences. While the overall steps carried out are identical to those of the human chef, the abstraction recipe of utility to the robotic kitchen requires that additional meta-data be a part of every step in the recipe. Such meta-data includes the cooking time and variables, such as temperature (and its variations over time), oven-setting, tool/equipment used, etc. Basically a machine-executable recipe-script needs to have all possible measured variables of import to the cooking process (all measured and stored while the human chef was preparing the recipe in the chef studio) correlated to time, both overall and that within each process-step of the cooking-sequence. Hence, the abstraction recipe is a representation of the cooking steps mapped into a machine-readable representation or domain, which takes the required process from the human-domain to that of the machine-understandable and machine-executable domain through a set of logical abstraction steps.

Acceleration—refers to the maximum rate of speed-change at which a robotic arm can accelerate around an axis or along a space-trajectory over a short distance.

Accuracy—refers to how closely a robot can reach a commanded position. Accuracy is determined by the difference between the absolute positions of the robot compared to the commanded position. Accuracy can be improved, adjusted, or calibrated with external sensing, such as sensors on a robotic hand or a real-time three-dimensional model using multiple (multi-mode) sensors.

Action Primitive—in one embodiment, the term refers to an indivisible robotic action, such as moving the robotic apparatus from location X1 to location X2, or sensing the distance from an object for food preparation without necessarily obtaining a functional outcome. In another embodiment, the term refers to an indivisible robotic action in a sequence of one or more such units for accomplishing a minimanipulation. These are two aspects of the same definition.

Automated Dosage System—refers to dosage containers in a standardized kitchen module where a particular size of food chemical compounds (such as salt, sugar, pepper, spice, any kind of liquids, such as water, oil, essences, ketchup, etc.) is released upon application.

Automated Storage and Delivery System—refers to storage containers in a standardized kitchen module that maintain a specific temperature and humidity for storing food; each storage container is assigned a code (e.g., a bar code) for the robotic kitchen to identify and retrieve where a particular storage container delivers the food contents stored therein.

Data Cloud—refers to a collection of sensor or data-based numerical measurement values from a particular space (three-dimensional laser/acoustic range measurement, RGB-values from a camera image, etc.) collected at certain intervals and aggregated based on a multitude of relationships, such as time, location, etc.

Degree of Freedom (“DOF”)—refers to a defined mode and/or direction in which a mechanical device or system can move. The number of degrees of freedom is equal to the total number of independent displacements or aspects of motion. The total number of degrees of freedom is doubled for two robotic arms.

Edge Detection—refers to a software-based computer program(s) capable of identifying the edges of multiple objects that may be overlapping in a two-dimensional-image of a camera yet successfully identifying their boundaries to aid in object identification and planning for grasping and handling.

Equilibrium Value—refers to the target position of a robotic appendage, such as a robotic arm where the forces acting upon it are in equilibrium, i.e. there is no net force and thus no net movement.

Execution Sequence Planner—refers to a software-based computer program(s) capable of creating a sequence of execution scripts or commands for one or more elements or systems capable of being computer controlled, such as arm(s), dispensers, appliances, etc.

Food Execution Fidelity—refers to a robotic kitchen, which is intended to replicate the recipe-script generated in the chef studio by watching, measuring, and understanding the steps, variables, methods, and processes of the human chef, thereby trying to emulate his/her techniques and skills. The fidelity of how close the execution of the dish-preparation comes to that of the human-chef is measured by how close the robotically-prepared dish resembles the human-prepared dish as measured by a variety of subjective elements, such as consistency, color, taste, etc. The notion is that the more closely the dish prepared by the robotic kitchen is to that prepared by the human chef, the higher the fidelity of the replication process.

Food Preparation Stage (also referred to as “Cooking Stage”)—refers to a combination, either sequential or in parallel, of one or more minimanipulations including action primitives, and computer instructions for controlling the various kitchen equipment and appliances in the standardized kitchen module. One or more food preparation stages collectively represent the entire food preparation process for a particular recipe.

Geometric Reasoning—refers to a software-based computer program(s) capable of using a two-dimensional (2D)/three-dimensional (3D) surface, and/or volumetric data to reason as to the actual shape and size of a particular volume. The ability to determine or utilize boundary information also allows for inferences as to the start and end of a particular geometric element and the number present in an image or model.

Grasp Reasoning—refers to a software-based computer program(s) capable of relying on geometric and physical reasoning to plan a multi-contact (point/area/volume) interaction between a robotic end-effector (gripper, link, etc.), or even tools/utensils held by the end-effector, so as to successfully contact, grasp, and hold the object in order to manipulate it in a three-dimensional space.

Hardware Automation Device-fixed process device capable of executing pre-programmed steps in succession without the ability to modify any of them; such devices are used for repetitive motions that do not need any modulation.

Ingredient Management and Manipulation—refers to defining each ingredient in detail (including size, shape, weight, dimensions, characteristics, and properties), one or more real-time adjustments in the variables associated with the particular ingredient that may differ from the previous stored ingredient details (such as the size of a fish fillet, the dimensions of an egg, etc.), and the process in executing the different stages for the manipulation movements to an ingredient.

Kitchen Module (or Kitchen Volume)—a standardized full-kitchen module with standardized sets of kitchen equipment, standardized sets of kitchen tools, standardized sets of kitchen handles, and standardized sets of kitchen containers, with predefined space and dimensions for storing, accessing, and operating each kitchen element in the standardized full-kitchen module. One objective of a kitchen module is to predefine as much of the kitchen equipment, tools, handles, containers, etc. as possible, so as to provide a relatively fixed kitchen platform for the movements of robotic arms and hands. Both a chef in the chef kitchen studio and a person at home with a robotic kitchen (or a person at a restaurant) uses the standardized kitchen module, so as to maximize the predictability of the kitchen hardware, while minimizing the risks of differentiations, variations, and deviations between the chef kitchen studio and a home robotic kitchen. Different embodiments of the kitchen module are possible, including a standalone kitchen module and an integrated kitchen module. The integrated kitchen module is fitted into a conventional kitchen area of a typical house. The kitchen module operates in at least two modes, a robotic mode and a normal (manual) mode.

Machine Learning—refers to the technology wherein a software component or program improves its performance based on experience and feedback. One kind of machine learning often used in robotics is reinforcement learning, where desirable actions are rewarded and undesirable ones are penalized. Another kind is case-based learning, where previous solutions, e.g. sequences of actions by a human teacher or by the robot itself are remembered, together with any constraints or reasons for the solutions, and then are applied or reused in new settings. There are also additional kinds of machine learning, such as inductive and transductive methods.

Minimanipulation (MM)—generally, MM refers to one or more behaviors or task-executions in any number or combinations and at various levels of descriptive abstraction, by a robotic apparatus that executes commanded motion-sequences under sensor-driven computer-control, acting through one or more hardware-based elements and guided by one or more software-controllers at multiple levels, to achieve a required task-execution performance level to arrive at an outcome approaching an optimal level within an acceptable execution fidelity threshold. The acceptable fidelity threshold is task-dependent and therefore defined for each task (also referred to as “domain-specific application”). In the absence of a task-specific threshold, a typical threshold would be 0.001 (0.1%) of optimal performance.

In one embodiment from a robotic technology perspective, the term MM refers to a well-defined pre-programmed sequence of actuator actions and collection of sensory feedback in a robot's task-execution behavior, as defined by performance and execution parameters (variables, constants, controller-type and -behaviors, etc.), used in one or more low-to-high level control-loops to achieve desired motion/interaction behavior for one or more actuators ranging from individual actuations to a sequence of serial and/or parallel multi-actuator coordinated motions (position and velocity)/interactions (force and torque) to achieve a specific task with desirable performance metrics. MMs can be combined in various ways by combining lower-level MM behaviors in serial and/or parallel to achieve ever-higher and higher-level more-and-more complex application-specific task behaviors with an ever higher level of (task-descriptive) abstraction.

In another embodiment from a software/mathematical perspective, the term MM refers to a combination (or a sequence) of one or more steps that accomplish a basic functional outcome within a threshold value of the optimal outcome (examples of threshold value as within 0.1, 0.01, 0.001, or 0.0001 of the optimal value with 0.001 as the preferred default). Each step can be an action primitive, corresponding to a sensing operation or an actuator movement, or another (smaller) MM, similar to a computer program comprised of basic coding steps and other computer programs that may stand alone or serve as sub-routines. For instance, a MM can be grasping an egg, comprised of the motor actions required to sense the location and orientation of the egg, then reaching out a robotic arm, moving the robotic fingers into the right configuration, and applying the correct delicate amount of force for grasping: all primitive actions. Another MM can be breaking-an-egg-with-a-knife, including the grasping MM with one robotic hand, followed by grasping-a-knife MM with the other hand, followed by the primitive action of striking the egg with the knife using a predetermined force at a predetermined location.

High-Level Application-specific Task Behaviors—refers to behaviors that can be described in natural human-understandable language and are readily recognizable by a human as clear and necessary steps in accomplishing or achieving a high-level goal. It is understood that many other lower-level behaviors and actions/movements need to take place by a multitude of individually actuated and controlled degrees of freedom, some in serial and parallel or even cyclical fashion, in order to successfully achieve a higher-level task-specific goal. Higher-level behaviors are thus made up of multiple levels of low-level MMs in order to achieve more complex, task-specific behaviors. As an example, the command of playing on a harp the first note of the 1^{st} bar of a particular sheet of music, presumes the note is known (i.e., g-flat), but now lower-level MMs have to take place involving actions by a multitude of joints to curl a particular finger, move the whole hand or shape the palm so as to bring the finger into contact with the correct string, and then proceed with the proper speed and movement to achieve the correct sound by plucking/strumming the cord. All these individual MMs of the finger and/or hand/palm in isolation can all be considered MMs at various low levels, as they are unaware of the overall goal (extracting a particular note from a specific instrument). While the task-specific action of playing a particular note on a given instrument so as to achieve the necessary sound, is clearly a higher-level application-specific task, as it is aware of the overall goal and need to interplay between behaviors/motions and is in control of all the lower-level MMs required for a successful completion. One could even go as far as defining playing a particular musical note as a lower-level MM to the overall higher-level applications-specific task behavior or command, spelling out the playing of an entire piano-concerto, where playing individual notes could each be deemed as low-level MM behaviors structured by the sheet music as the composer intended.

Low-Level Minimanipulation Behaviors—refers to movements that are elementary and required as basic building blocks for achieving a higher-level task-specific motion/movement or behavior. The low-level behavioral blocks or elements can be combined in one or more serial or parallel fashion to achieve a more complex medium or a higher-level behavior. As an example, curling a single finger at all finger joints is a low-level behavior, as it can be combined with curling all other fingers on the same hand in a certain sequence and triggered to start/stop based on contact/force-thresholds to achieve the higher-level behavior of grasping, whether this be a tool or a utensil. Hence, the higher-level task-specific behavior of grasping is made up of a serial/parallel combination of sensory-data driven low-level behaviors by each of the five fingers on a hand. All behaviors can thus be broken down into rudimentary lower levels of motions/movements, which when combined in certain fashion achieve a higher-level task behavior. The breakdown or boundary between low- and high-level behaviors can be somewhat arbitrary, but one way to think of it is that movements or actions or behaviors that humans tend to carry out without much conscious thinking (such as curling ones fingers around a tool/utensil until contact is made and enough contact-force is achieved) as part of a more human-language task-action (such as “grab the tool”), can and should be considered low-level. In terms of a machine-language execution language, all actuator-specific commands, which are devoid of higher-level task awareness, are certainly considered low-level behaviors.

Model Elements and Classification—refers to one or more software-based computer program(s) capable of understanding elements in a scene as being items that are used or needed in different parts of a task; such as a bowl for mixing and the need for a spoon to stir, etc. Multiple elements in a scene or a world-model may be classified into groupings allowing for faster planning and task-execution.

Motion Primitives—refers to motion actions that define different levels/domains of detailed action steps, e.g. a high-level motion primitive would be to grab a cup, and a low-level motion primitive would be to rotate a wrist by five degrees.

Multimodal Sensing Unit—refers to a sensing unit comprised of multiple sensors capable of sensing and detecting multiple modes or electromagnetic bands or spectra: particularly, capable of capturing three-dimensional position and/or motion information. The electromagnetic spectrum can range from low to high frequencies and does not need to be limited to that perceived by a human being. Additional modes might include, but are not limited to, other physical senses such as touch, smell, etc.

Number of Axes—three axes are required to reach any point in space. To fully control the orientation of the end of the arm (i.e. the wrist), three additional rotational axes (yaw, pitch, and roll) are required.

Parameters—refers to variables that can take numerical values or ranges of numerical values. Three kinds of parameters are particularly relevant: parameters in the instructions to a robotic device (e.g. the force or distance in an arm movement), user-settable parameters (e.g. prefers meat well done vs. medium), and chef-defined parameters (e.g. set oven temperature to 350 F).

Parameter Adjustment—refers to the process of changing the values of parameters based on inputs. For instance changes in the parameters of instructions to the robotic device can be based on the properties (e.g. size, shape, orientation) of, but not limited to, the ingredients, position/orientation of kitchen tools, equipment, appliances, speed, and time duration of a minimanipulation.

Payload or Carrying Capacity—refers to how much weight a robotic arm can carry and hold (or even accelerate) against the force of gravity as a function of its endpoint location.

Physical Reasoning—refers to a software-based computer program(s) capable of relying on geometrically-reasoned data and using physical information (density, texture, typical geometry, and shape) to assist an inference-engine (program) to better model the object and also predict its behavior in the real world, particularly when grasped and/or manipulated/handled.

Raw Data—refers to all measured and inferred sensory-data and representation information that is collected as part of the chef-studio recipe-generation process while watching/monitoring a human chef preparing a dish. Raw data can range from a simple data-point such as clock-time, to oven temperature (overtime), camera-imagery, three-dimensional laser-generated scene representation data, to appliances/equipment used, tools employed, ingredients (type and amount) dispensed and when, etc. All the information the studio-kitchen collects from its built-in sensors and stores in raw, time-stamped form, is considered raw data. Raw data is then used by other software processes to generate an even higher level of understanding and recipe-process understanding, turning raw data into additional time-stamped processed/interpreted data.

Robotic Apparatus—refers the set of robotic sensors and effectors. The effectors comprise one or more robotic arms and one or more robotic hands for operation in the standardized robotic kitchen. The sensors comprise cameras, range sensors, and force sensors (haptic sensors) that transmit their information to the processor or set of processors that control the effectors.

Recipe Cooking Process—refers to a robotic script containing abstract and detailed levels of instructions to a collection of programmable and hard-automation devices, to allow computer-controllable devices to execute a sequenced operation within its environment (e.g. a kitchen replete with ingredients, tools, utensils, and appliances).

Recipe Script—refers to a recipe script as a sequence in time containing a structure and a list of commands and execution primitives (simple to complex command software) that, when executed by the robotic kitchen elements (robot-arm, automated equipment, appliances, tools, etc.) in a given sequence, should result in the proper replication and creation of the same dish as prepared by the human chef in the studio-kitchen. Such a script is sequential in time and equivalent to the sequence employed by the human chef to create the dish, albeit in a representation that is suitable and understandable by the computer-controlled elements in the robotic kitchen.

Recipe Speed Execution—refers to managing a timeline in the execution of recipe steps in preparing a food dish by replicating a chef's movements, where the recipe steps include standardized food preparation operations (e.g., standardized cookware, standardized equipment, kitchen processors, etc.), MMs, and cooking of non-standardized objects.

Repeatability—refers to an acceptable preset margin in how accurately the robotic arms/hands can repeatedly return to a programmed position. If the technical specification in a control memory requires the robotic hand to move to a certain X-Y-Z position and within +/−0.1 mm of that position, then the repeatability is measured for the robotic hands to return to within +/−0.1 mm of the taught and desired/commanded position.

Robotic Recipe Script—refers to a computer-generated sequence of machine-understandable instructions related to the proper sequence of robotically/hard-automation execution of steps to mirror the required cooking steps in a recipe to arrive at the same end-product as if cooked by a chef.

Robotic Costume—External instrumented device(s) or clothing, such as gloves, clothing with camera-tractable markers, jointed exoskeleton, etc., used in the chef studio to monitor and track the movements and activities of the chef during all aspects of the recipe cooking process(es).

Scene Modeling—refers to a software-based computer program(s) capable of viewing a scene in one or more cameras' fields of view and being capable of detecting and identifying objects of importance to a particular task. These objects may be pre-taught and/or be part of a computer library with known physical attributes and usage-intent.

Smart Kitchen Cookware/Equipment—refers to an item of kitchen cookware (e.g., a pot or a pan) or an item of kitchen equipment (e.g., an oven, a grill, or a faucet) with one or more sensors that prepares a food dish based on one or more graphical curves (e.g., a temperature curve, a humidity curve, etc.).

Software Abstraction Food Engine—refers to a software engine that is defined as a collection of software loops or programs, acting in concert to process input data and create a certain desirable set of output data to be used by other software engines or an end-user through some form of textual or graphical output interface. An abstraction software engine is a software program(s) focused on taking a large and vast amount of input data from a known source in a particular domain (such as three-dimensional range measurements that form a data-cloud of three-dimensional measurements as seen by one or more sensors), and then processing the data to arrive at interpretations of the data in a different domain (such as detecting and recognizing a table-surface in a data-cloud based on data having the same vertical data value, etc.), in order to identify, detect, and classify data-readings as pertaining to an object in three-dimensional space (such as a table-top, cooking pot, etc.). The process of abstraction is basically defined as taking a large data set from one domain and inferring structure (such as geometry) in a higher level of space (abstracting data points), and then abstracting the inferences even further and identifying objects (pots, etc.) out of the abstraction data-sets to identify real-world elements in an image, which can then be used by other software engines to make additional decisions (handling/manipulation decisions for key objects, etc.). A synonym for “software abstraction engine” in this application could be also “software interpretation engine” or even “computer-software processing and interpretation algorithm”.

Task Reasoning—refers to a software-based computer program(s) capable of analyzing a task-description and breaking it down into a sequence of multiple machine-executable (robot or hard-automation systems) steps, to achieve a particular end result defined in the task description.

Three-dimensional World Object Modeling and Understanding—refers to a software-based computer program(s) capable of using sensory data to create a time-varying three-dimensional model of all surfaces and volumes, to enable it to detect, identify, and classify objects within the same and understand their usage and intent.

Torque Vector—refers to the torsion force upon a robotic appendage, including its direction and magnitude.

Volumetric Object Inference (Engine)—refers to a software-based computer program(s) capable of using geometric data and edge-information, as well as other sensory data (color, shape, texture, etc.), to allow for identification of three-dimensionality of one or more objects to aid in the object identification and classification process.

For additional information on replication by a robotic apparatus and MM library, see the pending U.S. non-provisional patent application Ser. No. 14/627,900, entitled “Methods and Systems for Food Preparation in Robotic Cooking Kitchen”. For additional information on replication by a robotic apparatus and MM library, see the pending U.S. nonprovisional patent application Ser. No. 14/829,579, entitled “Methods and Systems for Food Preparation in Robotic Cooking Kitchen” and the pending U.S. nonprovisional patent application Ser. No. 14/627,900, the disclosures of which are incorporated herein by reference in their entireties.

FIG. 1 is a system diagram illustrating an overall robotics food preparation kitchen 10 with robotic hardware 12 and robotic software 14. The overall robotics food preparation kitchen 10 comprises a robotics food preparation hardware 12 and robotics food preparation software 14 that operate together to perform the robotics functions for food preparation. The robotic food preparation hardware 12 includes a computer 16 that controls the various operations and movements of a standardized kitchen module 18 (which generally operate in an instrumented environment with one or more sensors), multimodal three-dimensional sensors 20, robotic arms 22, robotic hands 24 and capturing gloves 26. The robotic food preparation software 14 operates with the robotics food preparation hardware 12 to capture a chef's movements in preparing a food dish and replicating the chef's movements via robotics arms and hands to obtain the same result or substantially the same result (e.g., taste the same, smell the same, etc.) of the food dish that would taste the same or substantially the same as if the food dish was prepared by a human chef.

The robotic food preparation software 14 includes the multimodal three-dimensional sensors 20, a capturing module 28, a calibration module 30, a conversion algorithm module 32, a replication module 34, a quality check module 36 with a three-dimensional vision system, a same result module 38, and a learning module 40. The capturing module 28 captures the movements of the chef as the chef prepares a food dish. The calibration module 30 calibrates the robotic arms 22 and robotic hands 24 before, during, and after the cooking process. The conversion algorithm module 32 is configured to convert the recorded data from a chef's movements collected in the chef studio into recipe modified data (or transformed data) for use in a robotic kitchen where robotic hands replicate the food preparation of the chef's dish. The replication module 34 is configured to replicate the chef's movements in a robotic kitchen. The quality check module 36 is configured to perform quality check functions of a food dish prepared by the robotic kitchen during, prior to, or after the food preparation process. The same result module 38 is configured to determine whether the food dish prepared by a pair of robotic arms and hands in the robotic kitchen would taste the same or substantially the same as if prepared by the chef. The learning module 40 is configured to provide learning capabilities to the computer 16 that operates the robotic arms and hands.

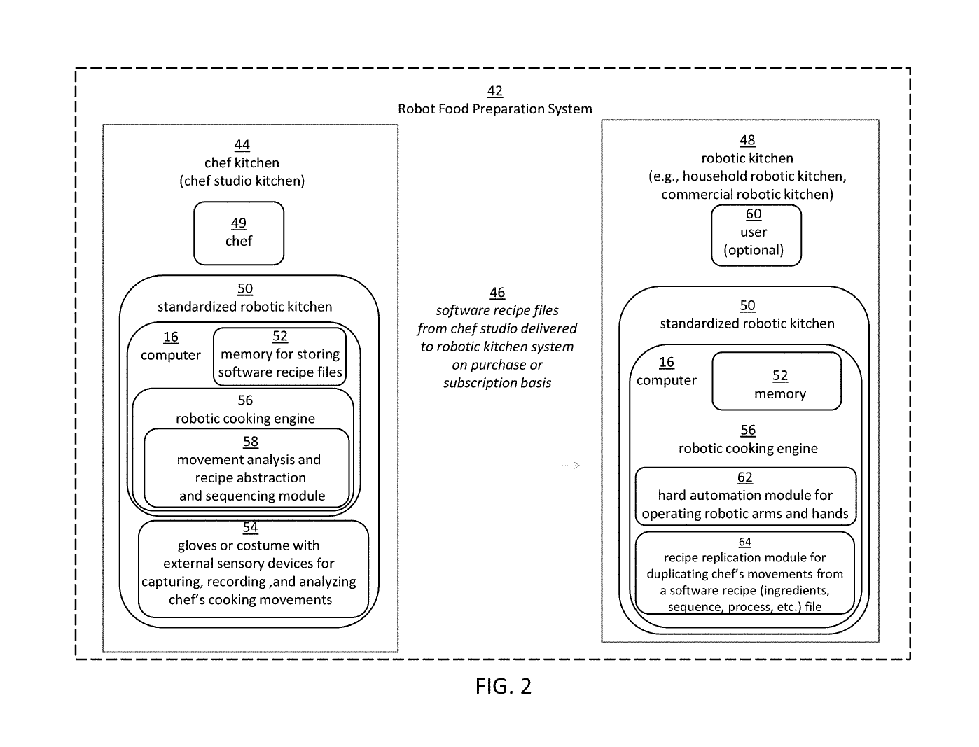

FIG. 2 is a system diagram illustrating a first embodiment of a food robot cooking system that includes a chef studio system and a household robotic kitchen system for preparing a dish by replicating a chef's recipe process and movements. The robotic kitchen cooking system 42 comprises a chef kitchen 44 (also referred to as “chef studio-kitchen”), which transfers one or more software recorded recipe files 46 to a robotic kitchen 48 (also referred to as “household robotic kitchen”). In one embodiment, both the chef kitchen 44 and the robotic kitchen 48 use the same standardized robotic kitchen module 50 (also referred as “robotic kitchen module”, “robotic kitchen volume”, or “kitchen module”, or “kitchen volume”) to maximize the precise replication of preparing a food dish, which reduces the variables that may contribute to deviations between the food dish prepared at the chef kitchen 44 and the one prepared by the robotic kitchen 46. A chef 52 wears robotic gloves or a costume with external sensory devices for capturing and recording the chef's cooking movements. The standardized robotic kitchen 50 comprises a computer 16 for controlling various computing functions, where the computer 16 includes a memory 52 for storing one or more software recipe files from the sensors of the gloves or costumes 54 for capturing a chef's movements, and a robotic cooking engine (software) 56. The robotic cooking engine 56 includes a movement analysis and recipe abstraction and sequencing module 58. The robotic kitchen 48 typically operates autonomously with a pair of robotic arms and hands, with an optional user 60 to turn on or program the robotic kitchen 46. The computer 16 in the robotic kitchen 48 includes a hard automation module 62 for operating robotic arms and hands, and a recipe replication module 64 for replicating a chef's movements from a software recipe (ingredients, sequence, process, etc.) file.

The standardized robotic kitchen 50 is designed for detecting, recording, and emulating a chef's cooking movements, controlling significant parameters such as temperature over time, and process execution at robotic kitchen stations with designated appliances, equipment, and tools. The chef kitchen 44 provides a computing kitchen environment 16 with gloves with sensors or a costume with sensors for recording and capturing a chef's 50 movements in the food preparation for a specific recipe. Upon recording the movements and recipe process of the chef 49 for a particular dish into a software recipe file in memory 52, the software recipe file is transferred from the chef kitchen 44 to the robotic kitchen 48 via a communication network 46, including a wireless network and/or a wired network connected to the Internet, so that the user (optional) 60 can purchase one or more software recipe files or the user can be subscribed to the chef kitchen 44 as a member that receives new software recipe files or periodic updates of existing software recipe files. The household robotic kitchen system 48 serves as a robotic computing kitchen environment at residential homes, restaurants, and other places in which the kitchen is built for the user 60 to prepare food. The household robotic kitchen system 48 includes the robotic cooking engine 56 with one or more robotic arms and hard-automation devices for replicating the chef's cooking actions, processes, and movements based on a received software recipe file from the chef studio system 44.

The chef studio 44 and the robotic kitchen 48 represent an intricately linked teach-playback system, which has multiple levels of fidelity of execution. While the chef studio 44 generates a high-fidelity process model of how to prepare a professionally cooked dish, the robotic kitchen 48 is the execution/replication engine/process for the recipe-script created through the chef working in the chef studio. Standardization of a robotic kitchen module is a means to increase performance fidelity and success/guarantee.

The varying levels of fidelity for recipe-execution depend on the correlation of sensors and equipment (besides of course the ingredients) between those in the chef studio 44 and that in the robotic kitchen 48. Fidelity can be defined as a dish tasting identical to that prepared by a human chef (indistinguishably so) at one of the (perfect replication/execution) ends of the spectrum, while at the opposite end the dish could have one or more substantial or fatal flaws with implications to quality (overcooked meat or pasta), taste (burnt elements), edibility (incorrect consistency) or even health-implications (undercooked meat such as chicken/pork with salmonella exposure, etc.).

A robotic kitchen that has identical hardware and sensors and actuation systems that can replicate the movements and processes akin to those by the chef that were recorded during the chef-studio cooking process is more likely to result in a higher fidelity outcome. The implication here is that the setups need to be identical, and this has a cost and volume implication. The robotic kitchen 48 can, however, still be implemented using more standardized non-computer-controlled or computer-monitored elements (pots with sensors, networked appliances, such as ovens, etc.), requiring more sensor-based understanding to allow for more complex execution monitoring. Since uncertainty has now increased as to key elements (correct amount of ingredients, cooking temperatures, etc.) and processes (use of stirrer/masher in case a blender is not available in a robotic home kitchen), the guarantees of having an identical outcome to that from the chef will undoubtedly be lower.

An emphasis in the present disclosure is that the notion of a chef studio 44 coupled with a robotic kitchen is a generic concept. The level of the robotic kitchen 48 is variable all the way from a home-kitchen outfitted with a set of arms and environmental sensors, all the way to an identical replica of the studio-kitchen, where a set of arms and articulated motions, tools, and appliances and ingredient-supply can replicate the chef's recipe in an almost identical fashion. The only variable to contend with will be the quality-degree of the end-result or dish in terms of quality, looks, taste, edibility, and health.

A potential method to mathematically describe this correlation between the recipe-outcome and the input variables in the robotic kitchen can best be described by the function below:

F_{recipe-outcome}=F_{studio}(I,E,P,M,V)+F_{RobKit}(E_{f},I,Rₑ,P_{mf})

where F_{studio}=Recipe Script Fidelity of Chef-Studio
F_{RobKit}=Recipe Script Execution by Robotic Kitchen
I=Ingredients
E=Equipment
P=Processes
M=Methods
V=Variables (Temperature, Time, Pressure, etc.)
E_{f}=Equipment Fidelity
Rₑ=Replication Fidelity
P_{mf}=Process Monitoring Fidelity

The above equation relates the degree to which the outcome of a robotically-prepared recipe matches that a human chef would prepare and serve (F_{recipe-outcome}) to the level that the recipe was properly captured and represented by the chef studio 44 (F_{studio}) based on the ingredients (I) used, the equipment (E) available to execute the chef's processes (P) and methods (M) by properly capturing all the key variables (V) during the cooking process; and how the robotic kitchen is able to represent the replication/execution process of the robotic recipe script by a function (F_{RobKit}) that is primarily driven by the use of the proper ingredients (I), the level of equipment fidelity (E_{f}) in the robotic kitchen compared to that in the chef studio, the level to which the recipe-script can be replicated (Rₑ) in the robotic kitchen, and to what extent there is an ability and need to monitor and execute corrective actions to achieve the highest process monitoring fidelity (P_{mf}) possible.

The functions (F_{studio}) and (F_{RobKit}) can be any combination of linear or non-linear functional formulas with constants, variables, and any form of algorithmic relationships. An example for such algebraic representations for both functions could be:

F_{studio}=I(fct. sin(Temp))+E(fct.Cooptop1*5)+P(fct.Circle(spoon)+V(fct.0.5*time)

Delineating that the fidelity of the preparation process is related to the temperature of the ingredient, which varies overtime in the refrigerator as a sinusoidal function, the speed with which an ingredient can be heated on the cooktop on specific station at a particular multiplicative rate, and related to how well a spoon can be moved in a circular path of a certain amplitude and period, and that the process needs to be carried out at no less than 2 the speed of the human chef for the fidelity of the preparation process to be maintained.

F_{RobKit}=E_{f},(Cooktop2,Size)+I(1.25*Size+Linear(Temp))+Rₑ(Motion-Profile)+P_{mf}(Sensor-Suite Correspondence)

Delineating that the fidelity of the replication process in the robotic kitchen is related to the appliance type and layout for a particular cooking-area and the size of the heating-element, the size and temperature profile of the ingredient being seared and cooked (thicker steak requiring more cooking time), while also preserving the motion-profile of any stirring and bathing motions of a particular step like searing or mousse-beating, and whether the correspondence between sensors in the robotic kitchen and the chef-studio is sufficiently high to trust the monitored sensor data to be accurate and detailed enough to provide a proper monitoring fidelity of the cooking process in the robotic kitchen during all steps in a recipe.

The outcome of a recipe is not only a function of what fidelity the human chef's cooking steps/methods/process/skills were captured with by the chef studio, but also with what fidelity these can be executed by the robotic kitchen, where each of them has key elements that impact their respective subsystem performance.

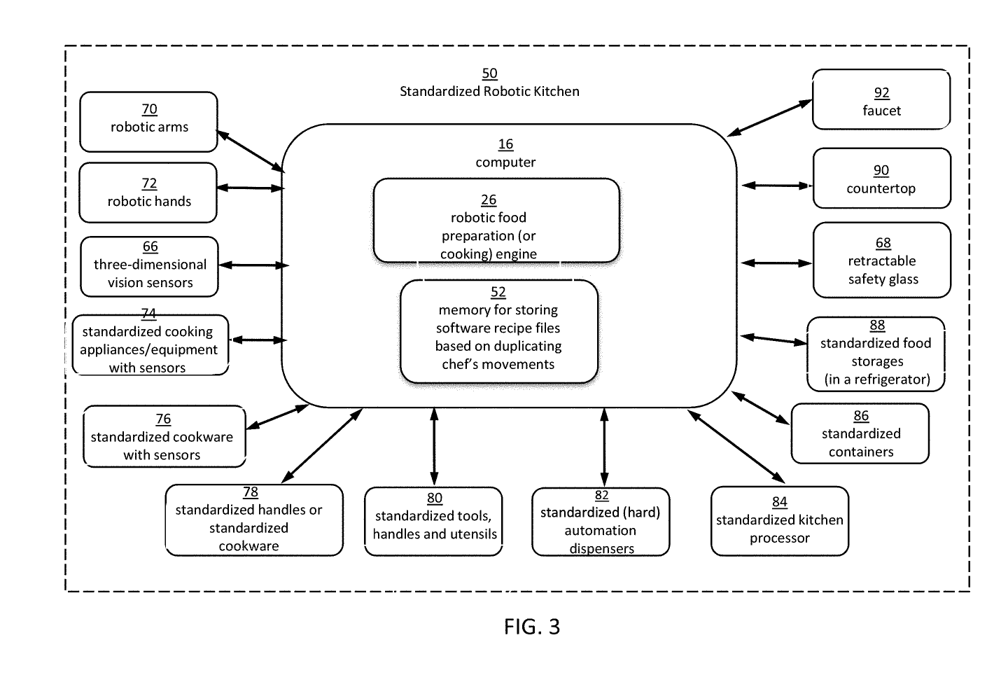

FIG. 3 is a system diagram illustrating one embodiment of the standardized robotic kitchen 50 for food preparation by recording a chef's movement in preparing and replicating a food dish by robotic arms and hands. In this context, the term “standardized” (or “standard”) means that the specifications of the components or features are presets, as will be explained below. The computer 16 is communicatively coupled to multiple kitchen elements in the standardized robotic kitchen 50, including a three-dimensional vision sensor 66, a retractable safety screen 68 (e.g., glass, plastic, or other types of protective material), robotic arms 70, robotic hands 72, standardized cooking appliances/equipment 74, standardized cookware with sensors 76, standardized handle(s) or standardized cookware 78, standardized handles and utensils 80, standardized hard automation dispenser(s) 82 (also referred to as “robotic hard automation module(s)”), a standardized kitchen processor 84, standardized containers 86, and a standardized food storage in a refrigerator 88.

The standardized (hard) automation dispenser(s) 82 is a device or a series of devices that is/are programmable and/or controllable via the cooking computer 16 to feed or provide pre-packaged (known) amounts or dedicated feeds of key materials for the cooking process, such as spices (salt, pepper, etc.), liquids (water, oil, etc.), or other dry materials (flour, sugar, etc.). The standardized hard automation dispensers 82 may be located at a specific station or may be able to be robotically accessed and triggered to dispense according to the recipe sequence. In other embodiments, a robotic hard automation module may be combined or sequenced in series or parallel with other modules, robotic arms, or cooking utensils. In this embodiment, the standardized robotic kitchen 50 includes robotic arms 70 and robotic hands 72; robotic hands, as controlled by the robotic food preparation engine 56 in accordance with a software recipe file stored in the memory 52 for replicating a chef's precise movements in preparing a dish to produce the same tasting dish as if the chef had prepared it himself or herself. The three-dimensional vision sensors 66 provide the capability to enable three-dimensional modeling of objects, providing a visual three-dimensional model of the kitchen activities, and scanning the kitchen volume to assess the dimensions and objects within the standardized robotic kitchen 50. The retractable safety glass 68 comprises a transparent material on the robotic kitchen 50, which when in an ON state extends the safety glass around the robotic kitchen to protect surrounding human beings from the movements of the robotic arms 70 and hands 72, hot water and other liquids, steam, fire and other dangers influents. The robotic food preparation engine 56 is communicatively coupled to an electronic memory 52 for retrieving a software recipe file previously sent from the chef studio system 44 for which the robotic food preparation engine 56 is configured to execute processes in preparing and replicating the cooking method and processes of a chef as indicated in the software recipe file. The combination of robotic arms 70 and robotic hands 72 serves to replicate the precise movements of the chef in preparing a dish, so that the resulting food dish will taste identical (or substantially identical) to the same food dish prepared by the chef. The standardized cooking equipment 74 includes an assortment of cooking appliances 46 that are incorporated as part of the robotic kitchen 50, including, but not limited to, a stove/induction/cooktop (electric cooktop, gas cooktop, induction cooktop), an oven, a grill, a cooking steamer, and a microwave oven. The standardized cookware and sensors 76 are used as embodiments for the recording of food preparation steps based on the sensors on the cookware and cooking a food dish based on the cookware with sensors, which include a pot with sensors, a pan with sensors, an oven with sensors, and a charcoal grill with sensors. The standardized cookware 78 includes frying pans, sauté pans, grill pans, multi-pots, roasters, woks, and braisers. The robotic arms 70 and the robotic hands 72 operate the standardized handles and utensils 80 in the cooking process. In one embodiment, one of the robotic hands 72 is fitted with a standardized handle, which is attached to a fork head, a knife head, and a spoon head for selection as required. The standardized hard automation dispensers 82 are incorporated into the robotic kitchen 50 to provide for expedient (via both robot arms 70 and human use) key and common/repetitive ingredients that are easily measured/dosed out or pre-packaged. The standardized containers 86 are storage locations that store food at room temperature. The standardized refrigerator containers 88 refer to, but are not limited to, a refrigerator with identified containers for storing fish, meat, vegetables, fruit, milk, and other perishable items. The containers in the standardized containers 86 or standardized storages 88 can be coded with container identifiers from which the robotic food preparation engine 56 is able to ascertain the type of food in a container based on the container identifier. The standardized containers 86 provide storage space for non-perishable food items such as salt, pepper, sugar, oil, and other spices. Standardized cookware with sensors 76 and the cookware 78 may be stored on a shelf or a cabinet for use by the robotic arms 70 for selecting a cooking tool to prepare a dish. Typically, raw fish, raw meat, and vegetables are pre-cut and stored in the identified standardized storages 88. The kitchen countertop 90 provides a platform for the robotic arms 70 to handle the meat or vegetables as needed, which may or may not include cutting or chopping actions. The kitchen faucet 92 provides a kitchen sink space for washing or cleaning food in preparation for a dish. When the robotic arms 70 have completed the recipe process to prepare a dish and the dish is ready for serving, the dish is placed on a serving counter 90, which further allows for the dining environment to be enhanced by adjusting the ambient setting with the robotic arms 70, such as placement of utensils, wineglasses, and a chosen wine compatible with the meal. One embodiment of the equipment in the standardized robotic kitchen module 50 is a professional series to increase the universal appeal to prepare various types of dishes.

The standardized robotic kitchen module 50 has as one objective: the standardization of the kitchen module 50 and various components with the kitchen module itself to ensure consistency in both the chef kitchen 44 and the robotic kitchen 48 to maximize the preciseness of recipe replication while minimizing the risks of deviations from precise replication of a recipe dish between the chef kitchen 44 and the robotic kitchen 48. One main purpose of having the standardization of the kitchen module 50 is to obtain the same result of the cooking process (or the same dish) between a first food dish prepared by the chef and a subsequent replication of the same recipe process via the robotic kitchen. Conceiving a standardized platform in the standardized robotic kitchen module 50 between the chef kitchen 44 and the robotic kitchen 48 has several key considerations: same timeline, same program or mode, and quality check. The same timeline in the standardized robotic kitchen 50 where the chef prepares a food dish at the chef kitchen 44 and the replication process by the robotic hands in the robotic kitchen 48 refers to the same sequence of manipulations, the same initial and ending time of each manipulation, and the same speed of moving an object between handling operations. The same program or mode in the standardized robotic kitchen 50 refers to the use and operation of standardized equipment during each manipulation recording and execution step. The quality check refers to three-dimensional vision sensors in the standardized robotic kitchen 50, which monitor and adjust in real time each manipulation action during the food preparation process to correct any deviation and avoid a flawed result. The adoption of the standardized robotic kitchen module 50 reduces and minimizes the risks of not obtaining the same result between the chef's prepared food dish and the food dish prepared by the robotic kitchen using robotic arms and hands. Without the standardization of a robotic kitchen module and the components within the robotic kitchen module, the increased variations between the chef kitchen 44 and the robotic kitchen 48 increase the risks of not being able to obtain the same result between the chef's prepared food dish and the food dish prepared by the robotic kitchen because more elaborate and complex adjustment algorithms will be required with different kitchen modules, different kitchen equipment, different kitchenware, different kitchen tools, and different ingredients between the chef kitchen 44 and the robotic kitchen 48.

The standardized robotic kitchen module 50 includes the standardization of many aspects. First, the standardized robotic kitchen module 50 includes standardized positions and orientations (in the XYZ coordinate plane) of any type of kitchenware, kitchen containers, kitchen tools, and kitchen equipment (with standardized fixed holes in the kitchen module and device positions). Second, the standardized robotic kitchen module 50 includes a standardized cooking volume dimension and architecture. Third, the standardized robotic kitchen module 50 includes standardized equipment sets, such as an oven, a stove, a dishwasher, a faucet, etc. Fourth, the standardized robotic kitchen module 50 includes standardized kitchenware, standardized cooking tools, standardized cooking devices, standardized containers, and standardized food storage in a refrigerator, in terms of shape, dimension, structure, material, capabilities, etc. Fifth, in one embodiment, the standardized robotic kitchen module 50 includes a standardized universal handle for handling any kitchenware, tools, instruments, containers, and equipment, which enable a robotic hand to hold the standardized universal handle in only one correct position, while avoiding any improper grasps or incorrect orientations. Sixth, the standardized robotic kitchen module 50 includes standardized robotic arms and hands with a library of manipulations. Seventh, the standardized robotic kitchen module 50 includes a standardized kitchen processor for standardized ingredient manipulations. Eighth, the standardized robotic kitchen module 50 includes standardized three-dimensional vision devices for creating dynamic three-dimensional vision data, as well as other possible standard sensors, for recipe recording, execution tracking, and quality check functions. Ninth, the standardized robotic kitchen module 50 includes standardized types, standardized volumes, standardized sizes, and standardized weights for each ingredient during a particular recipe execution.

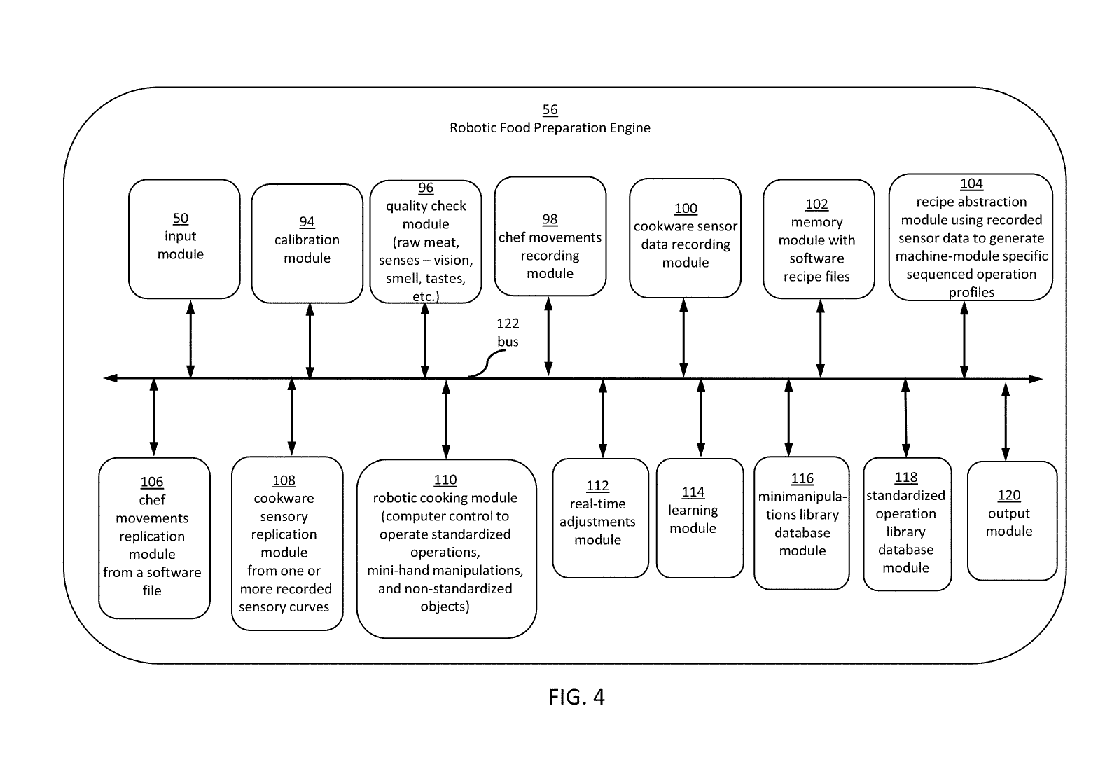

FIG. 4 is a system diagram illustrating one embodiment of the robotic cooking engine 56 (also referred to as “robotic food preparation engine”) for use with the computer 16 in the chef studio system 44 and the household robotic kitchen system 48. Other embodiments may have modifications, additions, or variations of the modules in the robotic cooking engine 16, in the chef kitchen 44, and robotic kitchen 48. The robotic cooking engine 56 includes an input module 50, a calibration module 94, a quality check module 96, a chef movement recording module 98, a cookware sensor data recording module 100, a memory module 102 for storing software recipe files, a recipe abstraction module 104 using recorded sensor data to generate machine-module specific sequenced operation profiles, a chef movements replication software module 106, a cookware sensory replication module 108 using one or more sensory curves, a robotic cooking module 110 (computer control to operate standardized operations, minimanipulations, and non-standardized objects), a real-time adjustment module 112, a learning module 114, a minimanipulation library database module 116, a standardized kitchen operation library database module 118, and an output module 120. These modules are communicatively coupled via a bus 122.

The input module 50 is configured to receive any type of input information, such as software recipe files sent from another computing device. The calibration module 94 is configured to calibrate itself with the robotic arms 70, the robotic hands 72, and other kitchenware and equipment components within the standardized robotic kitchen module 50. The quality check module 96 is configured to determine the quality and freshness of raw meat, raw vegetables, milk-associated ingredients, and other raw foods at the time that the raw food is retrieved for cooking, as well as checking the quality of raw foods when receiving the food into the standardized food storage 88. The quality check module 96 can also be configured to conduct quality testing of an object based on senses, such as the smell of the food, the color of the food, the taste of the food, and the image or appearance of the food. The chef movements recording module 98 is configured to record the sequence and the precise movements of the chef when the chef prepares a food dish. The cookware sensor data recording module 100 is configured to record sensory data from cookware equipped with sensors (such as a pan with sensors, a grill with sensors, or an oven with sensors) placed in different zones within the cookware, thereby producing one or more sensory curves. The result is the generation of a sensory curve, such as temperature curve (and/or humidity), that reflects the temperature fluctuation of cooking appliances over time for a particular dish. The memory module 102 is configured as a storage location for storing software recipe files, for either replication of chef recipe movements or other types of software recipe files including sensory data curves. The recipe abstraction module 104 is configured to use recorded sensor data to generate machine-module specific sequenced operation profiles. The chef movements replication module 106 is configured to replicate the chef's precise movements in preparing a dish based on the stored software recipe file in the memory 52. The cookware sensory replication module 108 is configured to replicate the preparation of a food dish by following the characteristics of one or more previously recorded sensory curves, which were generated when the chef 49 prepared a dish by using the standardized cookware with sensors 76. The robotic cooking module 110 is configured to control and operate autonomously standardized kitchen operations, minimanipulations, non-standardized objects, and the various kitchen tools and equipment in the standardized robotic kitchen 50. The real time adjustment module 112 is configured to provide real-time adjustments to the variables associated with a particular kitchen operation or a mini operation to produce a resulting process that is a precise replication of the chef movement or a precise replication of the sensory curve. The learning module 114 is configured to provide learning capabilities to the robotic cooking engine 56 to optimize the precise replication in preparing a food dish by robotic arms 70 and the robotic hands 72, as if the food dish was prepared by a chef, using a method such as case-based (robotic) learning. The minimanipulation library database module 116 is configured to store a first database library of minimanipulations. The standardized kitchen operation library database module 117 is configured to store a second database library of standardized kitchenware and information on how to operate this standardized kitchenware. The output module 118 is configured to send output computer files or control signals external to the robotic cooking engine.

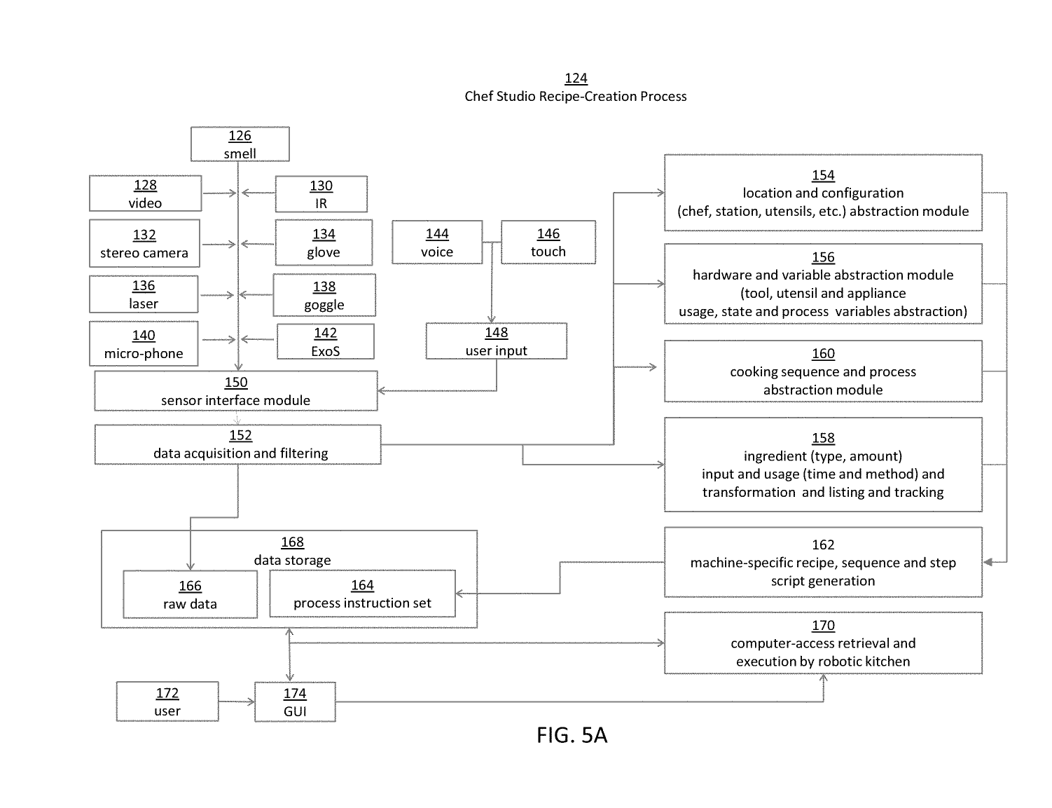

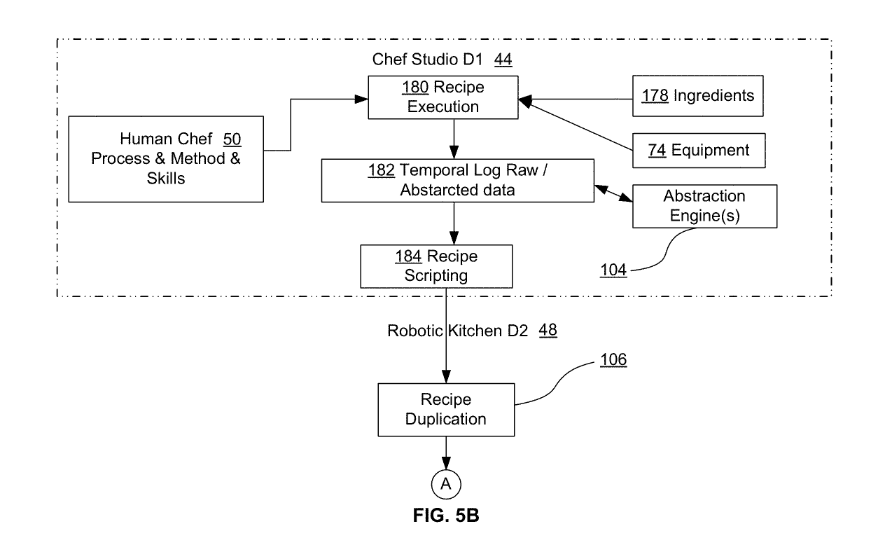

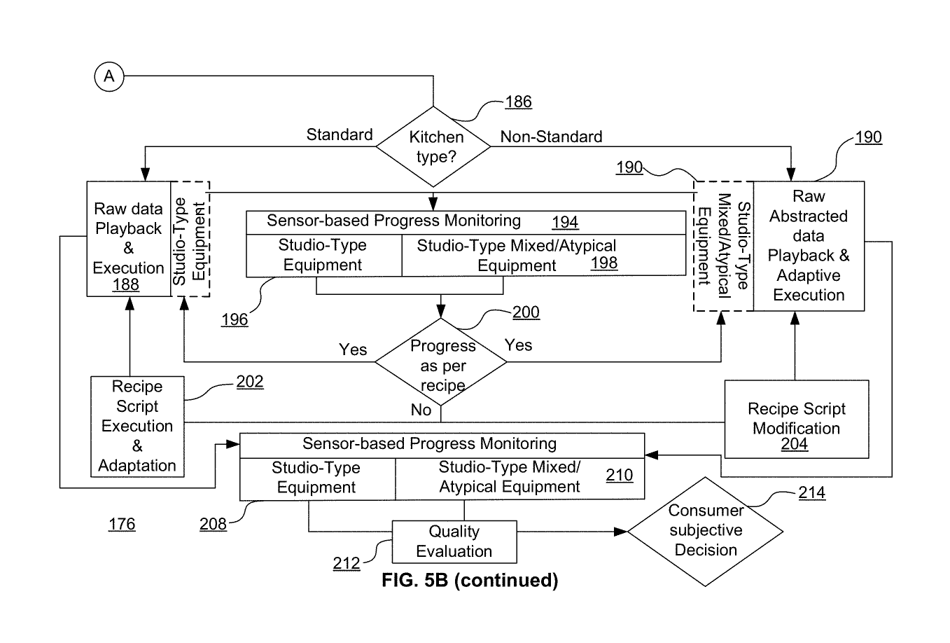

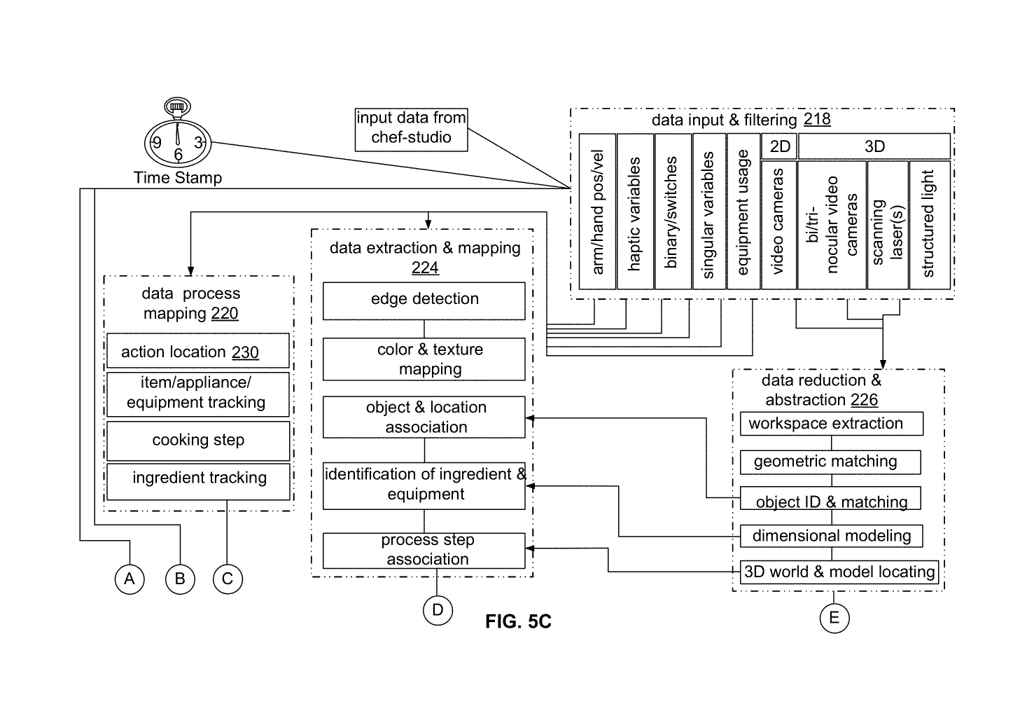

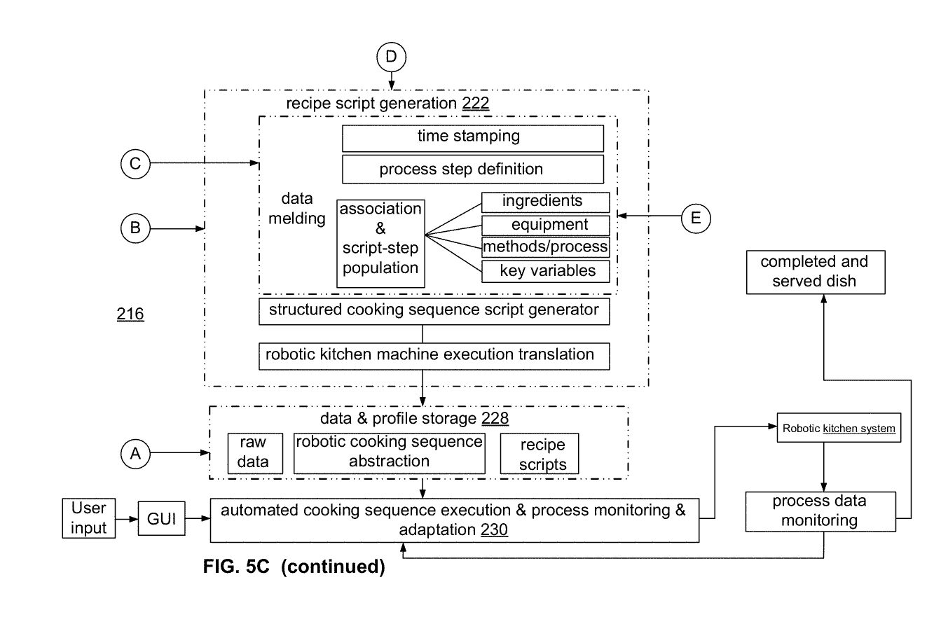

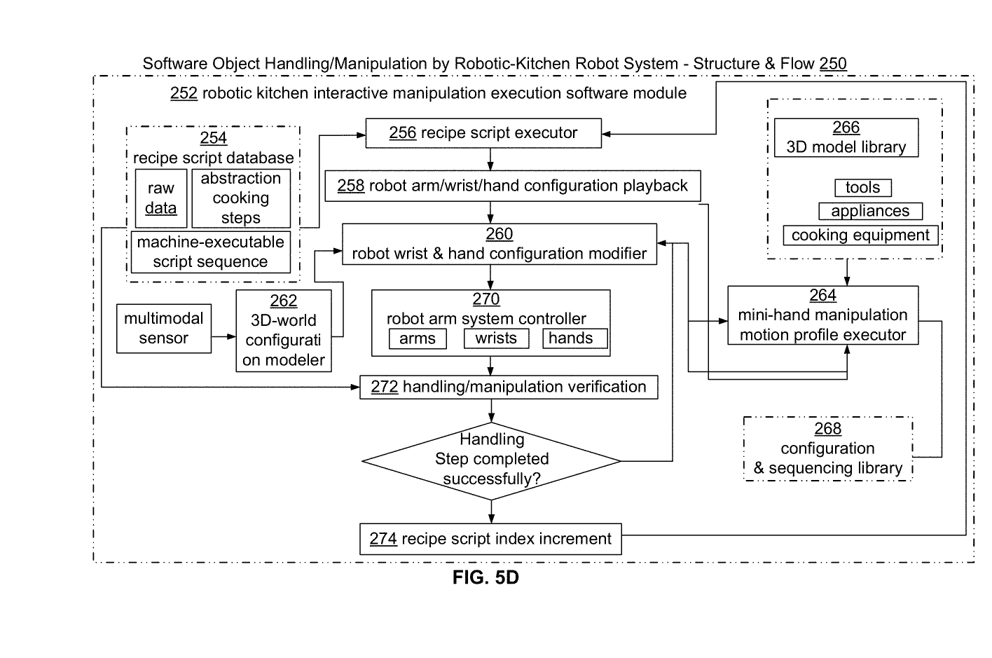

FIG. 5A is a block diagram illustrating a chef studio recipe-creation process 124, showcasing several main functional blocks supporting the use of expanded multimodal sensing to create a recipe instruction-script for a robotic kitchen. Sensor-data from a multitude of sensors, such as (but not limited to) smell 126, video cameras 128, infrared scanners and range finders 130, stereo (or even trinocular) cameras 132, haptic gloves 134, articulated laser-scanners 136, virtual-world goggles 138, microphones 140 or an exoskeleton motion suit 142, human voice 144, touch-sensors 146, and even other forms of user input 148, are used to collect data through a sensor interface module 150. The data is acquired and filtered 152, including possible human user input 148 (e.g., chef, touch-screen and voice input), after which a multitude of (parallel) software processes utilize the temporal and spatial data to generate the data that is used to populate the machine-specific recipe-creation process. Sensors may not be limited to capturing human position and/or motion but may also capture position, orientation, and/or motion of other objects in the standardized robotic kitchen 50.

These individual software modules generate such information (but are not thereby limited to only these modules) as (i) chef-location and cooking-station ID via a location and configuration module 154, (ii) configuration of arms (via torso), (iii) tools handled, when and how, (iv) utensils used and locations on the station through the hardware and variable abstraction module 156, (v) processes executed with them, and (vi) variables (temperature, lid y/n, stirring, etc.) in need of monitoring through the process module 158, (vii) temporal (start/finish, type) distribution and (viii) types of processes (stir, fold, etc.) being applied, and (ix) ingredients added (type, amount, state of prep, etc.) through the cooking sequence and process abstraction module 160.

All this information is then used to create a machine-specific (not just for the robotic-arms, but also ingredient dispensers, tools, and utensils, etc.) set of recipe instructions through the standalone module 162, which are organized as script of sequential/parallel overlapping tasks to be executed and monitored. This recipe-script is stored 164 alongside the entire raw data set 166 in the data storage module 168 and is made accessible to either a remote robotic cooking station through the robotic kitchen interface module 170 or a human user 172 via a graphical user interface (GUI) 174.

FIG. 5B is a block diagram illustrating one embodiment of the standardized chef studio 44 and robotic kitchen 50 with teach/playback process 176. The teach/playback process 176 describes the steps of capturing a chef's recipe-implementation processes/methods/skills 49 in the chef studio 44 where he/she carries out the recipe execution 180, using a set of chef-studio standardized equipment 74 and recipe-required ingredients 178 to create a dish while being logged and monitored 182. The raw sensor data is logged (for playback) in 182 and processed to generate information at different abstraction levels (tools/equipment used, techniques employed, times/temperatures started/ended, etc.), and then used to create a recipe-script 184 for execution by the robotic kitchen 48. The robotic kitchen 48 engages in a recipe replication process 106, whose profile depends on whether the kitchen is of a standardized or non-standardized type, which is checked by a process 186.

The robotic kitchen execution is dependent on the type of kitchen available to the user. If the robotic kitchen uses the same/identical (at least functionally) equipment as used in the in the chef studio, the recipe replication process is primarily one of using the raw data and playing it back as part of the recipe-script execution process. Should the kitchen however differ from the ideal standardized kitchen, the execution engine(s) will have to rely on the abstraction data to generate kitchen-specific execution sequences to try to achieve a similar step-by-step result.

Since the cooking process is continually monitored by all sensor units in the robotic kitchen via a monitoring process 194, regardless of whether the known studio equipment 196 or the mixed/atypical non-chef studio equipment 198 is being used, the system is able to make modifications as needed depending on a recipe progress check 200. In one embodiment of the standardized kitchen, raw data is typically played back through an execution module 188 using chef-studio type equipment, and the only adjustments that are expected are adaptations 202 in the execution of the script (repeat a certain step, go back to a certain step, slow down the execution, etc.) as there is a one-to-one correspondence between taught and played-back data-sets. However, in the case of the non-standardized kitchen, the chances are very high that the system will have to modify and adapt the actual recipe itself and its execution, via a recipe script modification module 204, to suit the available tools/appliances 192 which differ from those in the chef studio 44 or the measured deviations from the recipe script (meat cooking too slowly, hot-spots in pot burning the roux, etc.). Overall recipe-script progress is monitored using a similar process 206, which differs depending on whether chef-studio equipment 208 or mixed/atypical kitchen equipment 210 is being used.

A non-standardized kitchen is less likely to result in a close-to-human chef cooked dish, as compared to using a standardized robotic kitchen that has equipment and capabilities reflective of those used in the studio-kitchen. The ultimate subjective decision is of course that of the human (or chef) tasting, or a quality evaluation 212, which yields to a (subjective) quality decision 214.

FIG. 5C is a block diagram illustrating one embodiment 216 of a recipe script generation and abstraction engine that pertains to the structure and flow of the recipe-script generation process as part of the chef-studio recipe walk-through by a human chef. The first step is for all available data measurable in the chef studio 44, whether it be ergonomic data from the chef (arms/hands positions and velocities, haptic finger data, etc.), status of the kitchen appliances (ovens, fridges, dispensers, etc.), specific variables (cooktop temperature, ingredient temperature, etc.), appliance or tools being used (pots/pans, spatulas, etc.), or two-dimensional and three-dimensional data collected by multi-spectrum sensory equipment (including cameras, lasers, structured light systems, etc.), to be input and filtered by the central computer system and also time-stamped by a main process 218.

A data process-mapping algorithm 220 uses the simpler (typically single-unit) variables to determine where the process action is taking place (cooktop and/or oven, fridge, etc.) and assigns a usage tag to any item/appliance/equipment being used whether intermittently or continuously. It associates a cooking step (baking, grilling, ingredient-addition, etc.) to a specific time-period and tracks when, where, which, and how much of what ingredient was added. This (time-stamped) information dataset is then made available for the data-melding process during the recipe-script generation process 222.

The data extraction and mapping process 224 is primarily focused on taking two-dimensional information (such as from monocular/single-lensed cameras) and extracting key information from the same. In order to extract the important and more abstraction descriptive information from each successive image, several algorithmic processes have to be applied to this dataset. Such processing steps can include (but are not limited to) edge-detection, color and texture-mapping, and then using the domain-knowledge in the image, coupled with object-matching information (type and size) extracted from the data reduction and abstraction process 226, to allow for the identification and location of the object (whether an item of equipment or ingredient, etc.), again extracted from the data reduction and abstraction process 226, allowing one to associate the state (and all associated variables describing the same) and items in an image with a particular process-step (frying, boiling, cutting, etc.). Once this data has been extracted and associated with a particular image at a particular point in time, it can be passed to the recipe-script generation process 222 to formulate the sequence and steps within a recipe.

The data-reduction and abstraction engine (set of software routines) 226 is intended to reduce the larger three-dimensional data sets and extract from them key geometric and associative information. A first step is to extract from the large three-dimensional data point-cloud only the specific workspace area of importance to the recipe at that particular point in time. Once the data set has been trimmed, key geometric features will be identified by a process known as template matching. This allows for the identification of such items as horizontal tabletops, cylindrical pots and pans, arm and hand locations, etc. Once typical known (template) geometric entities are determined in a data-set a process of object identification and matching proceeds to differentiate all items (pot vs. pan, etc.) and associates the proper dimensionality (size of pot or pan, etc.) and orientation of the same, and places them within the three-dimensional world model being assembled by the computer. All this abstraction/extracted information are then also shared with the data-extraction and mapping engine 224, prior to all being fed to the recipe-script generation engine 222.

The recipe-script generation engine process 222 is responsible for melding (blending/combining) all the available data and sets into a structured and sequential cooking script with clear process-identifiers (prepping, blanching, frying, washing, plating, etc.) and process-specific steps within each, which can then be translated into robotic-kitchen machine-executable command-scripts that are synchronized based on process-completion and overall cooking time and cooking progress. Data melding will at least involve, but will not solely be limited to, the ability to take each (cooking) process step and populating the sequence of steps to be executed with the properly associated elements (ingredients, equipment, etc.), methods and processes to be used during the process steps, and the associated key control (set oven/cooktop temperatures/settings), and monitoring-variables (water or meat temperature, etc.) to be maintained and checked to verify proper progress and execution. The melded data is then combined into a structured sequential cooking script that will resemble a set of minimally descriptive steps (akin to a recipe in a magazine) but with a much larger set of variables associated with each element (equipment, ingredient, process, method, variable, etc.) of the cooking process at any one point in the procedure. The final step is to take this sequential cooking script and transform it into an identically structured sequential script that is translatable by a set of machines/robot/equipment within a robotic kitchen 48. It is this script the robotic kitchen 48 uses to execute the automated recipe execution and monitoring steps.

All raw (unprocessed) and processed data as well as the associated scripts (both structure sequential cooking-sequence script and the machine-executable cooking-sequence script) are stored in the data and profile storage unit/process 228 and time-stamped. It is from this database that the user, by way of a GUI, can select and cause the robotic kitchen to execute a desired recipe through the automated execution and monitoring engine 230, which is continually monitored by its own internal automated cooking process, with necessary adaptations and modifications to the script generated by the same and implemented by the robotic-kitchen elements, in order to arrive at a completely plated and served dish.

FIG. 5D is a block diagram illustrating software elements for object-manipulation (or object handling) in the standardized robotic kitchen 50, which shows the structure and flow 250 of the object-manipulation portion of the robotic kitchen execution of a robotic script, using the notion of motion-replication coupled-with/aided-by minimanipulation steps. In order for automated robotic-arm/-hand-based cooking to be viable, it is insufficient to monitor every single joint in the arm and hands/fingers. In many cases just the position and orientation of the hand/wrist are known (and able to be replicated), but then manipulating an object (identifying location, orientation, pose, grab-location, grabbing-strategy and task-execution) requires that local-sensing and learned behaviors and strategies for the hand and fingers be used to complete the grabbing/manipulating task successfully. These motion-profiles (sensor-based/-driven) behaviors and sequences are stored within the mini hand-manipulation library software repository in the robotic-kitchen system. The human chef could be wearing complete arm-exoskeleton or an instrumented/target-fitted motion-vest allowing the computer via built-in sensors or though camera-tracking to determine the exact 3D position of the hands and wrists at all times. Even if the ten fingers on both hands had all their joints instrumented (more than 30 DoFs (Degrees of Freedom) for both hands and very awkward to wear and use, and thus unlikely to be used), a simple motion-based playback of all joint positions would not guarantee successful (interactive) object manipulation.

The minimanipulation library is a command-software repository, where motion behaviors and processes are stored based on an off-line learning process, where the arm/wrist/finger motions and sequences to successfully complete a particular abstract task (grab the knife and then slice; grab the spoon and then stir; grab the pot with one hand and then use other hand to grab spatula and get under meat and flip it inside the pan; etc.). This repository has been built up to contain the learned sequences of successful sensor-driven motion-profiles and sequenced behaviors for the hand/wrist (and sometimes also arm-position corrections), to ensure successful completions of object (appliance, equipment, tools) and ingredient manipulation tasks that are described in a more abstract language, such as “grab the knife and slice the vegetable”, “crack the egg into the bowl”, “flip the meat over in the pan”, etc. The learning process is iterative and is based on multiple trials of a chef-taught motion-profile from the chef studio, which is then executed and iteratively modified by the offline learning algorithm module, until an acceptable execution-sequence can be shown to have been achieved. The minimanipulation library (command software repository) is intended to have been populated (a-priori and offline) with all the necessary elements to allow the robotic-kitchen system to successfully interact with all equipment (appliances, tools, etc.) and main ingredients that require processing (steps beyond just dispensing) during the cooking process. While the human chef wore gloves with embedded haptic sensors (proximity, touch, contact-location/-force) for the fingers and palm, the robotic hands are outfitted with similar sensor-types in locations to allow their data to be used to create, modify and adapt motion-profiles to execute successfully the desired motion-profiles and handling-commands.

The object-manipulation portion of the robotic-kitchen cooking process (robotic recipe-script execution software module for the interactive manipulation and handling of objects in the kitchen environment) 252 is further elaborated below. Using the robotic recipe-script database 254 (which contains data in raw, abstraction cooking-sequence and machine-executable script forms), the recipe script executor module 256 steps through a specific recipe execution-step. The configuration playback module 258 selects and passes configuration commands through to the robot arm system (torso, arm, wrist and hands) controller 270, which then controls the physical system to emulate the required configuration (joint-positions/-velocities/-torques, etc.) values.

The notion of being able to carry out proper environment interaction manipulation and handling tasks faithfully is made possible through a real-time process-verification by way of (i) 3D world modeling as well as (ii) minimanipulation. Both the verification and manipulation steps are carried out through the addition of the robot wrist and hand configuration modifier 260. This software module uses data from the 3D world configuration modeler 262, which creates a new 3D world model at every sampling step from sensory data supplied by the multimodal sensor(s) unit(s), in order to ascertain that the configuration of the robotic kitchen systems and process matches that required by the recipe script (database); if not, it enacts modifications to the commanded system-configuration values to ensure the task is completed successfully. Furthermore, the robot wrist and hand configuration modifier 260 also uses configuration-modifying input commands from the minimanipulation motion profile executor 264. The hand/wrist (and potentially also arm) configuration modification data fed to the configuration modifier 260 are based on the minimanipulation motion profile executor 264 knowing what the desired configuration playback should be from 258, but then modifying it based on its 3D object model library 266 and the a-priori learned (and stored) data from the configuration and sequencing library 268 (which was built based on multiple iterative learning steps for all main object handling and processing steps).

While the configuration modifier 260 continually feeds modified commanded configuration data to the robot arm system controler 270, it relies on the handling/manipulation verification software module 272 to verify not only that the operation is proceeding properly but also whether continued manipulation/handling is necessary. In the case of the latter (answer ‘N’ to the decision), the configuration modifier 260 re-requests configuration-modification (for the wrist, hands/fingers and potentially the arm and possibly even torso) updates from both the world modeler 262 and the minimanipulation profile executor 264. The goal is simply to verify that a successful manipulation/handling step or sequence has been successfully completed. The handling/manipulation verification software module 272 carries out this check by using the knowledge of the recipe script database F2 and the 3D world configuration modeler 262 to verify the appropriate progress in the cooking step currently being commanded by the recipe script executor 256. Once progress has been deemed successful, the recipe script index increment process 274 notifies the recipe script executor 256 to proceed to the next step in the recipe-script execution.

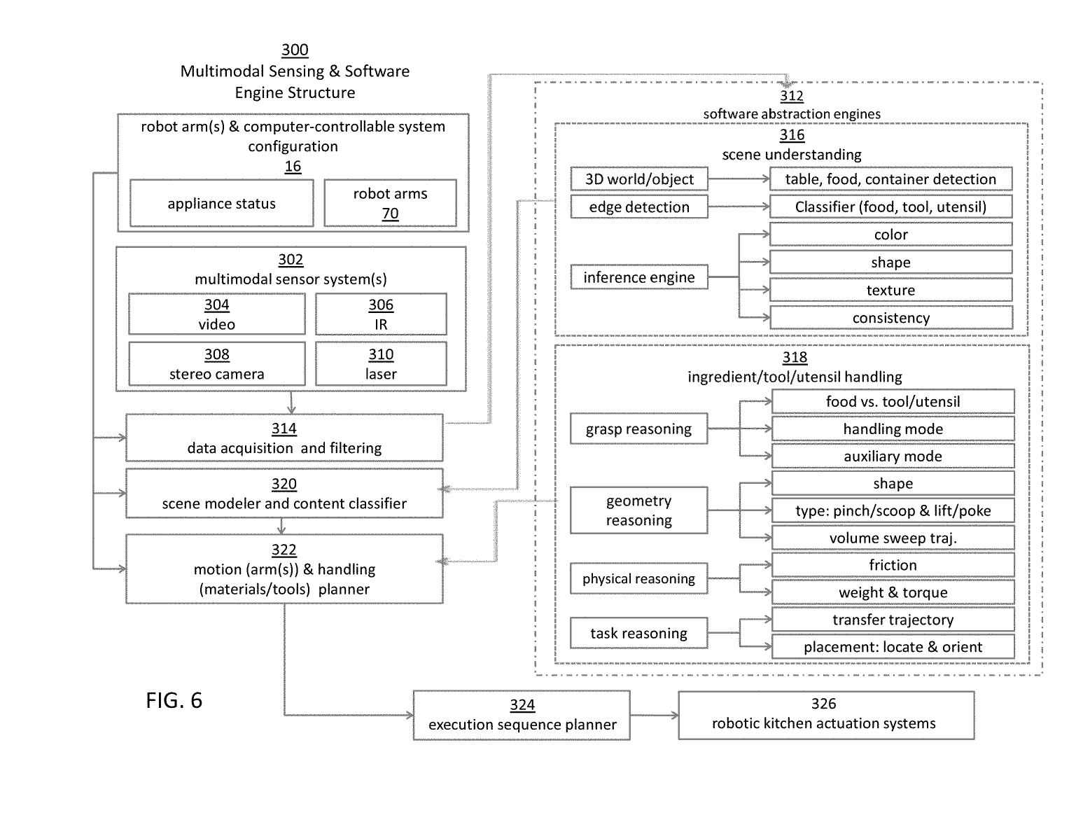

FIG. 6 is a block diagram illustrating a multimodal sensing and software engine architecture 300 in accordance with the present disclosure. One of the main autonomous cooking features allowing for planning, execution and monitoring of a robotic cooking script requires the use of multimodal sensory input 302 that is used by multiple software modules to generate data needed to (i) understand the world, (ii) model the scene and materials, (iii) plan the next steps in the robotic cooking sequence, (iv) execute the generated plan and (v) monitor the execution to verify proper operations—all of these steps occurring in a continuous/repetitive closed loop fashion.

The multimodal sensor-unit(s) 302, comprising, but not limited to, video cameras 304, IR cameras and range finders 306, stereo (or even trinocular) camera(s) 308 and multi-dimensional scanning lasers 310, provide multi-spectral sensory data to the main software abstraction engines 312 (after being acquired & filtered in the data acquisition and filtering module 314). The data is used in a scene understanding module 316 to carry out multiple steps such as (but not limited to) building high- and lower-resolution (laser: high-resolution; stereo-camera: lower-resolution) three-dimensional surface volumes of the scene, with superimposed visual and IR-spectrum color and texture video information, allowing edge-detection and volumetric object-detection algorithms to infer what elements are in a scene, allowing the use of shape-/color-/texture- and consistency-mapping algorithms to run on the processed data to feed processed information to the Kitchen Cooking Process Equipment Handling Module 318. In the module 318, software-based engines are used for the purpose of identifying and three-dimensionally locating the position and orientation of kitchen tools and utensils and identifying and tagging recognizable food elements (meat, carrots, sauce, liquids, etc.) so as to generate data to let the computer build and understand the complete scene at a particular point in time so as to be used for next-step planning and process monitoring. Engines required to achieve such data and information abstraction include, but are not limited to, grasp reasoning engines, robotic kinematics and geometry reasoning engines, physical reasoning engines and task reasoning engines. Output data from both engines 316 and 318 are then used to feed the scene modeler and content classifier 320, where the 3D world model is created with all the key content required for executing the robotic cooking script executor. Once the fully-populated model of the world is understood, it can be used to feed the motion and handling planner 322 (if robotic-arm grasping and handling are necessary, the same data can be used to differentiate and plan for grasping and manipulating food and kitchen items depending on the required grip and placement) to allow for planning motions and trajectories for the arm(s) and attached end-effector(s) (grippers, multi-fingered hands). A follow-on Execution Sequence planner 324 creates the proper sequencing of task-based commands for all individual robotic/automated kitchen elements, which are then used by the robotic kitchen actuation systems 326. The entire sequence above is repeated in a continuous closed loop during the robotic recipe-script execution and monitoring phase.

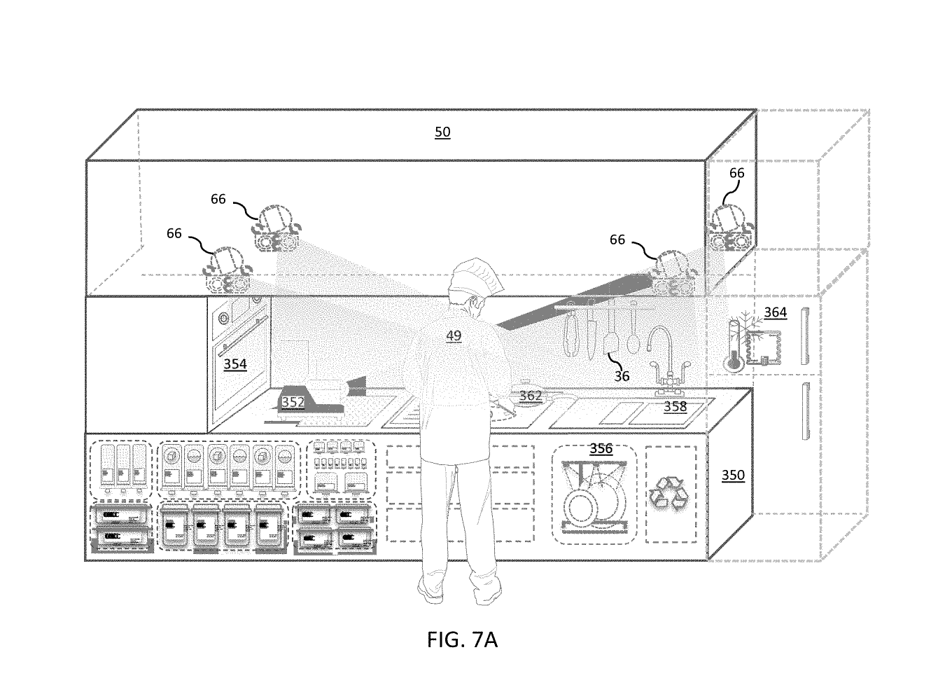

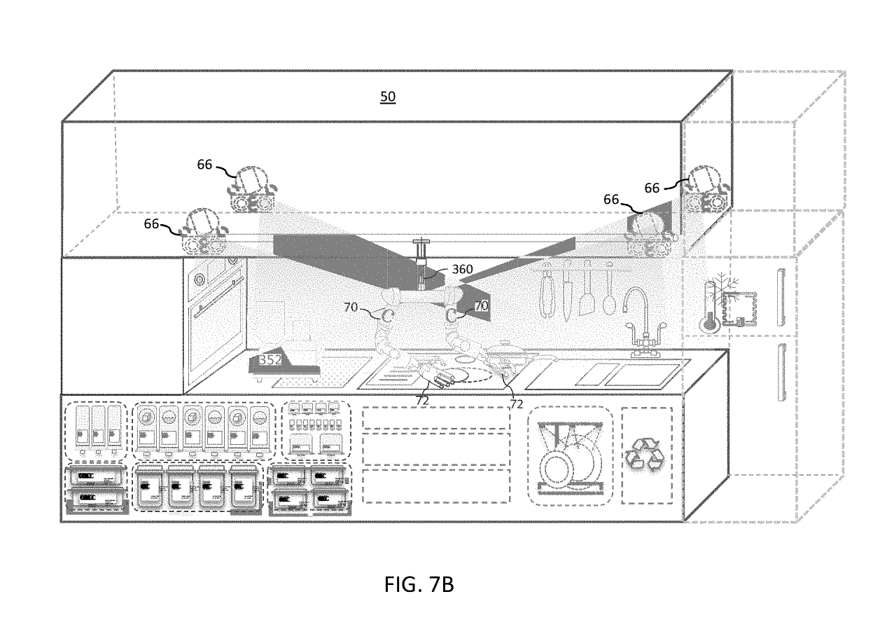

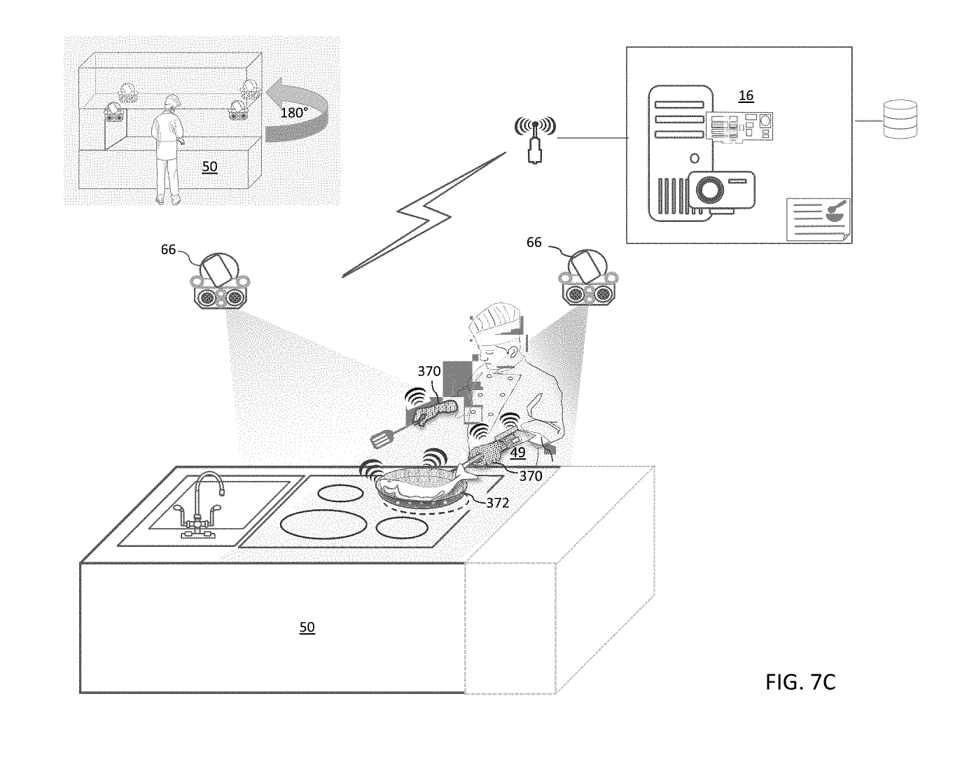

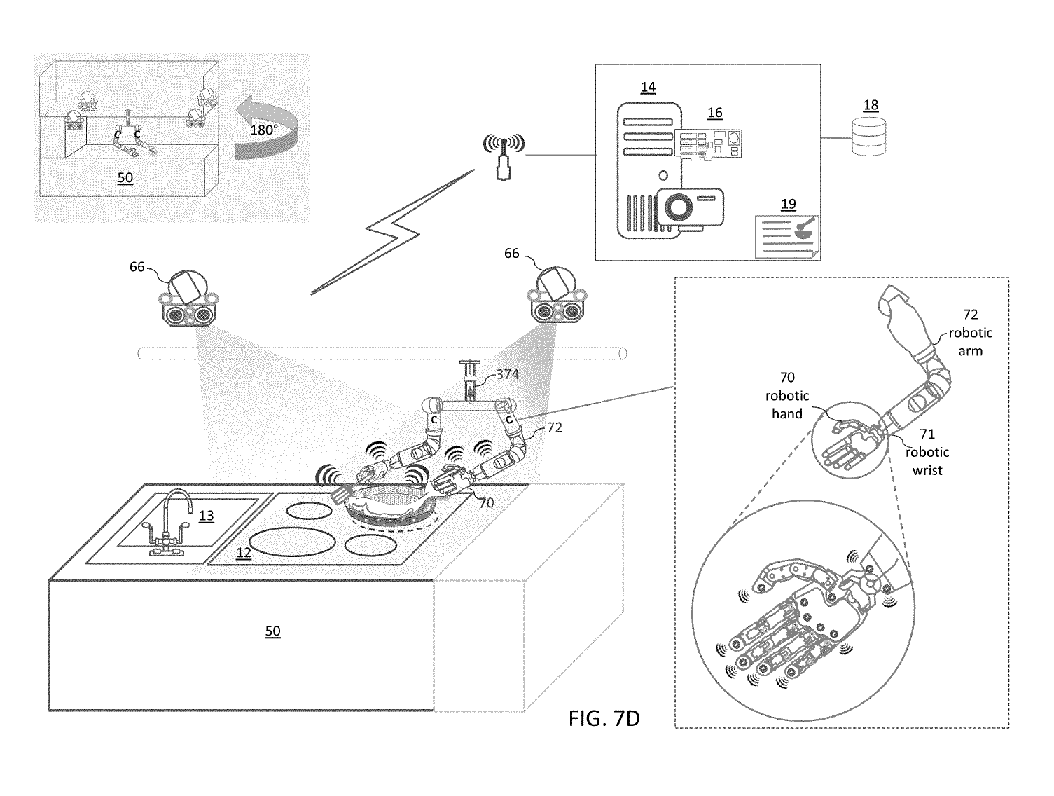

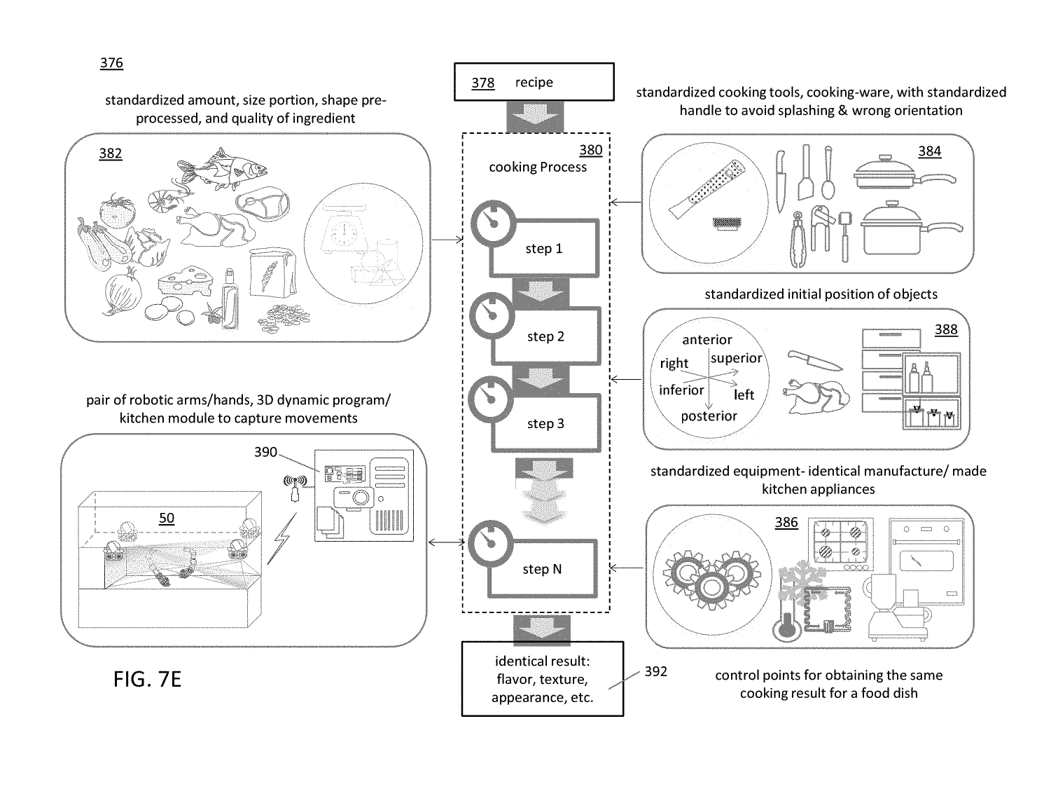

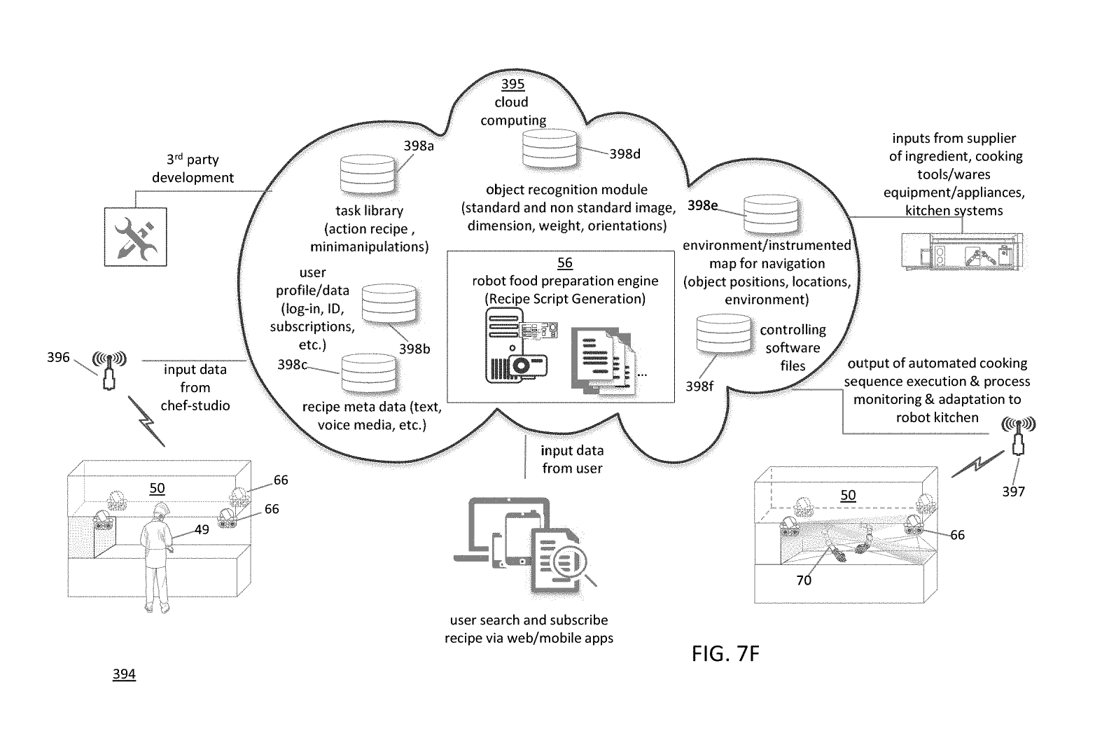

FIG. 7A depicts the standardized kitchen 50 which in this case plays the role of the chef-studio, in which the human chef 49 carries out the recipe creation and execution while being monitored by the multi-modal sensor systems 66, so as to allow the creation of a recipe-script. Within the standardized kitchen, are contained multiple elements necessary for the execution of a recipe, including the main cooking module 350, which includes such as equipment as utensils 360, a cooktop 362, a kitchen sink 358, a dishwasher 356, a table-top mixer and blender (also referred to as a “kitchen blender”) 352, an oven 354 and a refrigerator/freezer combination unit 364.

FIG. 7B depicts the standardized kitchen 50, which in this case is configured as the standardized robotic kitchen, with a dual-arm robotics system with vertical telescoping and rotating torso joint 366, outfitted with two arms 70, and two wristed and fingered hands 72, carries out the recipe replication processes defined in the recipe-script. The multi-modal sensor systems 66 continually monitor the robotically executed cooking steps in the multiple stages of the recipe replication process.

FIG. 7C depicts the systems involved in the creation of a recipe-script by monitoring a human chef 49 during the entire recipe execution process. The same standardized kitchen 50 is used in a chef studio mode, with the chef able to operate the kitchen from either side of the work-module. Multi-modal sensors 66 monitor and collect data, as well as through the haptic gloves 370 worn by the chef and instrumented cookware 372 and equipment, relaying all collected raw data wirelessly to a processing computer 16 for processing and storage.

FIG. 7D depicts the systems involved in a standardized kitchen 50 for the replication of a recipe script 19 through the use of a dual-arm system with telescoping and rotating torso 374, comprised of two arms 72, two robotic wrists 71 and two multi-fingered hands 72 with embedded sensory skin and point-sensors. The robotic dual-arm system uses the instrumented arms and hands with a cooking utensil and an instrumented appliance and cookware (pan in this image) on a cooktop 12, while executing a particular step in the recipe replication process, while being continuously monitored by the multi-modal sensor units 66 to ensure the replication process is carried out as faithfully as possible to that created by the human chef. All data from the multi-modal sensors 66, dual-arm robotics system comprised of torso 74, arms 72, wrists 71 and multi-fingered hands 72, utensils, cookware and appliances, is wirelessly transmitted to a computer 16, where it is processed by an onboard processing unit 16 in order to compare and track the replication process of the recipe to as faithfully as possible follow the criteria and steps as defined in the previously created recipe script 19 and stored in media 18.

Some suitable robotic hands that can be modified for use with the robotic kitchen 48 include Shadow Dexterous Hand and Hand-Lite designed by Shadow Robot Company, located in London, the United Kingdom; a servo-electric 5-finger gripping hand SVH designed by SCHUNK GmbH & Co. KG, located in Lauffen/Neckar, Germany; and DLR HIT HAND II designed by DLR Robotics and Mechatronics, located in Cologne, Germany.

Several robotic arms 72 are suitable for modification to operate with the robotic kitchen 48, which include UR3 Robot and UR5 Robot by Universal Robots A/S, located in Odense S, Denmark, Industrial Robots with various payloads designed by KUKA Robotics, located in Augsburg, Bavaria, Germany, Industrial Robot Arm Models designed by Yaskawa Motoman, located in Kitakyushu, Japan.

FIG. 7E is a block diagram depicting the stepwise flow and methods 376 to ensure that there are control or verification points during the recipe replication process based on the recipe-script when executed by the standardized robotic kitchen 50, that ensures as nearly identical as possible a cooking result for a particular dish as executed by the standardized robotic kitchen 50, when compared to the dish prepared by the human chef 49. Using a recipe 378, as described by the recipe-script and executed in sequential steps in the cooking process 380, the fidelity of execution of the recipe by the robotic kitchen 50 will depend largely on considering the following main control items. Key control items include the process of selecting and utilizing a standardized portion amount and shape of a high-quality and pre-processed ingredient 382, the use of standardized tools and utensils, cook-ware with standardized handles to ensure proper and secure grasping with a known orientation 384, standardized equipment 386 (oven, blender, fridge, fridge, etc.) in the standardized kitchen that is as identical as possible when comparing the chef studio kitchen where the human chef 49 prepares the dish and the standardized robotic kitchen 50, location and placement 388 for ingredients to be used in the recipe, and ultimately a pair of robotic arms, wrists and multi-fingered hands in the robotic kitchen module 50 continually monitored by sensors with computer-controlled actions 390 to ensure successful execution of each step in every stage of the replication process of the recipe-script for a particular dish. In the end, the task of ensuring an identical result 392 is the ultimate goal for the standardized robotic kitchen 50.

FIG. 7F depicts a block diagram of a cloud-based recipe software for facilitating between the chef studio, the robotic kitchen, and other sources. The various types of data communicated, modified, and stored on a cloud computing 396 between the chef kitchen 44, which operates a standardized robotic kitchen 50 and the robotic kitchen 48, which operates a standardized robotic kitchen 50. The cloud computing 394 provides a central location to store software files, including operation of the robot food preparation 56, which can conveniently retrieve and upload software files through a network between the chef kitchen 44 and the robotic kitchen 48. The chef kitchen 44 is communicatively coupled to the cloud computing 395 through a wired or wireless network 396 via the Internet, wireless protocols, and short distance communication protocols, such as BlueTooth. The robotic kitchen 48 is communicatively coupled to the cloud computing 395 through a wired or wireless network 397 via the Internet, wireless protocols, and short distance communication protocols, such as BlueTooth. The cloud computing 395 includes computer storage locations to store a task library 398a with actions, recipe, and minimanipulations; a user profile/data 398b with login information, ID, and subscriptions; a recipe meta data 398c with text, voice media, etc.; an object recognition module 398d with standard images, non-standard images, dimensions, weight, and orientations; an environment/instrumented map 398e for navigation of object positions, locations, and the operating environment; and a controlling software files 398f for storing robotic command instructions, high-level software files, and low-level software files. In another embodiment, the Internet of Things (IoT) devices can be incorporated to operate with the chef kitchen 44, the cloud computing 396 and the robotic kitchen 48.

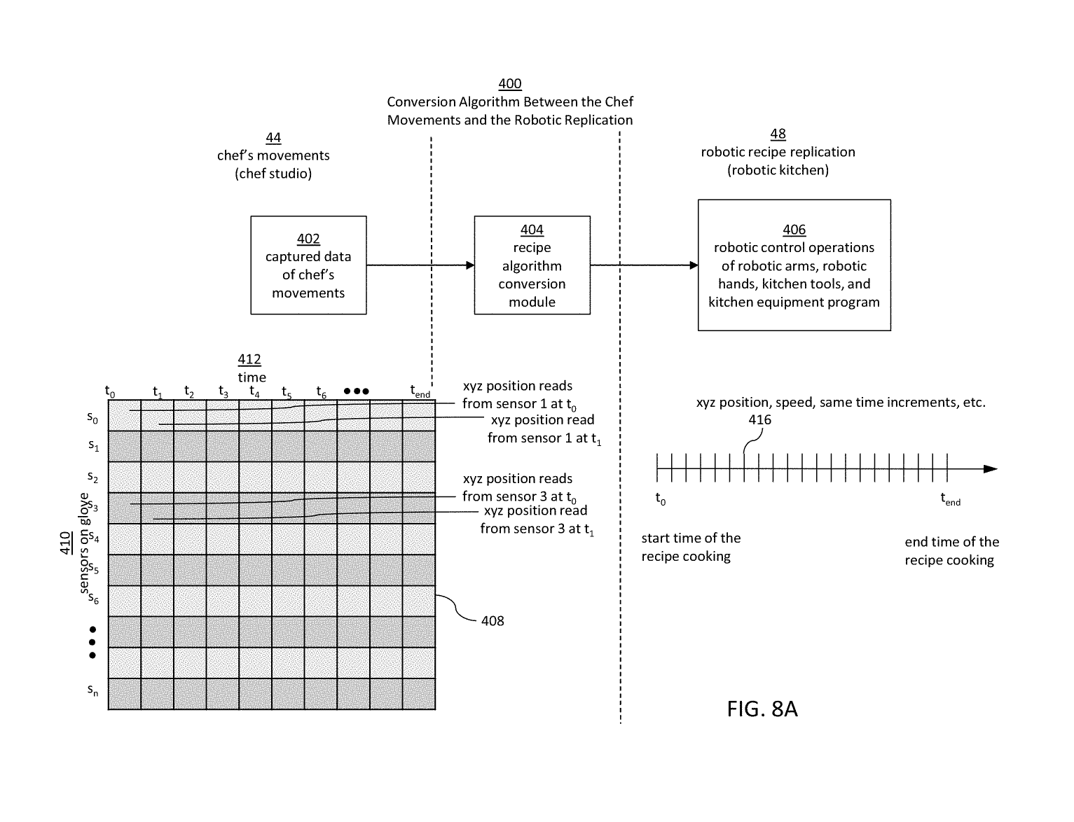

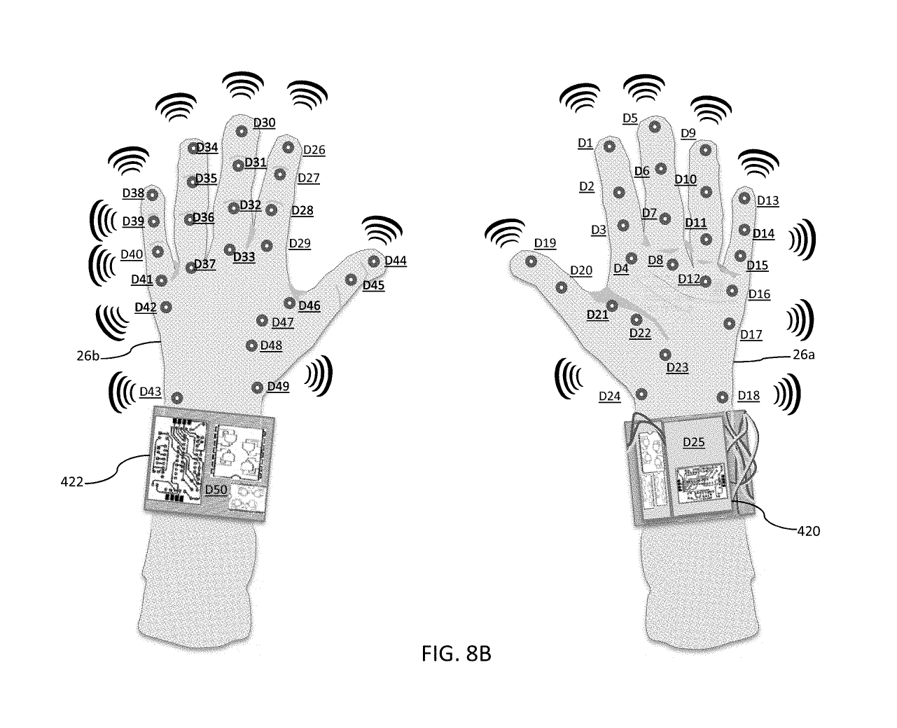

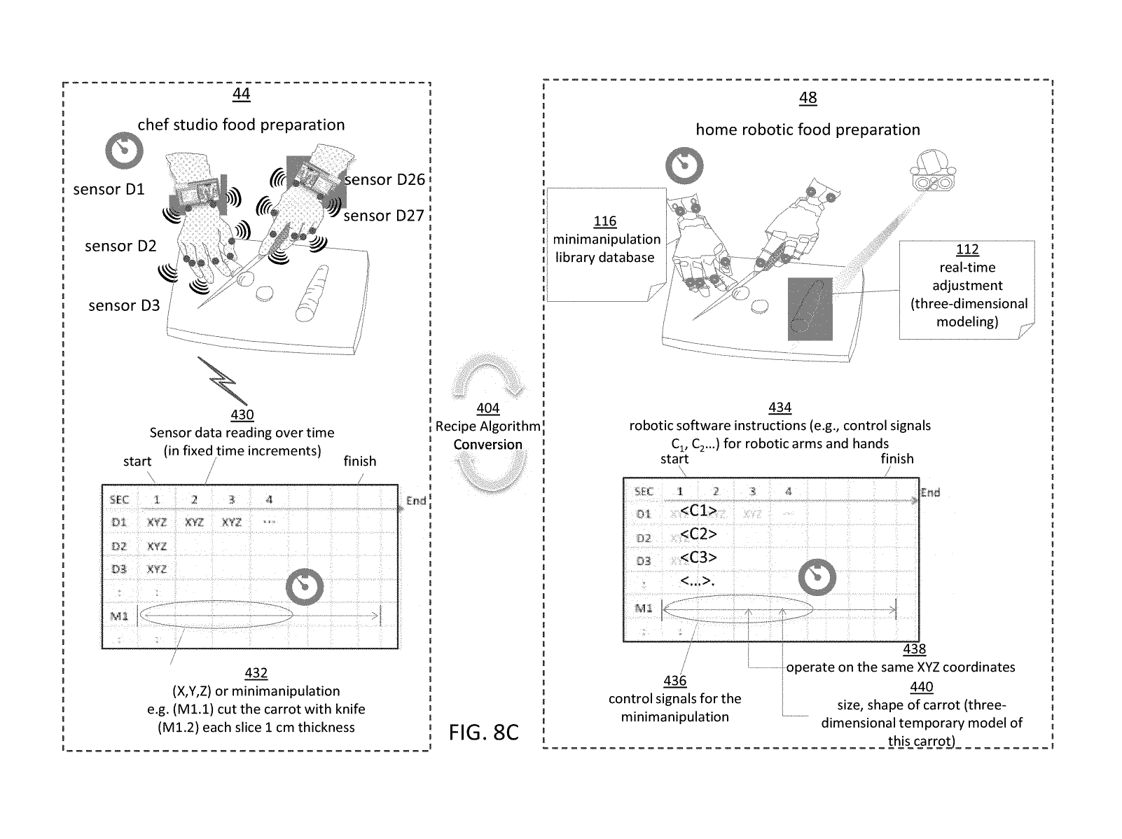

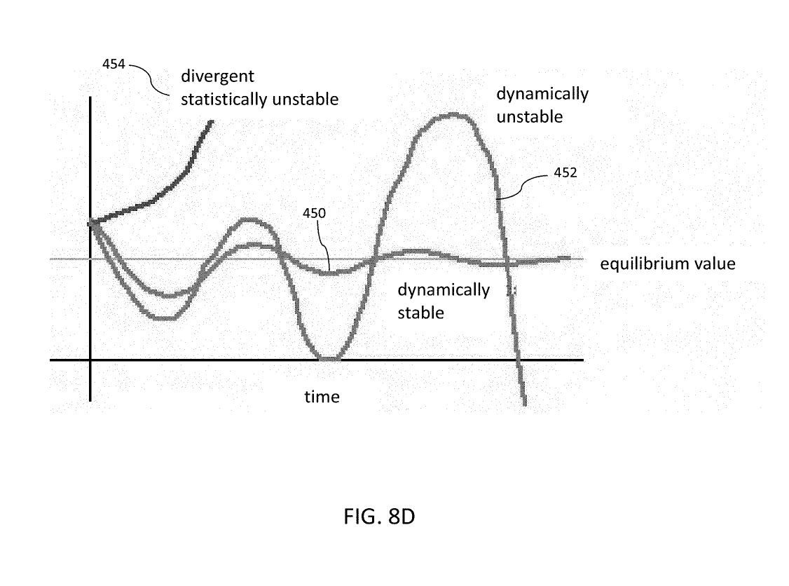

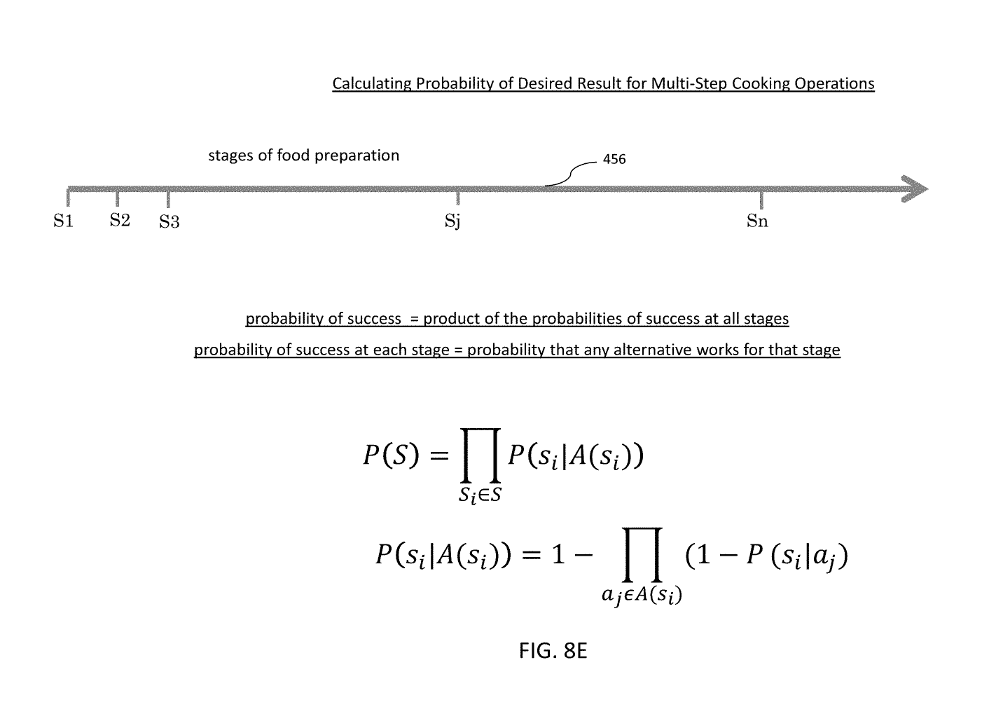

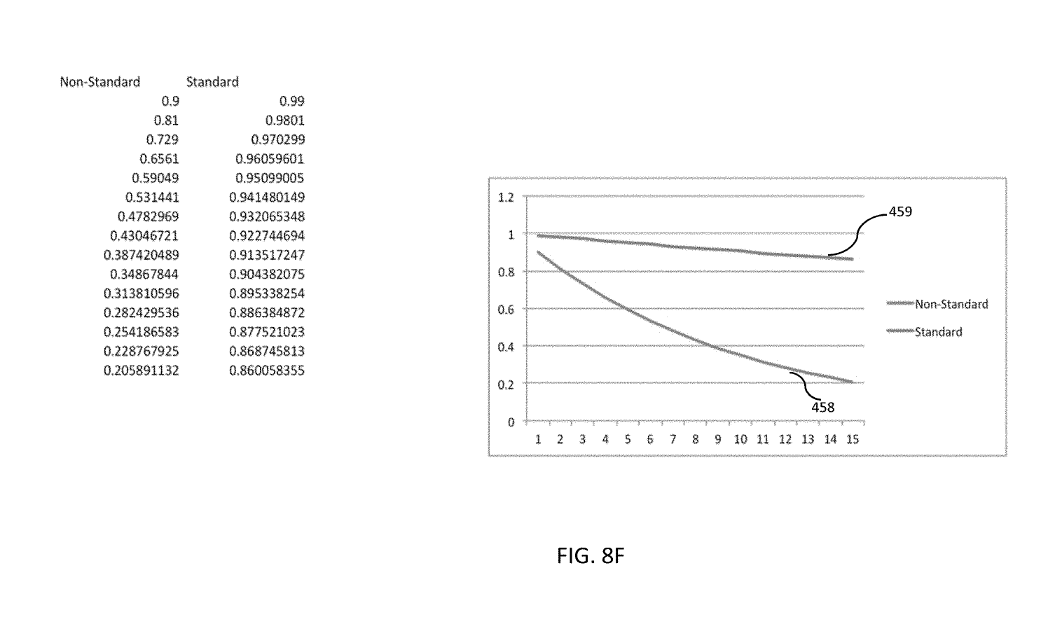

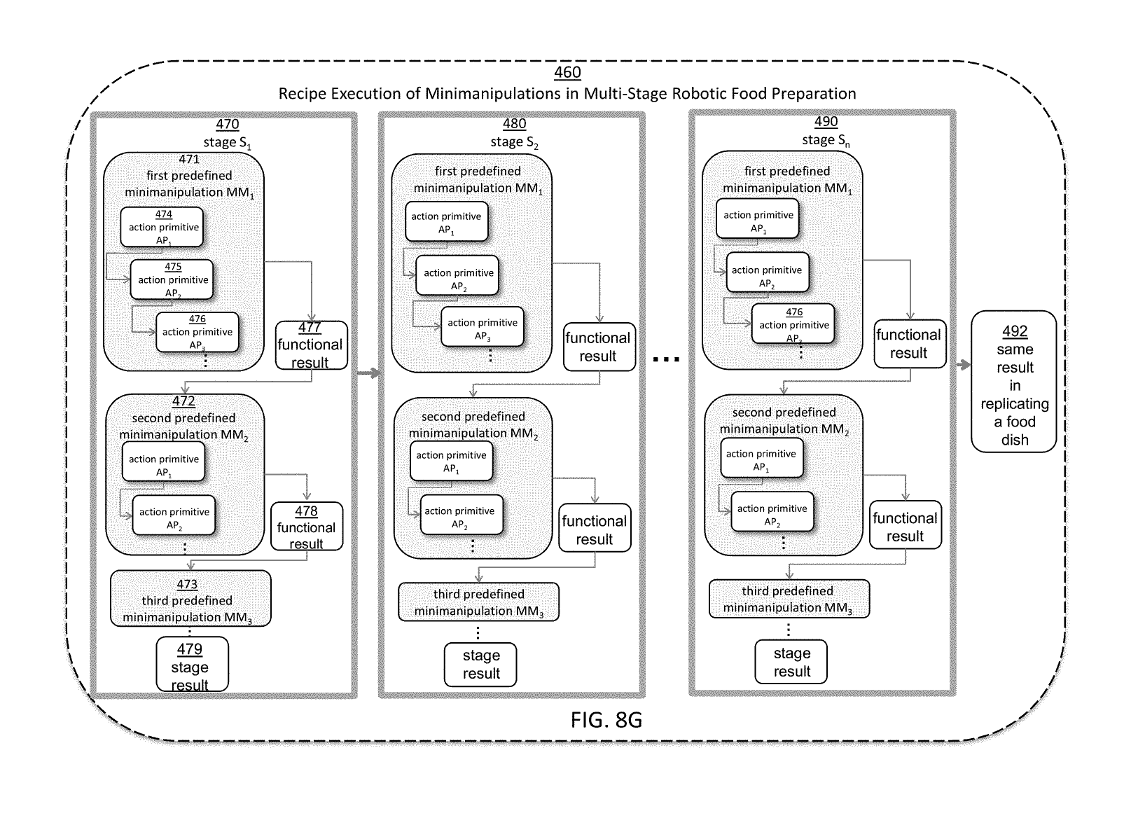

FIG. 8A is a block diagram illustrating one embodiment of a recipe conversion algorithm module 400 between the chef's movements and the robotic replication movements. A recipe algorithm conversion module 404 converts the captured data from the chef's movements in the chef studio 44 into a machine-readable and machine-executable language 406 for instructing the robotic arms 70 and the robotic hands 72 to replicate a food dish prepared by the chef's movement in the robotic kitchen 48. In the chef studio 44, the computer 16 captures and records the chef's movements based on the sensors on a glove 26 that the chef wears, represented by a plurality of sensors S₀, S₁, S₂, S₃, S₄, S₅, S₆ . . . Sₙ in the vertical columns, and the time increments t₀, t₁, t₂, t₃, t₄, t₅, t₆ . . . t_{end} in the horizontal rows, in a table 408. At time t₀, the computer 16 records the xyz coordinate positions from the sensor data received from the plurality of sensors S₀, S₁, S₂, S₃, S₄, S₅, S₆ . . . Sₙ. At time t₁, the computer 16 records the xyz coordinate positions from the sensor data received from the plurality of sensors S₀, S₁, S₂, S₃, S₄, S₅, S₆ . . . Sₙ. At time t₂, the computer 16 records the xyz coordinate positions from the sensor data received from the plurality of sensors S₀, S₁, S₂, S₃, S₄, S₅, S₆ . . . Sₙ. This process continues until the entire food preparation is completed at time t_{end}. The duration for each time units t₀, t₁, t₂, t₃, t₄, t₅, t₆ . . . t_{end} is the same. As a result of the captured and recorded sensor data, the table 408 shows any movements from the sensors S₀, S₁, S₂, S₃, S₄, S₅, S₆ . . . Sₙ in the glove 26 in xyz coordinates, which would indicate the differentials between the xyz coordinate positions for one specific time relative to the xyz coordinate positions for the next specific time. Effectively, the table 408 records how the chef's movements change over the entire food preparation process from the start time, t₀, to the end time, t_{end}. The illustration in this embodiment can be extended to two gloves 26 with sensors, which the chef 49 wears to capture the movements while preparing a food dish. In the robotic kitchen 48, the robotic arms 70 and the robotic hands 72 replicate the recorded recipe from the chef studio 44, which is then converted to robotic instructions, where the robotic arms 70 and the robotic hands 72 replicate the food preparation of the chef 49 according to the timeline 416. The robotic arms 70 and hands 72 carry out the food preparation with the same xyz coordinate positions, at the same speed, with the same time increments from the start time, t₀, to the end time, t_{end}, as shown in the timeline 416.

In some embodiments, a chef performs the same food preparation operation multiple times, yielding values of the sensor reading, and parameters in the corresponding robotic instructions that vary somewhat from one time to the next. The set of sensor readings for each sensor across multiple repetitions of the preparation of the same food dish provides a distribution with a mean, standard deviation and minimum and maximum values. The corresponding variations on the robotic instructions (also called the effector parameters) across multiple executions of the same food dish by the chef also define distributions with mean, standard deviation, minimum and maximum values. These distributions may be used to determine the fidelity (or accuracy) of subsequent robotic food preparations.

In one embodiment the estimated average accuracy of a robotic food preparation operation is given by:

$$A ( C , R ) = 1 - \frac{1}{n} {\sum }_{n = 1 , … n} \frac{\vert {c}_{i} - {p}_{i} \vert}{max ( \vert {c}_{i , t} - {p}_{i , t} \vert}$$

Where C represents the set of Chef parameters (1^{st} through n^{th}) and R represents the set of Robotic Apparatus parameters (correspondingly (1^{st} through n^{th}). The numerator in the sum represents the difference between robotic and chef parameters (i.e. the error) and the denominator normalizes for the maximal difference). The sum gives the total normalized cumulative error

$$( i . e . {\sum }_{n = 1 , … n} \frac{\vert {c}_{i} - {p}_{i} \vert}{max ( \vert {c}_{i , t} - {p}_{i , t} \vert} ) ,$$

and multiplying by 1/n gives the average error. The complement of the average error corresponds to the average accuracy.

Another version of the accuracy calculation weighs the parameters for importance, where each coefficient (each αᵢ) represents the importance of the i^{th} parameter, the normalized cumulative error is

$${\sum }_{n = 1 , … n} \frac{{α}_{i} \vert {c}_{i} - {p}_{i} \vert}{max ( \vert {c}_{i , t} - {p}_{i , t} \vert}$$

and the estimated average accuracy is given by:

$$A ( C , R ) = 1 - ( {\sum }_{n = 1 , … n} \frac{{α}_{i} \vert {c}_{i} - {p}_{i} \vert}{max ( \vert {c}_{i , t} - {p}_{i , t} \vert} ) / {\sum }_{n = 1 , … n} {α}_{i}$$

FIG. 8B is a block diagram illustrating the pair of gloves 26a and 26b with sensors worn by the chef 49 for capturing and transmitting the chef's movements. In this illustrative example, which is intended to show one example without limiting effects, a right hand glove 26a Includes 25 sensors to capture the various sensor data points D1, D2, D3, D4, D5, D6, D7, D8, D9, D10, D11, D12, D13, D14, D15, D16, D17, D18, D19, D20, D21, D22, D23, D24, and D25, on the glove 26a, which may have optional electronic and mechanical circuits 420. A left hand glove 26b Includes 25 sensors to capture the various sensor data points D26, D27, D28, D29, D30, D31, D32, D33, D34, D35, D36, D37, D38, D39, D40, D41, D42, D43, D44, D45, D46, D47, D48, D49, D50, on the glove 26b, which may have optional electronic and mechanical circuits 422.

FIG. 8C is a block diagram illustrating robotic cooking execution steps based on the captured sensory data from the chef's sensory capturing gloves 26a and 26b. In the chef studio 44, the chef 49 wears gloves 26a and 26b with sensors for capturing the food preparation process, where the sensor data are recorded in a table 430. In this example, the chef 49 is cutting a carrot with a knife in which each slice of the carrot is about 1 centimeter in thickness. These action primitives by the chef 49, as recorded by the gloves 26a, 26b, may constitute a minimanipulation 432 that take place over time slots 1, 2, 3 and 4. The recipe algorithm conversion module 404 is configured to convert the recorded recipe file from the chef studio 44 to robotic instructions for operating the robotic arms 70 and the robotic hands 72 in the robotic kitchen 28 according to a software table 434. The robotic arms 70 and the robotic hands 72 prepare the food dish with control signals 436 for the minimanipulation, as pre-defined in the minimanipulation library 116, of cutting the carrot with knife in which each slice of the carrot is about 1 centimeter in thickness. The robotic arms 70 and the robotic hands 72 operate autonomously with the same xyz coordinates 438 and with possible real-time adjustment on the size and shape of a particular carrot by creating a temporary three-dimensional model 440 of the carrot from the real-time adjustment devices 112

In order to operate a mechanical robotic mechanism autonomously such as the ones described in the embodiments of this disclosure, a skilled artisan realizes that many mechanical and control problems need to be addressed, and the literature in robotics describes methods to do just that. The establishment of static and/or dynamic stability in a robotics system is an important consideration. Especially for robotic manipulation, dynamic stability is a strongly desired property, in order to prevent accidental breakage or movements beyond those desired or programmed. Dynamic stability is illustrated in FIG. 8D relative to equilibrium. Here the “equilibrium value” is the desired state of the arm (i.e. the arm moves to exactly where it was programmed to move to, with deviations caused by any number of factors such as inertia, centripetal or centrifugal forces, harmonic oscillations, etc. A dynamically-stable system is one where variations are small and dampen out overtime, as represented by a curved line 450. A dynamically unstable system is one where variations fail to dampen and can increase overtime, as depicted by a curved line 452. In addition, the worst situation is when the arm is statically unstable (e.g. it cannot hold the weight of whatever it is grasping), and falls, or it fails to recover from any deviation from the programmed position and/or path, as illustrated by a curved line 454. For additional information on planning (forming sequences of minimanipulations, or recovering when something goes wrong), Garagnani, M. (1999) “Improving the Efficiency of Processed Domain-axioms Planning”, Proceedings of PLANSIG-99, Manchester, England, pp. 190-192, which this references is incorporated by reference herein in its entirety.

The cited literature addresses conditions for dynamic stability that are imported by reference into the present disclosure to enable proper functioning of the robotic arms. These conditions include the fundamental principle for calculating torque to the joints of a robotic arm:

$${T}^{->} = M ( {q}^{->} ) \frac{{d}^{2} {q}^{->}}{{dt}^{2}} + C ( {q}^{->} , \frac{d {q}^{->}}{dt} ) d {q}^{->} , + G ( {q}^{->} )$$

where T is the torque vector (T has n components, each corresponding to a degree of freedom of the robotic arm), M is the inertial matrix of the system (M is a positive semi-definite n-by-n matrix), C is a combination of centripetal and centrifugal forces, also an n-by-n matrix, G(q) is the gravity vector, and q is the position vector. In addition, they include finding stable points and minima, e.g. via the LaGrange equation if the robotic positions (x's) can be described by twice-differentiable functions (y's).

J[y]=∫ₓ_{₁}^{x}^{₂}L[x,y(x),y′(x)]dx.

J[f]≦J[f+εη].

In order for the system comprised of the robotic arms and hands/grippers to be stable, the system needs to be properly designed, built, and have an appropriate sensing and control system, which operates within the boundary of acceptable performance. One wants to achieve the best (highest speed with highest position/velocity and force/torque tracking and all under stable conditions) performance possible, given the physical system and what its controller is asking it to do.

When one speaks of proper design, the notion is one of achieving proper observability and controllability of the system. Observability implies that the key variables of the system (joint/finger positions and velocities, forces and torques) are measurable by the system, which implies one needs to have the ability to sense these variables, which in turn implies the presence and use of the proper sensing devices (internal or external). Controllability implies that one (computer in this case) have the ability to shape or control the key axes of the system based on observed parameters from internal/external sensors; this usually implies an actuator or direct/indirect control over a certain parameter by way of a motor or other computer-controlled actuation system. The ability to make the system as linear in its response as possible, thereby negating the detrimental effects of nonlinearities (stiction, backlash, hysteresis, etc.), allows for control schemes like PID gain-scheduling and nonlinear controllers like sliding-mode control to guarantee system stability and performance even in the light of system-modeling uncertainties (errors in mass/inertia estimates, dimensional geometry discretization, sensor/torque discretization anomalies, etc.) which are always present in any higher-performance control system.

Furthermore, the use of a proper computing and sampling system is significant, as the system's ability to follow rapid motions with a certain maximum frequency content is clearly related to what control bandwidth (closed-loop sampling rate of the computer control system) the entire system is able to achieve and thus the frequency-response (ability to track motions of certain speeds and motion-frequency content) the system is able to exhibit.

All the above characteristics are significant when it comes to ensuring that a highly redundant system can actually carry out the complex and dexterous tasks a human chef requires for a successful recipe-script execution, in both a dynamic and a stable fashion.

Machine learning in the context of robotic manipulation of relevance to the disclosure can involve well known methods for parameter adjustment, such as reinforcement learning. An alternate and preferred embodiment for this disclosure is a different and more appropriate learning technique for repetitive complex actions such as preparing and cooking a meal with multiple steps over time, namely case-based learning. Case-based reasoning, also known as analogical reasoning, has been developed overtime.

As a general overview, case-based reasoning comprises the following steps:

A. Constructing and Remembering Cases.

A case is a sequence of actions with parameters that are successfully carried out to achieve an objective. The parameters include distances, forces, directions, positions, and other physical or electronic measures whose values are required to carry out the task successfully (e.g. a cooking operation). First, storing aspects of the problem that was just solved together with the method(s) and optionally intermediate steps to solve the problem and its parameter values, and (typically) storing the final outcome.

B. Applying Cases (at a Later Point of Time).

Retrieving one or more stored cases whose problems bear strong similarity to the new problem, optionally adjusting the parameters from the retrieved case(s) to apply to the current case (e.g. an item may weigh somewhat more, and hence a somewhat stronger force is needed to lift it), and using the same methods and steps from the case(s) with the adjusted parameters (if needed) at least in part to solve the new problem.

Hence, case-based reasoning comprises remembering solutions to past problems and applying them with possible parametric modification to new very similar problems. However, in order to apply case-based reasoning to the robotic manipulation challenge, something more is needed. Variation in one parameter of the solution plan will cause variation in one or more coupled parameters. This requires transformation of the problem solution, not just application. We call the new process case-based robotic learning since it generalizes the solution to a family of close solutions (those corresponding to small variations in the input parameters—such as exact weight, shape and location of the input ingredients). Case-based robotic learning operates as follows:

C. Constructing, Remembering and Transforming Robotic Manipulation Cases.

Storing aspects of the problem that was just solved together with the value of the parameters (e.g. the inertial matrix, forces, etc. from equation 1), perform perturbation analysis by varying the parameter(s) pertinent to the domain (e.g. in cooking, vary the weight of the materials or their exact starting position), to see how much parameter values can vary and still obtain the desired results, via perturbation analysis on the model, record which other parameter values will change (e.g. forces) and by how much they should change, and if the changes are within operating specification of the robotic apparatus, store the transformed solution plan (with the dependencies among parameters and projected change calculations for their values).

D. Applying Cases (at a Later Point of Time).

Retrieve one or more stored cases with the transformed exact values (now ranges, or calculations for new values depending on values of the input parameters), but still whose initial problems bear strong similarity to the new problem, including parameter values and value ranges, and use the transformed methods and steps from the case(s) at least in part to solve the new problem.

As the chef teaches the robot (the two arms and the sensing devices, such as haptic feedback from fingers, force-feedback from joints, and one or more observation cameras), the robot learns not only the specific sequence of movements, and time correlations, but also the family of small variations around the chef's movements to be able to prepare the same dish regardless of minor variations in the observable input parameters—and thus it learns a generalized transformed plan, giving it far greater utility than rote memorization. For additional information on case-based reasoning and learning, see materials by Leake, 1996 Book, Case-Based Reasoning: Experiences, Lessons and Future Directions, http://journals.cambridge.org/action/displayAbstract?fromPage=online&aid=4068324&fileld=S0269888 900006585dl.acm.org/citation.cfm?id=524680; Carbonell, 1983, Learning by Analogy: Formulating and Generalizing Plans from Past Experience, http://link.springer.com/chapter/10.1007/978-3-662-12405-5_5, which these references are incorporated by reference herein in their entireties.

As depicted in FIG. 8E, the process of cooking requires a sequence of steps that are referred to as a plurality of stages S₁, S₂, S₃ . . . Sⱼ . . . Sₙ of food preparation, as shown in a timeline 456. These may require strict linear/sequential ordering or some may be performed in parallel; either way we have a set of stages {S₁, S₂, . . . , Sᵢ, . . . , Sₙ}, all of which must be completed successfully to achieve overall success. If the probability of success for each stage is P(sᵢ) and there are n stages, then the probability of overall success is estimated by the product of the probability of success at each stage:

$$P ( S ) = {\prod }_{{S}_{i} ∈ S}^{ } P ( {s}_{i} )$$

A person of skill in the art will appreciate that the probability of overall success can be low even if the probability of success of individual stages is relatively high. For instance, given 10 stages and a probability of success of each stage being 90%, the probability of overall success is (0.9)¹⁰=0.28 or 28%.

A stage in preparing a food dish comprises one or more minimanipulations, where each minimanipulation comprises one or more robotic actions leading to a well-defined intermediate result. For instance, slicing a vegetable can be a minimanipulation comprising grasping the vegetable with one hand, grasping a knife with the other, and applying repeated knife movements until the vegetable is sliced. A stage in preparing a dish can comprise one or multiple slicing minimanipulations.

The probability of success formula applies equally well at the level of stages and at the level of minimanipulations, so long as each minimanipulation is relatively independent of other minimanipulations.

In one embodiment, in order to mitigate the problem of reduced certainty of success due to potential compounding errors, standardized methods for most or all of the minimanipulations in all of the stages are recommended. Standardized operations are ones that can be pre-programmed, pre-tested, and if necessary pre-adjusted to select the sequence of operations with the highest probability of success. Hence, if the probability of standardized methods via the minimanipulations within stages is very high, so will be the overall probability of success of preparing the food dish, due to the prior work, until all of the steps have been perfected and tested. For instance, to return to the above example, if each stage utilizes reliable standardized methods, and its success probability is 99% (instead of 90% as in the earlier example), then the overall probability of success will be (0.99)¹⁰=90.4%, assuming there are 10 stages as before. This is clearly better than 28% probability of an overall correct outcome.

In another embodiment, more than one alternative method is provided for each stage, wherein, if one alternative fails, another alternative is tried. This requires dynamic monitoring to determine the success or failure of each stage, and the ability to have an alternate plan. The probability of success for that stage is the complement of the probability of failure for all of the alternatives, which mathematically is written as:

$$P ( {s}_{i} \vert A ( {s}_{i} ) ) = 1 - {\prod }_{{a}_{j} ∈ A ( {s}_{i} )}^{ } ( 1 - P ( {s}_{i} \vert {a}_{j} ) )$$

In the above expression, s, is the stage and A(sᵢ) is the set of alternatives for accomplishing sᵢ. The probability of failure for a given alternative is the complement of the probability of success for that alternative, namely 1−P(sᵢ|aⱼ), and the probability of all the alternatives failing is the product in the above formula. Hence, the probability that not all will fail is the complement of the product. Using the method of alternatives, the overall probability of success can be estimated as the product of each stage with alternatives, namely:

$$P ( S ) = {\prod }_{{S}_{i} ∈ S}^{ } P ( {s}_{i} \vert A ( {s}_{i} ) )$$

With this method of alternatives, if each of the 10 stages had 4 alternatives, and the expected success of each alternative for each stage was 90%, then the overall probability of success would be (1−(1−(0.9))⁴)¹⁰=0.99 or 99% versus just 28% without the alternatives. The method of alternatives transforms the original problem from a chain of stages with multiple single points of failure (if any stage fails) to one without single points of failure, since all the alternatives would need to fail in order for any given stage to fail, providing more robust outcomes.

In another embodiment, both standardized stages, comprising of standardized minimanipulations and alternate means of the food dish preparation stages, are combined, yielding a behavior that is even more robust. In such a case, the corresponding probability of success can be very high, even if alternatives are only present for some of the stages or minimanipulations.

In another embodiment only the stages with lower probability of success are provided alternatives, in case of failure, for instance stages for which there is no very reliable standardized method, or for which there is potential variability, e.g. depending on odd-shaped materials. This embodiment reduces the burden of providing alternatives to all stages.

FIG. 8F is a graphical diagram showing the probability of overall success (y-axis) as a function of the number of stages needed to cook a food dish (x-axis) for a first curve 458 illustrating a non-standardized kitchen 458 and a second curve 459 illustrating the standardized kitchen 50. In this example, the assumption made is that the individual probability of success per food preparation stage was 90% for a non-standardized operation and 99% for a standardized pre-programmed stage. The compounded error is much worse in the former case, as shown in the curve 458 compared to the curve 459.

FIG. 8G is a block diagram illustrating the execution of a recipe 460 with multi-stage robotic food preparation with minimanipulations and action primitives. Each food recipe 460 can be divided into a plurality of food preparation stages: a first food preparation stage S₁ 470, a second food preparation stage S₂ . . . an n-stage food preparation stage Sₙ 490, as executed by the robotic arms 70 and the robotic hands 72. The first food preparation stage S₁ 470 comprises one or more minimanipulations MM₁ 471, MM₂ 472, and MM₃ 473. Each minimanipulation includes one or more action primitives, which obtains a functional result. For example, the first minimanipulation MM₁ 471 includes a first action primitive AP₁ 474, a second action primitive AP₂ 475, and a third action primitive AP₃ 475, which then achieves a functional result 477. The one or more minimanipulations MM₁ 471, MM₂ 472, MM₃ 473 in the first stage S₁ 470 then accomplish a stage result 479. The combination of one or more food preparation stage S₁ 470, the second food preparation stage S₂ and the n-stage food preparation stage Sₙ 490 produces substantially the same or the same result by replicating the food preparation process of the chef 49 as recorded in the chef studio 44.

A predefined minimanipulation is available to achieve each functional result (e.g., the egg is cracked). Each minimanipulation comprises of a collection of action primitives which act together to accomplish the functional result. For example, the robot may begin by moving its hand towards the egg, touching the egg to localize its position and verify its size, and executing the movements and sensing actions necessary to grasp and lift the egg into the known and predetermined configuration.

Multiple minimanipulations may be collected into stages such as making a sauce for convenience in understanding and organizing the recipe. The end result of executing all of the minimanipulations to complete all of the stages is that a food dish has been replicated with a consistent result each time.

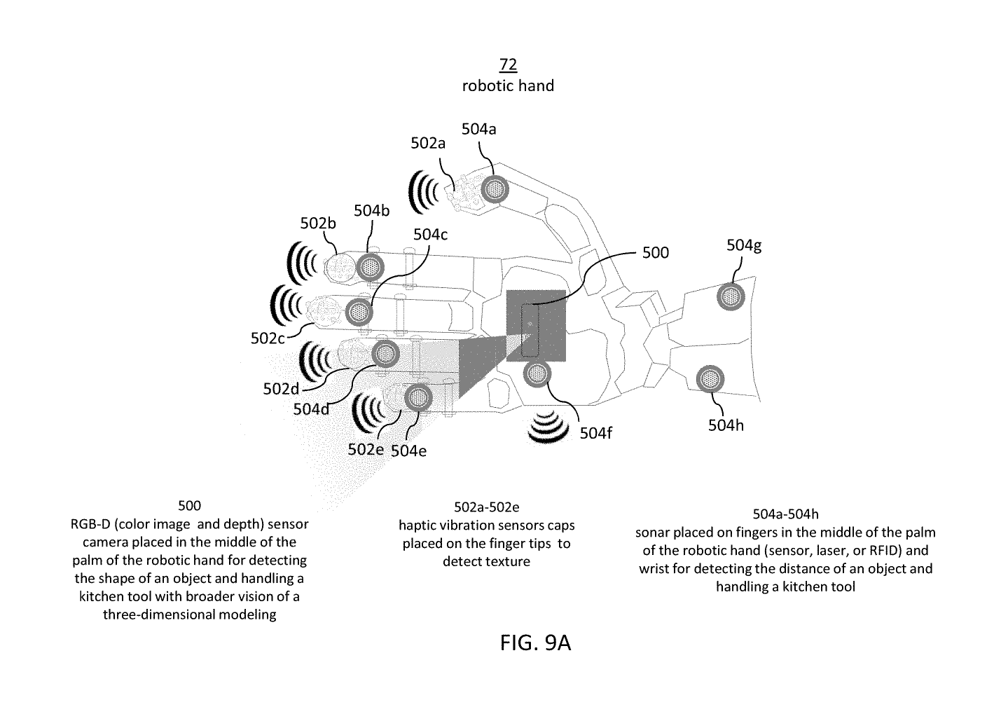

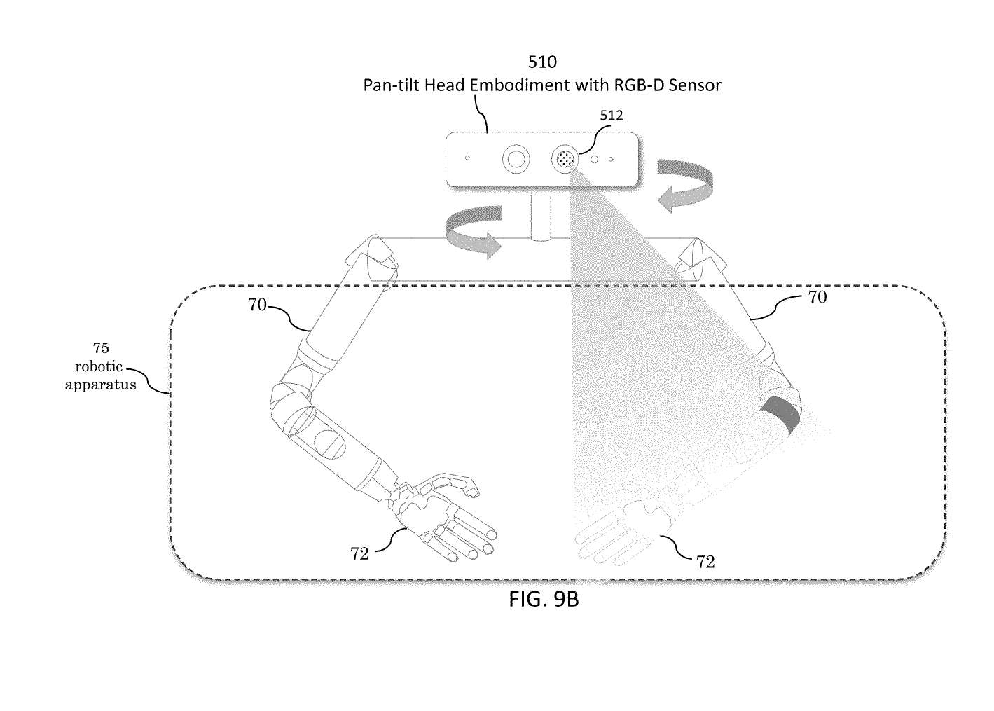

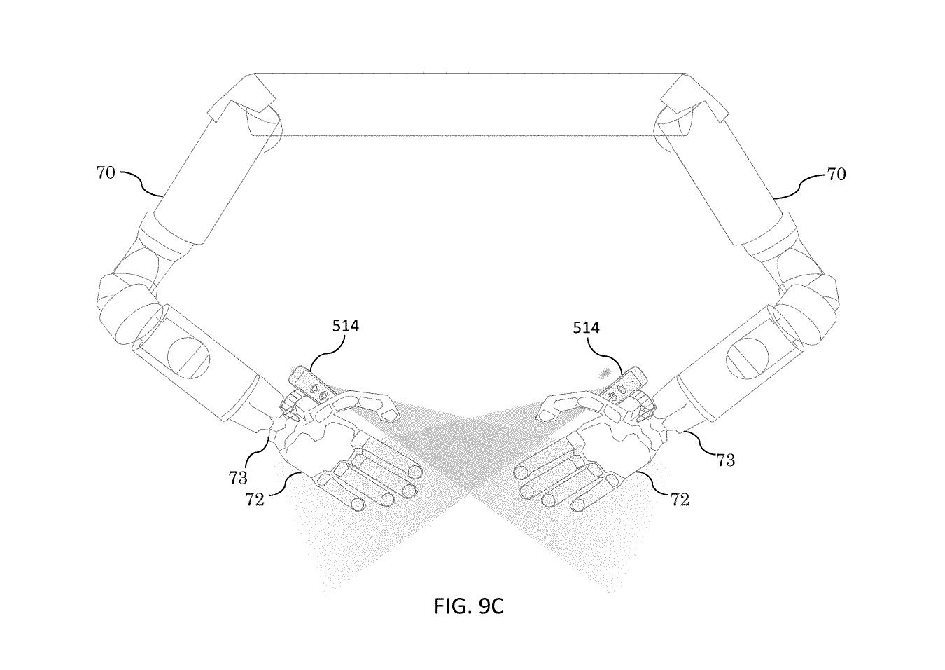

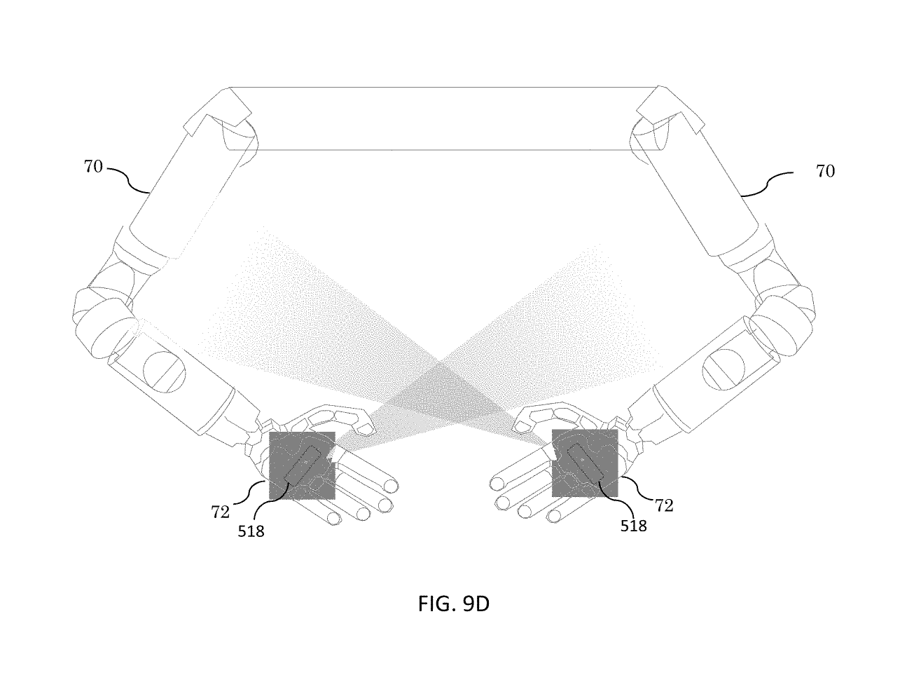

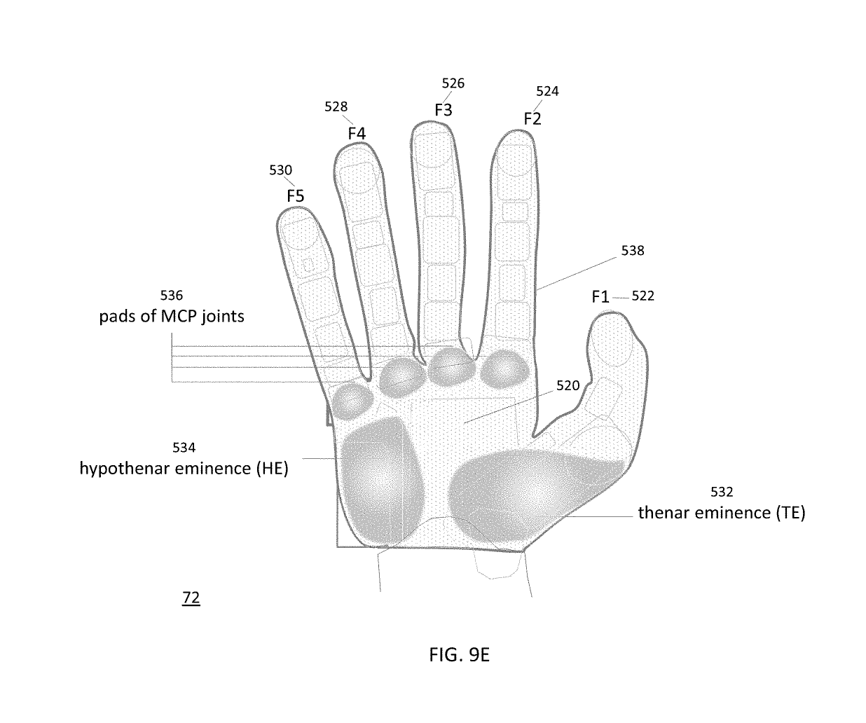

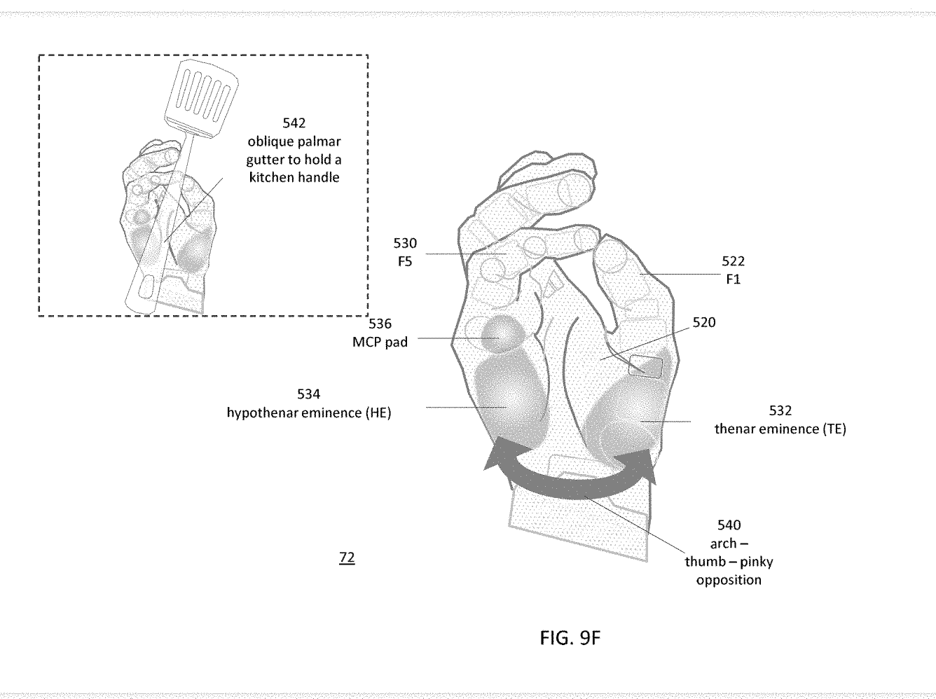

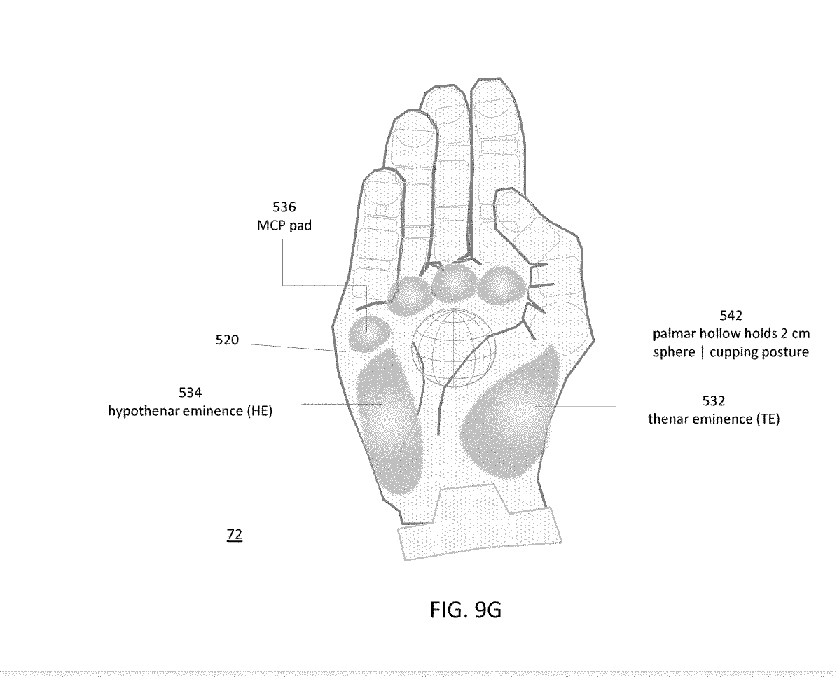

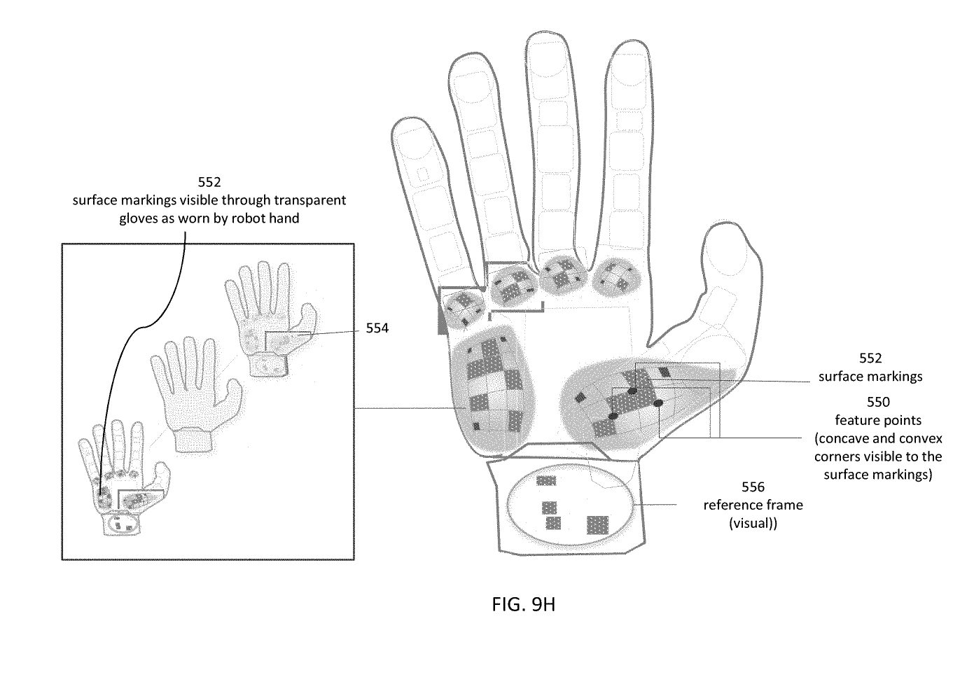

FIG. 9A is a block diagram illustrating an example of the robotic hand 72 with five fingers and a wrist with RGB-D sensor, camera sensors and sonar sensor capabilities for detecting and moving a kitchen tool, an object, or an item of kitchen equipment. The palm of the robotic hand 72 includes an RGB-D sensor 500, a camera sensor or a sonar sensor 504f. Alternatively, the palm of the robotic hand 450 includes both the camera sensor and the sonar sensor. The RGB-D sensor 500 or the sonar sensor 504f is capable of detecting the location, dimensions and shape of the object to create a three-dimensional model of the object. For example, the RGB-D sensor 500 uses structured light to capture the shape of the object, three-dimensional mapping and localization, path planning, navigation, object recognition and people tracking. The sonar sensor 504f uses acoustic waves to capture the shape of the object. In conjunction with the camera sensor 452 and/or the sonar sensor 454, the video camera 66 placed somewhere in the robotic kitchen, such as on a railing, or on a robot, provides a way to capture, follow, or direct the movement of the kitchen tool as used by the chef 49, as illustrated in FIG. 7A. The video camera 66 is positioned at an angle and some distance away from the robotic hand 72, and therefore provides a higher-level view of the robotic hand's 72 gripping of the object, and whether the robotic hand has gripped or relinquished/released the object. A suitable example of RGB-D (a red light beam, a green light beam, a blue light beam, and depth) sensor is the Kinect system by Microsoft, which features an RGB camera, depth sensor and multi-array microphone running on software, which provide full-body 3D motion capture, facial recognition and voice recognition capabilities.

The robotic hand 72 has the RGB-D sensor 500 placed in or near the middle of the palm for detecting the distance and shape of an object, as well as the distance of the object, and for handling a kitchen tool. The RGB-D sensor 500 provides guidance to the robotic hand 72 in moving the robotic hand 72 toward the direction of the object and to make necessary adjustments to grab an object. Second, a sonar sensor 502f and/or a tactile pressure sensor are placed near the palm of the robotic hand 72, for detecting the distance and shape, and subsequent contact, of the object. The sonar sensor 502f can also guide the robotic hand 72 to move toward the object. Additional types of sensors in the hand may include ultrasonic sensors, lasers, radio frequency identification (RFID) sensors, and other suitable sensors. In addition, the tactile pressure sensor serves as a feedback mechanism so as to determine whether the robotic hand 72 continues to exert additional pressure to grab the object at such point where there is sufficient pressure to safely lift the object. In addition, the sonar sensor 502f in the palm of the robotic hand 72 provides a tactile sensing function to grab and handle a kitchen tool. For example, when the robotic hand 72 grabs a knife to cut beef, the amount of pressure that the robotic hand exerts on the knife and applies to the beef can be detected by the tactile sensor when the knife finishes slicing the beef, i.e. when the knife has no resistance, or when holding an object. The pressure distributed is not only to secure the object, but also not to break it (e.g. an egg).

Furthermore, each finger on the robotic hand 72 has haptic vibration sensors 502a-e and sonar sensors 504a-e on the respective fingertips, as shown by a first haptic vibration sensor 502a and a first sonar sensor 504a on the fingertip of the thumb, a second haptic vibration sensor 502b and a second sonar sensor 504b on the fingertip of the index finger, a third haptic vibration sensor 502c and a third sonar sensor 504c on the fingertip of the middle finger, a fourth haptic vibration sensor 502d and a fourth sonar sensor 504d on the fingertip of the ring finger, and a fifth haptic vibration sensor 502e and a fifth sonar sensor 504e on the fingertip of the pinky. Each of the haptic vibration sensors 502a, 502b, 502c, 502d and 502e can simulate different surfaces and effects by varying the shape, frequency, amplitude, duration and direction of a vibration. Each of the sonar sensors 504a, 504b, 504c, 504d and 504e provides sensing capability on the distance and shape of the object, sensing capability for the temperature or moisture, as well as feedback capability. Additional sonar sensors 504g and 504h are placed on the wrist of the robotic hand 72.

FIG. 9B is a block diagram illustrating one embodiment of a pan-tilt head 510 with a sensor camera 512 coupled to a pair of robotic arms and hands for operation in the standardized robotic kitchen. The pan-tilt head 510 has an RGB-D sensor 512 for monitoring, capturing or processing information and three-dimensional images within the standardized robotic kitchen 50. The pan-tilt head 510 provides good situational awareness, which is independent of arm and sensor motions. The pan-tilt head 510 is coupled to the pair of robotic arms 70 and hands 72 for executing food preparation processes, but the pair of robotic arms 70 and hands 72 may cause occlusions. In one embodiment, a robotic apparatus comprises one or more robotic arms 70 and one or more robotic hands (or robotic grippers) 72.

FIG. 9C is a block diagram illustrating sensor cameras 514 on the robotic wrists 73 for operation in the standardized robotic kitchen 50. One embodiment of the sensor cameras 514 is an RGB-D sensor that provides color image and depth perception mounted to the wrists 73 of the respective hand 72. Each of the camera sensors 514 on the respective wrist 73 provides limited occlusions by an arm, while generally not occluded when the robotic hand 72 grasps an object. However, the RGB-D sensors 514 may be occluded by the respective robotic hand 72.

FIG. 9D is a block diagram illustrating an eye-in-hand 518 on the robotic hands 72 for operation in the standardized robotic kitchen 50. Each hand 72 has a sensor, such as an RGD-D sensor for providing an eye-in-hand function by the robotic hand 72 in the standardized robotic kitchen 50. The eye-in-hand 518 with RGB-D sensor in each hand provides high image details with limited occlusions by the respective robotic arm 70 and the respective robotic hand 72. However, the robotic hand 72 with the eye-in-hand 518 may encounter occlusions when grasping an object.

FIGS. 9E-G are pictorial diagrams illustrating aspects of a deformable palm 520 in the robotic hand 72. The fingers of a five-fingered hand are labeled with the thumb as a first finger F1 522, the index finger as a second finger F2 524, the middle finger as a third finger F3 526, the ring finger as a fourth finger F4528, and the little finger as a fifth finger F5530. The thenar eminence 532 is a convex volume of deformable material on the radial (the first finger F1522) side of the hand. The hypothenar eminence 534 is a convex volume of deformable material on the ulnar (the fifth finger F5 530) side of the hand. The metacarpophalangeal pads (MCP pads) 536 are convex deformable volumes on the ventral (pal mar) side of the metacarpophalangeal (knuckle) joints of second, third, fourth and fifth fingers F2 524, F3 526, F4 528, F5 530. The robotic hand 72 with the deformable palm 520 wears a glove on the outside with a soft human-like skin.

Together the thenar eminence 532 and hypothenar eminence 534 support application of large forces from the robot arm to an object in the working space such that application of these forces puts minimal stress on the robot hand joints (e.g., picture of the rolling pin). Extra joints within the palm 520 themselves are available to deform the palm. The palm 520 should deform in such a way as to enable the formation of an oblique palmar gutter for tool grasping in a way similar to a chef (typical handle grasp). The palm 520 should deform in such a way as to enable cupping, for conformable grasping of convex objects such as dishes and food materials in a manner similar to the chef, as shown by a cupping posture 542 in FIG. 9G.

Joints within the palm 520 that may support these motions include the thumb carpometacarpal joint (CMC), located on the radial side of the palm near the wrist, which may have two distinct directions of motion (flexion/extension and abduction/adduction). Additional joints required to support these motions may include joints on the ulnar side of the palm near the wrist (the fourth finger F4 528 and the fifth finger F5 530 CMC joints), which allow flexion at an oblique angle to support cupping motion at the hypothenar eminence 534 and formation of the palmar gutter.

The robotic palm 520 may include additional/different joints as needed to replicate the palm shape observed in human cooking motions, e.g., a series of coupled flexure joints to support formation of an arch 540 between the thenar and hypothenar eminences 532 and 534 to deform the palm 520, such as when the thumb F1 522 touches the pinky finger F5530, as illustrated in FIG. 9F.

When the palm is cupped, the thenar eminence 532, the hypothenar eminence 534, and the MCP pads 536 form ridges around a palmar valley that enable the palm to close around a small spherical object (e.g., 2 cm).

The shape of the deformable palm will be described using locations of feature points relative to a fixed reference frame, as shown in FIGS. 9H and 9I. Each feature point is represented as a vector of x, y, and z coordinate positions over time. Feature point locations are marked on the sensing glove worn by the chef and on the sensing glove worn by the robot. A reference frame is also marked on the glove, as illustrated in FIGS. 9H and 9I. Feature points are defined on a glove relative to the position of the reference frame.

Feature points are measured by calibrated cameras mounted in the workspace as the chef performs cooking tasks. Trajectories of feature points in time are used to match the chef motion with the robot motion, including matching the shape of the deformable palm. Trajectories of feature points from the chef's motion may also be used to inform robot deformable palm design, including shape of the deformable palm surface and placement and range of motion of the joints of the robot hand.

In the embodiment as depicted in FIG. 9H, the feature points are in the hypothenar eminence 534, the thenar eminence 532, and the MCP pad 536 are checkered patterns with markings that show the feature points in each region of the palm. The reference frame in the wrist area has four rectangles that are identifiable as a reference frame. The feature points (or markers) are identified in their respective locations relative to the reference frame. The feature points and reference frame in this embodiment can be implemented underneath a glove for food safety but transparent through the glove for detection.

FIG. 9H shows the robot hand with a visual pattern that may be used to determine the locations of three-dimensional shape feature points 550. The locations of these shape feature points provide information about the shape of the palm surface as the palm joints move and as the palm surface deforms in response to applied forces.

The visual pattern comprises surface markings 552 on the robot hand or on a glove worn by the chef. These surface markings may be covered by a food safe transparent glove 554, but the surface markings 552 remain visible through the glove.

When the surface markings 552 are visible in a camera image, two-dimensional feature points may be identified within that camera image by locating convex or concave corners within the visual pattern. Each such corner in a single camera image is a two-dimensional feature point.

When the same feature point is identified in multiple camera images, the three-dimensional location of this point can be determined in a coordinate frame, which is fixed with respect to the standardized robotic kitchen 50. This calculation is performed based on the two-dimensional location of the point in each image and the known camera parameters (position, orientation, field of view, etc.).

A reference frame 556 fixed to the robotic hand 72 can be obtained using a reference frame visual pattern. In one embodiment, the reference frame 556 fixed to the robotic hand 72 comprises of an origin and three orthogonal coordinate axes. It is identified by locating features of the reference frame's visual pattern in multiple cameras, and using known parameters of the reference frame visual pattern and known parameters of the cameras to extract the origin and coordinate axes.

Three-dimensional shape feature points expressed in the coordinate frame of the food preparation station can be converted into the reference frame of the robot hand once the reference frame of the robot hand is observed.

The shape of the deformable palm is comprised of a vector of three-dimensional shape feature points, all of which are expressed in the reference coordinate frame fixed to the hand of the robot or the chef.

As illustrated in FIG. 9I, the feature points 560 in the embodiments are represented by the sensors, such as Hall effect sensors, in the different regions (the hypothenar eminence 534, the thenar eminence 532, and the MCP pad 536 of the palm. The feature points are identifiable in their respective locations relative to the reference frame, which in this implementation is a magnet. The magnet produces magnetic fields that are readable by the sensors. The sensors in this embodiment are embedded underneath the glove.

FIG. 9I shows the robot hand 72 with embedded sensors and one or more magnets 562 that may be used as an alternative mechanism to determine the locations of three-dimensional shape feature points. One shape feature point is associated with each embedded sensor. The locations of these shape feature points 560 provide information about the shape of the palm surface as the palm joints move and as the palm surface deforms in response to applied forces.

Shape feature point locations are determined based on sensor signals. The sensors provide an output that allows calculation of distance in a reference frame, which is attached to the magnet, which furthermore is attached to the hand of the robot or the chef.

The three-dimensional location of each shape feature point is calculated based on the sensor measurements and known parameters obtained from sensor calibration. The shape of the deformable palm is comprised of a vector of three-dimensional shape feature points, all of which are expressed in the reference coordinate frame, which is fixed to the hand of the robot or the chef. For additional information on common contact regions on the human hand and function in grasping, see the material from Kamakura, Noriko, Michiko Matsuo, Harumi Ishii, Fumiko Mitsuboshi, and Yoriko Miura. “Patterns of static pretension in normal hands.” American Journal of Occupational Therapy 34, no. 7 (1980): 437-445, which this reference is incorporated by reference herein in its entirety.

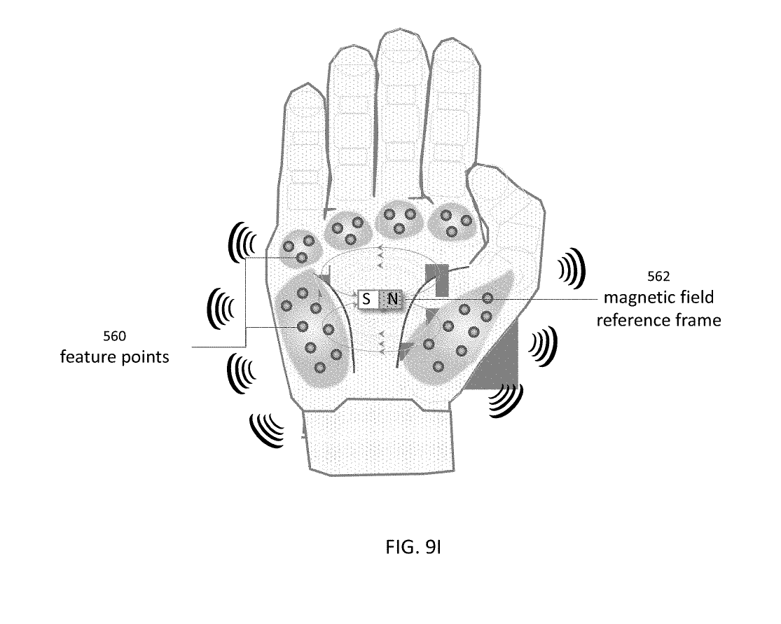

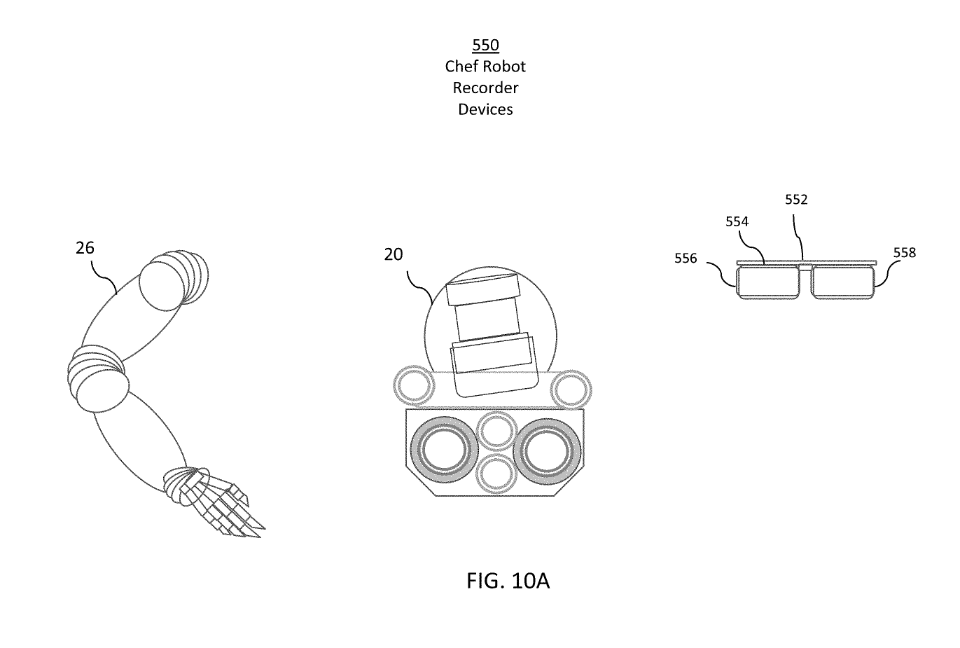

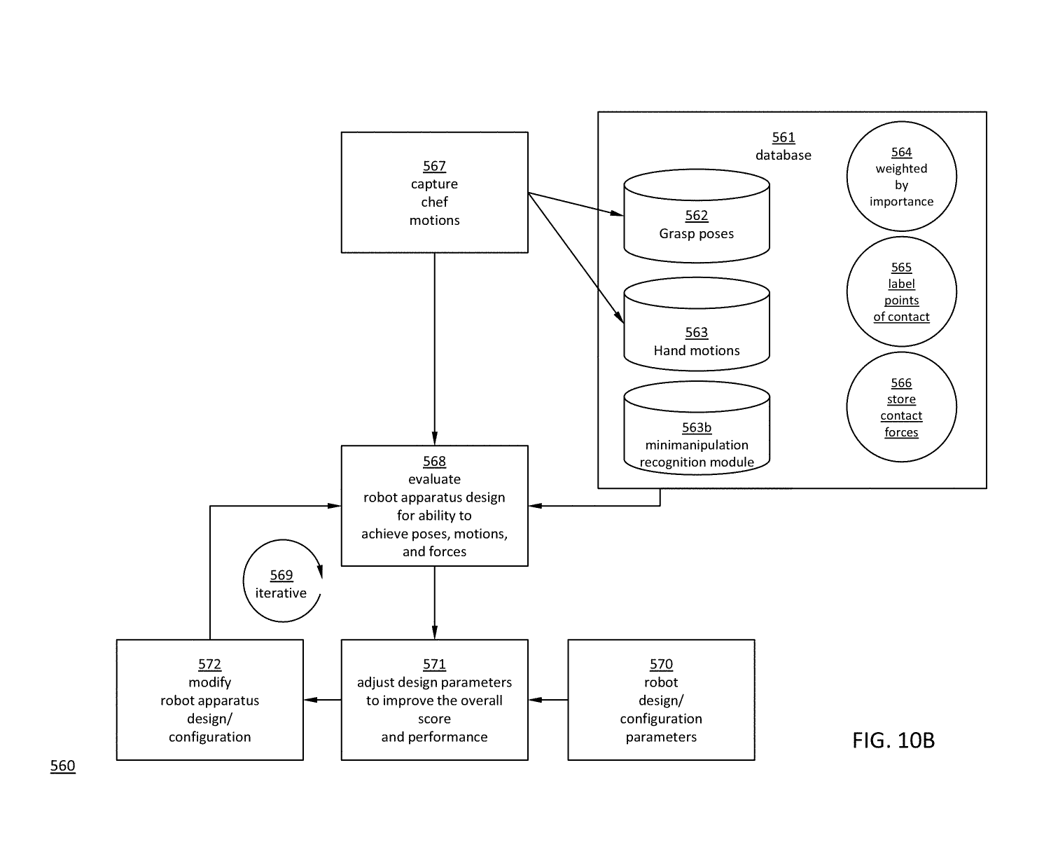

FIG. 10A is block diagram illustrating examples of chef recording devices 550 which the chef 49 wears in the standardized robotic kitchen environment 50 for recording and capturing the chef's movements during the food preparation process for a specific recipe. The chef recording devices 550 include, but are not limited to, one or more robot gloves (or robot garment) 26, a multimodal sensor unit 20 and a pair of robot glasses 552. In the chef studio system 44, the chef 49 wears the robot gloves 26 for cooking, recording, and capturing the chef's cooking movements. Alternatively, the chef 49 may wear a robotic costume with robotic gloves instead of just the robot gloves 26. In one embodiment, the robot glove 26, with embedded sensors, captures, records and saves the position, pressure and other parameters of the chef's arm, hand, and finger motions in a xyz-coordinate system with a time-stamp. The robot gloves 26 save the position and pressure of the arms and fingers of the chef 18 in a three-dimensional coordinate frame over a time duration from the start time to the end time in preparing a particular food dish. When the chef 49 wears the robotic gloves 26, all of the movements, the position of the hands, the grasping motions, and the amount of pressure exerted, in preparing a food dish in the chef studio system 44, are precisely recorded at a periodic time interval, such as every t seconds. The multimodal sensor unit(s) 20 include video cameras, IR cameras and range finders 306, stereo (or even trinocular) camera(s) 308 and multi-dimensional scanning lasers 310, and provide multi-spectral sensory data to the main software abstraction engines 312 (after being acquired and filtered in the data acquisition and filtering module 314). The multimodal sensor unit 20 generates a three-dimensional surface or texture, and processes abstraction model-data. The data is used in a scene understanding module 316 to carry out multiple steps such as (but not limited to) building high- and lower-resolution (laser: high-resolution; stereo-camera: lower-resolution) three-dimensional surface volumes of the scene, with superimposed visual and IR-spectrum color and texture video-information, allowing edge-detection and volumetric object-detection algorithms to infer what elements are in a scene, allowing the use of shape-/color-/texture- and consistency-mapping algorithms to run on the processed data to feed processed information to the Kitchen Cooking Process Equipment Handling Module 318. Optionally, in addition to the robot gloves 76, the chef 49 can wear a pair of robot glasses 552, which has one or more robot sensors 554 around the frame with a robot earpiece 556 and a microphone 558. The robot glasses 552 provide additional vision and capturing capabilities such as a camera for capturing video and recording images that the chef 49 sees while cooking a meal. The one or more robot sensors 554 capture and record temperature and smell of the meal that is being prepared. The earpiece 556 and the microphone 558 capture and record sounds that the chef 49 hears while cooking, which may include human voices, sounds characteristics of frying, grilling, grinding, etc. The chef 49 may also record simultaneous voice instructions and real-time cooking steps of the food preparation by using the earpiece and microphone 82. In this respect, the chef robot recorder devices 550 record the chef's movements, speed, temperature and sound parameters during the food preparation process for a particular food dish.

FIG. 10B is a flow diagram illustrating one embodiment of the process 560 in evaluating the captured of chef's motions with robot poses, motions and forces. A database 561 stores predefined (or predetermined) grasp poses 562 and predefined hand motions by the robotic arms 72 and the robotic hands 72, which are weighted by importance 564, labeled with points of contact 565, and stored contact forces 565. At operation 567, the chef movements recording module 98 is configured to capture the chef's motions in preparing a food dish based in part on the predefined grasp poses 562 and the predefined hand motions 563. At operation 568, the robotic food preparation engine 56 is configured to evaluate the robot apparatus configuration for its ability to achieve poses, motions and forces, and to accomplish minimanipulations. Subsequently, the robot apparatus configuration undergoes an iterative process 569 in assessing the robot design parameters 570, adjusting design parameters to improve the score and performance 571, and modifying the robot apparatus configuration 572.

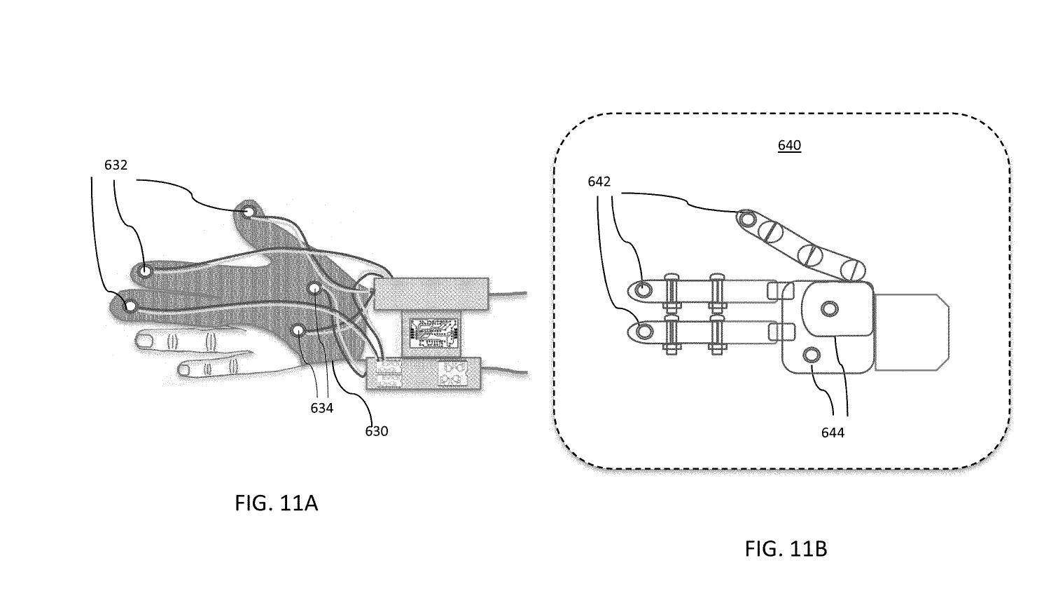

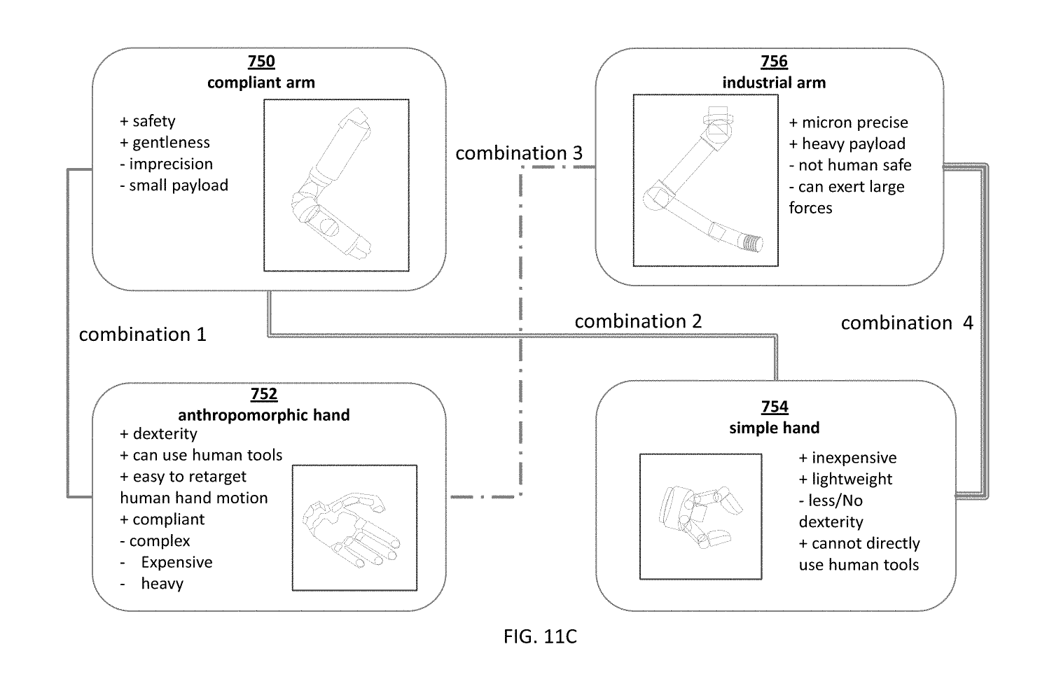

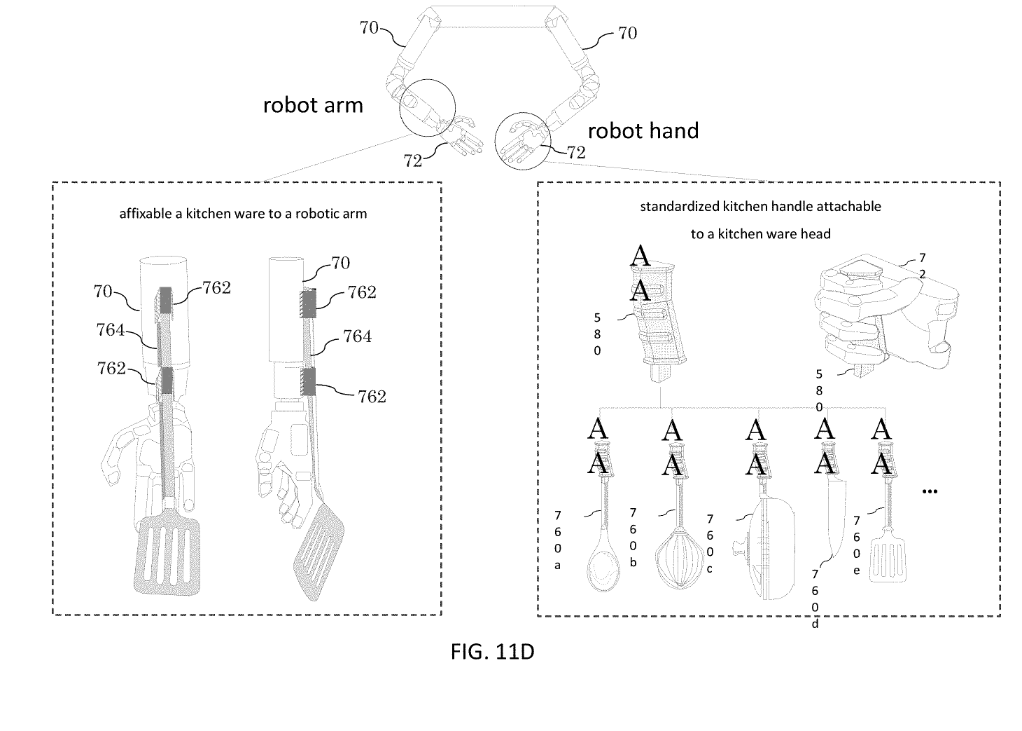

FIGS. 11A-11B are pictorial diagrams illustrating one embodiment of a three-finger haptic glove 630 with sensors for food preparation by the chef 49 and an example of a three-fingered robotic hand 640 with sensors. The embodiment illustrated herein shows the simplified robotic hand 640, which has less than five fingers for food preparation. Correspondingly, the complexity in the design of the simplified robotic hand 640 would be significantly reduced, as well as the cost to manufacture the simplified robotic hand 640. Two finger grippers or four-finger robotic hands, with or without an opposing thumb, are also possible alternate implementations. In this embodiment, the chef's hand movements are limited by the functionalities of the three fingers, thumb, index finder and middle finger, where each finger has a sensor 632 for sensing data of the chef's movement with respect to force, temperature, humidity, toxicity or tactile-sensation. The three-finger haptic glove 630 also includes point sensors or distributed pressure sensors in the palm area of the three-finger haptic glove 630. The chef's movements in preparing a food dish wearing the three-finger haptic glove 630 using the thumb, the index finger, and the middle fingers are recorded in a software file. Subsequently, the three-fingered robotic hand 640 replicates the chef's movements from the converted software recipe file into robotic instructions for controlling the thumb, the index finger and the middle finger of the robotic hand 640 while monitoring sensors 642b on the fingers and sensors 644 on the palm of the robotic hand 640. The sensors 642 include a force, temperature, humidity, toxicity or tactile sensor, while the sensors 644 can be implemented with point sensors or distributed pressure sensors.

FIG. 11C is a block diagram illustrating one example of the interplay and interactions between the robotic arm 70 and the robotic hand 72. A compliant robotic arm 750 provides a smaller payload, higher safety, more gentle actions, but less precision. An anthropomorphic robotic hand 752 provides more dexterity, capable of handling human tools, is easier to retarget for a human hand motion, more compliant, but the design requires more complexity, increase in weight, and higher product cost. A simple robotic hand 754 is lighter in weight, less expensive, with lower dexterity, and not able to use human tools directly. An industrial robotic arm 756 is more precise, with higher payload capacity but generally not considered safe around humans and can potentially exert a large amount of force and cause harm. One embodiment of the standardized robotic kitchen 50 is to utilize a first combination of the compliant arm 750 with the anthropomorphic hand 752. The other three combinations are generally less desirable for implementation of the present disclosure.

FIG. 11D is a block diagram illustrating the robotic hand 72 using the standardized kitchen handle 580 to attach to a custom cookware head and the robotic arm 70 affixable to kitchen ware. In one technique to grab a kitchen ware, the robotic hand 72 grabs the standardized kitchen tool 580 for attaching to any one of the custom cookware heads from the illustrated choices of 760a, 760b, 760c, 760d, 760e, and others. For example, the standardized kitchen handle 580 is attached to the custom spatula head 760e for use to stir-fry the ingredients in a pan. In one embodiment, the standardized kitchen handle 580 can be held by the robotic hand 72 in just one position, which minimizes the potential confusion in different ways to hold the standardized kitchen handle 580. In another technique to grab a kitchen ware, the robotic arm has one or more holders 762 that are affixable to a kitchen ware 762, where the robotic arm 70 is able to exert more forces if necessary in pressing the kitchen ware 762 during the robotic hand motion.

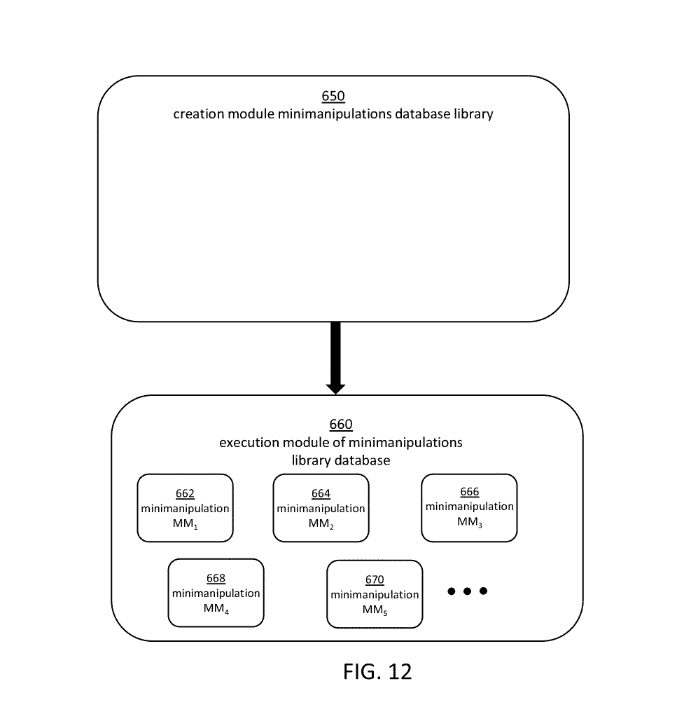

FIG. 12 is a block diagram illustrating a creation module 650 of a minimanipulation library database and an execution module 660 of the minimanipulation library database. The creation module 60 of the minimanipulation database library is a process of creating, testing various possible combinations, and selecting an optimal minimanipulation to achieve a specific functional result. One objective of the creation module 60 is to explore all different possible combinations in performing a specific minimanipulation and predefine a library of optimal minimanipulations for subsequent execution by the robotic arms 70 and the robotic hands 72 in preparing a food dish. The creation module 650 of the minimanipulation library can also be used as a teaching method for the robotic arms 70 and the robotic hands 72 to learn about the different food preparation functions from the minimanipulation library database. The execution modules 660 of the minimanipulations library database is configured to provide a range of minimanipulation functions which the robotic apparatus 75 can access and execute from the minimanipulations library database containing a first minimanipulation MM₁ with a first functional outcome 662, a second minimanipulation MM₂ with a second functional outcome 664, a third minimanipulation MM₃ with a third functional outcome 666, a fourth minimanipulation MM₄ with a fourth functional outcome 668, and a fifth minimanipulation MM₅ with a fifth functional outcome 670, during the process of preparing a food dish.

Generalized Minimanipulations: A generalized minimanipulation comprises a well-defined sequence of sensing and actuator actions with an expected functional outcome. Associated with each minimanipulation we have a set of pre-conditions and a set of post-conditions. The pre-conditions assert what must be true in the world state in order to enable the minimanipulation to take place. The postconditions are changes to the world state brought about by the minimanipulations.

For instance, the minimanipulation for grasping a small object would comprise observing the location and orientation of the object, moving the robotic hand (the gripper) to align it with the object's position, applying the requisite force based on the object's weight and rigidity, and moving the arm upwards.

In this example, the preconditions include having a graspable object located within reach of the robotic hand, and its weight being within the lifting capabilities of the arm. The postconditions are that the object is no longer resting on the surface where it was found previously and it is now held by to robot's hand.

More generally, a generalized minimanipulation M comprises triple <PRE, ACT, POST>, where PRE={(s₁, s₂, . . . , sₙ} is a set of items in the world state that must be true before the actions ACT=[a₁, a₂, . . . , aₖ] can take place, and result in a set of changes to the world state denoted as POST={p₁, p₂ . . . , pₘ}. Note that [square brackets] mean sequences, and {curly brackets} mean unordered sets. Each post condition may also have a probability in case the outcome is less than certain. For instance the minimanipulation for grasping an egg may have a 0.99 probability that the egg is in the hand of the robot (the remaining 0.01 probability may correspond to inadvertently breaking the egg while attempting to grasp it, or other unwanted consequence).

Even more generally, a minimanipulation can include other (smaller) minimanipulations in its sequence of actions instead of just atomic or basic robotic sensing or actuating. In such a case, the minimanipulation would comprise the sequence: ACT=[a₁, m₂, m₃, . . . , aₖ] where basic actions denoted by “a's” are interspersed with minimanipulations denoted by “m's”. In such a case, the post condition set would be satisfied by the union of the preconditions for its basic actions and the union of the preconditions of all of its sub-minimanipulations.

PRE=PREₐ∪(Uₘ_{ᵢ}_{εACT}PRE(mᵢ))

The postconditions would of the generalized minimanipulation would be determined in a similar manner, that is:

POST=POSTₐ∪(Uₘ_{ᵢ}_{εACT}POST(mᵢ))

Of note is that the preconditions and postconditions refer to specific aspects of the physical world (locations, orientation, weights, shapes, etc.), rather than just being mathematical symbols. In other words, the software and algorithms that implement selection and assembly of minimanipulations have direct effects on the robotic machinery, which in turn has directs effects on the physical world.

In one embodiment, when specifying the threshold performance of a minimanipulation, whether generalized or basic, the measurements are performed on the POST conditions, comparing the actual result to the optimal result. For instance, in the task of assembly if a part is positioned within 1% of its desired orientation and location and the threshold of performance was 2%, then the minimanipulation is successful. Similarly, if the threshold were 0.5% in the above example, then the minimanipulation is unsuccessful.

In another embodiment, instead of specifying a threshold performance for a minimanipulation, an acceptable range is defined for the parameters of the POST conditions, and the minimanipulation is successful if the resulting value of the parameters after executing the minimanipulation fall within the specified range. These ranges are task dependent and specified for each task. For instance, in the assembly task, the position of a part may be specified within a range (or tolerance), such as between 0 and 2 millimeters of another part, and the minimanipulation is successful if it the final location of the part is within the range.

In a third embodiment a minimanipulation is successful if its POST conditions match PRE conditions of the next minimanipulation in the robotic task. For instance, if the POST condition in the assembly task of one minimanipulation places a new part 1 millimeter from a previously placed part and the next minimanipulation (e.g. welding) has a PRE condition that specifies the parts must be within 2 millimeters, then the first minimanipulation was successful.

In general, the preferred embodiments for all minimanipulations, basic and generalized, that are stored in the minimanipulation library have been designed, programmed and tested in order that they be performed successfully in foreseen circumstances.

Tasks comprising of minimanipulations: A robotic task is comprised of one or (typically) multiple minimanipulations. These minimanipulations may execute sequentially, in parallel, or adhering to a partial order. “Sequentially” means that each step is completed before the subsequent one is started. “In parallel” means that the robotic device can execute the steps simultaneously or in any order. A “partial order” means that some steps must be performed in sequence-those specified in the partial order—and the rest can be executed before, after, or during the steps specified in the atrial order. A partial order is defined in the standard mathematical sense as a set of steps S and ordering constraints among some of the steps sᵢ→sⱼ meaning that step i must be executed before step j. These steps can be minimanipulations or combinations of minimanipulations. For instance in a robotic chef, if two ingredients must be placed in a bowl and the mixed. There are ordering constraint that each ingredient must be placed in the bowl before mixing, but no ordering constraint on which ingredient is placed first into the mixing bowl.

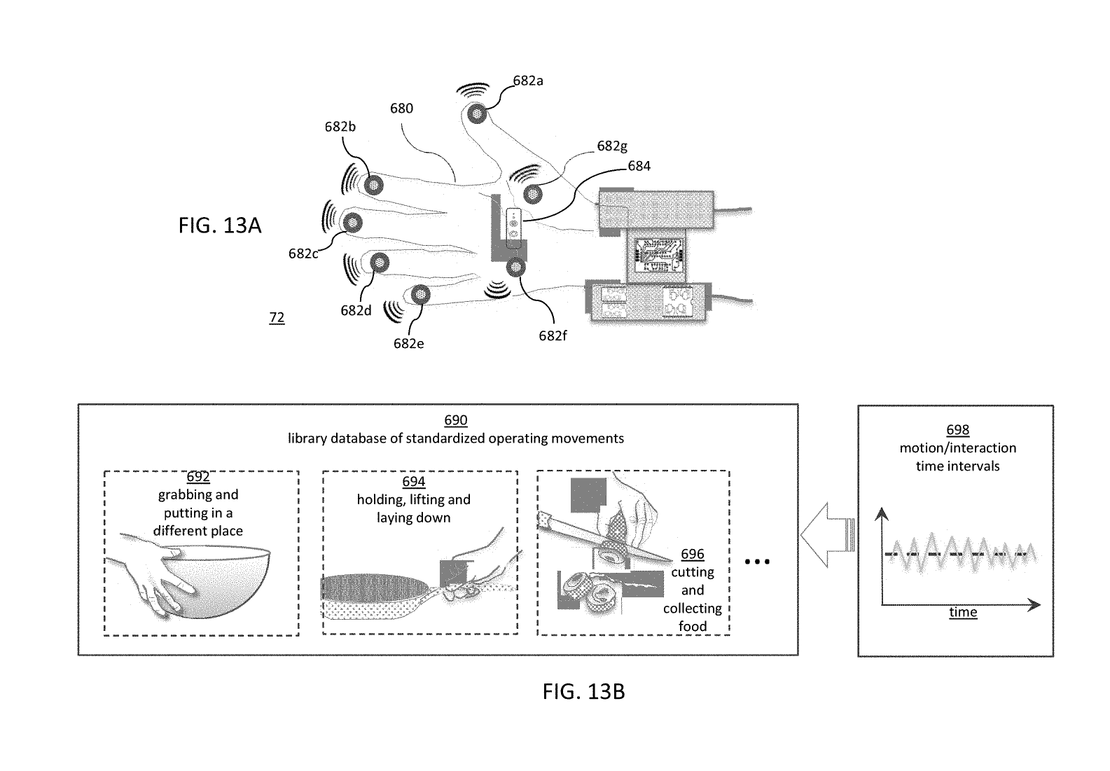

FIG. 13A is a block diagram illustrating a sensing glove 680 used by the chef 49 to sense and capture the chef's movements while preparing a food dish. The sensing glove 680 has a plurality of sensors 682a, 682b, 682c, 682d, 682e on each of the fingers, and a plurality of sensors 682f, 682g, in the palm area of the sensing glove 680. In one embodiment, the at least 5 pressure sensors 682a, 682b, 682c, 682d, 682e inside the soft glove are used for capturing and analyzing the chef's movements during all hand manipulations. The plurality of sensors 682a, 682b, 682c, 682d, 682e, 682f, and 682g in this embodiment are embedded in the sensing glove 680 but transparent to the material of the sensing glove 680 for external sensing. The sensing glove 680 may have feature points associated with the plurality of sensors 682a, 682b, 682c, 682d, 682e, 682f, 682g that reflect the hand curvature (or relief) of various higher and lower points in the sensing glove 680. The sensing glove 680, which is placed over the robotic hand 72, is made of soft materials that emulate the compliance and shape of human skin. Additional description elaborating on the robotic hand 72 can be found in FIG. 9A.

The robotic hand 72 includes a camera senor 684, such as an RGB-D sensor, an imaging sensor or a visual sensing device, placed in or near the middle of the palm for detecting the distance and shape of an object, as well as the distance of the object, and for handling a kitchen tool. The imaging sensor 682f provides guidance to the robotic hand 72 in moving the robotic hand 72 towards the direction of the object and to make necessary adjustments to grab an object. In addition, a sonar sensor, such as a tactile pressure sensor, may be placed near the palm of the robotic hand 72, for detecting the distance and shape of the object. The sonar sensor 682f can also guide the robotic hand 72 to move toward the object. Each of the sonar sensors 682a, 682b, 682c, 682d, 682e, 682f, 682g includes ultrasonic sensors, laser, radiofrequency identification (RFID), and other suitable sensors. In addition, each of the sonar sensors 682a, 682b, 682c, 682d, 682e, 682f, 682g serves as a feedback mechanism to determine whether the robotic hand 72 continues to exert additional pressure to grab the object at such point where there is sufficient pressure to grab and lift the object. In addition, the sonar sensor 682f in the palm of the robotic hand 72 provides tactile sensing function to handle a kitchen tool. For example, when the robotic hand 72 grabs a knife to cut beef, the amount of pressure that the robotic hand 72 exerts on the knife and applies to the beef, allows the tactile sensor to detect when the knife finishes slicing the beef, i.e., when the knife has no resistance. The distributed pressure is not only to secure the object, but also so as not to exert too much pressure so as to, for example, not to break an egg). Furthermore, each finger on the robotic hand 72 has a sensor on the finger tip, as shown by the first sensor 682a on the fingertip of the thumb, the second sensor 682b on the fingertip of the index finger, the third sensor 682c on the finger tip of the middle finger, the fourth sensor 682d on the finger tip of the ring finger, and the fifth sensor 682f on the finger tip of the pinky. Each of the sensors 682a, 682b, 682c, 682d, 682e provide sensing capability on the distance and shape of the object, sensing capability for temperature or moisture, as well as tactile feedback capability.

The RGB-D sensor 684 and the sonar sensor 682f in the palm, plus the sonar sensors 682a, 682b, 682c, 682d, 682e in the fingertip of each finger, provide a feedback mechanism to the robotic hand 72 as a means to grab a non-standardized object, or a non-standardized kitchen tool. The robotic hands 72 may adjust the pressure to a sufficient degree to grab ahold of the non-standardized object. A program library 690 that stores sample grabbing functions 692, 694, 696 according to a specific time interval for which the robotic hand 72 can draw from in performing a specific grabbing function, is illustrated in FIG. 13B. FIG. 13B is a block diagram illustrating a library database 690 of standardized operating movements in the standardized robotic kitchen module 50. Standardized operating movements, which are predefined and stored in the library database 690, include grabbing, placing, and operating a kitchen tool or a piece of kitchen equipment, with motion/interaction time profiles 698.

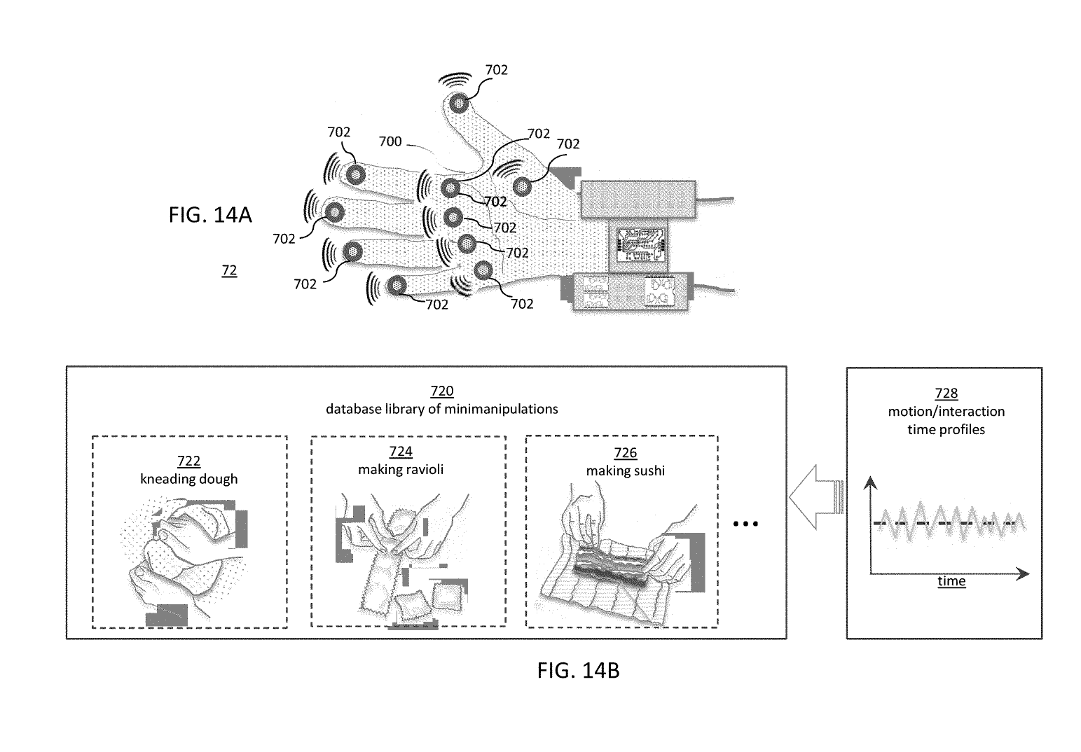

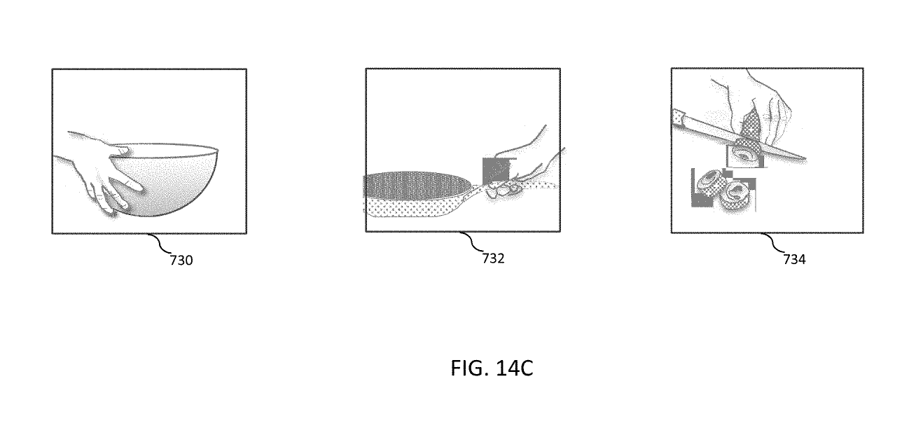

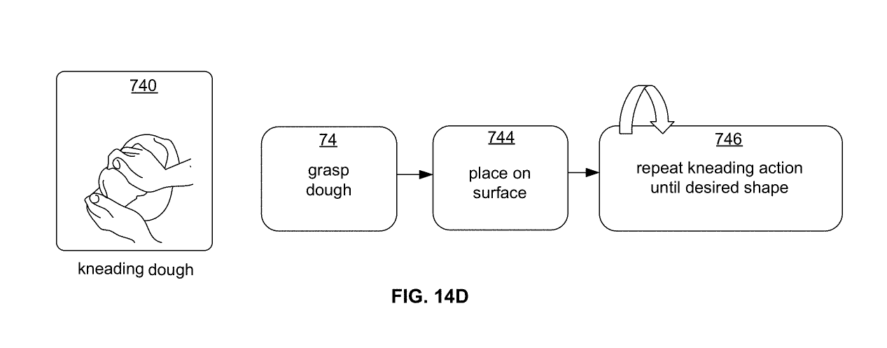

FIG. 14A is a graphical diagram illustrating that each of the robotic hands 72 is coated with an artificial human-like soft-skin glove 700. The artificial human-like soft-skin glove 700 includes a plurality of embedded sensors that are transparent and sufficient for the robot hands 72 to perform high-level minimanipulations. In one embodiment, the soft-skin glove 700 includes ten or more sensors to replicate a chef's hand movements.

FIG. 14B is a block diagram illustrating robotic hands coated with artificial human-like skin gloves to execute high-level minimanipulations based on a library database 720 of minimanipulations, which have been predefined and stored in the library database 720. High-level minimanipulations refer to a sequence of action primitives requiring a substantial amount of interaction movements and interaction forces and control over the same. Three examples of minimanipulations are provided, which are stored in the database library 720. The first example of minimanipulation is to use the pair of robotic hands 72 to knead the dough 722. The second example of minimanipulation is to use the pair of robotic hands 72 to make ravioli 724. The third example of minimanipulation is to use the pair of robotic hands 72 to make sushi 726. Each of the three examples of minimanipulations has motion/interaction time profiles 728 that are tracked by the computer 16.

FIG. 14C is a graphical diagram illustrating three types of taxonomy of manipulation actions for food preparation with continuous trajectory of the robotic arm 70 and the robotic hand 72 motions and forces that result in a desired goal state. The robotic arm 70 and the robotic hand 72 execute rigid grasping and transfer 730 movements for picking up an object with an immovable grasp and transferring them to a goal location without the need for a forceful interaction. Examples of a rigid grasping and transfer include putting the pan on the stove, picking up the salt shaker, shaking salt into the dish, dropping ingredients into a bowl, pouring the contents out of a container, tossing a salad, and flipping a pancake. The robotic arm 70 and the robotic hand 72 execute a rigid grasp with forceful interaction 732 where there is a forceful contact between two surfaces or objects. Examples of a rigid grasp with forceful interaction include stirring a pot, opening a box, and turning a pan, and sweeping items from a cutting board into a pan. The robotic arm 70 and the robotic hand 72 execute a forceful interaction with deformation 734 where there is a forceful contact between two surfaces or objects that results in the deformation of one of two surfaces, such as cutting a carrot, breaking an egg, or rolling dough. For additional information on the function of the human hand, deformation of the human palm, and its function in grasping, see the material from I. A. Kapandji, “The Physiology of the Joints, Volume 1: Upper Limb, 6e,” Churchill Livingstone, 6 edition, 2007, which this reference is incorporated by reference herein in its entirety.

FIG. 14D is a simplified flow diagram illustrating one embodiment on taxonomy of manipulation actions for food preparation in kneading dough 740. Kneading dough 740 may be a minimanipulation that has been previously predefined in the library database of minimanipulations. The process of kneading dough 740 comprises a sequence of actions (or short minimanipulations), including grasping the dough 742, placing the dough on a surface 744, and repeating the kneading action until one obtains a desired shape 746.

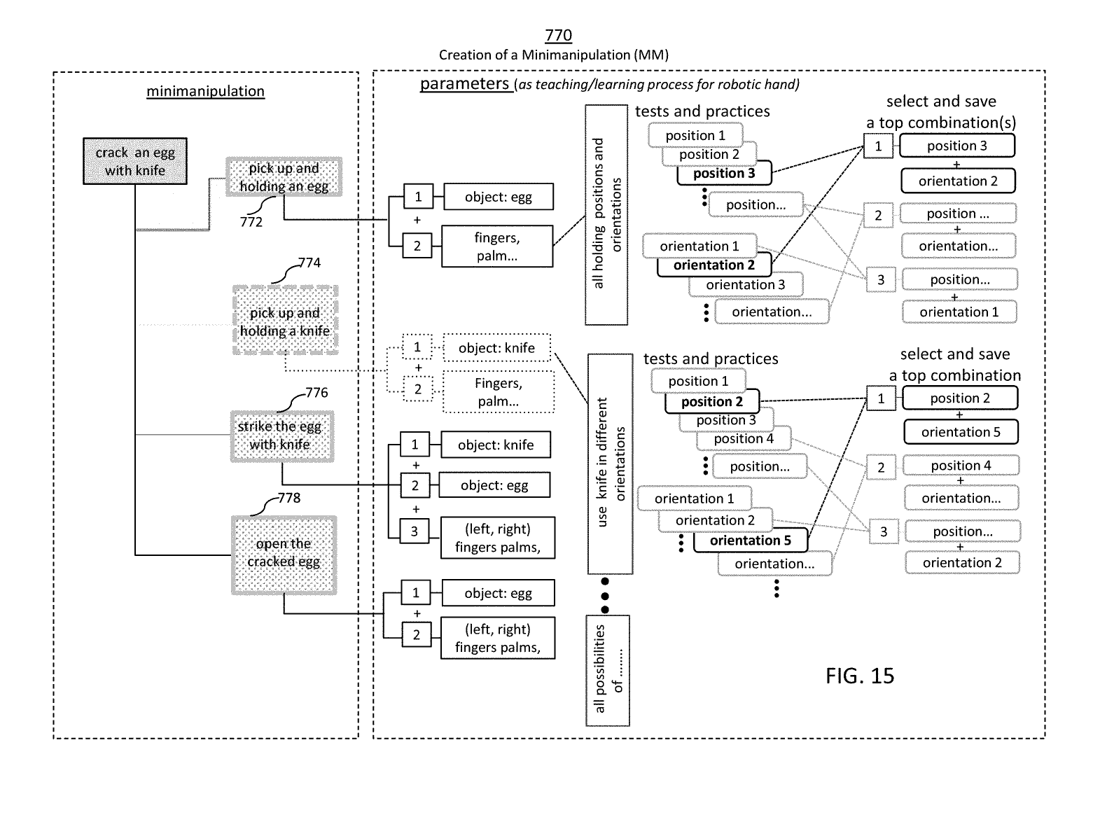

FIG. 15 is a block diagram illustrating an example of a database library structure 770 of a minimanipulation that results in “cracking an egg with a knife.” The minimanipulation 770 of cracking an egg includes how to hold an egg in the right position 772, how to hold a knife relative to the egg 774, what is the best angle to strike the egg with the knife 776, and how to open the cracked egg 778. Various possible parameters for each 772, 774, 776, and 778, are tested to find the best way to execute a specific movement. For example in holding an egg 772, the different positions, orientations, and ways to hold an egg are tested to find an optimal way to hold the egg. Second, the robotic hand 72 picks up the knife from a predetermined location. The holding the knife 774 is explored as to the different positions, orientations, and the way to hold the knife in order to find an optimal way to handle the knife. Third, the striking the egg with knife 776 is also tested for the various combinations of striking the knife on the egg to find the best way to strike the egg with the knife. Consequently, the optimal way to execute the minimanipulation of cracking an egg with a knife 770 is stored in the library database of minimanipulations. The saved minimanipulation of cracking an egg with a knife 770 would comprise the best way to hold the egg 772, the best way to hold the knife 774, and the best way to strike the knife with the egg 776.

To create the minimanipulation that results in cracking an egg with a knife, multiple parameter combinations must be tested to identify a set of parameters that ensure the desired functional result—that the egg is cracked—is achieved. In this example, parameters are identified to determine how to grasp and hold an egg in such a way so as not to crush it. An appropriate knife is selected through testing, and suitable placements are found for the fingers and palm so that it may be held for striking. A striking motion is identified that will successfully crack an egg. An opening motion and/or force are identified that allows a cracked egg to be opened successfully.

The teaching/learning process for the robotic apparatus 75 involves multiple and repetitive tests to identify the necessary parameters to achieve the desired final functional result.

These tests may be performed over varying scenarios. For example, the size of the egg can vary. The location at which it is to be cracked can vary. The knife may be at different locations. The minimanipulations must be successful in all of these variable circumstances.

Once the learning process has been completed, results are stored as a collection of action primitives that together are known to accomplish the desired functional result.

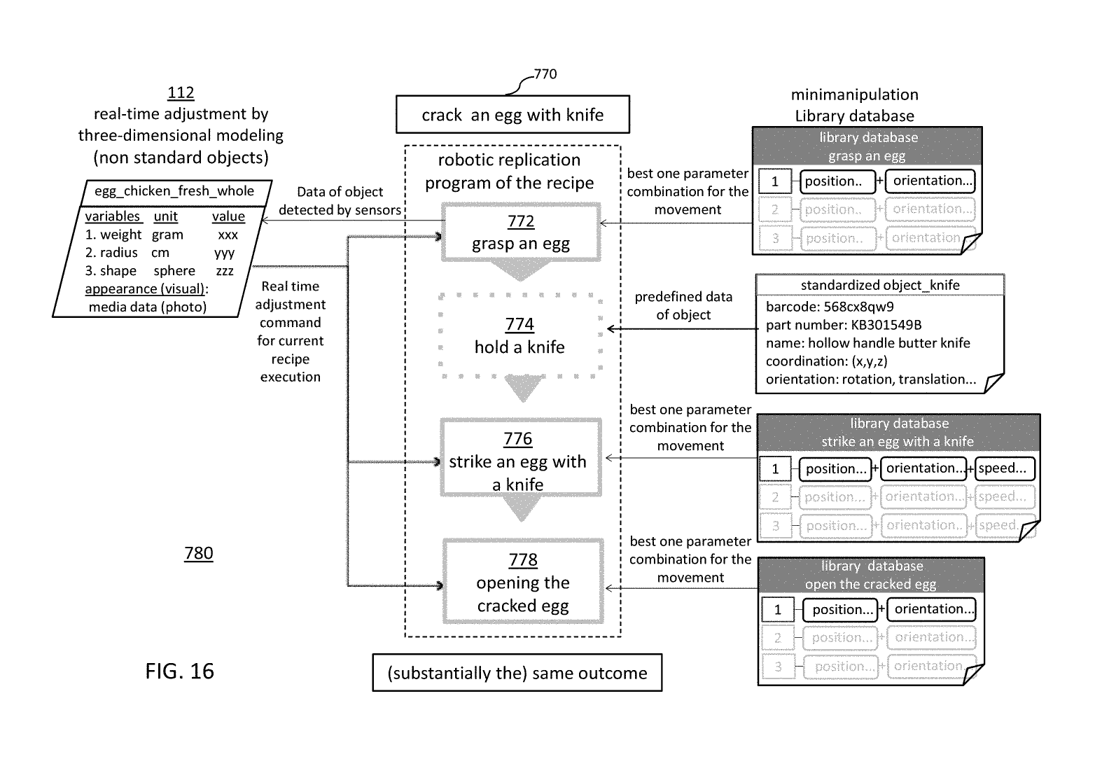

FIG. 16 is a block diagram illustrating an example of recipe execution 780 for a mini manipulation with real-time adjustment by three-dimensional modeling of non-standard objects 112. In recipe execution 780, the robotic hands 72 execute the minimanipulations 770 of cracking an egg with a knife, where the optimal way to execute each movement in the cracking an egg operation 772, the holding a knife operation 774, the striking the egg with a knife operation 776, and opening the cracked egg operation 778 is selected from the minimanipulations library database. The process of executing the optimal way to carry out each of the movements 772, 774, 776, 778 ensures that the minimanipulation 770 will achieve the same (or guarantee of), or substantially the same, outcome for that specific minimanipulation. The multimodal three-dimensional sensor 20 provides real-time adjustment capabilities 112 as to the possible variations in one or more ingredients, such as the dimension and weight of an egg.

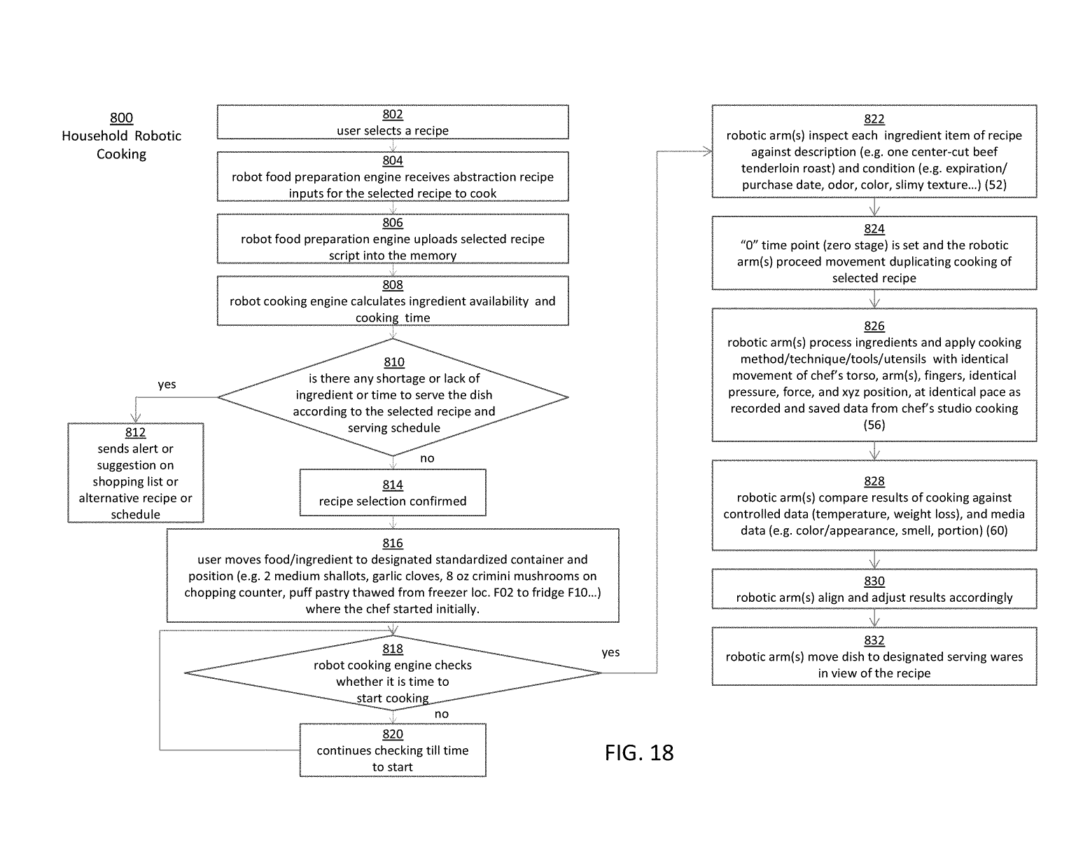

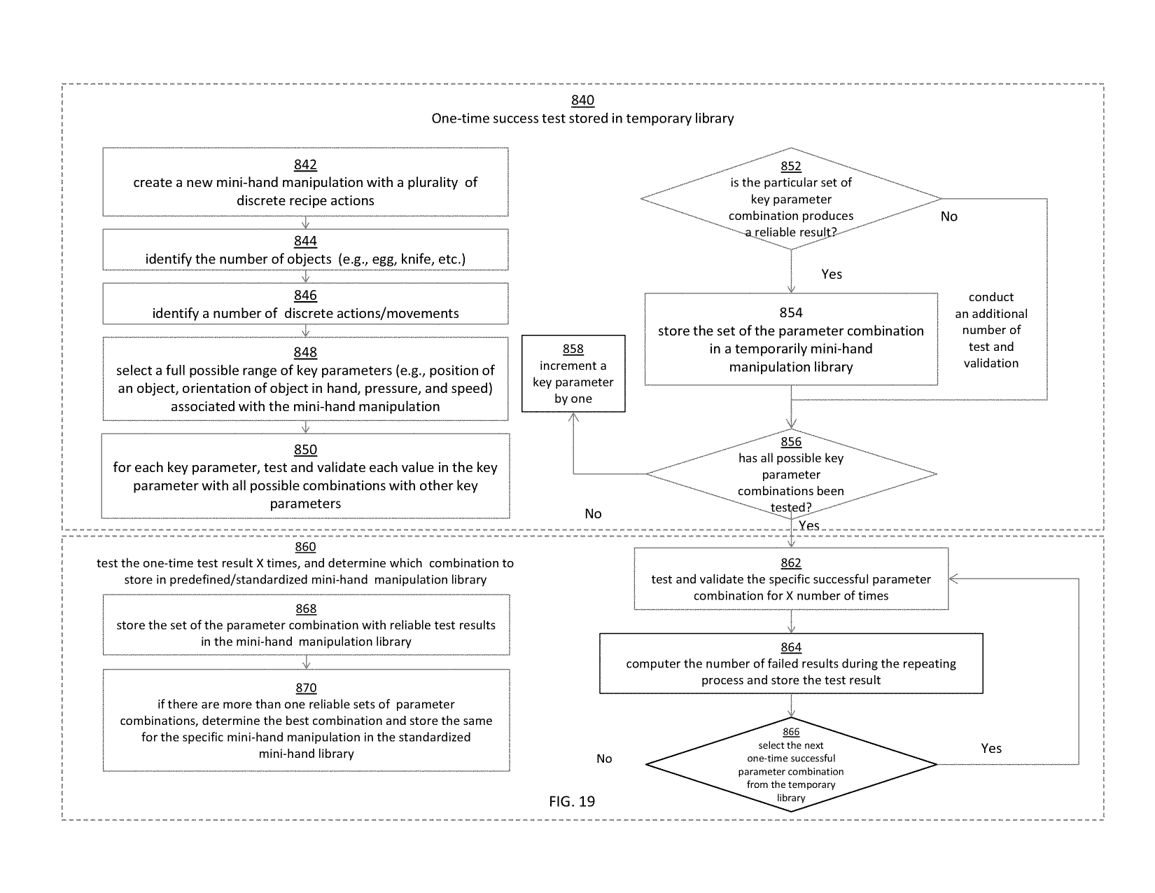

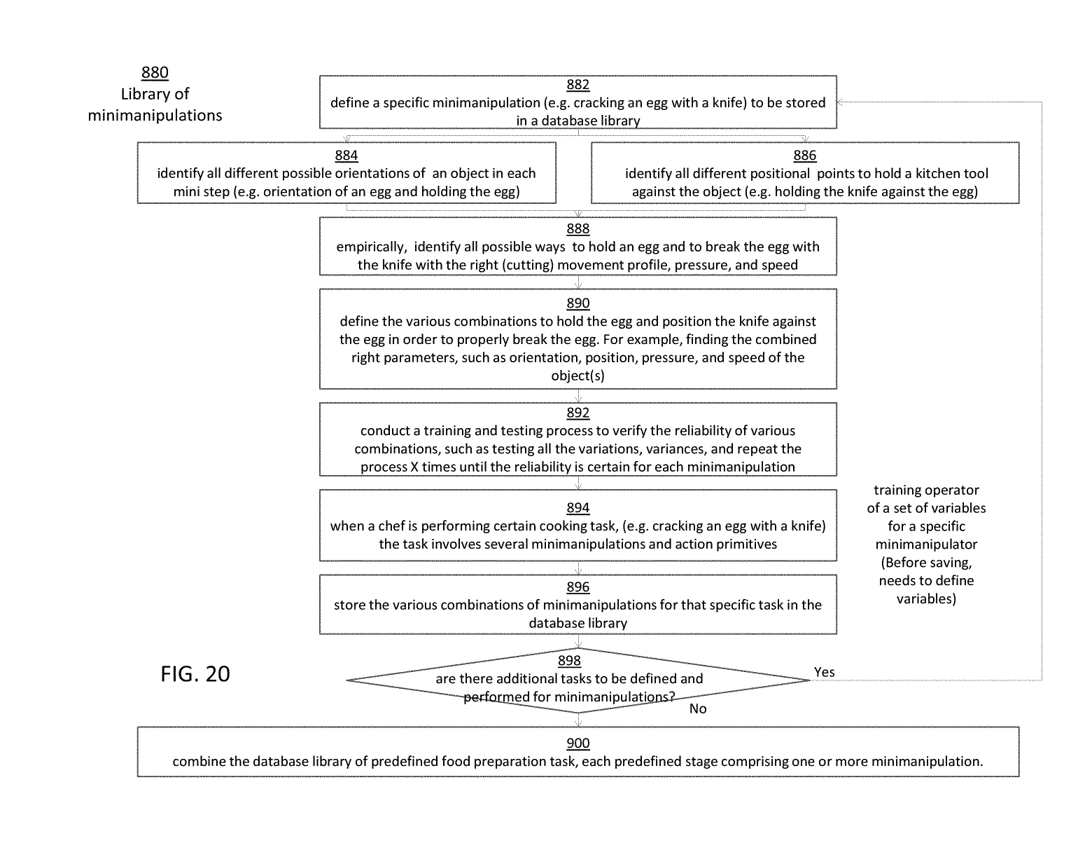

As an example of the operative relationship between the creation of a minimanipulation in FIG. 19 and the execution of the minimanipulation in FIG. 20, specific variables associated with the minimanipulation of “cracking an egg with a knife,” includes an initial xyz coordinates of egg, an initial orientation of the egg, the size of the egg, the shape of the egg, an initial xyz coordinate of the knife, an initial orientation of the knife, the xyz coordinates where to crack the egg, speed, and the time duration of the minimanipulation. The identified variables of the minimanipulation, “crack an egg with a knife,” are thus defined during the creation phase, where these identifiable variables may be adjusted by the robotic food preparation engine 56 during the execution phase of the associated minimanipulation.

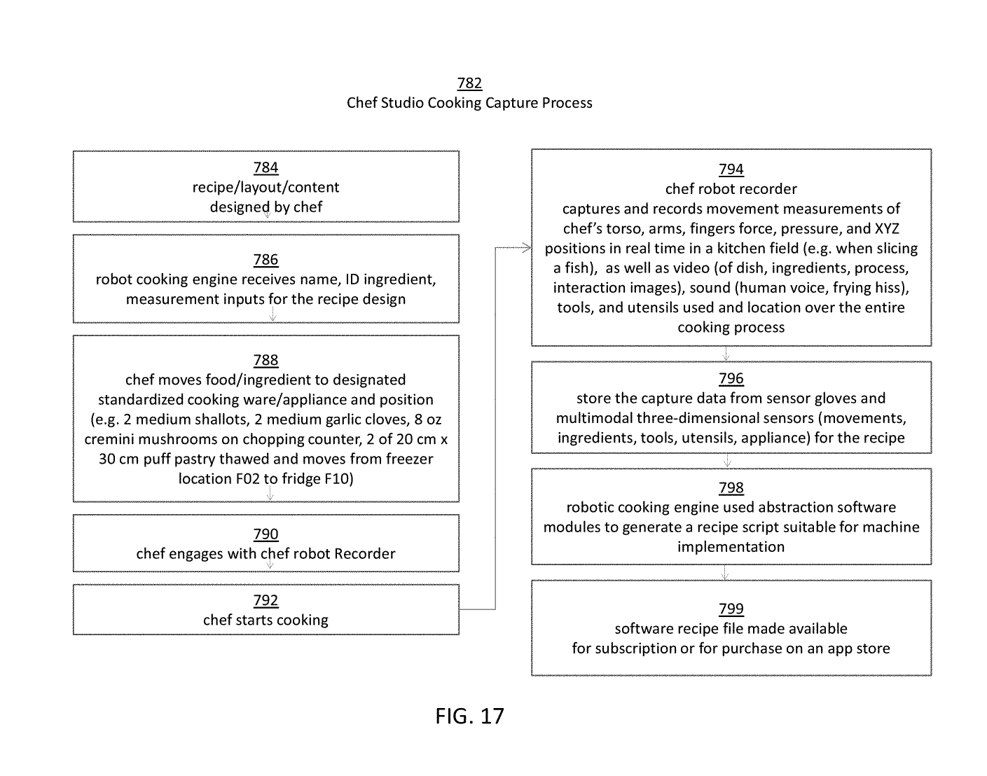

FIG. 17 is a flow diagram illustrating the software process 782 to capture a chef's food preparation movements in a standardized kitchen module to produce the software recipe files 46 from the chef studio 44. In the chef studio 44, at step 784, the chef 49 designs the different components of a food recipe. At step 786, the robotic cooking engine 56 is configured to receive the name, ID ingredient, and measurement inputs for the recipe design that the chef 49 has selected. At step 788, the chef 49 moves food/ingredients into designated standardized cooking ware/appliances and into their designated positions. For example, the chef 49 may pick two medium shallots and two medium garlic cloves, place eight crimini mushrooms on the chopping counter, and move two 20 cm×30 cm puff pastry units thawed from freezer lock F02 to a refrigerator (fridge). At step 790, the chef 49 wears the capturing gloves 26 or the haptic costume 622, which has sensors that capture the chef's movement data for transmission to the computer 16. At step 792, the chef 49 starts working the recipe that he or she selects from step 122. At step 794, the chef movement recording module 98 is configured to capture and record the chef's precise movements, including measurements of the chef's arms and fingers' force, pressure, and XYZ positions and orientations in real time in the standardized robotic kitchen 50. In addition to capturing the chef's movements, pressure, and positions, the chef movement recording module 98 is configured to record video (of dish, ingredients, process, and interaction images) and sound (human voice, frying hiss, etc.) during the entire food preparation process for a particular recipe. At step 796, the robotic cooking engine 56 is configured to store the captured data from step 794, which includes the chef's movements from the sensors on the capturing gloves 26 and the multimodal three-dimensional sensors 30. At step 798, the recipe abstraction software module 104 is configured to generate a recipe script suitable for machine implementation. At step 799, after the recipe data has been generated and saved, the software recipe file 46 is made available for sale or subscription to users via an app store or marketplace to a user's computer located at home or in a restaurant, as well as integrating the robotic cooking receipt app on a mobile device.

FIG. 18 is a flow diagram 800 illustrating the software process for food preparation by the robotic apparatus 75 in the robotic standardized kitchen with the robotic apparatus 75 based one or more of the software recipe files 22 received from chef studio system 44. At step 802, the user 24 through the computer 15 selects a recipe bought or subscribed to from the chef studio 44. At step 804, the robot food preparation engine 56 in the household robotic kitchen 48 is configured to receive inputs from the input module 50 for the selected recipe to be prepared. At step 806, the robot food preparation engine 56 in the household robotic kitchen 48 is configured to upload the selected recipe into the memory module 102 with software recipe files 46. At step 808, the robot food preparation engine 56 in the household robotic kitchen 48 is configured to calculate the ingredient availability to complete the selected recipe and the approximate cooking time required to finish the dish. At step 810, the robot food preparation engine 56 in the household robotic kitchen 48 is configured to analyze the prerequisites for the selected recipe and decides whether there is any shortage or lack of ingredients, or insufficient time to serve the dish according to the selected recipe and serving schedule. If the prerequisites are not met, at step 812, the robot food preparation engine 56 in the household robotic kitchen 48 sends an alert, indicating that the ingredients should be added to a shopping list, or offers an alternate recipe or serving schedules. However, if the prerequisites are met, the robot food preparation engine 56 is configured to confirm the recipe selection at step 814. At step 816, after the recipe selection has been confirmed, the user 60 through the computer 16 moves the food/ingredients to specific standardized containers and into the required positions. After the ingredients have been placed in the designated containers and the positions as identified, the robot food preparation engine 56 in the household robotic kitchen 48 is configured to check if the start time has been triggered at step 818. At this juncture, the household robot food preparation engine 56 offers a second process check to ensure that all the prerequisites are being met. If the robot food preparation engine 56 in the household robotic kitchen 48 is not ready to start the cooking process, the household robot food preparation engine 56 continues to check the prerequisites at step 820 until the start time has been triggered. If the robot food preparation engine 56 is ready to start the cooking process, at step 822, the quality check for raw food module 96 in the robot food preparation engine 56 is configured to process the prerequisites for the selected recipe and inspects each ingredient item against the description of the recipe (e.g. one center-cut beef tenderloin roast) and condition (e.g. expiration/purchase date, odor, color, texture, etc.). At step 824, the robot food preparation engine 56 sets the time at a “0” stage and uploads the software recipe file 46 to the one or more robotic arms 70 and the robotic hands 72 for replicating the chef's cooking movements to produce a selected dish according to the software recipe file 46. At step 826, the one or more robotic arms 72 and hands 74 process ingredients and execute the cooking method/technique with identical movements as that of the chef's 49 arms, hands and fingers, with the exact pressure, the precise force, and the same XYZ position, at the same time increments as captured and recorded from the chef's movements. During this time, the one or more robotic arms 70 and hands 72 compare the results of cooking against the controlled data (such as temperature, weight, loss, etc.) and the media data (such as color, appearance, smell, portion-size, etc.), as illustrated in step 828. After the data has been compared, the robotic apparatus 75 (including the robotic arms 70 and the robotic hands 72) aligns and adjusts the results at step 830. At step 832, the robot food preparation engine 56 is configured to instruct the robotic apparatus 75 to move the completed dish to the designated serving dishes and placing the same on the counter.

FIG. 19 is a flow diagram illustrating one embodiment of the software process for creating, testing, and validating, and storing the various parameter combinations for a minimanipulation library database 840. The minimanipulation library database 840 involves a one-time success test process 840 (e.g., holding an egg), which is stored in a temporary library, and testing the combination of one-time test results 860 (e.g., the entire movements of cracking an egg) in the minimanipulation database library. At step 842, the computer 16 creates a new minimanipulation (e.g., crack an egg) with a plurality of action primitives (or a plurality of discrete recipe actions). At step 844, the number of objects (e.g., an egg and a knife) associated with the new minimanipulation are identified. The computer 16 identifies a number of discrete actions or movements at step 846. At step 848, the computer selects a full possible range of key parameters (such as the positions of an object, the orientations of the object, pressure, and speed) associated with the particular new minimanipulation. At step 850, for each key parameter, the computer 16 tests and validates each value of the key parameters with all possible combinations with other key parameters (e.g., holding an egg in one position but testing other orientations). At step 852, the computer 16 is configured to determine if the particular set of key parameter combinations produces a reliable result. The validation of the result can be done by the computer 16 or a human. If the determination is negative, the computer 16 proceeds to step 856 to find if there are other key parameter combinations that have yet to be tested. At step 858, the computer 16 increments a key parameter by one in formulating the next parameter combination for further testing and evaluation for the next parameter combination. If the determination at step 852 is positive, the computer 16 then stores the set of successful key parameter combinations in a temporary location library at step 854. The temporary location library stores one or more sets of successful key parameter combinations (that have either the most successful or optimal test or have the least failed results).

At step 862, the computer 16 tests and validates the specific successful parameter combination for X number of times (such as one hundred times). At step 864, the computer 16 computes the number of failed results during the repeated test of the specific successful parameter combination. At step 866, the computer 16 selects the next one-time successful parameter combination from the temporary library, and returns the process back to step 862 for testing the next one-time successful parameter combination X number of times. If no further one-time successful parameter combination remains, the computer 16 stores the test results of one or more sets of parameter combinations that produce a reliable (or guaranteed) result at step 868. If there are more than one reliable sets of parameter combinations, at step 870, the computer 16 determines the best or optimal set of parameter combinations and stores the optimal set of parameter combination which is associated with the specific minimanipulation for use in the minimanipulation library database by the robotic apparatus 75 in the standardized robotic kitchen 50 during the food preparation stages of a recipe.

FIG. 20 is a flow diagram illustrating one embodiment of the software process 880 for creating the tasks for a minimanipulation. At step 882, the computer 16 defines a specific robotic task (e.g. cracking an egg with a knife) with a robotic mini hand manipulator to be stored in a database library. The computer at step 884 identifies all different possible orientations of an object in each mini step (e.g. orientation of an egg and holding the egg) and at step 886 identifies all different positional points to hold a kitchen tool against the object (e.g. holding the knife against the egg). At step 888, the computer empirically identifies all possible ways to hold an egg and to break the egg with the knife with the right (cutting) movement profile, pressure, and speed. At step 890, the computer 16 defines the various combinations to hold the egg and positioning of the knife against the egg in order to properly break the egg (for example, finding the combination of optimal parameters such as orientation, position, pressure, and speed of the object(s)). At step 892, the computer 16 conducts training and testing process to verify the reliability of various combinations, such as testing all the variations, variances, and repeats the process X times until the reliability is certain for each minimanipulation. When the chef 49 is performing certain food preparation task, (e.g. cracking an egg with a knife) the task is translated to several steps/tasks of mini-hand manipulation to perform as part of the task at step 894. At step 896, the computer 16 stores the various combinations of minimanipulations for that specific task in the database library. At step 898, the computer 16 determines whether there are additional tasks to be defined and performed for any minimanipulations. The process returns to step 882 if there are any additional minimanipulations to be defined. Different embodiments of the kitchen module are possible, including a standalone kitchen module and an integrated robotic kitchen module. The integrated robotic kitchen module is fitted into a conventional kitchen area of a typical house. The robotic kitchen module operates in at least two modes, a robotic mode and a normal (manual) mode. Cracking an egg is one example of a minimanipulation. The minimanipulation library database would also apply to a wide a variety of tasks, such as using a fork to grab a slab of beef by applying the right pressure in the right direction and to the proper depth to the shape and depth of the meat. At step 900, the computer combines the database library of predefined kitchen tasks, where each predefined kitchen task comprises one or more minimanipulations.

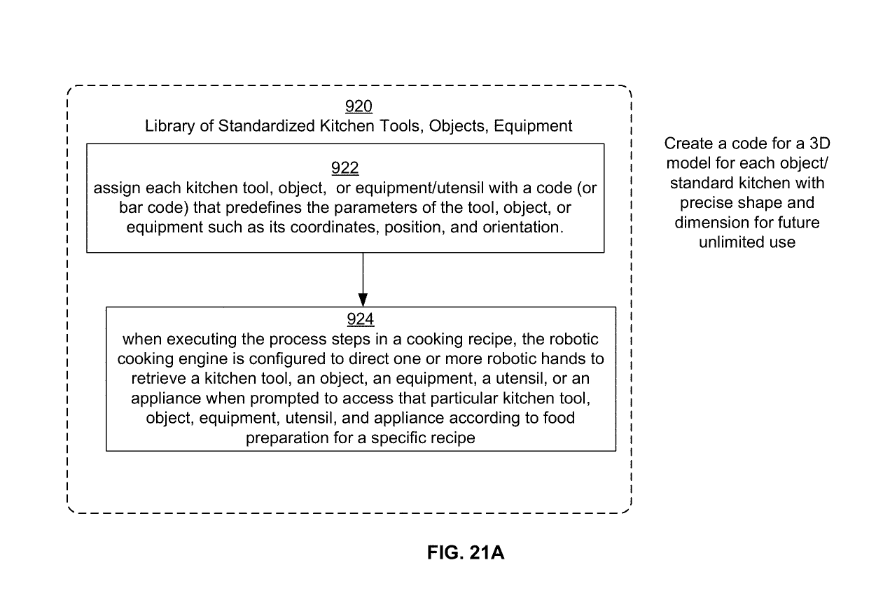

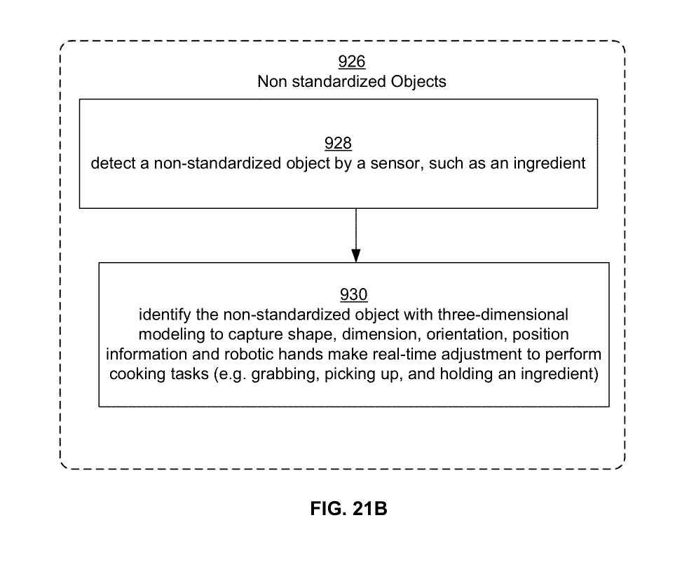

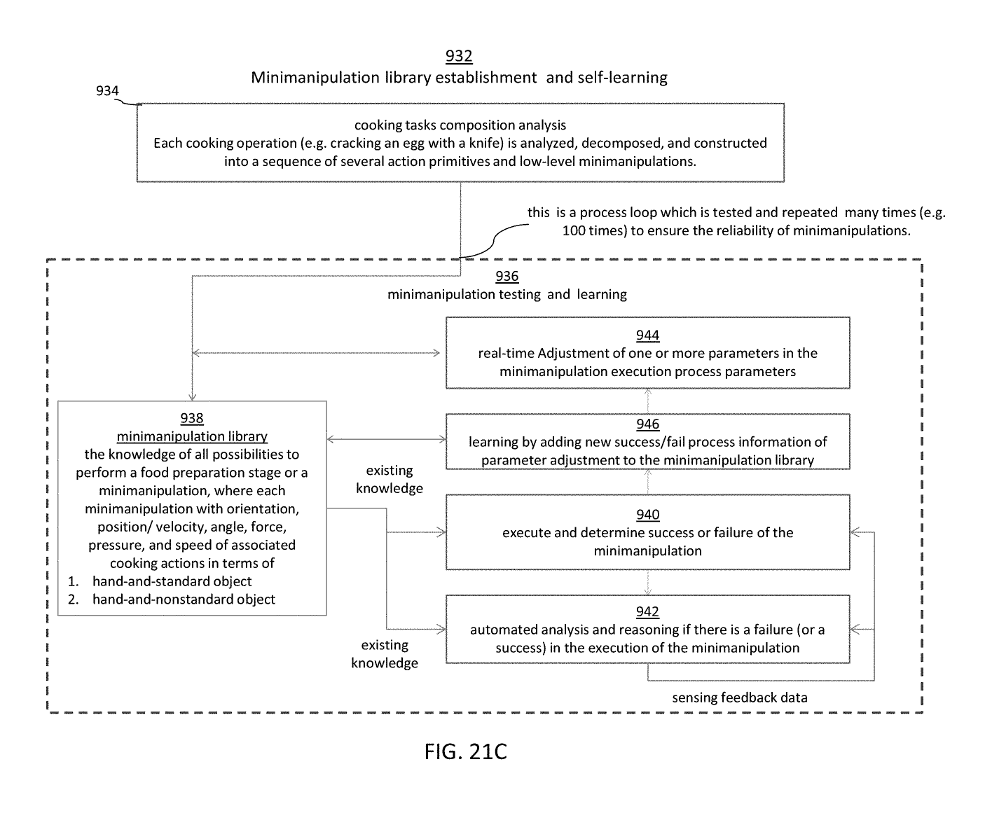

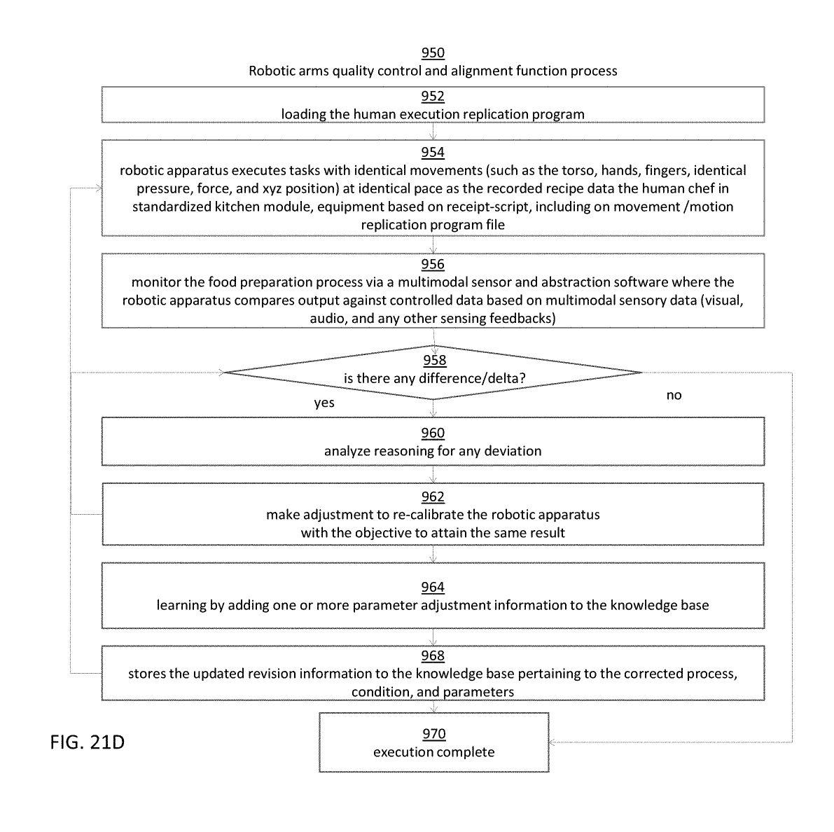

FIG. 21A is a flow diagram illustrating the process 920 of assigning and utilizing a library of standardized kitchen tools, standardized objects, and standardized equipment in a standardized robotic kitchen. At step 922, the computer 16 assigns each kitchen tool, object, or equipment/utensil with a code (or bar code) that predefines the parameters of the tool, object, or equipment such as its three-dimensional position coordinates and orientation. This process standardizes the various elements in the standardized robotic kitchen 50, including but not limited to: standardized kitchen equipment, standardized kitchen tools, standardized knifes, standardized forks, standardized containers, standardized pans, standardized appliances, standardized working spaces, standardized attachments, and other standardized elements. When executing the process steps in a cooking recipe, at step 924, the robotic cooking engine is configured to direct one or more robotic hands to retrieve a kitchen tool, an object, a piece of equipment, a utensil, or an appliance when prompted to access that particular kitchen tool, object, equipment, utensil or appliance, according to the food preparation process for a specific recipe.

FIG. 21B is a flow diagram illustrating the process 926 of identifying a non-standard object through three-dimensional modeling and reasoning. At step 928, the computer 16 detects a non-standard object by a sensor, such as an ingredient that may have a different size, different dimensions, and/or different weight. At step 930, the computer 16 identifies the non-standard object with three-dimensional modeling sensors 66 to capture shape, dimensions, orientation and position information and robotic hands 72 make a real-time adjustment to perform the appropriate food preparation tasks (e.g. cutting or picking up a piece of steak).

FIG. 21C is a flow diagram illustrating the process 932 for testing and learning of minimanipulations. At step 934, the computer performs a food preparation task composition analysis in which each cooking operation (e.g. cracking an egg with a knife) is analyzed, decomposed, and constructed into a sequence of action primitives or minimanipulations. In one embodiment, a minimanipulation refers to a sequence of one or more action primitives that accomplish a basic functional outcome (e.g., the egg has been cracked, or a vegetable sliced) that advances toward a specific result in preparing a food dish. In this embodiment, a minimanipulation can be further described as a low-level minimanipulation or a high-level minimanipulation where a low-level minimanipulation refers to a sequence of action primitives that requires minimal interaction forces and relies almost exclusively on the use of the robotic apparatus 75, and a high-level minimanipulation refers to a sequence of action primitives requiring a substantial amount of interaction and interaction forces and control thereof. The process loop 936 focuses on minimanipulation and learning steps and comprises tests, which are repeated many times (e.g. 100 times) to ensure the reliability of minimanipulations. At step 938, the robotic food preparation engine 56 is configured to assess the knowledge of all possibilities to perform a food preparation stage or a minimanipulation, where each minimanipulation is tested with respect to orientations, positions/velocities, angles, forces, pressures, and speeds with a particular minimanipulation. A minimanipulation or an action primitive may involve the robotic hand 72 and a standard object, or the robotic hand 72 and a nonstandard object. At step 940, the robotic food preparation engine 56 is configured to execute the minimanipulation and determine if the outcome can be deemed successful or a failure. At step 942, the computer 16 conducts an automated analysis and reasoning about the failure of the minimanipulation. For example, the multimodal sensors may provide sensing feedback data on the success or failure of the minimanipulation. At step 944, the computer 16 is configured to make a real-time adjustment and adjusts the parameters of the minimanipulation execution process. At step 946, the computer 16 adds new information about the success or failure of the parameter adjustment to the minimanipulation library as a learning mechanism to the robotic food preparation engine 56.

FIG. 21D is a flow diagram illustrating the process 950 for quality control and alignment functions for robotic arms. At step 952, the robotic food preparation engine 56 loads a human chef replication software recipe file 46 via the input module 50. For example, the software recipe file 46 to replicate food preparation from Michelin starred chef Arnd Beuchel's “Wiener Schnitzel”. At step 954, the robotic apparatus 75 executes tasks with identical movements such as those for the torso, hands, fingers, with identical pressure, force and xyz position, at an identical pace as the recorded recipe data stored based on the actions of the human chef preparing the same recipe in a standardized kitchen module with standardized equipment based on the stored receipt-script including all movement/motion replication data. At step 956, the computer 16 monitors the food preparation process via a multimodal sensor that generates raw data supplied to abstraction software where the robotic apparatus 75 compares real-world output against controlled data based on multimodal sensory data (visual, audio, and any other sensory feedback). At step 958, the computer 16 determines if there any differences between the controlled data and the multimodal sensory data. At step 960, the computer 16 analyzes whether the multimodal sensory data deviates from the controlled data. If there is a deviation, at step 962, the computer 16 makes an adjustment to re-calibrate the robotic arm 70, the robotic hand 72, or other elements. At step 964, the robotic food preparation engine 16 is configured to learn in process 964 by adding the adjustment made to one or more parameter values to the knowledge database. At step 968, the computer 16 stores the updated revision information to the knowledge database pertaining to the corrected process, condition, and parameters. If there is no difference in deviation from step 958, the process 950 goes directly to step 970 in completing the execution.

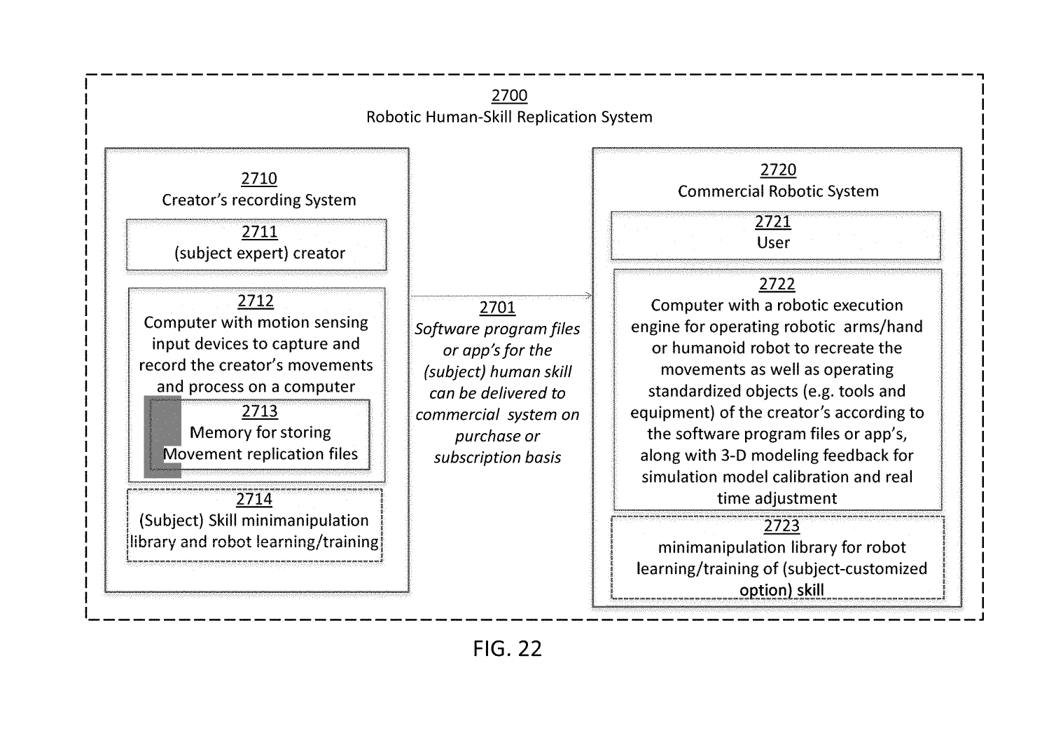

FIG. 22 is a block diagram illustrating the general applicability (or universal) of robotic human-skill replication system 2700 with a creator's recording system 2710 and a commercial robotic system 2720. The human-skill replication system 2700 may be used to capture the movements or manipulations of a subject expert or creator 2711. Creator 2711 may be an expert in his/her respective field and may be a professional or someone who has gained the necessary skills to have refined specific tasks, such as cooking, painting, medical diagnostics, or playing a musical instrument. The creator's recording system 2710 comprises a computer 2712 with sensing inputs, e.g. motion sensing inputs, a memory 2713 for storing replication files and a subject/skill library 2714. Creator's recording system 2710 may be a specialized computer or may be a general purpose computer with the ability to record and capture the creator 2711 movements and analyze and refine those movements down into steps that may be processed on computer 2712 and stored in memory 2713. The sensors may be any type of visual, IR, thermal, proximity, temperature, pressure, or any other type of sensor capable of gathering information to refine and perfect the minimanipulations required by the robotic system to perform the task. Memory 2713 may be any type of remote or local memory type storage and may be stored on any type of memory system including magnetic, optical, or any other known electronic storage system. Memory 2713 maybe a public or private cloud based system and may be provided locally or by a third party. Subject/skill library 2714 may be a compilation or collection of previously recorded and captured minimanipulations and may be categorized or arranged in any logical or relational order, such as by task, by robotic components, or by skill.

Commercial robotic system 2720 comprises a user 2721, a computer 2722 with a robotic execution engine and a minimanipulation library 2723. The computer 2722 comprises a general or special purpose computer and may be any compilation of processors and or other standard computing devices. Computer 2722 comprises a robotic execution engine for operating robotic elements such as arms/hands or a complete humanoid robot to recreate the movements captured by the recording system. The Computer 2722 may also operate standardized objects (e.g. tools and equipment) of the creator's 2711 according to the program files or app's captured during the recording process. Computer 2722 may also control and capture 3-D modeling feedback for simulation model calibration and real time adjustments. Minimanipulation library 2723 stores the captured minimanipulations that have been downloaded from the creator's recording system 2710 to the commercial robotic system 2720 via communications link 2701. Minimanipulation library 2723 may store the minimanipulations locally or remotely and may store them in a predetermined or relational basis. Communications link 2701 conveys program files or app's for the (subject) human skill to the commercial robotic system 2720 on a purchase, download, or subscription basis. In operation robotic human-skill replication system 2700 allows a creator 2711 to perform a task or series of tasks which are captured on computer 2712 and stored in memory 2713 creating minimanipulation files or libraries. The minimanipulation files may then be conveyed to the commercial robotic system 2720 via communications link 2701 and executed on computer 2722 causing a set of robotic appendage of hands and arms or a humanoid robot to duplicate the movements of the creator 2711. In this manner, the movements of the creator 2711 are replicated by the robot to complete the required task.

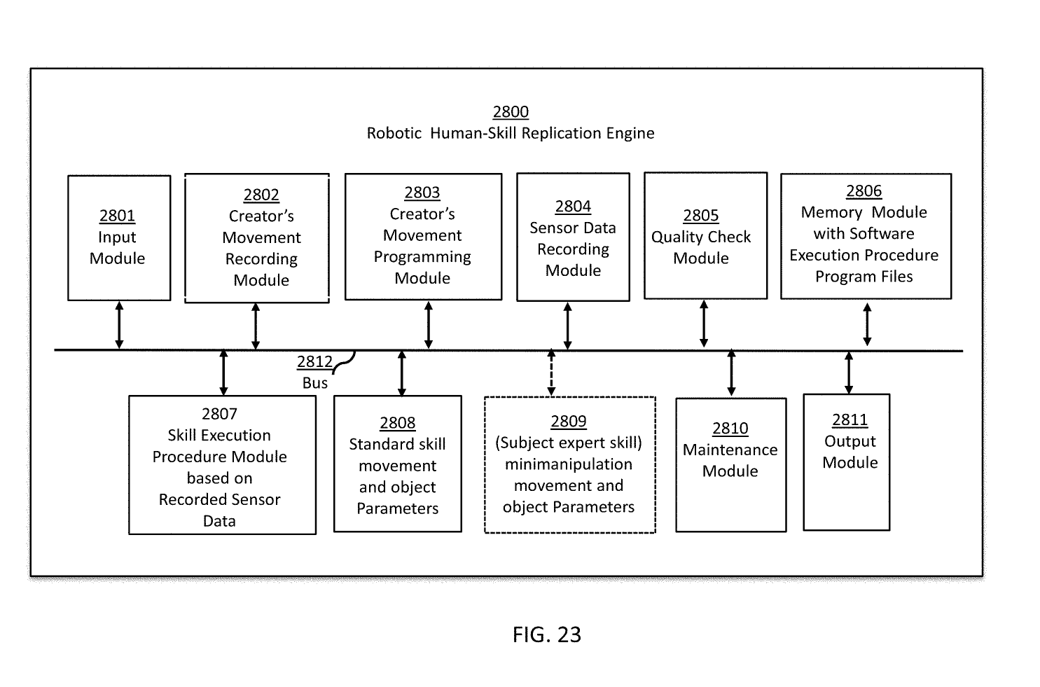

FIG. 23 is a software system diagram illustrating the robotic human-skill replication engine 2800 with various modules. Robotic human-skill replication engine 2800 may comprise an input module 2801, a creator's movement recording module 2802, a creator's movement programing module 2803, a sensor data recording module 2804, a quality check module 2805, a memory module 2806 for storing software execution procedure program files, a skill execution procedure module 2807, which may be based on the recorded sensor data, a standard skill movement and object parameter capture module 2808, a minimanipulation movement and object parameter module 2809, a maintenance module 2810 and an output module 2811. Input module 2801 may include any standard inputting device, such as a keyboard, mouse, or other inputting device and may be used for inputting information into robotic human-skill replication engine 2800. Creator movement recording module 2802 records and captures all the movements, and actions of the creator 2711 when robotic human-skill replication engine 2800 is recording the movements or minimanipulations of the creator 2711. The recording module 2802 may record input in any known format and may parse the creator's movements in small incremental movements to make up a primary movement. Creator movement recording module 2802 may comprise hardware or software and may comprise any number or combination of logic circuits. The creator's movement programing module 2803 allows the creator 2711 to program the movements rather than allow the system to capture and transcribe the movements. Creator's movement programing module 2803 may allow for input through both input instructions as well as captured parameters obtained by observing the creator 2711. Creator's movement programing module 2803 may comprise hardware or software and may be implemented utilizing any number or combination of logic circuits. Sensor Data Recording Module 2804 is used to record sensor input data captured during the recording process. Sensor Data Recording Module 2804 may comprise hardware or software and may be implemented utilizing any number or combination of logic circuits. Sensor Data Recording Module 2804 may be utilized when a creator 2711 is performing a task that is being monitored by a series of sensors such as motion, IR, auditory or the like. Sensor Data Recording Module 2804 records all the data from the sensors to be used to create a mini-manipulate of the task being performed. Quality Check Module 2805 may be used to monitor the incoming sensor data, the health of the overall replication engine, the sensors or any other component or module of the system. Quality Check Module 2805 may comprise hardware or software and may be implemented utilizing any number or combination of logic circuits. Memory Module 2806 may be any type of memory element and may be used to store Software Execution Procedure Program Files. It may comprise local or remote memory and may employ short term, permanent or temporary memory storage. Memory module 2806 may utilize any form of magnetic, optic or mechanical memory. Skill Execution Procedure Module 2807 is used to implement the specific skill based on the recorded sensor data. Skill Execution Procedure Module 2807 may utilize the recorded sensor data to execute a series of steps or minimanipulations to complete a task or a portion of a task one such a task has been captured by the robotic replication engine. Skill Execution Procedure Module 2807 may comprise hardware or software and may be implemented utilizing any number or combination of logic circuits.

Standard skill movement and object Parameters module 2802 may be a modules implemented in software or hardware and is intended to define standard movements of objects and or basic skills. It may comprise subject parameters, which provide the robotic replication engine with information about standard objects that may need to be utilized during a robotic procedure. It may also contain instructions and or information related to standard skill movements, which are not unique to any one minimanipulation. Maintenance module 2810 may be any routine or hardware that is used to monitor and perform routine maintenance on the system and the robotic replication engine. Maintenance module 2810 may allow for controlling, updating, monitoring, and troubleshooting any other module or system coupled to the robotic human-skill replication engine. Maintenance module 2810 may comprise hardware or software and may be implemented utilizing any number or combination of logic circuits. Output module 2811 allows for communications from the robotic human-skill replication engine 2800 to any other system component or module. Output module 2811 may be used to export, or convey the captured minimanipulations to a commercial robotic system 2720 or may be used to convey the information into storage. Output module 2811 may comprise hardware or software and may be implemented utilizing any number or combination of logic circuits. Bus 2812 couples all the modules within the robotic human-skill replication engine and may be a parallel bus, serial bus, synchronous or asynchronous. It may allow for communications in any form using serial data, packetized data, or any other known methods of data communication.

Minimanipulation movement and object parameter module 2809 may be used to store and/or categorize the captured minimanipulations and creator's movements. It may be coupled to the replication engine as well as the robotic system under control of the user.

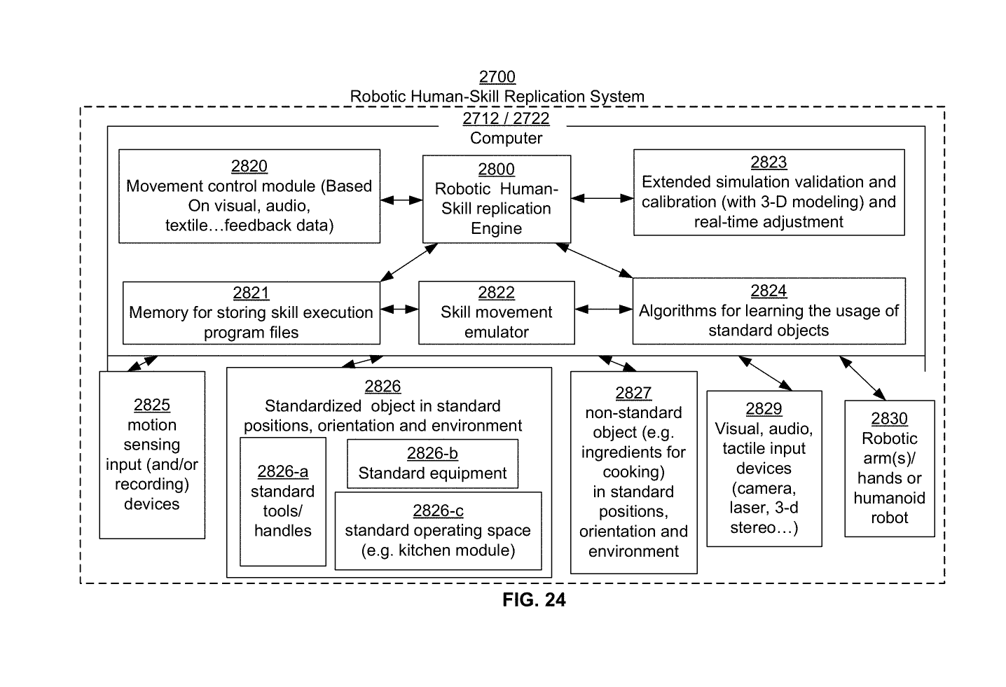

FIG. 24 is a block diagram illustrating one embodiment of the robotic human-skill replication system 2700. The robotic human-skill replication system 2700 comprises the computer 2712 (or the computer 2722), motion sensing devices 2825, standardized objects 2826, nonstandard objects 2827.

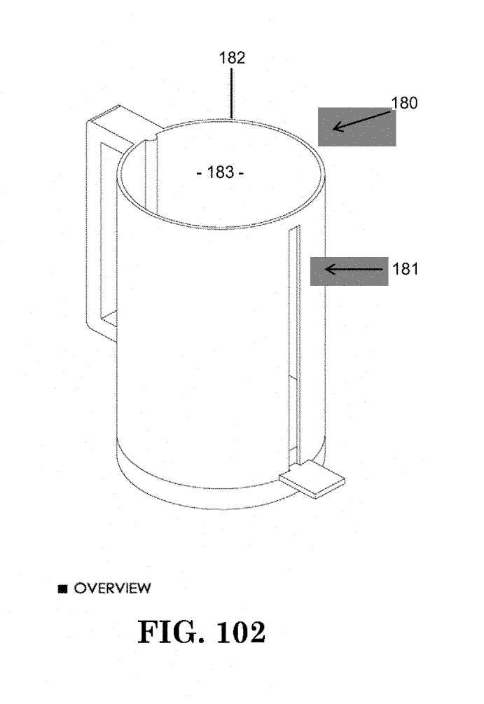

Computer 2712 comprises robotic human-skill replication engine 2800, movement control module 2820, memory 2821, skills movement emulator 2822, extended simulation validation and calibration module 2823 and standard object algorithms 2824. As described with respect to FIG. 102, robotic human-skill replication engine 2800 comprises several modules, which enable the capture of creator 2711 movements to create and capture minimanipulations during the execution of a task. The captured minimanipulations are converted from sensor input data to robotic control library data that may be used to complete a task or may be combined in series or parallel with other minimanipulations to create the necessary inputs for the robotic arms/hands or humanoid robot 2830 to complete a task or a portion of a task.

Robotic human-skill replication engine 2800 is coupled to movement control module 2820, which may be used to control or configure the movement of various robotic components based on visual, auditory, tactile or other feedback obtained from the robotic components. Memory 2821 may be coupled to computer 2712 and comprises the necessary memory components for storing skill execution program files. A skill execution program file contains the necessary instructions for computer 2712 to execute a series of instructions to cause the robotic components to complete a task or series of tasks. Skill movement emulator 2822 is coupled to the robotic human-skill replication engine 2800 and may be used to emulate creator skills without actual sensor input. Skill movement emulator 2822 provides alternate input to robotic human-skill replication engine 2800 to allow for the creation of a skill execution program without the use of a creator 2711 providing sensor input. Extended simulation validation and calibration module 2823 may be coupled to robotic human-skill replication engine 2800 and provides for extended creator input and provides for real time adjustments to the robotic movements based on 3-D modeling and real time feedback. Computer 2712 comprises standard object algorithms 2824, which are used to control the robotic hands 72/the robotic arms 70 or humanoid robot 2830 to complete tasks using standard objects. Standard objects may include standard tools or utensils or standard equipment, such as a stove or EKG machine. The algorithms in 2824 are precompiled and do not require individual training using robotic human-skills replication.

Computer 2712 is coupled to one or more motion sensing devices 2825. Motion sensing device 2825 may be visual motion sensors, IR motion sensors, tracking sensors, laser monitored sensors, or any other input or recording device that allows computer 2712 to monitor the position of the tracked device in 3-D space. Motion sensing devices 2825 may comprise a single sensor or a series of sensors that include single point sensors, paired transmitters and receivers, paired markers and sensors or any other type of spatial sensor. Robotic human-skill replication system 2700 may comprise standardized objects 2826 Standardized objects 2826 is any standard object found in a standard orientation and position within the robotic human-skill replication system 2700. These may include standardized tools or tools with standardized handles or grips 2826-a, standard equipment 2826-b, or a standardized space 2826-c. Standardized tools 2826-a may be those depicted in FIGS. 12A-C and 152-162S, or may be any standard tool, such as a knife, a pot, a spatula, a scalpel, a thermometer, a violin bow, or any other equipment that may be utilized within the specific environment. Standard equipment 2826-b may be any standard kitchen equipment, such as a stove, broiler, microwave, mixer, etc. or may be any standard medical equipment, such as a pulse-ox meter, etc. the space itself, 2826-c may be standardized such as a kitchen module or a trauma module or recovery module or piano module. By utilizing these standard tools, equipment and spaces, the robotic hands/arms or humanoid robots may more quickly adjust and learn how to perform their desired function within the standardized space.

Also within the robotic human-skill replication system 2700 may be nonstandard objects 2827. Nonstandard objects may be for example, cooking ingredients such as meats and vegetables. These nonstandard sized, shaped and proportioned objects may be located in standard positions and orientations, such as within drawers or bins but the items themselves may vary from item to item.

Visual, audio, and tactile input devices 2829 may be coupled to computer 2712 as [part of the robotic human-skill replication system 2700. Visual, audio, and tactile input devices 2829 may be cameras, lasers, 3-D steroptics, tactile sensors, mass detectors, or any other sensor or input device that allows computer 21712 to determine an object type and position within 3-D space. It may also allow for the detection of the surface of an object and detect objects properties based on touch sound, density or weight.

Robotic arms/hands or humanoid robot 2830 may be directly coupled to computer 2712 or may be connected over a wired or wireless network and may communicate with robotic human-skill replication engine 2800. Robotic arms/hands or humanoid robot 2830 is capable of manipulating and replicating any of the movements performed by creator 2711 or any of the algorithms for using a standard object.

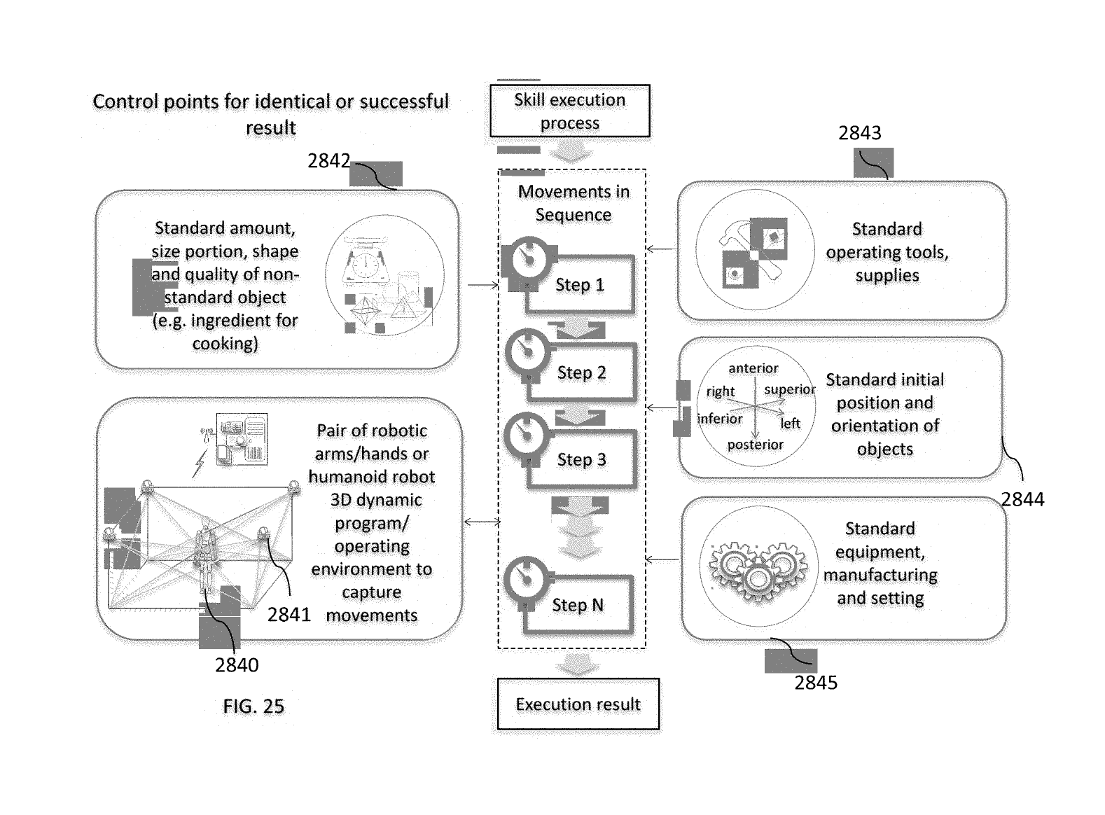

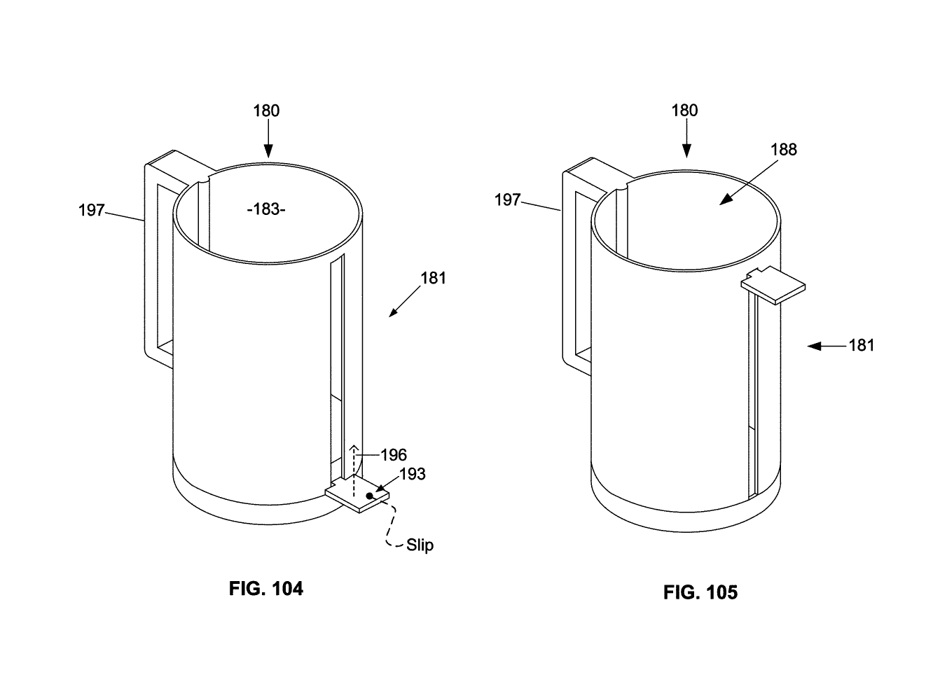

FIG. 25 is a block diagram illustrating a humanoid 2840 with controlling points for skill execution or replication process with standardized operating tools, standardized positions and orientations, and standardized equipment. As seen in FIG. 104, the humanoid 2840 is positioned within a sensor field 2841 as part of the Robotic Human-skill replication system 2700. The humanoid 2840 may be wearing a network of control points or sensors points to enable capture of the movements or minimanipulations made during the execution of a task. Also within the Robotic Human-skill replication system 2700 may be standard tools, 2843, standard equipment 2845 and nonstandard objects 2842 all arranged in a standard initial position and orientation 2844. As the skills are executed, each step in the skill is recorded within the sensor field 2841. Starting from an initial position humanoid 2840 may execute step 1-step n, all of which is recorded to create a repeatable result that may be implemented by a pair of robotic arms or a humanoid robot. By recording the human creator's movements within the sensor filed 2841, the information may be converted into a series of individual steps 1-n or as a sequence of events to complete a task. Because all the standard and nonstandard objects are located and oriented in a standard initial position, the robotic component replicating the human movements is able to accurately and consistently perform the recorded task.

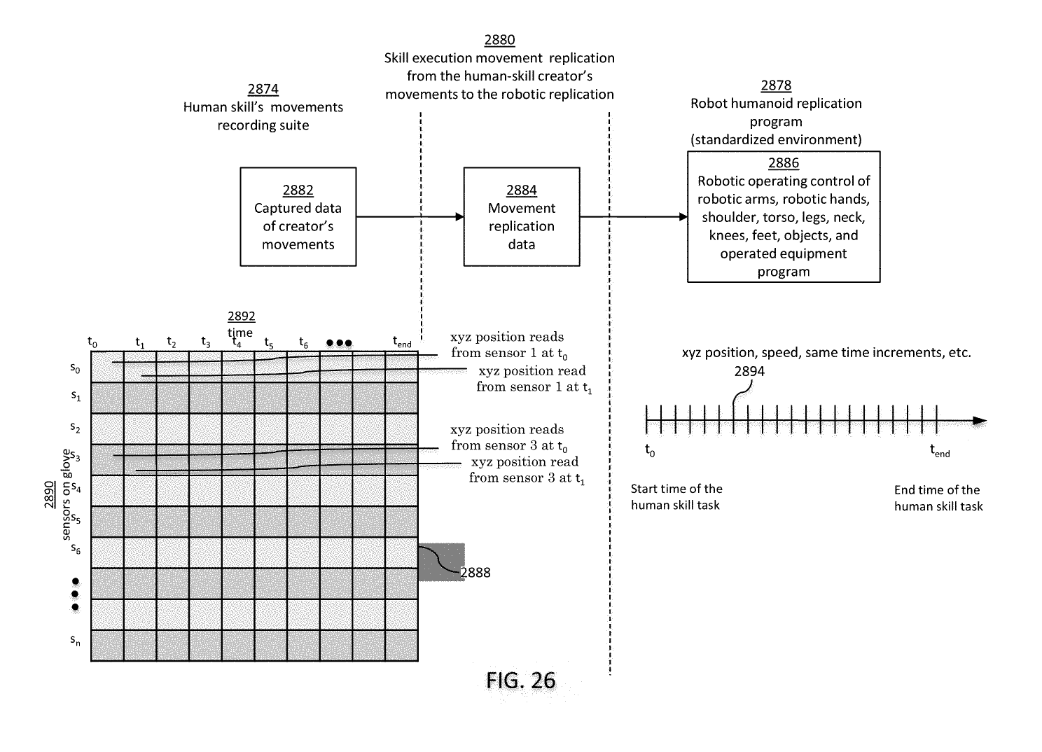

FIG. 26 is a block diagram illustrating one embodiment of a conversion algorithm module 2880 between a human or creator's movements and the robotic replication movements. A movement replication data module 2884 converts the captured data from the human's movements in the recording suite 2874 into a machine-readable and machine-executable language 2886 for instructing the robotic arms and the robotic hands to replicate a skill performed by the human's movement in the robotic robot humanoid replication environment 2878. In the recording suite 2874, the computer 2812 captures and records the human's movements based on the sensors on a glove that the human wears, represented by a plurality of sensors S₀, S₁, S₂, S₃, S₄, S₅, S₆, . . . Sₙ in the vertical columns, and the time increments t₀, t₁, t₂, t₃, t₄, t₅, t₆ . . . t_{end} in the horizontal rows, in a table 2888. At time t₀, the computer 2812 records the xyz coordinate positions from the sensor data received from the plurality of sensors S0, S1, S2, S3, S4, S5, S6 . . . Sn. At time t₁, the computer 2812 records the xyz coordinate positions from the sensor data received from the plurality of sensors S₀, S₁, S₂, S₃, S₄, S₅, S₆ . . . Sₙ. At time t₂, the computer 2812 records the xyz coordinate positions from the sensor data received from the plurality of sensors S₀, S₁, S₂, S₃, S₄, S₅, S₆, . . . Sₙ. This process continues until the entire skill is completed at time t_{end}. The duration for each time units t₀, t₁, t₂, t₃, t₄, t₅, t₆ . . . t_{end} is the same. As a result of the captured and recorded sensor data, the table 2888 shows any movements from the sensors S₀, S₁, S₂, S₃, S₄, S₅, S₆, . . . Sₙ in the glove in xyz coordinates, which would indicate the differentials between the xyz coordinate positions for one specific time relative to the xyz coordinate positions for the next specific time. Effectively, the table 2888 records how the human's movements change over the entire skill from the start time, t₀, to the end time, t_{end}. The illustration in this embodiment can be extended to multiple sensors, which the human wears to capture the movements while performing the skill. In the standardized environment 2878, the robotic arms and the robotic hands replicate the recorded skill from the recording suite 2874, which is then converted to robotic instructions, where the robotic arms and the robotic hands replicate the skill of the human according to the timeline 2894. The robotic arms and hands carry out the skill with the same xyz coordinate positions, at the same speed, with the same time increments from the start time, t₀, to the end time, t_{end}, as shown in the timeline 2894.

In some embodiments a human performs the same skill multiple times, yielding values of the sensor reading, and parameters in the corresponding robotic instructions that vary somewhat from one time to the next. The set of sensor readings for each sensor across multiple repetitions of the skill provides a distribution with a mean, standard deviation and minimum and maximum values. The corresponding variations on the robotic instructions (also called the effector parameters) across multiple executions of the same skill by the human also defines distributions with mean, standard deviation, minimum and maximum values. These distributions may be used to determine the fidelity (or accuracy) of subsequent robotic skills.

In one embodiment the estimated average accuracy of a robotic skill operation is given by:

$$A ( C , R ) = 1 - \frac{1}{n} {\sum }_{n = 1 , … n} \frac{\vert {c}_{i} - {p}_{i} \vert}{max ( \vert {c}_{i , t} - {p}_{i , t} \vert}$$

Where C represents the set of human parameters (1^{st} through n^{th}) and R represents the set of the robotic apparatus 75 parameters (correspondingly (1^{st} through n^{th}). The numerator in the sum represents the difference between robotic and human parameters (i.e. the error) and the denominator normalizes for the maximal difference). The sum gives the total normalized cumulative error

$$( i . e . \sum n = 1 , … n \frac{\vert {c}_{i} - {p}_{i} \vert}{max ( \vert {c}_{i , t} - {p}_{i , t} \vert} ) ,$$

and multiplying by 1/n gives the average error. The complement of the average error corresponds to the average accuracy.

Another version of the accuracy calculation weighs the parameters for importance, where each coefficient (each αi) represents the importance of the i^{th} parameter, the normalized cumulative error is

$$\sum n = 1 , … n \frac{{∝}_{i} \vert {c}_{i} - {p}_{i} \vert}{max ( \vert {c}_{i , t} - {p}_{i , t} \vert}$$

and the estimated average accuracy is given by:

$$A ( C , R ) = 1 - ( {\sum }_{n = 1 , … n} \frac{{∝}_{i} \vert {c}_{i} - {p}_{i} \vert}{max ( \vert {c}_{i , t} - {p}_{i , t} \vert} ) / {\sum }_{n = 1 , … n} {∝}_{i}$$

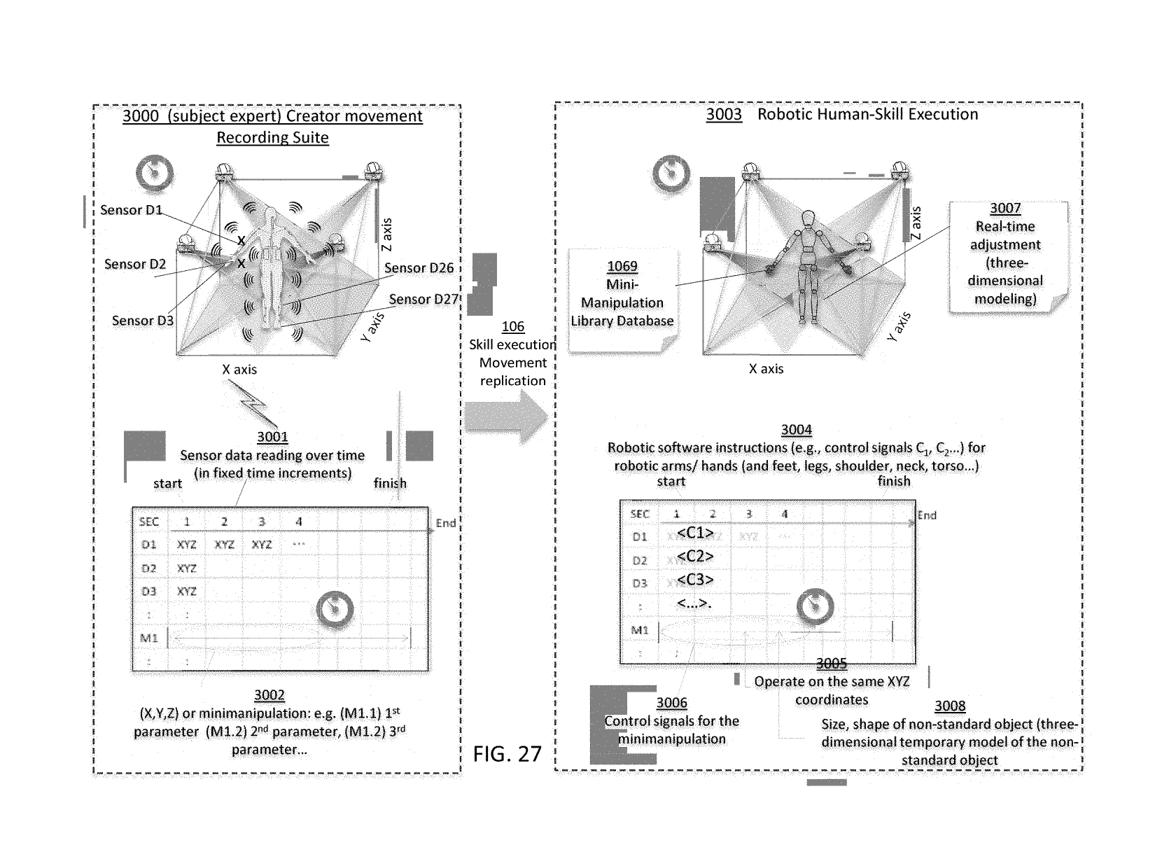

FIG. 27 is a block diagram illustrating the creator movement recording and humanoid replication based on the captured sensory data from sensors aligned on the creator. In the In the creator movement recording suite 3000, the creator may wear various body sensors D1-Dn with sensors for capturing the skill, where sensor data 3001 are recorded in a table 3002. In this example, the creator is preforming a task with a tool. These action primitives by the creator, as recorded by the sensors and may constitute a mini-manipulation 3002 that take place over time slots 1, 2, 3 and 4. The skill Movement replication data module 2884 is configured to convert the recorded skills file from the creator recording suite 3000 to robotic instructions for operating robotic components such as arms and the robotic hands in the robotic human-skill execution portion 1063 according to a robotic software instructions 3004. The robotic components perform the skill with control signals 3006 for the mini-manipulation, as pre-defined in the mini-manipulation library 116 from a minimanipulation library database 3009, of performing the skill with a tool. The robotic components operate with the same xyz coordinates 3005 and with possible real-time adjustment to the skill by creating a temporary three-dimensional model 3007 of the skill from a real-time adjustment device.

In order to operate a mechanical robotic mechanism such as the ones described in the embodiments of this disclosure, a skilled artisan realizes that many mechanical and control problems need to be addressed, and the literature in robotics describes methods to do just that. The establishment of static and/or dynamic stability in a robotics system is an important consideration. Especially for robotic manipulation, dynamic stability is a strongly desired property, in order to prevent accidental breakage or movements beyond those desired or programmed.

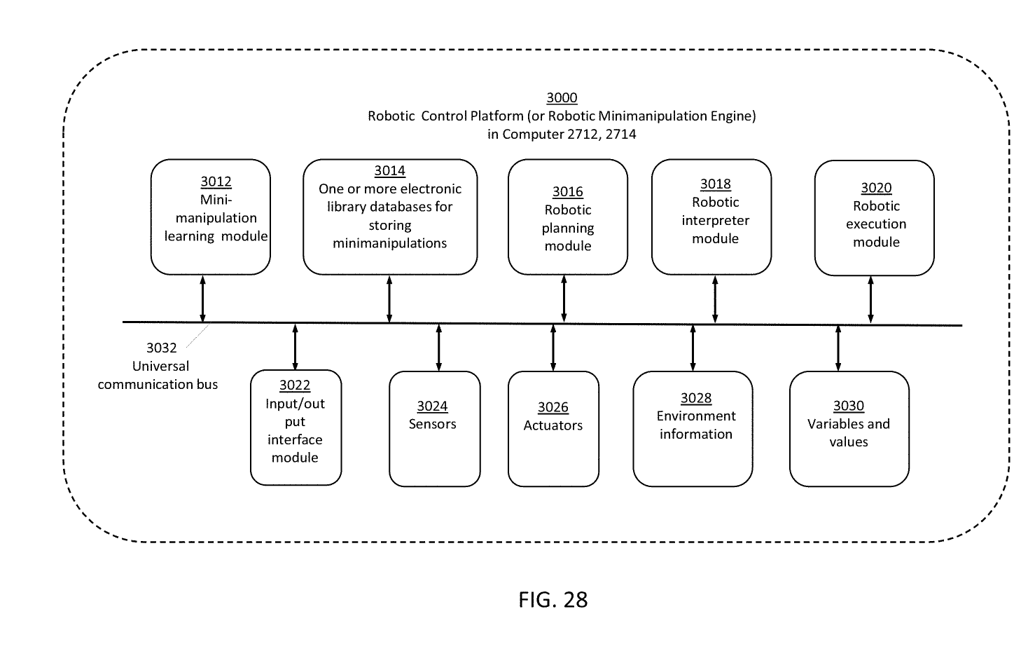

FIG. 28 depicts the overall robotic control platform 3010 for a general-purpose humanoid robot at as a high level description of the functionality of the present disclosure. An universal communication bus 3002 serves an electronic conduit for data, including reading from internal and external sensors 3014, variables and their current values 3016 pertinent to the current state of the robot, such as tolerances in its movements, exact location of its hands, etc. and environment information 3018 such as where the robot is or where are the objects that it may need to manipulation. These input sources make the humanoid robot situationally aware and thus able to carry out its tasks, from direct low level actuator commands 3020 to high level robotic end-to-end task plans from the robotic planner 3022 that can reference a large electronic library of component minimanipulations 3024, which are then interpreted to determine whether their preconditions permit application and converted to machine-executable code from a robotic interpreter module 3026 and then sent as the actual command-and-sensing sequences to the robotic execution module 3028.

In addition to the robotic planning, sensing and acting, the robotic control platform can also communicate with humans via icons, language, gestures, etc. via the robot-human interfaces module 3030, and can learn new minimanipulations by observing humans perform building-block tasks corresponding to the minimanipulations and generalizing multiple observations into minimanipulations, i.e., reliable repeatable sensing-action sequences with preconditions and postconditions by a minimanipulation learning module 3032.

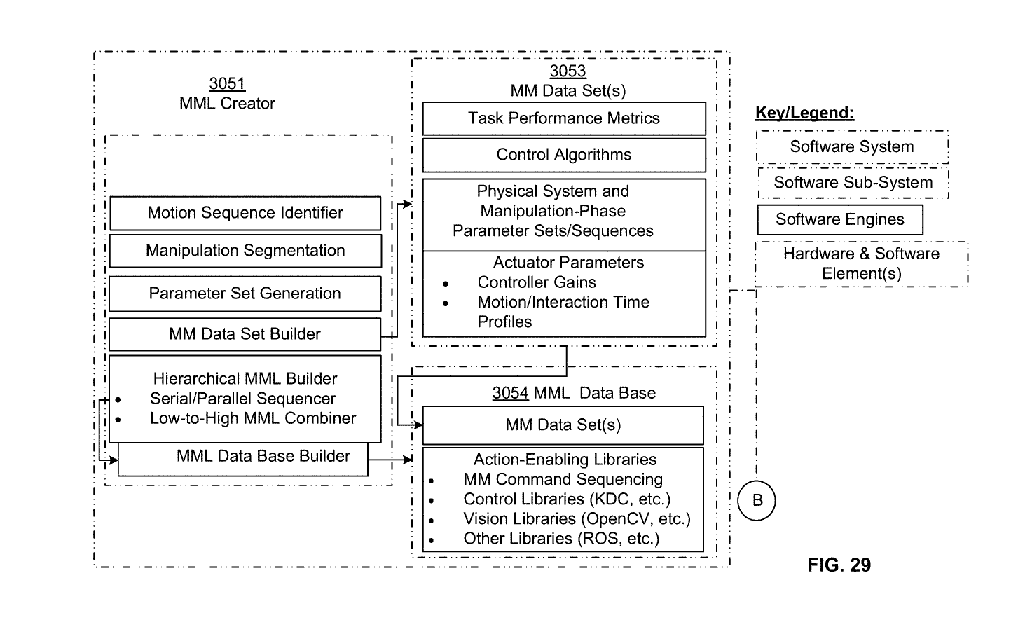

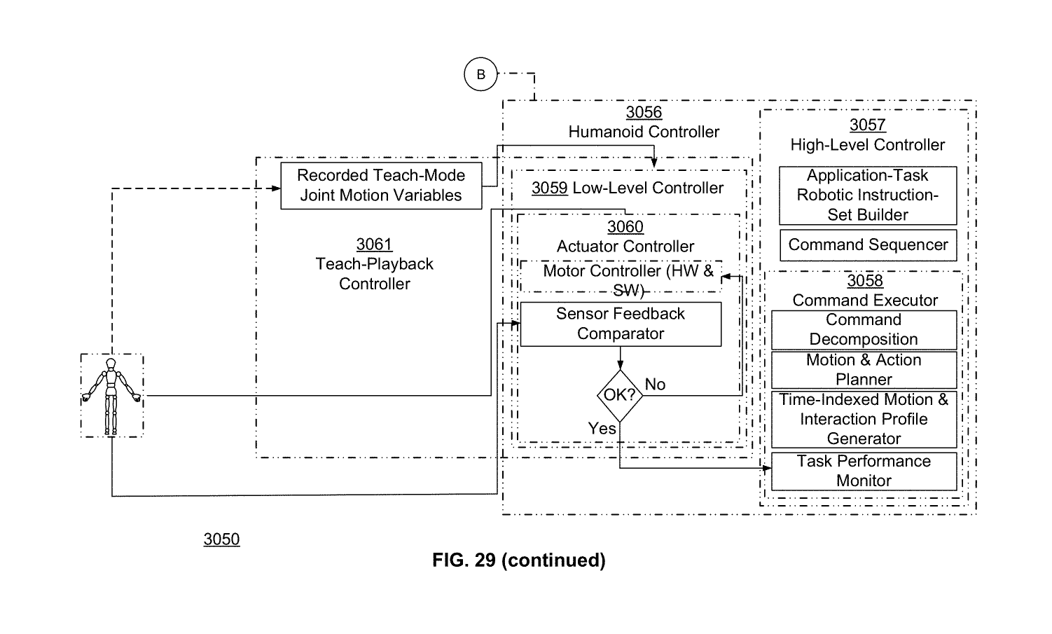

FIG. 29 is a block diagram illustrating a computer architecture 3050 (or a schematic) for generation, transfer, implementation and usage of minimanipulation libraries as part of a humanoid application-task replication process. The present disclosure relates to a combination of software systems, which include many software engines and datasets and libraries, which when combined with libraries and controller systems, results in an approach to abstracting and recombining computer-based task-execution descriptions to enable a robotic humanoid system to replicate human tasks as well as self-assemble robotic execution sequences to accomplish any required task sequence. Particular elements of the present disclosure relate to a Minimanipulation (MM) Generator 3051, which creates Minimanipulation libraries (MMLs) that are accessible by the humanoid controller 3056 in order to create high-level task-execution command sequences that are executed by a low-level controller residing on/with the humanoid robot itself.

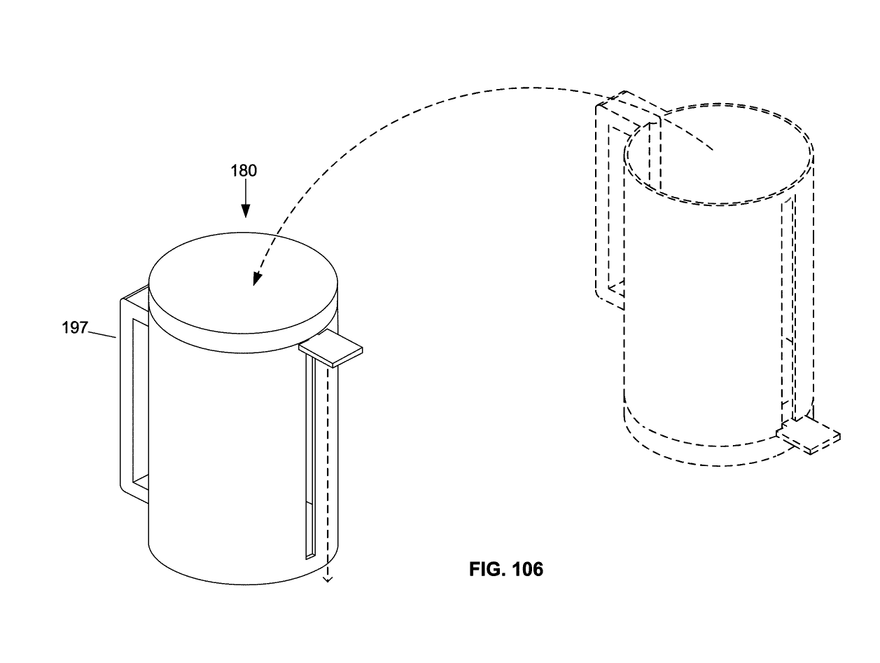

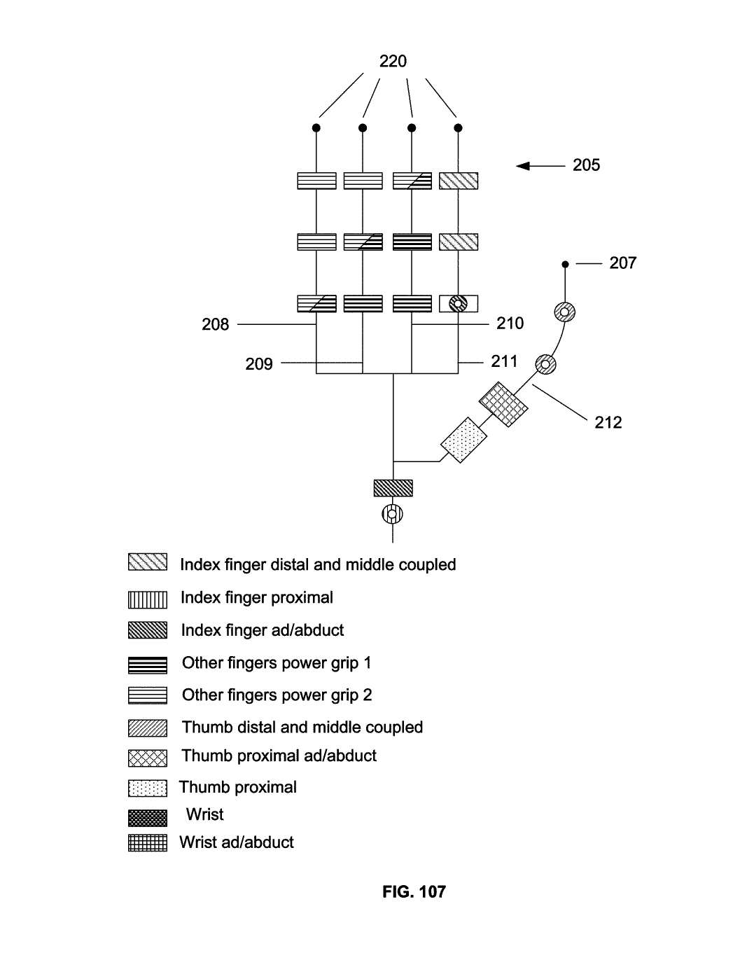

The computer architecture 3050 for executing minimanipulations comprises a combination of disclosure of controller algorithms and their associated controller-gain values as well as specified time-profiles for position/velocity and force/torque for any given motion/actuation unit, as well as the low-level (actuator) controller(s) (represented by both hardware and software elements) that implement these control algorithms and use sensory feedback to ensure the fidelity of the prescribed motion/interaction profiles contained within the respective datasets. These are also described in further detail below and so designated with appropriate color-code in the associated FIG. 107.

The MML generator 3051 is a software system comprising multiple software engines GG2 that create both minimanipulation (MM) data sets GG3 which are in turn used to also become part of one or more MML Data bases GG4.

The MML Generator 3051 contains the aforementioned software engines 3052, which utilize sensory and spatial data and higher-level reasoning software modules to generator parameter-sets that describe the respective manipulation tasks, thereby allowing the system to build a complete MM data set 3053 at multiple levels. A hierarchical MM Library (MML) builder is based on software modules that allow the system to decompose the complete task action set in to a sequence of serial and parallel motion-primitives that are categorized from low- to high-level in terms of complexity and abstraction. The hierarchical breakdown is then used by a MML database builder to build a complete MML database 3054.

The previously mentioned parameter sets 3053 comprise multiple forms of input and data (parameters, variables, etc.) and algorithms, including task performance metrics for a successful completion of a particular task, the control algorithms to be used by the humanoid actuation systems, as well as a breakdown of the task-execution sequence and the associated parameter sets, based on the physical entity/subsystem of the humanoid involved as well as the respective manipulation phases required to execute the task successfully. Additionally, a set of humanoid-specific actuator parameters are included in the datasets to specify the controller-gains for the specified control algorithms, as well as the time-history profiles for motion/velocity and force/torque for each actuation device(s) involved in the task execution.

The MML database 3054 comprises multiple low- to higher-level of data and software modules necessary for a humanoid to accomplish any specific low- to high-level task. The libraries not only contain MM datasets generated previously, but also other libraries, such as currently-existing controller-functionality relating to dynamic control (KDC), machine-vision (OpenCV) and other interaction/inter-process communication libraries (ROS, etc.). The humanoid controller 3056 is also a software system comprising the high-level controller software engine 3057 that uses high-level task-execution descriptions to feed machine-executable instructions to the low-level controller 3059 for execution on, and with, the humanoid robot platform.

The high-level controller software engine 3057 builds the application-specific task-based robotic instruction-sets, which are in turn fed to a command sequencer software engine that creates machine-understandable command and control sequences for the command executor GG8. The software engine 3052 decomposes the command sequence into motion and action goals and develops execution-plans (both in time and based on performance levels), thereby enabling the generation of time-sequenced motion (positions & velocities) and interaction (forces and torques) profiles, which are then fed to the low-level controller 3059 for execution on the humanoid robot platform by the affected individual actuator controllers 3060, which in turn comprise at least their own respective motor controller and power hardware and software and feedback sensors.

The low level controller contain actuator controllers which use digital controller, electronic power-driver and sensory hardware to feed software algorithms with required set-points for position/velocity and force/torque, which the controller is tasked to faithfully replicate along a time-stamped sequence, relying on feedback sensor signals to ensure the required performance fidelity. The controller remains in a constant loop to ensure all set-points are achieved overtime until the required motion/interaction step(s)/profile(s) are completed, while higher-level task-performance fidelity is also being monitored by the high-level task performance monitoring software module in the command executor 3058, leading to potential modifications in the high-to-low motion/interaction profiles fed to the low-level controller to ensure task-outcomes fall within required performance bounds and meet specified performance metrics.

In a teach-playback controller 3061, a robot is led through a set of motion profiles, which are continuously stored in a time-synched fashion, and then ‘played-back’ by the low-level controller by controlling each actuated element to exactly follow the motion profile previously recorded. This type of control and implementation are necessary to control a robot, some of which may be available commercially. While the present described disclosure utilizes a low-level controller to execute machine-readable time-synched motion/interaction profiles on a humanoid robot, embodiments of the present disclosure are directed to techniques that are much more generic than teach-motions, more automated and far more capable process, more complexity, allowing one to create and execute a potentially high number of simple to complex tasks in a far more efficient and cost-effective manner.

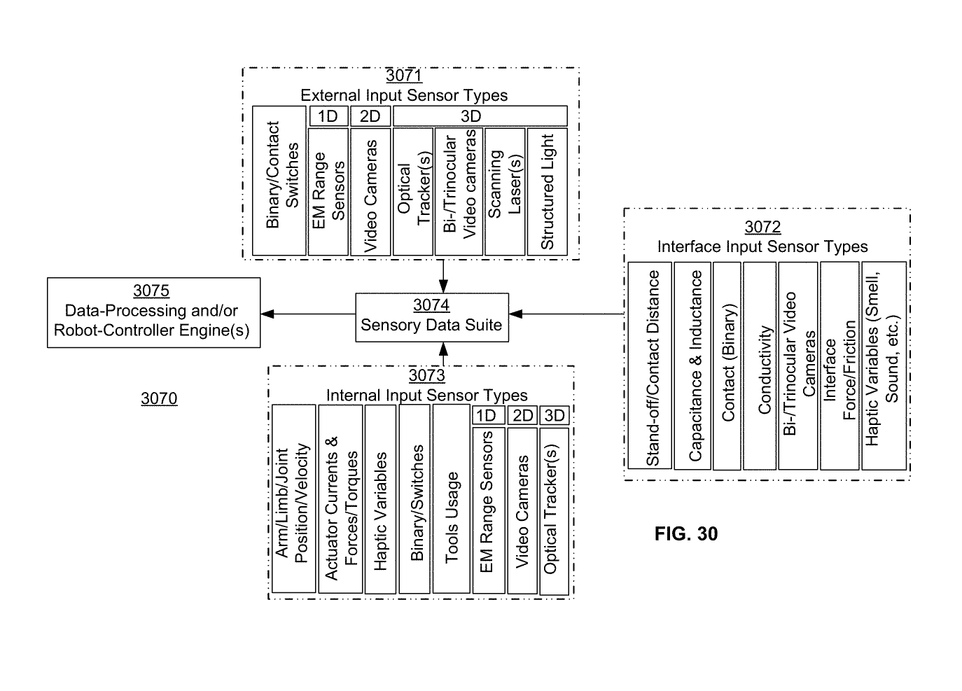

FIG. 30 depicts the different types of sensor categories 3070 and their associated types for studio-based and robot-based sensory data input categories and types, which would be involved in both the creator studio-based recording step and during the robotic execution of the respective task. These sensory data-sets form the basis upon which minimanipulation action-libraries are built, through a multi-loop combination of the different control actions based on particular data and/or to achieve particular data-values to achieve a desired end-result, whether it be very focused ‘sub-routine’ (grab a knife, strike a piano-key, paint a line on canvas, etc.) or a more generic MM routine (prepare a salad, play Shubert's #5 piano concerto, paint a pastoral scene, etc.); the latter is achievable through a concatenation of multiple serial and parallel combinations of MM subroutines.

Sensors have been grouped in three categories based on their physical location and portion of a particular interaction that will need to be controlled. Three types of sensors (External 3071, Internal 3073, and Interface 3072) feed their data sets into a data-suite process 3074 that forwards the data over the proper communication link and protocol to the data processing and/or robot-controller engine(s) 3075.

External Sensors 3071 comprise sensors typically located/used external to the dual-arm robot torso/humanoid and tend to model the location and configuration of the individual systems in the world as well as the dual-arm torso/humanoid. Sensor types used for such a suite would include simple contact switches (doors, etc.), electromagnetic (EM) spectrum based sensors for one-dimensional range measurements (IR rangers, etc.), video cameras to generate two-dimensional information (shape, location, etc.), and three-dimensional sensors used to generate spatial location and configuration information using bi-/tri-nocular cameras, scanning lasers and structured light, etc.).

Internal Sensors 3073 are sensors internal to the dual-arm torso/humanoid, mostly measuring internal variables, such as arm/limb/joint positions and velocity, actuator currents and joint- and Cartesian forces and torques, haptic variables (sound, temperature, taste, etc.) binary switches (travel limits, etc.) as well as other equipment-specific presence switches. Additional One-/two- and three-dimensional sensor types (such as in the hands) can measure range/distance, two-dimensional layouts via video camera and even built-in optical trackers (such as in a torso-mounted sensor-head).

Interface-sensors 3072 are those kinds of sensors that are used to provide high-speed contact and interaction movements and forces/torque information when the dual-arm torso/humanoid interacts with the real world during any of its tasks. These are critical sensors as they are integral to the operation of critical MM sub-routine actions such as striking a piano-key in just the right way (duration and force and speed, etc.) or using a particular sequence of finger-motions to grab and achieve a safe grab of a knife to orient it to be able for a particular task (cut a tomato, strike an egg, crush garlic gloves, etc.). These sensors (in order of proximity) can provide information related to the stand-off/contact distance between the robot appendages to the world, the associated capacitance/inductance between the end effector and the world measurable immediately prior to contact, the actual contact presence and location and its associated surface properties (conductivity, compliance, etc.) as well as associated interaction properties (force, friction, etc.) and any other haptic variables of importance (sound, heat, smell, etc.).

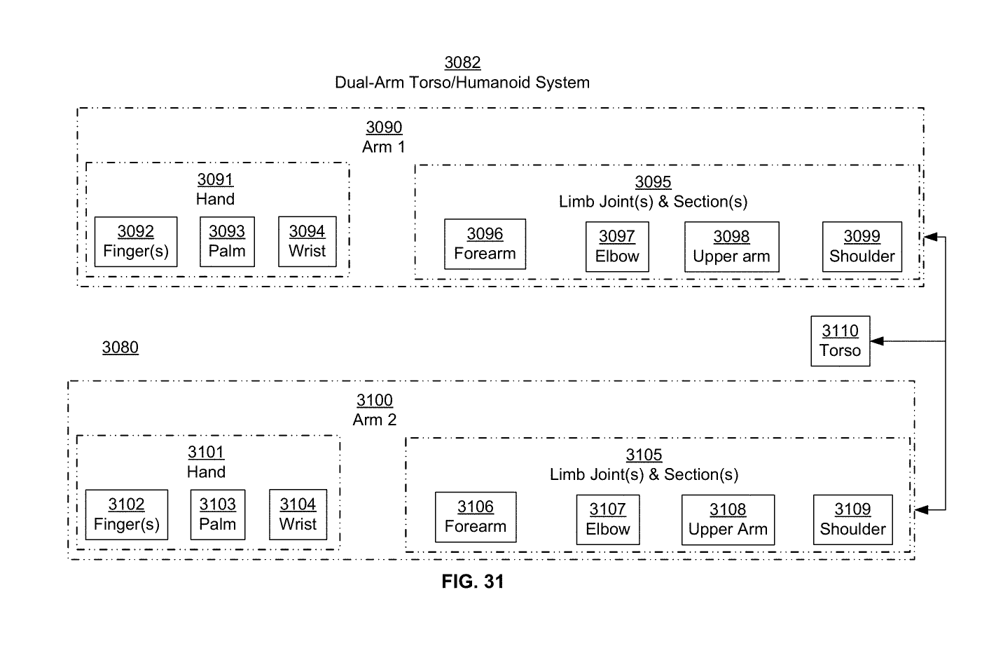

FIG. 31 depicts a block diagram illustrating a system-based minimanipulation library action-based dual-arm and torso topology 3080 for a dual-arm torso/humanoid system 3082 with two individual but identical arms 1 (3090) and 2 (3100), connected through a torso 3110. Each arm 3090 and 3100 are split internally into a hand (3091, 3101) and a limb-joint sections 3095 and 3105. Each hand 3091, 3101 is in turn comprised of a one or more finger(s) 3092 and 3102, a palm 3093 and 3103, and a wrist 3094 and 3104. Each of the limb-joint sections 3095 and 3105 are in turn comprised of a forearm-limb 3096 and 3106, an elbow-joint 3097 and 3107, an upper-arm-limb 3098 and 3108, as well as a shoulder-joint 3099 and 3109.

The interest in grouping the physical layout as shown in FIG. BB is related to the fact that MM actions can readily be split into actions performed mostly by a certain portion of a hand or limb/joint, thereby reducing the parameter-space for control and adaptation/optimization during learning and playback, dramatically. It is a representation of the physical space into which certain subroutine or main minimanipulation (MM) actions can be mapped, with the respective variables/parameters needed to describe each minimanipulation (MM) being both minimal/necessary and sufficient.

A breakdown in the physical space-domain also allows for a simpler breakdown of minimanipulation (MM) actions for a particular task into a set of generic minimanipulation (sub-) routines, dramatically simplifying the building of more complex and higher-level complexity minimanipulation (MM) actions using a combination of serial/parallel generic minimanipulation (MM) (sub-) routines. Note that the physical domain breakdown to readily generate minimanipulation (MM) action primitives (and/or sub-routines), is but one of the two complementary approaches allowing for simplified parametric descriptions of minimanipulation (MM) (sub-) routines to allow one to properly build a set of generic and task-specific minimanipulation (MM) (sub-) routines or motion primitives to build up a complete (set of) motion-library(ies).

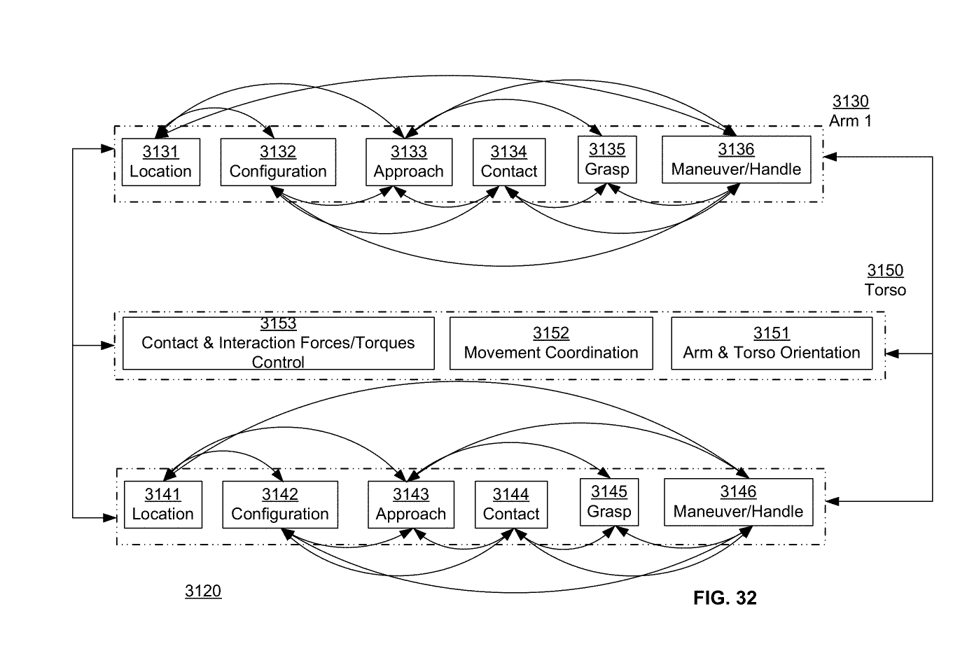

FIG. 32 depicts a dual-arm torso humanoid robot system 3120 as a set of manipulation function phases associated with any manipulation activity, regardless of the task to be accomplished, for MM library manipulation-phase combinations and transitions for task-specific action-sequences 3120.

Hence in order to build an ever more complex and higher level set of minimanipulation (MM) motion-primitive routines form a set of generic sub-routines, a high-level minimanipulation (MM) can be thought of as a transition between various phases of any manipulation, thereby allowing for a simple concatenation of minimanipulation (MM) sub-routines to develop a higher-level minimanipulation routine (motion-primitive). Note that each phase of a manipulation (approach, grasp, maneuver, etc.) is itself its own low-level minimanipulation described by a set of parameters involved in controlling motions and forces/torques (internal, external as well as interface variables) involving one or more of the physical domain entities [finger(s), palm, wrist, limbs, joints (elbow, shoulder, etc.), torso, etc.].

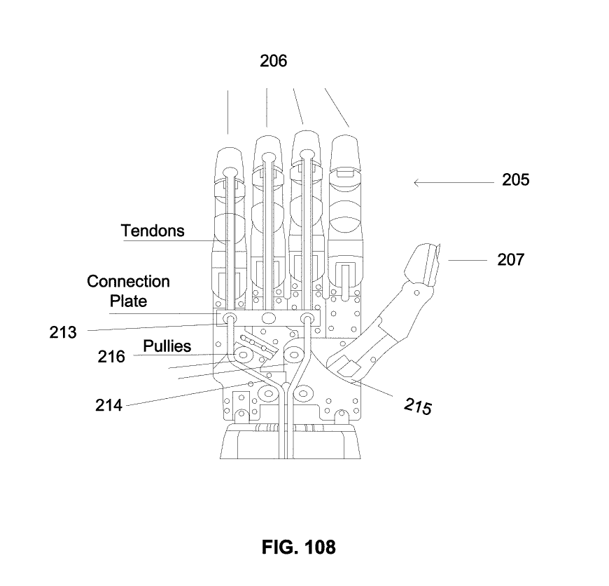

Arm 1 3131 of a dual-arm system, can be thought of as using external and internal sensors as defined in FIG. 108, to achieve a particular location 3131 of the end effector, with a given configuration 3132 prior to approaching a particular target (tool, utensil, surface, etc.), using interface-sensors to guide the system during the approach-phase 3133, and during any grasping-phase 3035 (if required); a subsequent handling-/maneuvering-phase 3136 allows for the end effector to wield an instrument in it grasp (to stir, draw, etc.). The same description applies to an Arm 2 3140, which could perform similar actions and sequences.

Note that should a minimanipulation (MM) sub-routine action fail (such as needing to re-grasp), all the minimanipulation sequencer has to do is to jump back backwards to a prior phase and repeat the same actions (possibly with a modified set of parameters to ensure success, if needed). More complex sets of actions, such playing a sequence of piano-keys with different fingers, involves a repetitive jumping-loops between the Approach 3133, 3134 and the Contact 3134, 3144 phases, allowing for different keys to be struck in different intervals and with different effect (soft/hard, short/long, etc.); moving to different octaves on the piano key-scale would simply require a phase-backwards to the configuration-phase 3132 to reposition the arm, or possibly even the entire torso 3140 through translation and/or rotation to achieve a different arm and torso orientation 3151.

Arm 2 3140 could perform similar activities in parallel and independent of Arm 3130, or in conjunction and coordination with Arm 3130 and Torso 3150, guided by the movement-coordination phase 315 (such as during the motions of arms and torso of a conductor wielding a baton), and/or the contact and interaction control phase 3153, such as during the actions of dual-arm kneading of dough on a table.

One aspect depicted in FIG. 32, is that minimanipulations (MM) ranging from the lowest-level sub-routine to the more higher level motion-primitives or more complex minimanipulation (MM) motions and abstraction sequences, can be generated from a set of different motions associated with a particular phase which in turn have a clear and well-defined parameter-set (to measure, control and optimize through learning). Smaller parameter-sets allow for easier debugging and sub-routines that can be guaranteed to work, allowing for a higher-level MM routines to be based completely on well-defined and successful lower-level MM sub-routines.

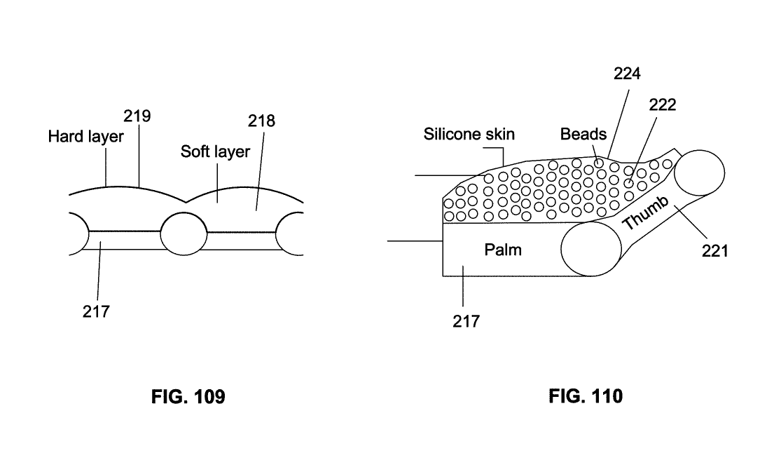

Notice that coupling a minimanipulation (sub-) routine to a not only a set of parameters required to be monitored and controlled during a particular phase of a task-motion as depicted in FIG. 110, but also associated further with a particular physical (set of) units as broken down in FIG. 109, allows for a very powerful set of representations to allow for intuitive minimanipulation (MM) motion-primitives to be generated and compiled into a set of generic and task-specific minimanipulation (MM) motion/action libraries.

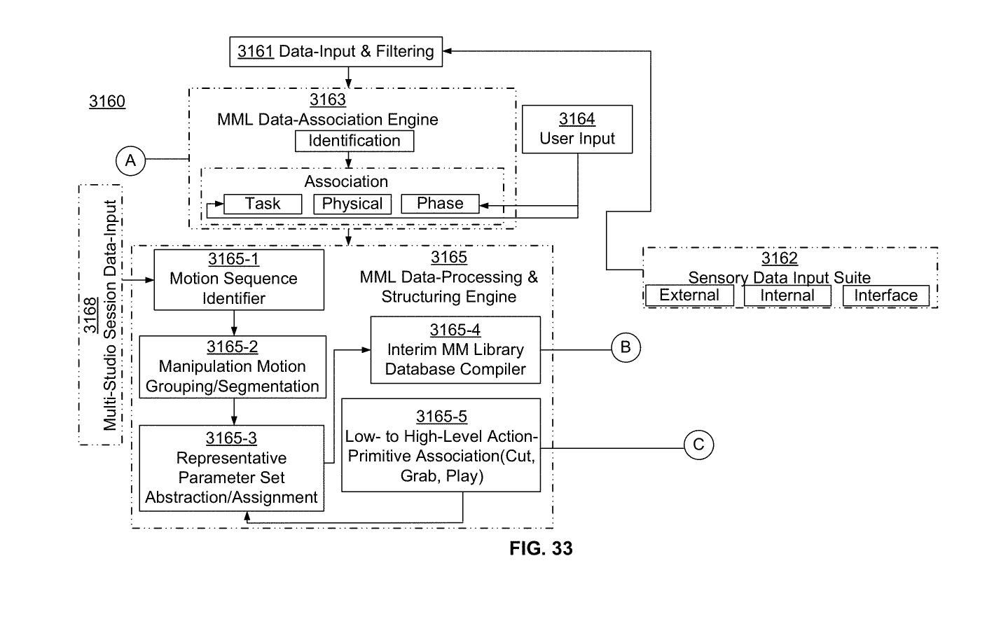

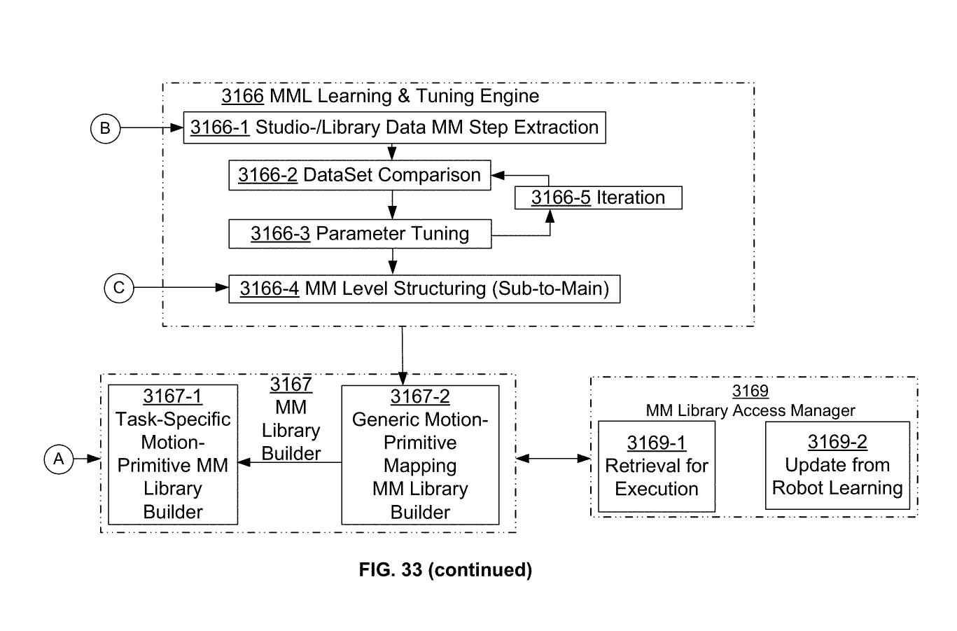

FIG. 33 depicts a flow diagram illustrating the process 3160 of minimanipulation Library(ies) generation, for both generic and task-specific motion-primitives as part of the studio-data generation, collection and analysis process. This figure depicts how sensory-data is processed through a set of software engines to create a set of minimanipulation libraries containing datasets with parameter-values, time-histories, command-sequences, performance-measures and -metrics, etc. to ensure low- and higher-level minimanipulation motion primitives result in a successful completion of low-to-complex remote robotic task-executions.

In a more detailed view, it is shown how sensory data is filtered and input into a sequence of processing engines to arrive at a set of generic and task-specific minimanipulation motion primitive libraries. The processing of the sensory data 3162 identified in FIG. 108 involves its filtering-step 3161 and grouping it through an association engine 3163, where the data is associated with the physical system elements as identified in FIG. 109 as well as manipulation-phases as described in FIG. 110, potentially even allowing for user input 3164, after which they are processed through two MM software engines.

The MM data-processing and structuring engine 3165 creates an interim library of motion-primitives based on identification of motion-sequences 3165-1, segmented groupings of manipulation steps 3165-2 and then an abstraction-step 3165-3 of the same into a dataset of parameter-values for each minimanipulation step, where motion-primitives are associated with a set of pre-defined low- to high-level action-primitives 3165-5 and stored in an interim library 3165-4. As an example, process 3165-1 might identify a motion-sequence through a dataset that indicates object-grasping and repetitive back-and-forth motion related to a studio-chef grabbing a knife and proceeding to cut a food item into slices. The motion-sequence is then broken down in 3165-2 into associated actions of several physical elements (fingers and limbs/joints) shown in FIG. 109 with a set of transitions between multiple manipulation phases for one or more arm(s) and torso (such as controlling the fingers to grasp the knife, orienting it properly, translating arms and hands to line up the knife for the cut, controlling contact and associated forces during cutting along a cut-plane, re-setting the knife to the beginning of the cut along a free-space trajectory and then repeating the contact/force-control/trajectory-following process of cutting the food-item indexed for achieving a different slice width/angle). The parameters associated with each portion of the manipulation-phase are then extracted and assigned numerical values in 3165-3, and associated with a particular action-primitive offered by 3165-5 with mnemonic descriptors such as ‘grab’, ‘align utensil’, ‘cut’, ‘index-over’, etc.

The interim library data 3165-4 is fed into a learning-and-tuning engine 3166, where data from other multiple studio-sessions 3168 is used to extract similar minimanipulation actions and their outcomes 3166-1 and comparing their data sets 3166-2, allowing for parameter-tuning 3166-3 within each minimanipulation group using one or more of standard machine-learning/-parameter-tuning techniques in an iterative fashion 3166-5. A further level-structuring process 3166-4 decides on breaking the minimanipulation motion-primitives into generic low-level sub-routines and higher-level minimanipulations made up of a sequence (serial and parallel combinations) of sub-routine action-primitives.

A following library builder 3167 then organizes all generic minimanipulation routines into a set of generic multi-level minimanipulation action-primitives with all associated data (commands, parameter-sets and expected/required performance metrics) as part of a single generic minimanipulation library 3167-2. A separate and distinct library is then also built as a task-specific library 3167-1 that allows for assigning any sequence of generic minimanipulation action-primitives to a specific task (cooking, painting, etc.), allowing for the inclusion of task-specific datasets which only pertain to the task (such as kitchen data and parameters, instrument-specific parameters, etc.) which are required to replicate the studio-performance by a remote robotic system.

A separate MM library access manager 3169 is responsible for checking-out proper libraries and their associated datasets (parameters, time-histories, performance metrics, etc.) 3169-1 to pass onto a remote robotic replication system, as well as checking back in updated minimanipulation motion primitives (parameters, performance metrics, etc.) 3169-2 based on learned and optimized minimanipulation executions by one or more same/different remote robotic systems. This ensures the library continually grows and is optimized by a growing number of remote robotic execution platforms.

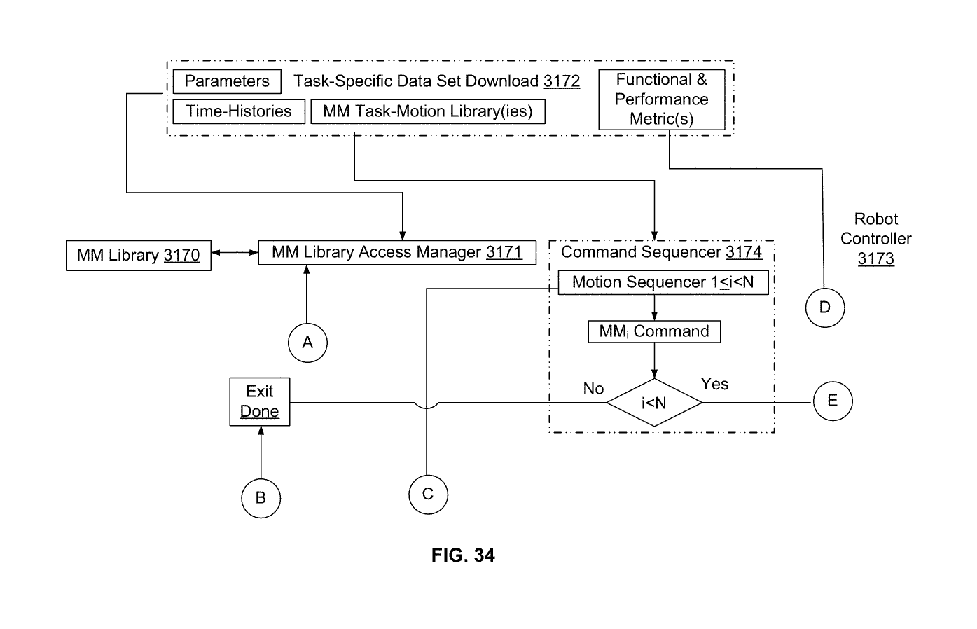

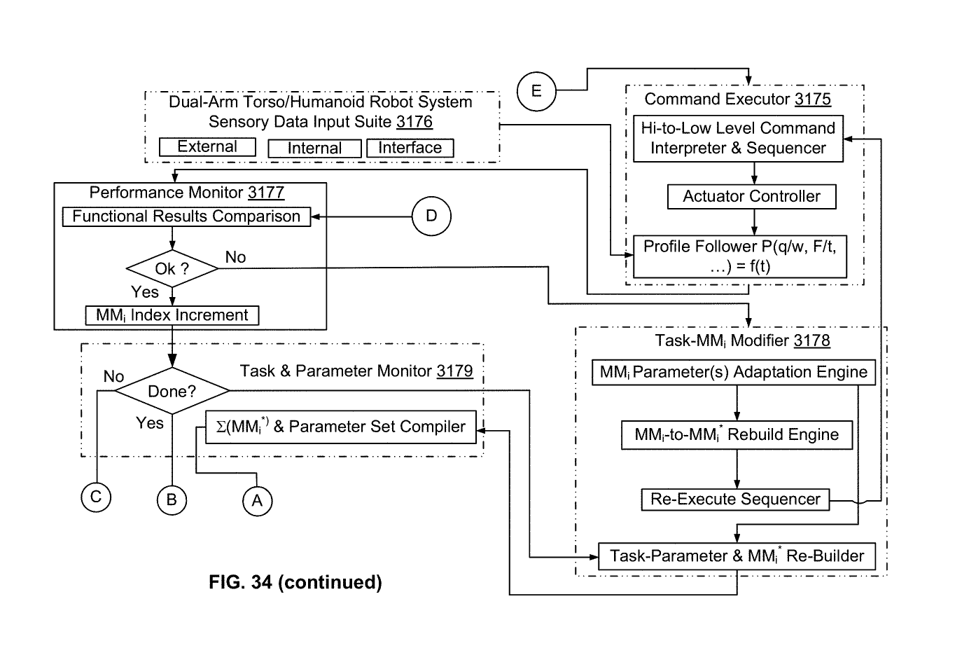

FIG. 34 depicts a block diagram illustrating the process of how a remote robotic system would utilize the minimanipulation (MM) library(ies) to carry out a remote replication of a particular task (cooking, painting, etc.) carried out by an expert in a studio-setting, where the expert's actions were recorded, analyzed and translated into machine-executable sets of hierarchically-structured minimanipulation datasets (commands, parameters, metrics, time-histories, etc.) which when downloaded and properly parsed, allow for a robotic system (in this case a dual-arm torso/humanoid system) to faithfully replicate the actions of the expert with sufficient fidelity to achieve substantially the same end-result as that of the expert in the studio-setting.

At a high level, this is achieved by downloading the task-descriptive libraries containing the complete set of minimanipulation datasets required by the robotic system, and providing them to a robot controller for execution. The robot controller generates the required command and motion sequences that the execution module interprets and carries out, while receiving feedback from the entire system to allow it to follow profiles established for joint and limb positions and velocities as well as (internal and external) forces and torques. A parallel performance monitoring process uses task-descriptive functional and performance metrics to track and process the robot's actions to ensure the required task-fidelity. A minimanipulation learning-and-adaptation process is allowed to take any minimanipulation parameter-set and modify it should a particular functional result not be satisfactory, to allow the robot to successfully complete each task or motion-primitive. Updated parameter data is then used to rebuild the modified minimanipulation parameter set for re-execution as well as for updating/rebuilding a particular minimanipulation routine, which is provided back to the original library routines as a modified/re-tuned library for future use by other robotic systems. The system monitors all minimanipulation steps until the final result is achieved and once completed, exits the robotic execution loop to await further commands or human input.

In specific detail the process outlined above, can be detailed as the sequences described below. The MM library 3170, containing both the generic and task-specific MM-libraries, is accessed via the MM library access manager 3171, which ensures all the required task-specific data sets 3172 required for the execution and verification of interim/end-result for a particular task are available. The data set includes at least, but is not limited to, all necessary kinematic/dynamic and control parameters, time-histories of pertinent variables, functional and performance metrics and values for performance validation and all the MM motion libraries relevant to the particular task at hand.

All task-specific datasets 3172 are fed to the robot controller 3173. A command sequencer 3174 creates the proper sequential/parallel motion sequences with an assigned index-value ‘I’, for a total of ‘i=N’ steps, feeding each sequential/parallel motion command (and data) sequence to the command executor 3175. The command executor 3175 takes each motion-sequence and in turn parses it into a set of high-to-low command signals to actuation and sensing systems, allowing the controllers for each of these systems to ensure motion-profiles with required position/velocity and force/torque profiles are correctly executed as a function of time. Sensory feedback data 3176 from the (robotic) dual-arm torso/humanoid system is used by the profile-following function to ensure actual values track desired/commanded values as close as possible.

A separate and parallel performance monitoring process 3177 measures the functional performance results at all times during the execution of each of the individual minimanipulation actions, and compares these to the performance metrics associated with each minimanipulation action and provided in the task-specific minimanipulation data set provided in 3172. Should the functional result be within acceptable tolerance limits to the required metric value(s), the robotic execution is allowed to continue, by way of incrementing the minimanipulation index value to ‘i++’, and feeding the value and returning control back to the command-sequencer process 3174, allowing the entire process to continue in a repeating loop. Should however the performance metrics differ, resulting in a discrepancy of the functional result value(s), a separate task-modifier process 3178 is enacted.

The minimanipulation task-modifier process 3178 is used to allow for the modification of parameters describing any one task-specific minimanipulation, thereby ensuring that a modification of the task-execution steps will arrive at an acceptable performance and functional result. This is achieved by taking the parameter-set from the ‘offending’ minimanipulation action-step and using one or more of multiple techniques for parameter-optimization common in the field of machine-learning, to rebuild a specific minimanipulation step or sequence MMᵢ into a revised minimanipulation step or sequence MMᵢ*. The revised step or sequence MMᵢ* is then used to rebuild a new command-0sequence that is passed back to the command executor 3175 for re-execution. The revised minimanipulation step or sequence MMᵢ* is then fed to a re-build function that re-assembles the final version of the minimanipulation dataset, that led to the successful achievement of the required functional result, so it may be passed to the task- and parameter monitoring process 3179.

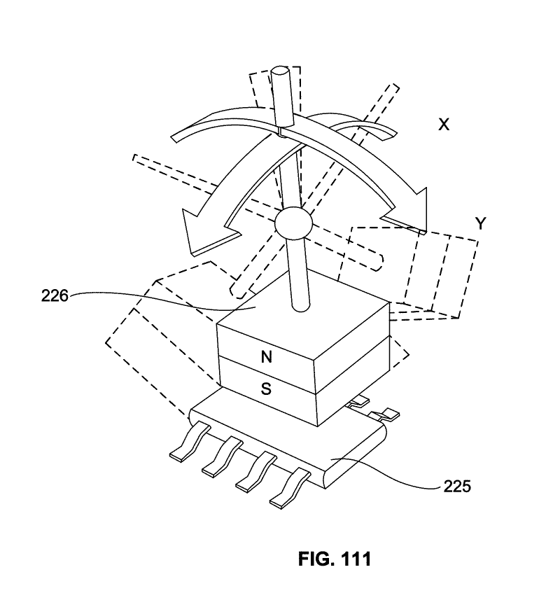

The task- and parameter monitoring process 3179 is responsible for checking for both the successful completion of each minimanipulation step or sequence, as well as the final/proper minimanipulation dataset considered responsible for achieving the required performance-levels and functional result. As long as the task execution is not completed, control is passed back to the command sequencer 3174. Once the entire sequences have been successfully executed, implying ‘i=N’, the process exits (and presumably awaits further commands or user input. For each sequence-counter value ‘I’, the monitoring task 3179 also forwards the sum of all rebuilt minimanipulation parameter sets Σ(MMᵢ*) back to the MM library access manager 3171 to allow it to update the task-specific library(ies) in the remote MM library 3170 shown in FIG. 111. The remote library then updates its own internal task-specific minimanipulation representation [setting Σ(MM_{i,new})=Σ(MMᵢ)], thereby making an optimized minimanipulation library available for all future robotic system usage.

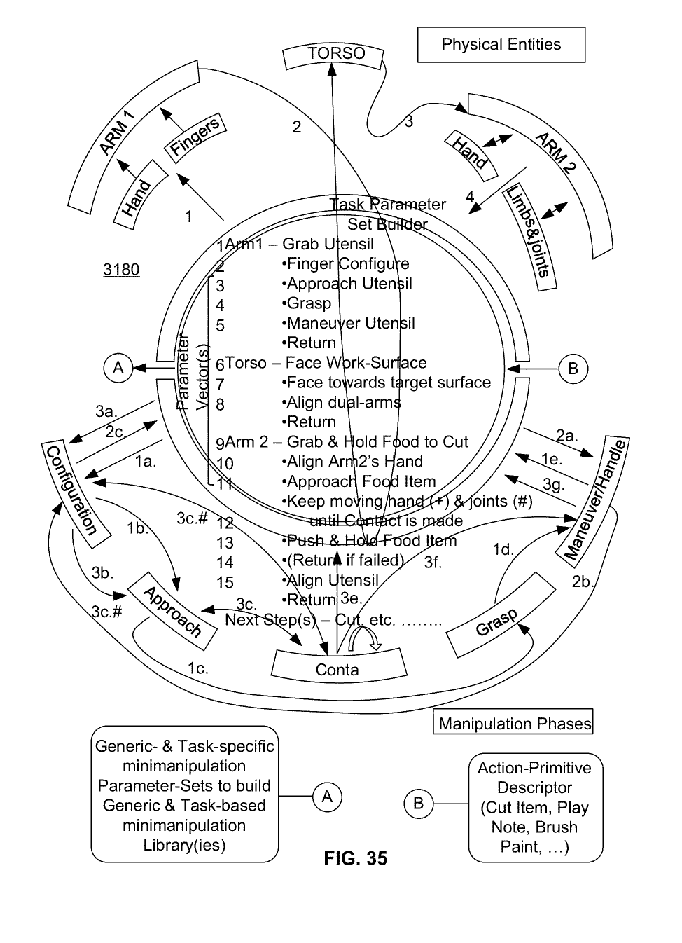

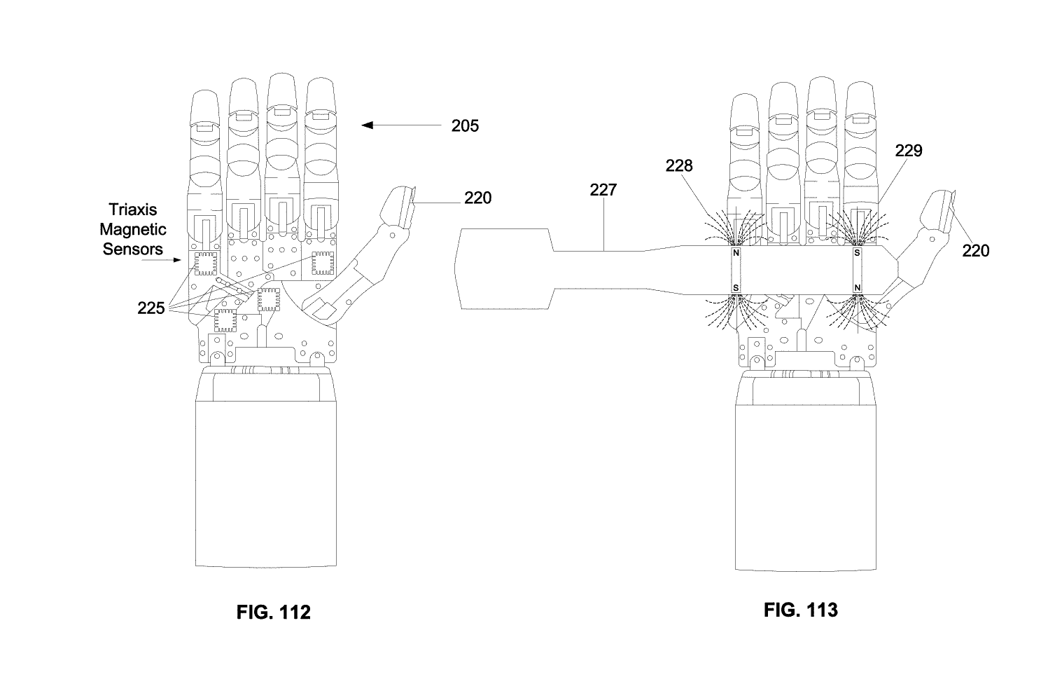

FIG. 35 depicts a block diagram illustrating an automated minimanipulation parameter-set building engine 3180 for a minimanipulation task-motion primitive associated with a particular task. It provides a graphical representation of how the process of building (a) (sub-) routine for a particular minimanipulation of a particular task is accomplished based on using the physical system groupings and different manipulation-phases, where a higher-level minimanipulation routine can be built up using multiple low-level minimanipulation primitives (essentially sub-routines comprised of small and simple motions and closed-loop controlled actions) such as grasp, grasp the tool, etc. This process results in a sequence (basically task- and time-indexed matrices) of parameter values stored in multi-dimensional vectors (arrays) that are applied in a stepwise fashion based on sequences of simple maneuvers and steps/actions. In essence this figure depicts an example for the generation of a sequence of minimanipulation actions and their associated parameters, reflective of the actions encapsulated in the MM Library Processing & Structuring Engine 3160 from FIG. 112.

The example depicted in FIG. 113 shows a portion of how a software engine proceeds to analyze sensory-data to extract multiple steps from a particular studio data set. In this case it is the process of grabbing a utensil (a knife for instance) and proceeding to a cutting-station to grab or hold a particular food-item (such as a loaf of bread) and aligning the knife to proceed with cutting (slices). The system focuses on Arm 1 in Step 1., which involves the grabbing of a utensil (knife), by configuring the hand for grabbing (1.a.), approaching the utensil in a holder or on a surface (1.b.), performing a pre-determined set of grasping-motions (including contact-detection and -force control not shown but incorporated in the GRASP minimanipulation step 1.c.) to acquire the utensil and then move the hand in free-space to properly align the hand/wrist for cutting operations. The system thereby is able to populate the parameter-vectors (1 thru 5) for later robotic control. The system returns to the next step that involves the torso in Step 2., which comprises a sequence of lower-level minimanipulations to face the work (cutting) surface (2.a.), align the dual-arm system (2.b.) and return for the next step (2.c.). In the next Step 3., the Arm 2 (the one not holding the utensil/knife), is commanded to align its hand (3.a.) for a larger-object grasp, approach the food item (3.b.; involves possibly moving all limbs and joints and wrist; 3.c.), and then move until contact is made (3.c.) and then push to hold the item with sufficient force (3.d.), prior to aligning the utensil (3.f.) to allow for cutting operations after a return (3.g.) and proceeding to the next step(s) (4. and so on).

The above example illustrates the process of building a minimanipulation routine based on simple sub-routine motions (themselves also minimanipulations) using both a physical entity mapping and a manipulation-phase approach which the computer can readily distinguish and parameterize using external/internal/interface sensory feedback data from the studio-recording process. This minimanipulation library building-process for process-parameters generates ‘parameter-vectors’ which fully describe a (set of) successful minimanipulation action(s), as the parameter vectors include sensory-data, time-histories for key variables as well as performance data and metrics, allowing a remote robotic replication system to faithfully execute the required task(s). The process is also generic in that it is agnostic to the task at hand (cooking, painting, etc.), as it simply builds minimanipulation actions based on a set of generic motion- and action-primitives. Simple user input and other pre-determined action-primitive descriptors can be added at any level to more generically describe a particular motion-sequence and to allow it to be made generic for future use, or task-specific for a particular application. Having minimanipulation datasets comprised of parameter vectors, also allows for continuous optimization through learning, where adaptions to parameters are possible to improve the fidelity of a particular minimanipulation based on field-data generated during robotic replication operations involving the application (and evaluation) of minimanipulation routines in one or more generic and/or task-specific libraries.

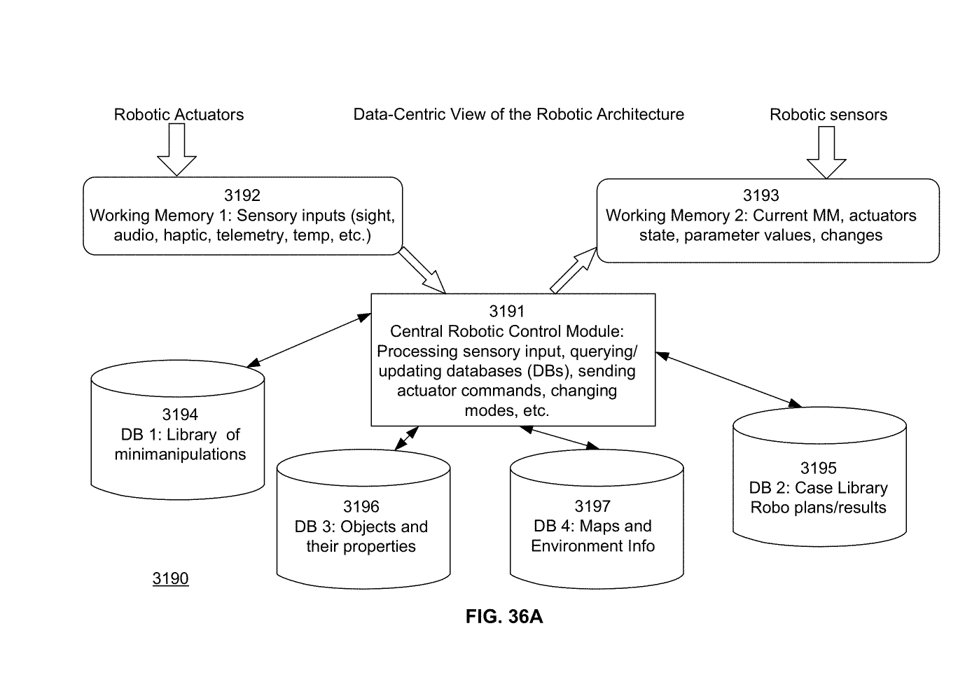

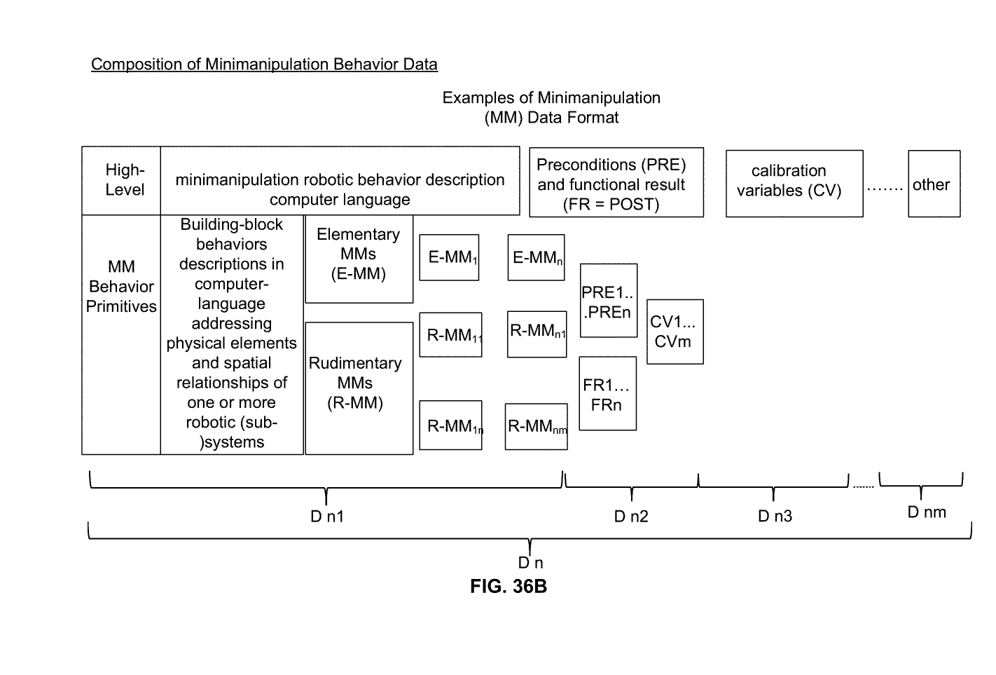

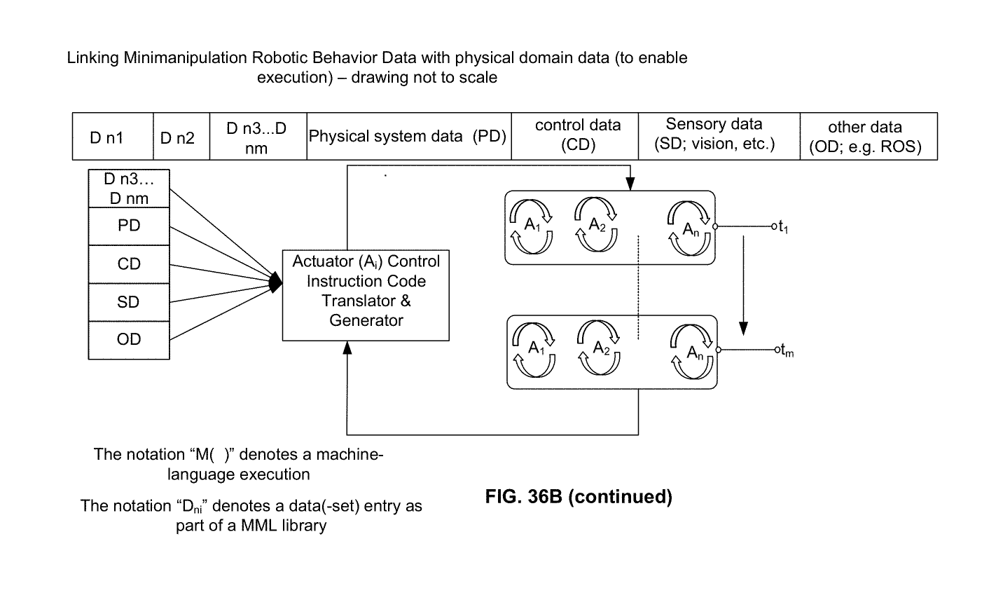

FIG. 36A is a block diagram illustrating a data-centric view of the robotic architecture (or robotic system), with a central robotic control module contained in the central box, in order to focus on the data repositories. The central robotic control module 3191 contains working memory needed by all the processes disclosed in <fill in>. In particular the Central Robotic Control establishes the mode of operation of the Robot, for instance whether it is observing and learning new minimanipulations, from an external teacher, or executing a task or in yet a different processing mode.

A working memory 13192 contains all the sensor readings for a period of time until the present: a few seconds to a few hours—depending on how much physical memory, typical would be about 60 seconds. The sensor readings come from the on-board or off-board robotic sensors and may include video from cameras, ladar, sonar, force and pressure sensors (haptic), audio, and/or any other sensors. Sensor readings are implicitly or explicitly time-tagged or sequence-tagged (the latter means the order in which the sensor readings were received).

A working memory 2 3193 contains all of the actuator commands generated by the Central RoboticControl and either passed to the actuators, or queued to be passed to same at a given point in time or based on a triggering event (e.g. the robot completing the previous motion). These include all the necessary parameter values (e.g. how far to move, how much force to apply, etc.).

A first database (database 1) 3194 contains the library of all minimanipulations (MM) known to the robot, including for each MM, a triple <PRE, ACT, POST>, where PRE={s₁, s₂, . . . , sₙ} is a set of items in the world state that must be true before the actions ACT=[a₁, a₂, . . . , aₖ] can take place, and result in a set of changes to the world state denoted as POST={p₁, p₂, . . . , pₘ}. In a preferred embodiment, the MMs are index by purpose, by sensors and actuators they involved, and by any other factor that facilitates access and application. In a preferred embodiment each POST result is associated with a probability of obtaining the desired result if the MM is executed. The Central Robotic Control both accesses the MM library to retrieve and execute MM's and updates it, e.g. in learning mode to add new MMs.

A second database (database 2) 3195 contains the case library, each case being a sequence of minimanipulations to perform a give task, such as preparing a given dish, or fetching an item from a different room. Each case contains variables (e.g. what to fetch, how far to travel, etc.) and outcomes (e.g. whether the particular case obtained the desired result and how close to optimal—how fast, with or without side-effects etc.). The Central RoboticControl both accesses the Case Library to determine if has a known sequence of actions for a current task, and updates the Case Library with outcome information upon executing the task. If in learning mode, the Central Robotic Control adds new cases to the case library, or alternately deletes cases found to be ineffective.

A third database (database 3) 3196 contains the object store, essentially what the robot knows about external objects in the world, listing the objects, their types and their properties. For instance, an knife is of type “tool” and “utensil” it is typically in a drawer or countertop, it has a certain size range, it can tolerate any gripping force, etc. An egg is of type “food”, it has a certain size range, it is typically found in the refrigerator, it can tolerate only a certain amount of force in gripping without breaking, etc. The object information is queried while forming new robotic action plans, to determine properties of objects, to recognize objects, and so on. The object store can also be updated when new objects introduce and it can update its information about existing objects and their parameters or parameter ranges.

A fourth database (database 4) 3197 contains information about the environment in which the robot is operating, including the location of the robot, the extent of the environment (e.g. the rooms in a house), their physical layout, and the locations and quantities of specific objects within that environment. Database 4 is queried whenever the robot needs to update object parameters (e.g. locations, orientations), or needs to navigate within the environment. It is updated frequently, as objects are moved, consumed, or new objects brought in from the outside (e.g. when the human returns form the store or supermarket).

FIG. 36B is a block diagram illustrating examples of various minimanipulation data formats in the composition, linking and conversion of minimanipulation robotic behavior data. In composition, high-level MM behavior descriptions in a dedicated/abstraction computer programming language are based on the use of elementary MM primitives which themselves may be described by even more rudimentary MM in order to allow for building behaviors from ever-more complex behaviors.

An example of a very rudimentary behavior might be ‘finger-curl’, with a motion primitive related to ‘grasp’ that has all 5 fingers curl around an object, with a high-level behavior termed ‘fetch utensil’ that would involve arm movements to the respective location and then grasping the utensil with all five fingers. Each of the elementary behaviors (incl. the more rudimentary ones as well) have a correlated functional result and associated calibration variables describing and controlling each.

Linking allows for behavioral data to be linked with the physical world data, which includes data related to the physical system (robot parameters and environmental geometry, etc.), the controller (type and gains/parameters) used to effect movements, as well as the sensory-data (vision, dynamic/static measures, etc.) needed for monitoring and control, as well as other software-loop execution-related processes (communications, error-handling, etc.).

Conversion takes all linked MM data, from one or more databases, and byway of a software engine, termed the Actuator Control Instruction Code Translator & Generator, thereby creating machine-executable (low-level) instruction code for each actuator (A₁ thru Aₙ) controller (which themselves run a high-bandwidth control loop in position/velocity and/or force/torque) for each time-period (t₁ thru tₘ), allowing for the robot system to execute commanded instruction in a continuous set of nested loops.

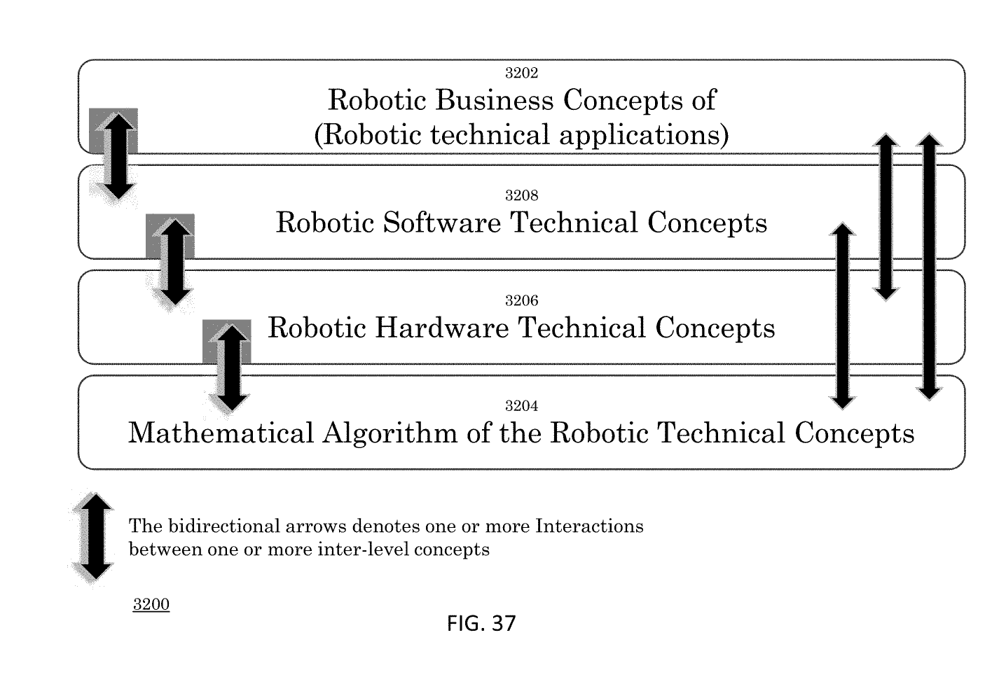

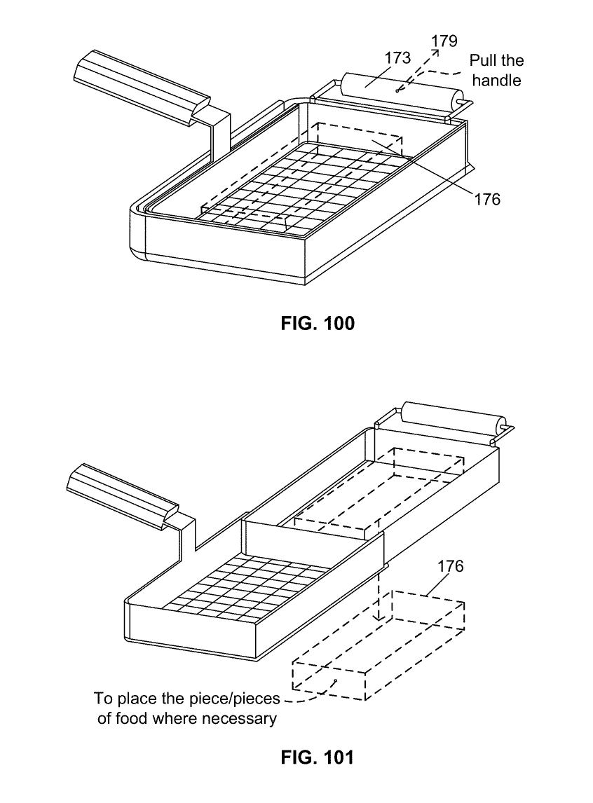

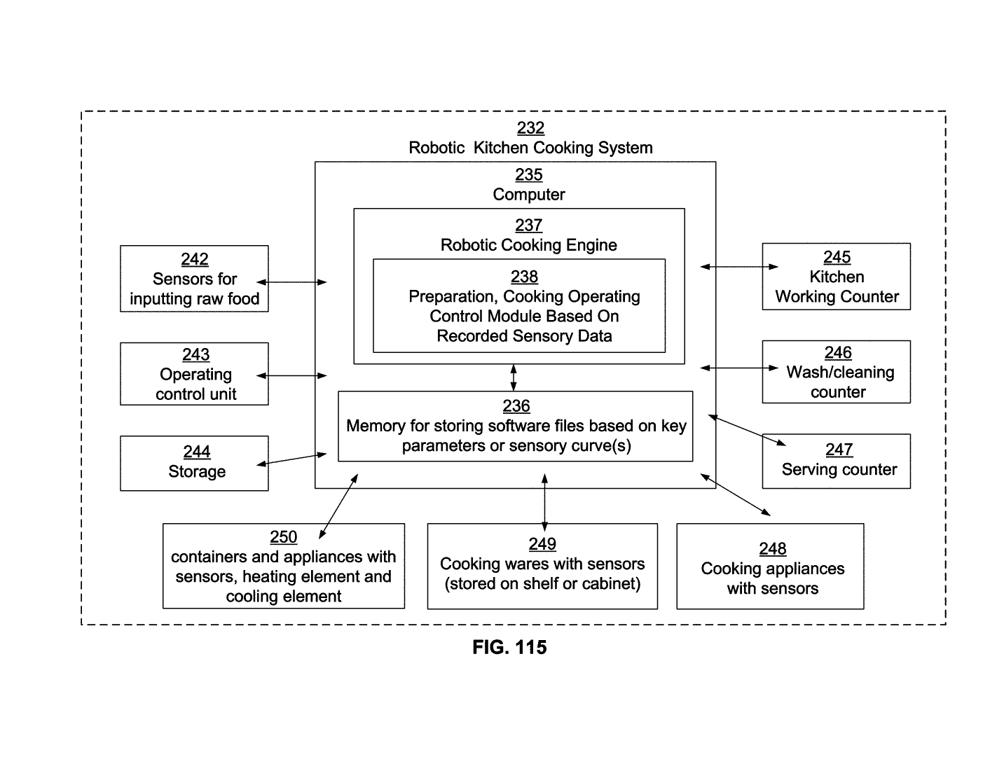

FIG. 37 is a block diagram illustrating one perspective on the different levels of bidirectional abstractions 3200 between the robotic hardware technical concepts 3206, the robotic software technical concepts 3208, the robotic business concepts 3202, and mathematical algorithms 3204 for carrying the robotic technical concepts. If the robotic concept of the present disclosure is viewed as vertical and horizontal concepts, the robotic business concept comprises business applications of the robotic kitchen at the top level 3202, mathematical algorithm 3204 of the robotic concept at the bottom level, and robotic hardware technical concepts 3206, and robotic software technical concepts 3208 between the robotic business concepts 3202 and mathematical algorithm 3204. Practically speaking, each of the levels in the robotic hardware technical concept, robotic software technical concept, mathematical algorithm, and business concepts interact with any of the levels bidirectionally as shown in FIG. 115. For example, a computer processor for processing software minimanipulations from a database in order to prepare a food dish by sending command instructions to the actuators for controlling the movements of each of the robotic elements on a robot to accomplish an optimal functional result in preparing the food dish. Details of the horizontal perspective of the robotic hardware technical concepts and robotic software technical concepts are described throughout the present disclosure, for example as illustrated in FIG. 100 through FIG. 114.

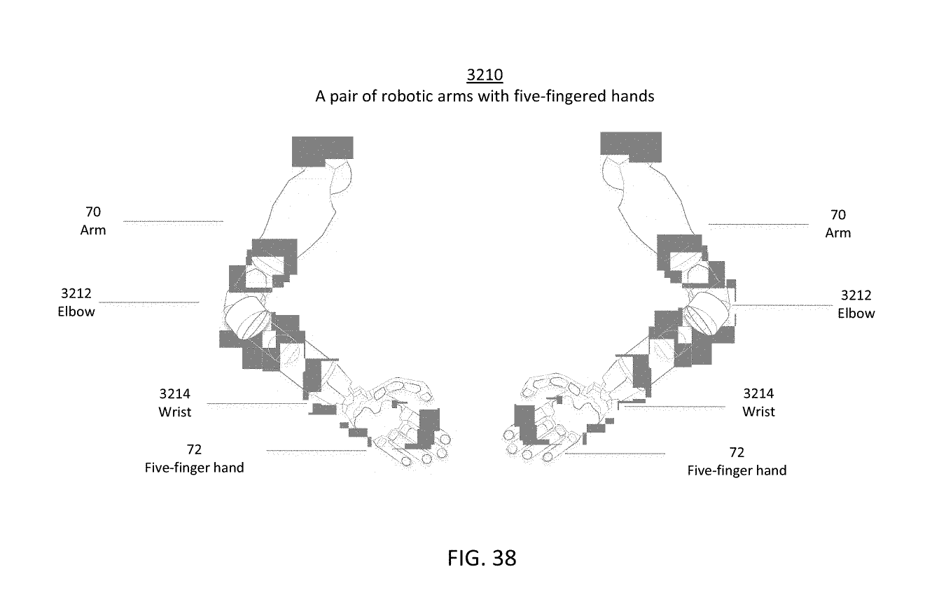

FIG. 38 is a block diagram illustrating a pair of robotic arms and five-fingered hands 3210. Each robotic arm 70 may be articulated at several joints such as the elbow 3212 and wrist 3214. Each hand 72 may have five fingers to replicate the motions and minimanipulations of a creator.

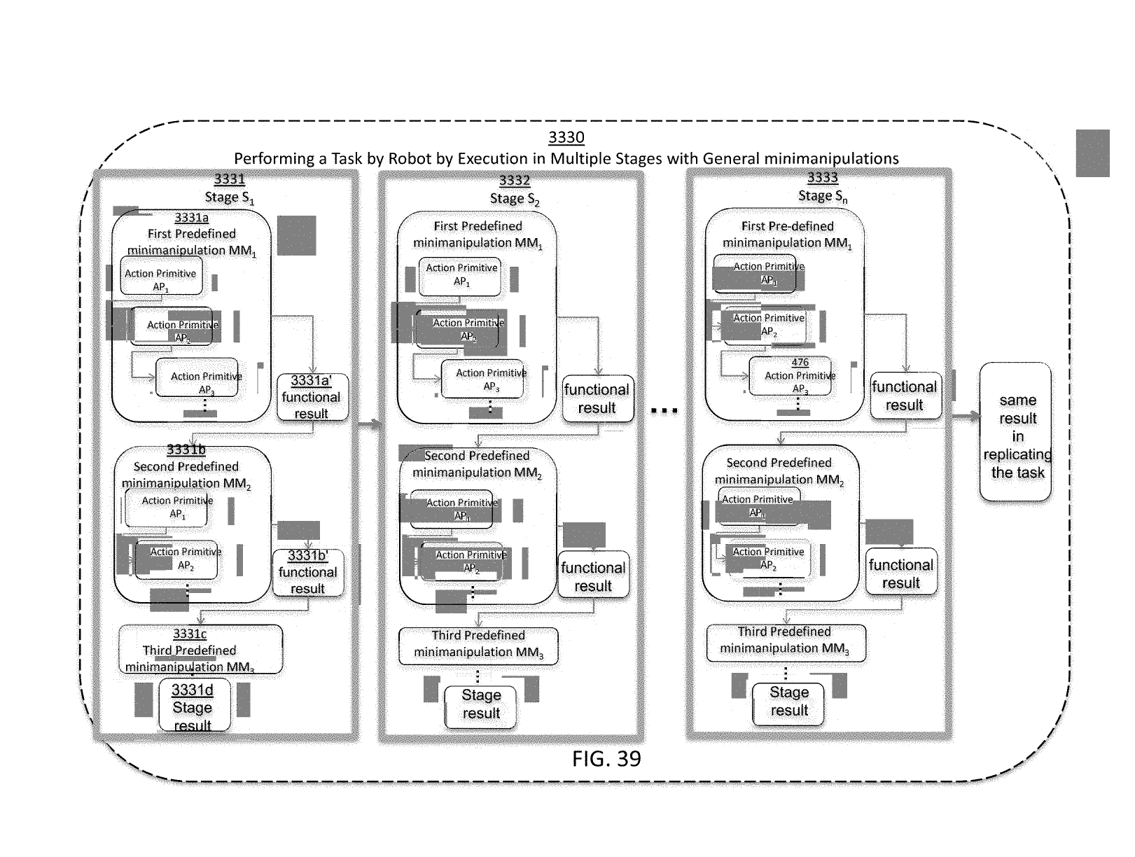

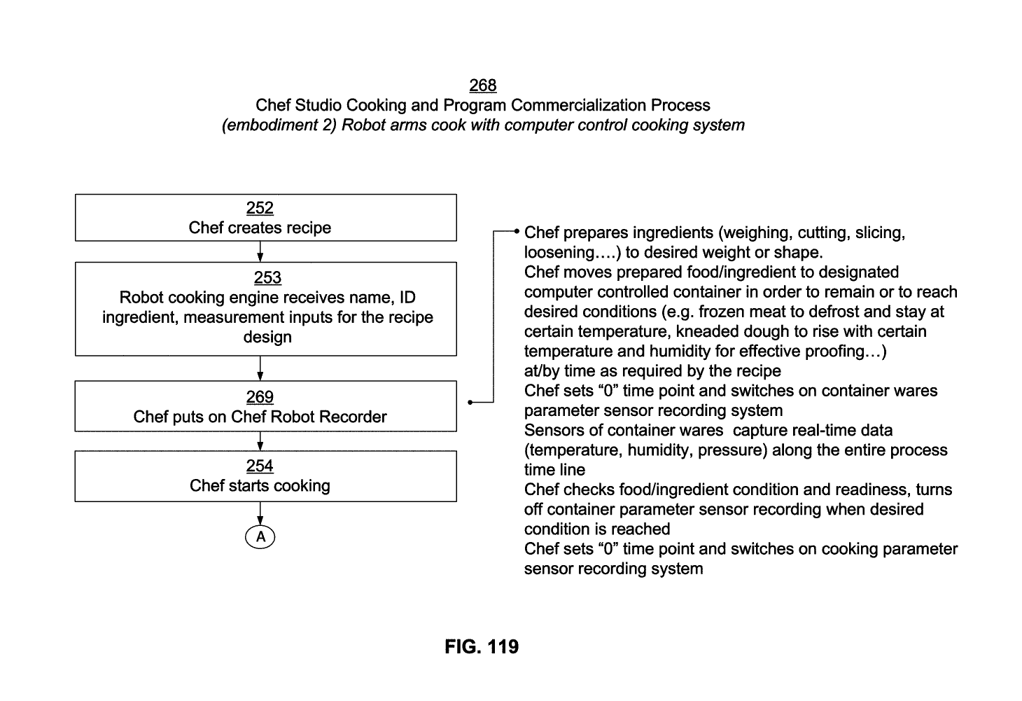

FIG. 39 is a block diagram illustrating performing a task 3330 by robot by execution in multiple stages 3331-3333 with general minimanipulations. When action plans require sequences of minimanipulations as in FIG. 119, in one embodiment the estimated average accuracy of a robotic plan in terms of achieving its desired result is given by:

$$A ( G , P ) = 1 - \frac{1}{n} {\sum }_{n = 1 , … n} \frac{\vert {g}_{i} - {p}_{i} \vert}{max ( \vert {g}_{i , t} - {p}_{i , t} \vert}$$

where G represents the set of objective (or “goal”) parameters (1st through nth) and P represents the set of Robotic apparatus 75 parameters (correspondingly (1st through nth). The numerator in the sum represents the difference between robotic and goal parameters (i.e. the error) and the denominator normalizes for the maximal difference). The sum gives the total normalized cumulative error

$$( i . e . {\sum }_{n = 1 , … n} \frac{\vert {g}_{i} - {p}_{i} \vert}{max ( \vert {g}_{i , t} - {p}_{i , t} \vert} ) ,$$

and multiplying by 1/n gives the average error. The complement of the average error (i.e. subtracting it from 1) corresponds to the average accuracy.

In another embodiment the accuracy calculation weighs the parameters for their relative importance, where each coefficient (each αi) represents the importance of the ith parameter, the normalized cumulative error is

$${\sum }_{n = 1 , … n} \frac{{α}_{i} \vert g - {p}_{i} \vert}{max ( \vert {g}_{i , t} - {p}_{i , t} \vert}$$

and the estimated average accuracy is given by:

$$A ( G , P ) = 1 - ( {\sum }_{n = 1 , … n} \frac{{α}_{i} \vert g - {p}_{i} \vert}{max ( \vert {g}_{i , t} - {p}_{i , t} \vert} ) / {\sum }_{n = 1 , … n} {α}_{i}$$

In FIG. 39, task 3330 may be broken down into stages which each need to be completed prior to the next stage. For example, stage 3331 must complete the stage result 3331d before advancing onto stage 3332. Additionally and/or alternatively, stages 3331 and 3332 may proceed in parallel. Each minimanipulation can be broken down into a series of action primitives which may result in a functional result for example, in stage S₁ all the action primitives in the first defined minimanipulation 3331a must be completed yielding in a functional result 3331a′ before proceeding to the second predefined minimanipulation 3331b (MM1.2). This in turn yields the functional result 3331b′ etc. until the desired stage result 3331d is achieved. Once stage 1 is completed, the task may proceed to stage S₂ 3332. At this point, the action primitives for stage S₂ are completed and so on until the task 3330 is completed. The ability to perform the steps in a repetitive fashion yields a predictable and repeatable way to perform the desired task.

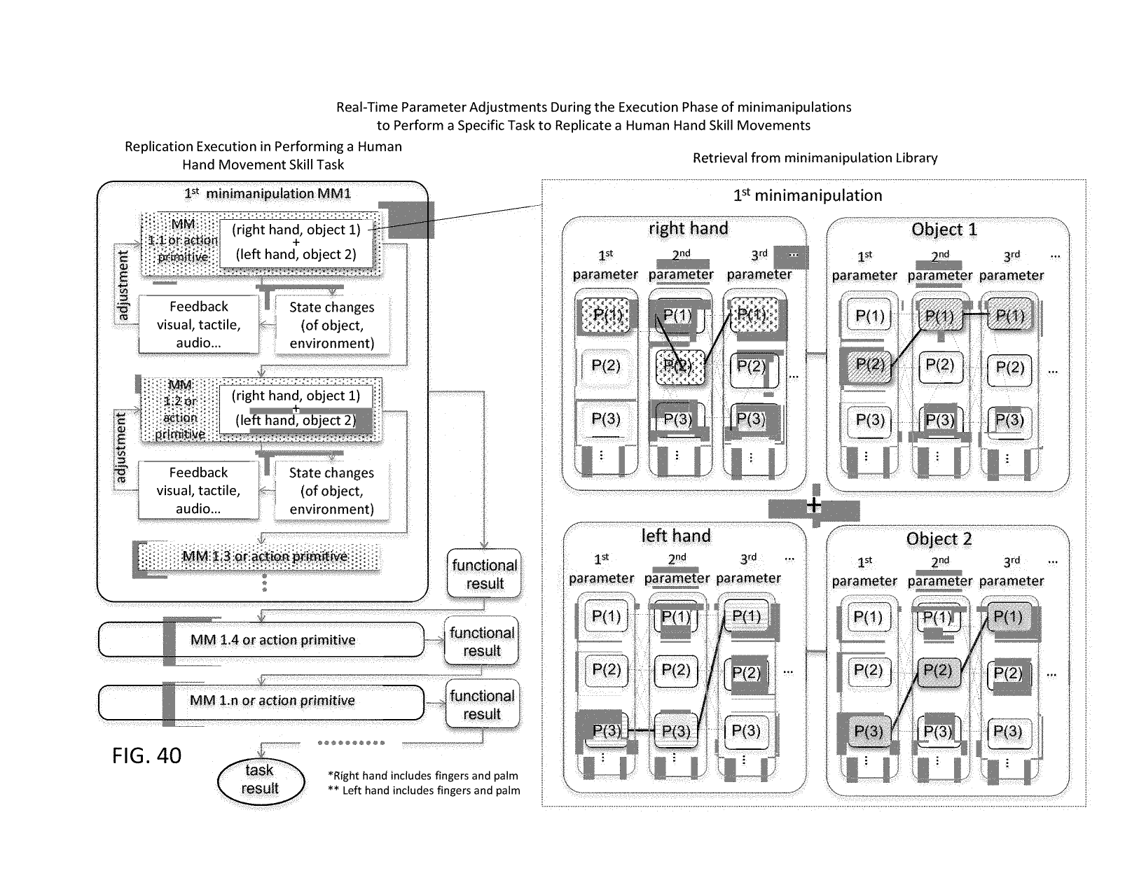

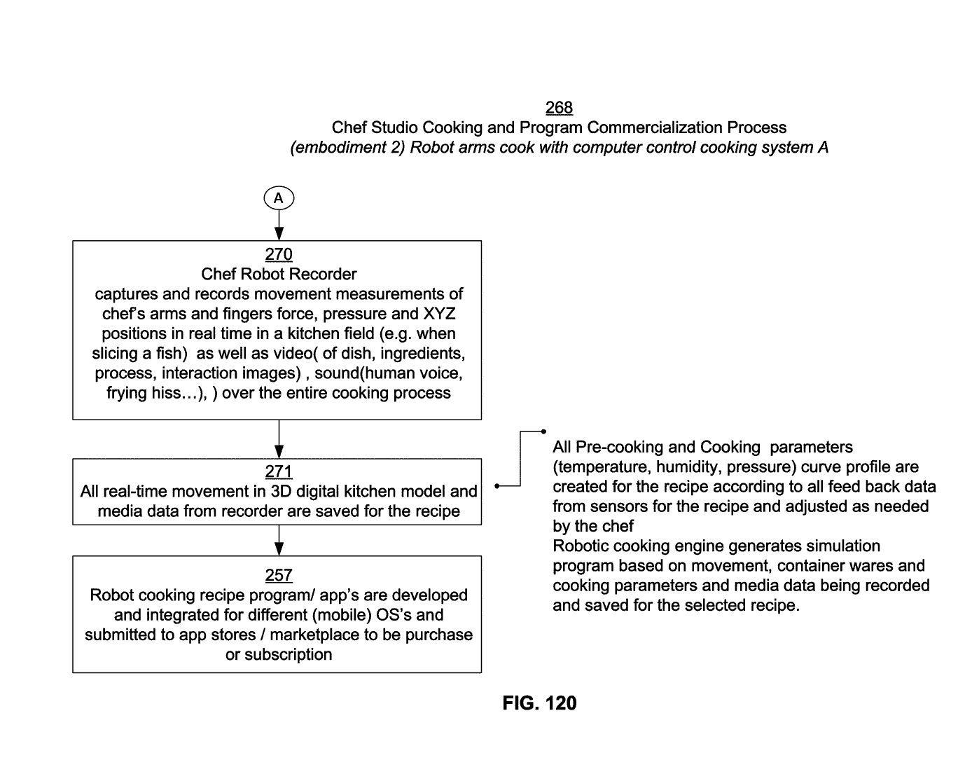

FIG. 40 is a block diagram illustrating the real-time parameter adjustment during the execution phase of minimanipulations in accordance with the present disclosure. The performance of a specific task may require adjustments to the stored minimanipulations to replicate actual human skills and movements. In an embodiment, the real-time adjustments may be necessary to address variations in objects. Additionally and or alternatively, adjustments may be required to coordinate left and right hand, arm, or other robotic parts movements. Further, variations in an object requiring a minimanipulation in the right hand may affect the minimanipulation required by the left hand or palm. For example, if a robotic hand is attempting to peel fruit that it grasps with the right hand, the minimanipulations required by the left hand will be impacted by the variations of the object held in the right hand. As seen in FIG. 120, each parameter to complete the minimanipulation to achieve the functional result may require different parameters for the left hand. Specifically, each change in a parameter sensed by the right hand as a result of a parameter in the first object make impact the parameters used by the left hand and the parameters of the object in the left hand.

In an embodiment, in order to complete minimanipulations 1-.1-1.3, to yield the functional result, right hand and left hand must sense and receive feedback on the object and the state change of the object in the hand or palm, or leg. This sensed state change may result in an adjustment to the parameters that comprise the minimanipulation. Each change in one parameter may yield in a change to each subsequent parameter and each subsequent required minimanipulation until the desired tasks result is achieved.

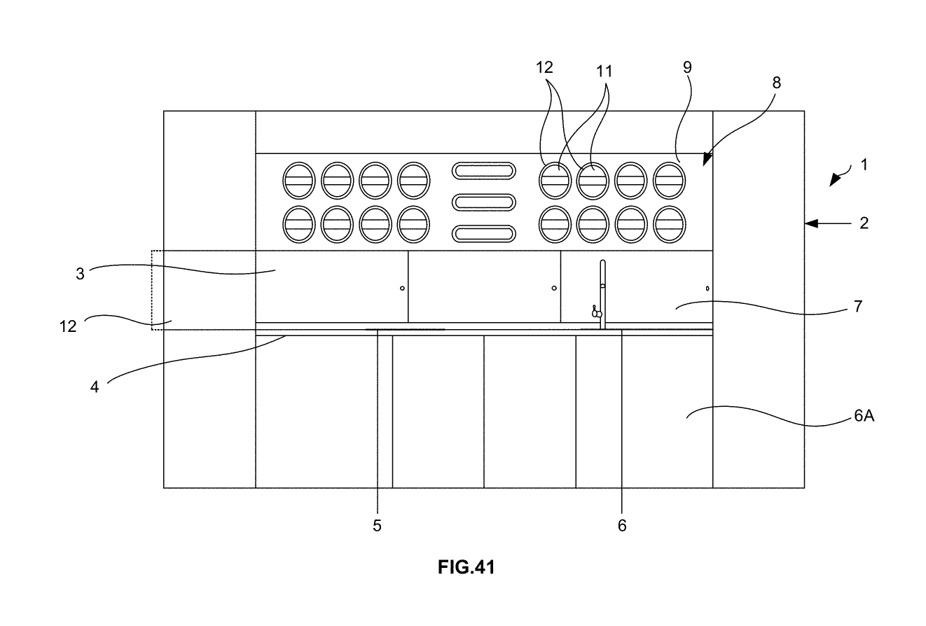

Referring initially to FIG. 41 of the accompanying drawings, there is provided a kitchen module 1 of some embodiments. The kitchen module 1 comprises a main kitchen unit 2 which is provided with a recess 3. The main kitchen unit 2 preferably comprises at least one kitchen cabinet. A work surface 4 is provided along the length of the recess 3. In some embodiments, the work surface 4 is provided with a hob 5 and/or a sink 6. In other embodiments, the work surface 4 is provided with other kitchen appliances and in further embodiments, the work surface 4 is not provided with any kitchen appliances but is instead a flat work surface. In the preferred embodiment, the work surface 4 incorporates a hob 5 and a sink 6.

A rear wall 7 extends upwardly from the work surface 4 at the rear of the recess 3. In some embodiments, the rear wall 7 is formed from at least one door or panel which is moveable to reveal a storage arrangement behind the moveable door or panel. In some embodiments, the rear wall comprises moveable sliding panels which may be of glass. In embodiments where the rear wall 7 comprises moveable doors or panels, the moveable doors or panels may be moved to expose a storage arrangement behind the moveable doors or panels to enable articles, such as foodstuffs to be placed into or removed from the storage arrangement.

The kitchen module 1 further comprises a storage arrangement 8 which is preferably positioned above the work surface 4 but may be positioned elsewhere in the kitchen module 1. The storage arrangement 8 comprises a housing 9 which incorporates a plurality of storage units 10. The storage arrangement 8 further comprises a plurality of containers 11 which are each configured to be carried by one of the respective storage units 10. The containers 11 and the storage arrangement 8 will be described in more detail below.

In some embodiments, the kitchen module 1 comprises a moveable cooking appliance 12 which, in this embodiment, is a rotatable oven. The moveable cooking appliance 12 will be described in more detail below.

In some embodiments, the kitchen module 1 comprises a dishwasher unit 6A which is preferably inset into the work surface 4 and concealed behind a panel of the housing 2.

In some embodiments, the kitchen module 1 comprises a display screen which is configured to display information to a user. The display screen is preferably integrated with electronic components of the kitchen module 1 and configured to enable a user to control the electronic components of the kitchen module 1.

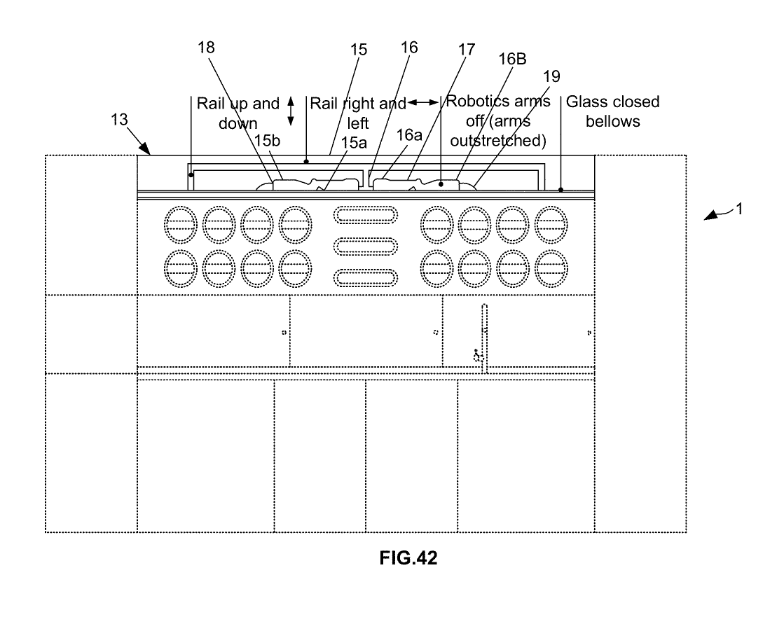

Referring now to FIG. 42 of the accompanying drawings, the kitchen module 1 of some embodiments incorporates a robot arm arrangement 13. The robot arm arrangement 13 is provided in an upper portion of the housing 2 and is preferably at least partly concealed behind a panel of the housing 2. The robot arm arrangement 13 comprises a rail 14 which is fixed within the housing 2. The rail 14 carries at least one robot arm. In preferred embodiments, the rail 14 carries two robot arms 15, 16.

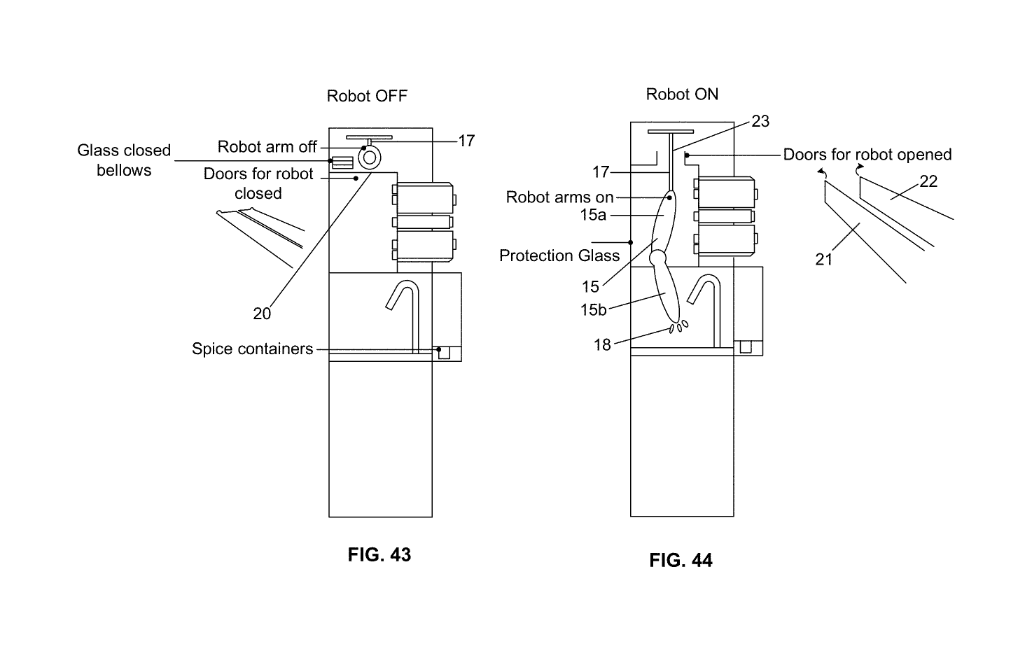

Referring now to FIGS. 43 and 44 of the accompanying drawings, the robot arms 15, 16 are each mounted to a central support member 17 which is coupled to the rail 14. The central support member 17 is configured to move along the length of the rail 14. The central support member 17 is also configured to move the robot 15, 16 downwardly and upwardly relative to the rail 14.

Each one of the robot arms 15, 16 comprises a first arm section 15a, 16a which is moveably mounted at one end to the central support member 17. Each robot arm 15, 16 further comprises a second arm section 15b, 16b which is moveably attached at one end to a respective first arm section 15a, 16a. The other end of each of the second arm sections 15b, 16b is provided with an end effector. In preferred embodiments, the end effector is a robotic hand 18, 19.

Each of the robot arms 15, 16 comprises computer-controlled motors which are configured to move the first and second sections of the robot arms 15, 16 and to control the hands 18, 19. The robot arms 15, 16 are coupled to a control unit (not shown) which is configured to control the robot arms 15, 16 to move and carry out tasks within the kitchen module 1.

In some embodiments, the robot arms 15, 16 are configured to move such that the first and second arm sections 15a, 16a and 15b, 16b are aligned with one another and substantially parallel to the rail 14, as shown in FIGS. 42 and 43. When the robot arms are in this position, the robot is in an offline state with the robot arms 15, 16 positioned away from the work surface 4.

In some embodiments, the robot arms 15, 16 are configured to rest in a rearward position when the robot is in the offline state and the robot arms 15, 16 are configured to move forwardly when the robot is activated.

In some embodiments, at least one moveable door 20 is configured to be closed beneath the robot arms 15, 16 when the robot arms 15, 16 are in the offline position, as shown in FIG. 43. Each moveable door 20 is configured to conceal the robot arms 15, 16 when the robot arms 15, 16 are not in use. When the robot arms 15, 16 are to be activated, the moveable door 20 opens to enable the robot arms 15, 16 to be lowered to perform tasks within the kitchen module 1, as shown in FIG. 44. In preferred embodiments, the moveable door 20 comprises two door portions 21, 22 which pivot upwardly to provide an opening 23 beneath robot arms 15, 16, as shown in FIG. 44.

In some embodiments, the sink 6 in the kitchen module is provided with a sanitization arrangement. The sanitization arrangement comprises a sanitizing liquid outlet which is configured to spray sanitizing liquid on part of the robot arms 15, 16 when positioned within the sink 6. The sanitization arrangement is thus configured to sanitize the hands 18, 19 of the robot when the hands 18, 19 are placed within the sink 6.

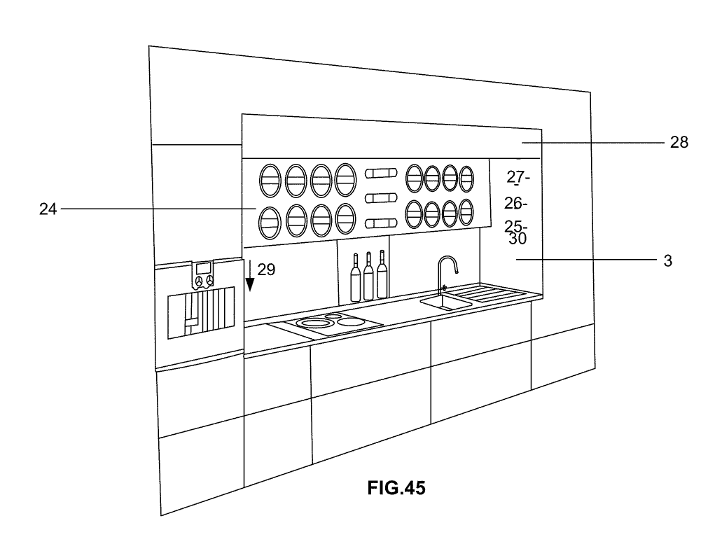

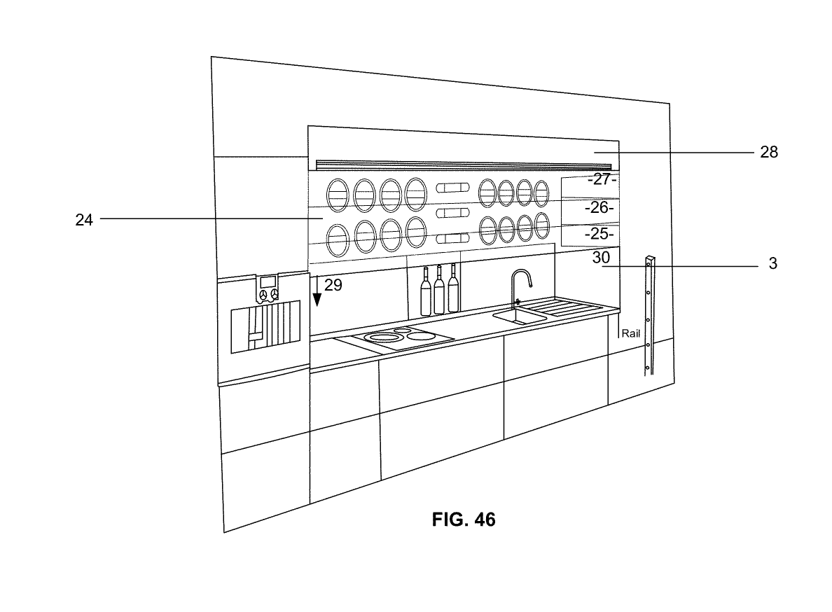

Referring now to FIGS. 45 and 46 of the accompanying drawings, some embodiments incorporate a moveable barrier which is configured to substantially close the recess 3 in the kitchen module 1. In the embodiment shown in FIGS. 45 and 46, the barrier is in the form of a moveable glass barrier 24. The glass barrier 24 comprises a plurality of interlinked glass panel elements 25-27 which are interlinked with further glass elements (not shown in FIGS. 45 and 46). The barrier 24 is configured to be stowed when not in use in a storage compartment 28 which is positioned above the recess 3 in the kitchen module 1. When the barrier 24 is stored in the storage compartment 28, the recess 3 in the kitchen module 1 is exposed to enable the kitchen module to be used by a human chef.

The barrier 24 is configured to be driven by a drive arrangement (not shown) to move out from within the storage compartment 28 to at least partly close the recess 3 in the direction generally indicated by arrows 29, 30 in FIG. 6. The barrier 24 preferably closes the recess 3 entirely so that a human chef cannot gain access to the recess 3. The barrier 24 is moved to this in-use position to provide a safety barrier which minimizes or prevents a human chef from accessing the recess 3 while the robot arms 15, 16 are operating within the recess 3. The barrier 24 therefore prevents injury to a person while the robot arms 15, 16 are operating.

Once the robot arms 15, 16 have completed their programmed operation, the robot arms 15, 16 are returned to their horizontal stored configuration and the barrier 24 is raised to open the recess 3 for access by a human chef.

Referring now to FIG. 47 of the accompanying drawings, in some embodiments, the kitchen module 1 comprises a dishwasher unit 31 which is positioned adjacent to the sink 6. The dishwasher unit 31 preferably comprises a planar lid 32 which is pivotally mounted to a housing of the dishwasher unit 31 to enable the lid 32 to pivot upwardly, as shown in FIG. 7. The dishwasher unit 31 is configured for use by the robot arms 15, 16 which can pivot the lid 32 upwardly and insert items to be washed within a wash chamber 33 within the dishwasher unit 31. When the lid 32 is not raised, it sits flush with the work surface 4 to provide an additional surface which can be used for food or drink preparation.

In some embodiments, the slidable glass panels in the rear wall 7 are configured to move to expose at least one storage compartment which is configured to store kitchen items, such as crockery 34, spice containers 35, bottles 36 and/or kitchen utensils 37.

In some embodiments, the kitchen module 1 comprises an extractor unit 38 which is preferably fitted within the work surface 4 adjacent to the hob 5.

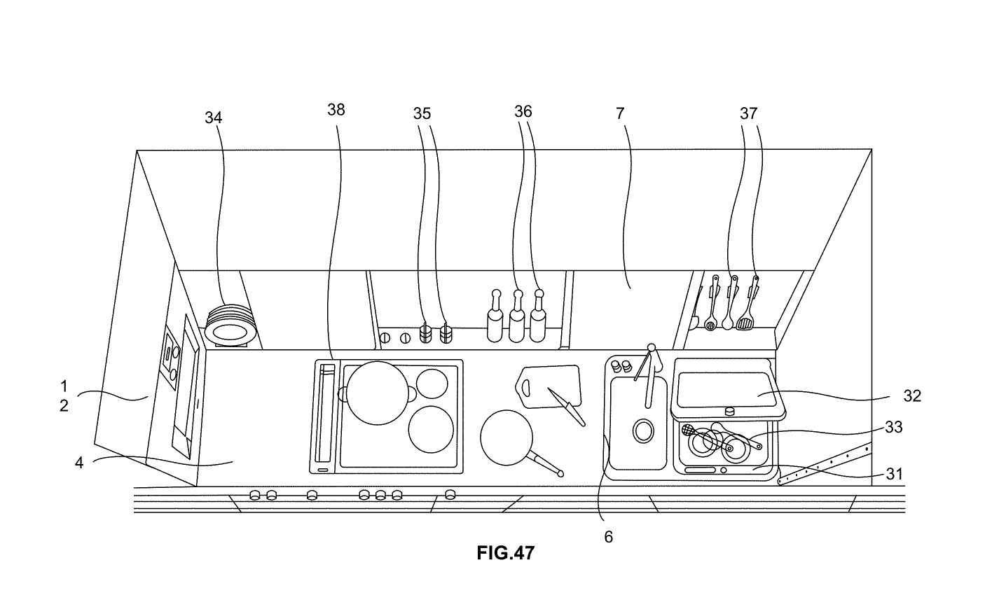

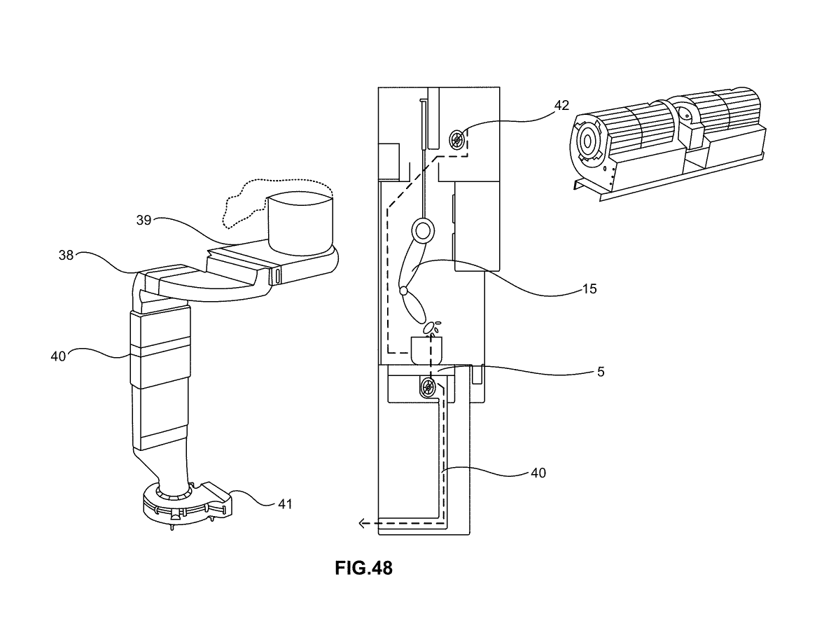

Referring now to FIG. 48 of the accompanying drawings, the extractor unit 38 comprises an inlet 39 which is positioned adjacent to the hob 5 and configured to draw cooking vapors from above the surface of the hob 5 downwardly, through an extractor duct 40 and to expel the cooking vapors from an outlet 41. The outlet 41 preferably expels the cooking vapors to a location which is remote from the kitchen module 1.

In other embodiments, a further extractor unit 42 is provided above the opening 23 in the storage compartment 28 which stores the robot arms 15, 16 when the robot arms are not in use. The further extractor unit 42 is configured to draw cooking vapors upwardly from the recess 3 and to extract the cooking vapors via a further ventilation duct (not shown) to a remote location. This further extractor unit 42 minimizes or prevents the build-up of moisture from cooking vapors within the recess 3. The further extractor unit 42 therefore minimizes fogging or misting of glass panels in the recess 3 due to cooking vapors.

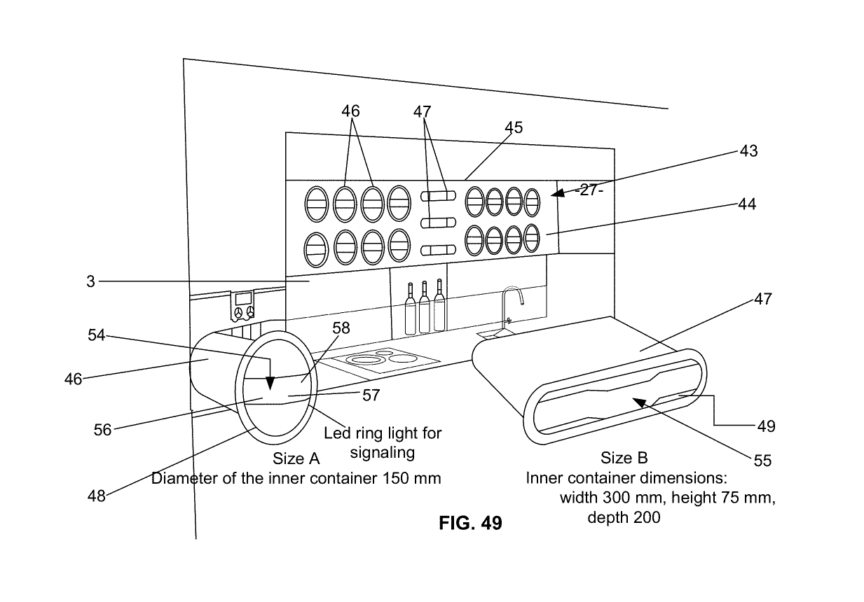

Referring now to FIG. 49 of the accompanying drawings, a storage arrangement 43 of some embodiments comprises a housing 44. The housing 44 is preferably a unit which is installed within or adjacent to part of a standardized kitchen. In the embodiment shown in FIG. 49, the housing 44 is installed above the recess 3 in the kitchen module 1. A front face 45 of the housing 44 faces outwardly, and is accessible by a human chef standing adjacent to the kitchen module 1 and/or by robotic arms 15, 16 that are operating within the recess 3.

The housing 44 comprises a plurality of storage units 26 which, in this embodiment, are recesses within the housing 44.

In this embodiment, the storage units 46 are substantially cylindrical recesses and the housing 44 further comprises a plurality of further storage units 47 which are recesses having a generally rectangular cross-section.

The storage units 46 are each configured to receive and carry at least part of a container 48. In this embodiment, each container 48 has a substantially cylindrical cross-section. The further storage units 47 are each configured to carry a further container 49 having a generally rectangular cross-section.

In other embodiments, the housing 44 incorporates a plurality of storage units which are the same shape and dimensions as one another or a mixture of different shapes and dimensions. For simplicity, the following description will refer to the generally cylindrical storage units 46 and their respective containers 48.

Referring now to FIGS. 49 to 51 of the accompanying drawings, the storage unit 46 comprises a storage unit housing 50 which is fixed to the housing 44 of the storage arrangement. The storage unit housing 50 is configured to receive at least part of a container 48.

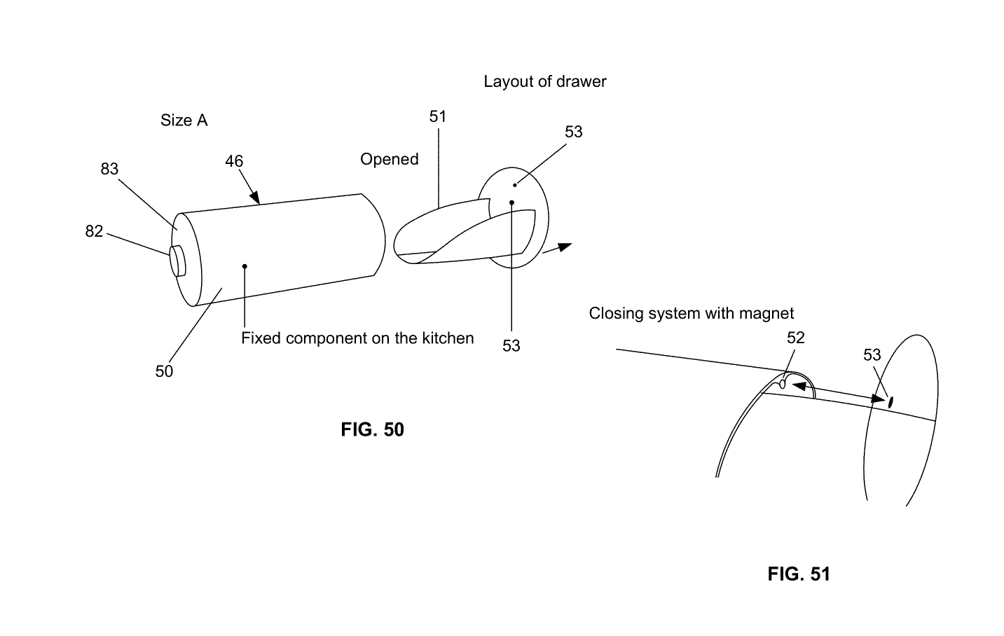

The container 48 comprises a container body 51 for receiving an ingredient (not shown). In the embodiment shown in FIG. 50, the container body is an open channel or scoop. However, in other embodiments, the container body of the container 48 may be a flat surface, such as a flat tray.

Referring now to FIG. 51 of the accompanying drawings, in some embodiments, the container 48 is provided with a retainer arrangement to retain the container 48 within the storage unit 46. In this embodiment, the retainer arrangement is in the form of a pair of magnets 52, 53 which are positioned respectively on the storage unit 46 and the container 48. In some embodiments, a first magnet is provided on the rear wall of the container 48 and a second magnet is provided on the rear wall of the storage unit 46.

When the container 48 is inserted into the storage unit 46, the magnets 52, 53 are brought adjacent to one another and attract one another to retain the container 48 at least partly within the storage unit 46. The retainer arrangement formed by the magnets 52, 53 is configured such that the container 48 can be pulled out from within the storage unit 46 by a human or by the robot arms 15, 16.

In some embodiments, the surface of the container body 51 is a low-friction surface which is preferably a glossy and smooth surface to enable food to slide easily off the surface. The container body 51 preferably also presents a curved surface on which to store the food to further minimize the risk of the food adhering to the surface.

In some embodiments, at least one of the containers 48 is provided with a volume indicator which provides a visual indication of the volume of an ingredient stored within the container 48. The volume indicator is preferably in the form of a graduated scale that indicates the level at which the container 48 is filled with an ingredient. In other embodiments, the container 48 comprises an electronic volume indicator which indicates the volume of an ingredient in the container 48 on a display screen or by way of an electronic indicator that is preferably provided on the container 48.

Each container 48 is provided with a respective elongate handle 54, 55. For simplicity, the following description refers to the container 48 and its container handle 54. However, the description applies equally to one of the further containers 47 and its respective handle 55.

Each handle 54 comprises at least one support leg which is carried by the container body 51. In this embodiment, the handle 54 comprises two spaced apart support legs 56, 57 which are each coupled at one end to the container body 51. The handle 54 further comprises an elongate handle element 58 which is coupled to and extends between support legs 56, 57. The support legs 56, 57 are angled away from the container body 51 such that the handle element 58 is held in a spaced apart position from the container body. In this embodiment, the support legs, 56, 57 and the handle element 58 are formed integrally as a single element which is preferably of metal.

In further embodiments, a container of the storage arrangement comprises a handle with only one support leg which supports a handle element in a spaced apart position from the container body.

The handle 54 of each container 48 facilitates movement of the container 48 by a robot. The spaced apart positioning of the handle element 58 enable a hand on the end of a robotic arm to grasp the handle 54 to permit the robot arm to easily move the container 48 out from and back into the storage unit 46.

The elongate configuration of the handle 54 provides a primary or only one option for a robot hand (or gripper) to hold the handle 54 to avoid any container miss orientation by the robot. This facilitates the orientation and movement of the container by a robot.

In some embodiments, the handle 54 is a universal handle that is used on the majority or all of the containers in the kitchen module 1. In these embodiments, the handle is a standardized handle that is configured to be easily recognized and manipulated by a robot. The robot can use the handle to pick up and manipulate a component carrying the handle without the robot needing to analyze or determine specific details about the component. The elongate shape and the size of the handle provides all the information that the robot needs to pick up and manipulate any component carrying the handle.

In some embodiments, the recess within the storage unit 46 into which the container 48 is inserted is configured to facilitate the insertion and removal of the container 48. For instance, in some embodiments, the internal recess of the storage unit 46 has side walls which diverge outwardly from one another from the rear of the recess to the opening into which the container 48 is inserted. The diverging side walls facilitate the insertion of the container 48 into the opening and guide the container 48 to align with the recess.

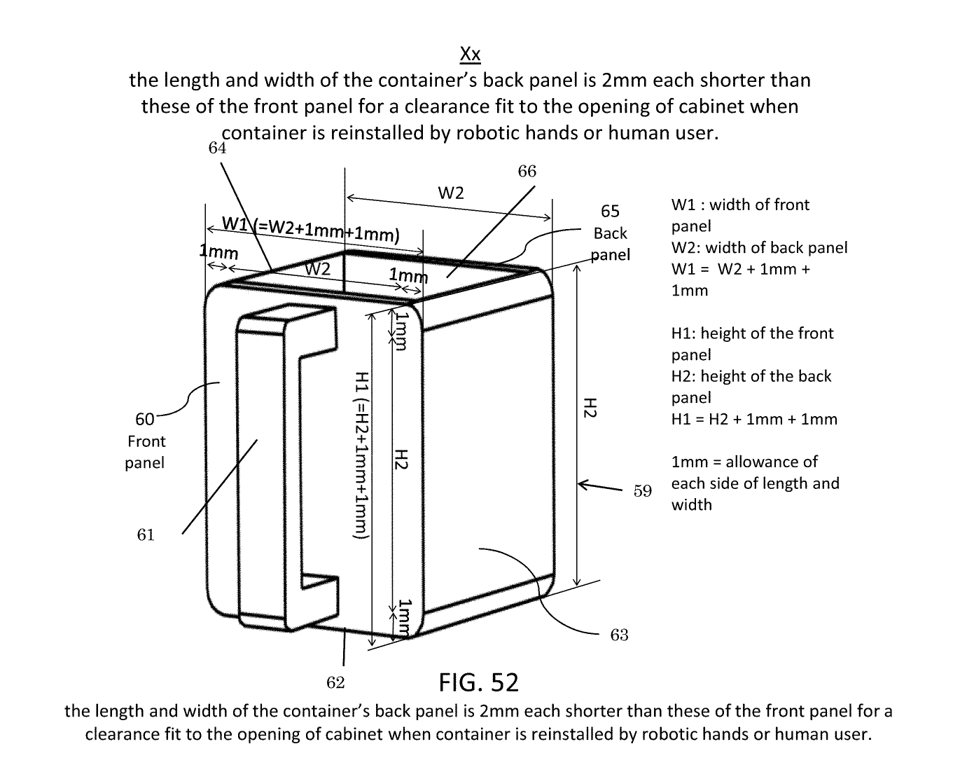

Referring now to FIG. 52 of the accompanying drawings, a container 59 of some embodiments has a generally rectangular cross-section. The container 59 comprises a front panel 60 which carries a handle 61. A base 62 and two spaced apart side walls 63, 64 project rearwardly from the front panel 60 to a back panel 65. The front and back panels 60, 65, the side walls 63, 64 and the base 62 form the walls of an open ended chamber 66 within the container 59 for containing a cooking ingredient.

The width W of the front panel 60 is greater than the width W2 of the back panel 65. In a preferred embodiment, the width of the front panel 60 is at least 2 mm greater than the width W2 of the back panel 65. Consequently, in a preferred embodiment, there is an allowance of substantially 1 mm or greater along each of the side walls 63, 64 of the container 59.

In this embodiment, the height H1 of the front panel 60 is greater than the height H2 of the back panel 65. In a preferred embodiment, the height H1 of the front panel 60 is at least 2 mm greater than the height H2 of the back panel 65. Consequently, in a preferred embodiment, there is an allowance of substantially 1 mm or greater at the back panel 65 of the container 59.

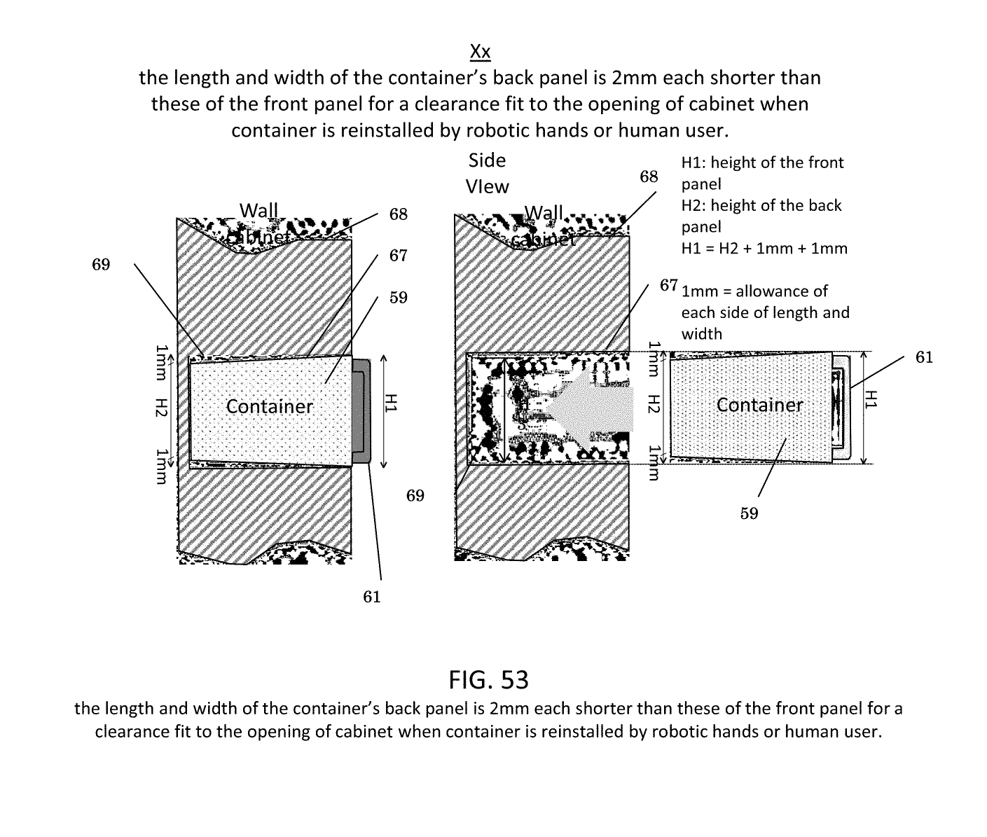

Referring now to FIG. 53 of the accompanying drawings, the container 59 is configured to be at least partly received within a storage unit 67 in a storage arrangement 68. In this embodiment, the storage unit 67 is a recess 69 which is provided in part of the storage arrangement 68. The recess 69 is dimensioned such that the recess 69 has a substantially uniform height H3 along its length. The height H3 of the recess 69 is substantially equal to or slightly less than the height H1 of the front panel 60 of the container 59. Consequently, the height H2 of the back panel 65 of the container 59 has a clearance of substantially 1 mm or greater from the upper and lower walls of the recess 69 when the container 59 is inserted into the recess 69.

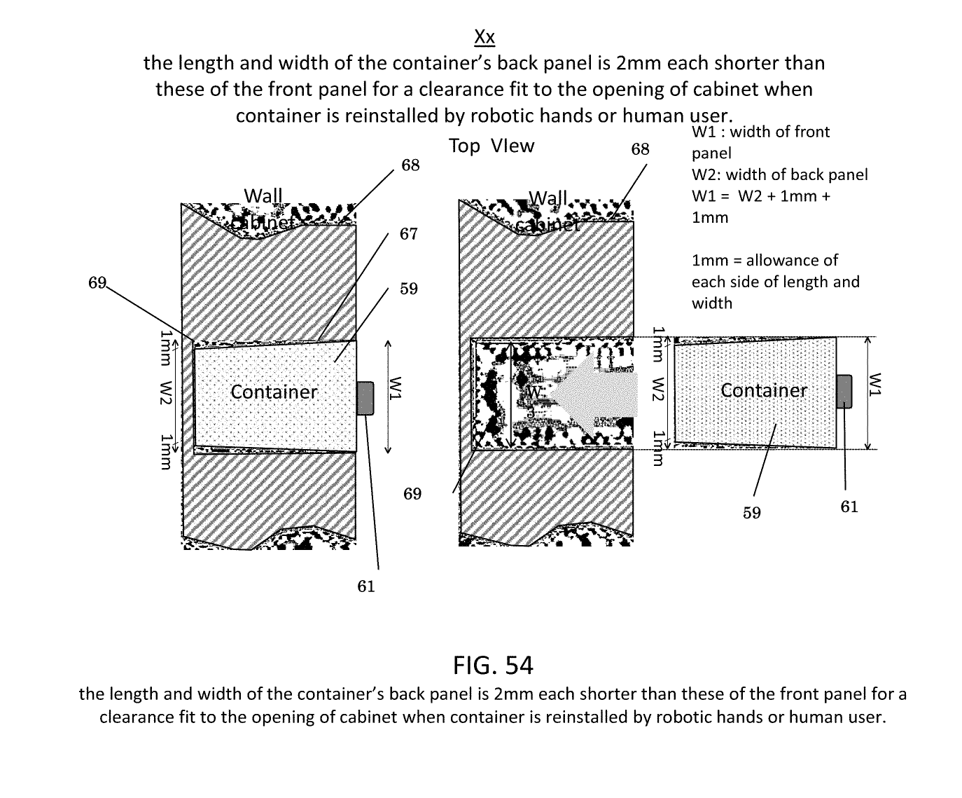

Referring now to FIG. 54 of the accompanying drawings, in some embodiments, the width W3 of the recess 69 is substantially uniform along the length of the recess 69. The width W3 of the recess 69 is substantially equal to or slightly less than the width W1 of the front panel 60 of the container 59. Consequently, there is a clearance of substantially 1 mm or greater between the back panel 65 of the container 59 when the container 59 is inserted into the recess 69.

The clearance between the back panel 65 of the container 59 and the walls of the recess 69 of the storage unit 67 facilitate the insertion of the container 59 into the storage unit 67 by both a human and by a robot. The clearance of 1 mm or greater ensures that there is some margin for error when inserting the container 59 into the storage unit 67. The diverging side walls of the container 59 guide the container 59 to locate the container 59 centrally within the storage unit 67 such that the front panel 60 of the container 59 substantially closes the opening in the storage unit 67.

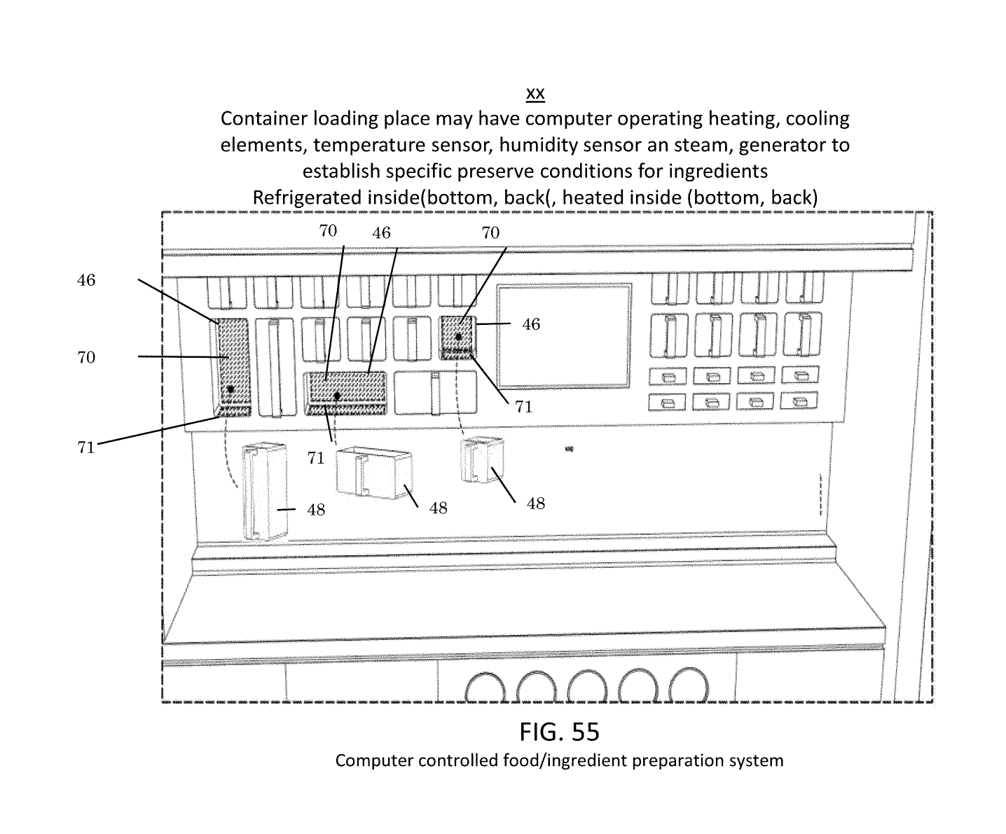

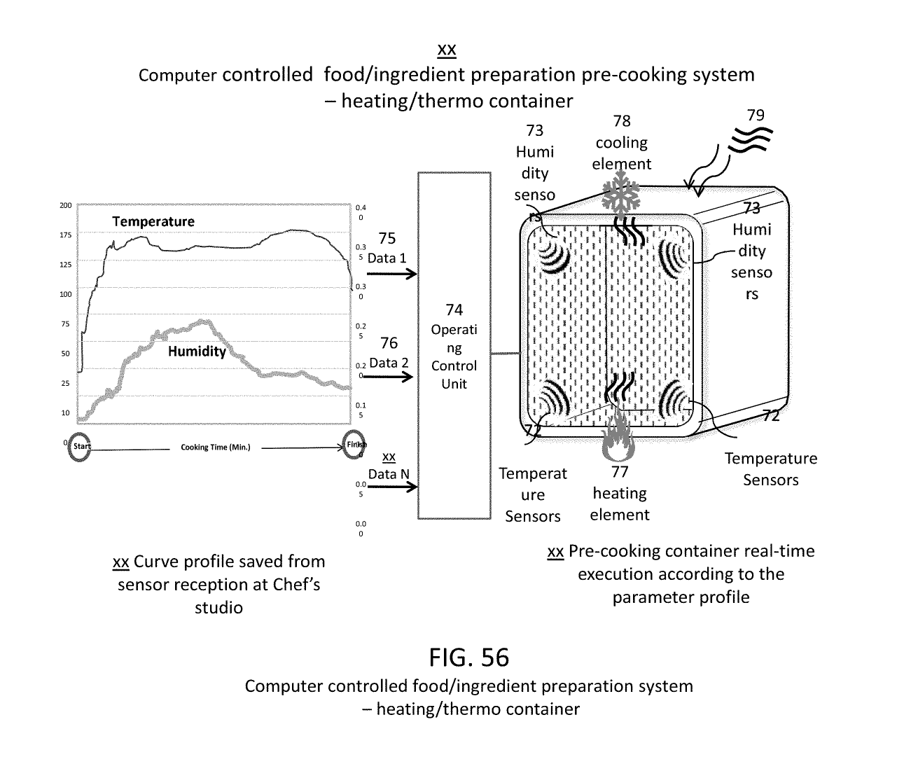

Referring now to FIGS. 55 and 56 of the accompanying drawings, the storage arrangement of some embodiments of comprises heating and/or cooling elements 70, 71 which are positioned respectively on the rear wall and lower wall of the storage unit 46. At least one of the storage units 46 preferably comprises at least one of a heating and cooling element. In a preferred embodiment, the storage arrangement comprises a heating and cooling element 70, 71 positioned on each of the rear wall and the lower surface of the storage unit 46, as shown in FIG. 55. In further embodiments, the storage unit 46 comprises additional heating and/or cooling elements on other side walls of the storage unit 46.

In some embodiments, at least one of the storage units 46 comprises at least one temperature sensor 72 and preferably also comprises at least one humidity sensor 73, as shown in FIG. 56.

The temperature and humidity sensors 72, 73 are connected to a temperature control unit 74. The temperature control unit 74 is configured to process the temperature and humidity sensed by each of the sensors 72, 73 and compare the sensed temperature and humidity with temperature and humidity profile data 75, 76.

The temperature control unit 74 is connected to control a heating element 77 and a cooling element 78 which are positioned adjacent to a side or rear wall of the storage unit 46. A steam generator 79 is preferably also coupled to the temperature control unit 74. The steam generator 79 is configured to introduce humidity into the storage unit 46 to raise the humidity within the storage unit 46.

The control unit 74 senses the humidity and the temperature within the storage unit 46 and controls the temperature and humidity within the storage unit 46 by activating and deactivating selectively the heating and cooling elements 77, 78 and the steam generator 79 to maintain a desired temperature and humidity within the storage unit 46. The control unit 74 can therefore create optimal temperature and humidity conditions within the storage unit 46 for storing a cooking ingredient.

In some embodiments, the control unit 74 is configured to optimize the conditions within the storage unit 46 to store an ingredient for a predetermined length of time. In other embodiments, the control unit 74 is configured to raise or lower the temperature or humidity within the storage unit 46 to prepare an ingredient for cooking at a predetermined time.

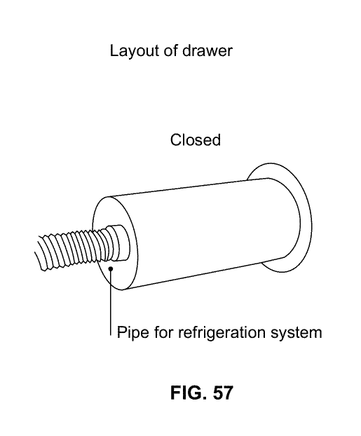

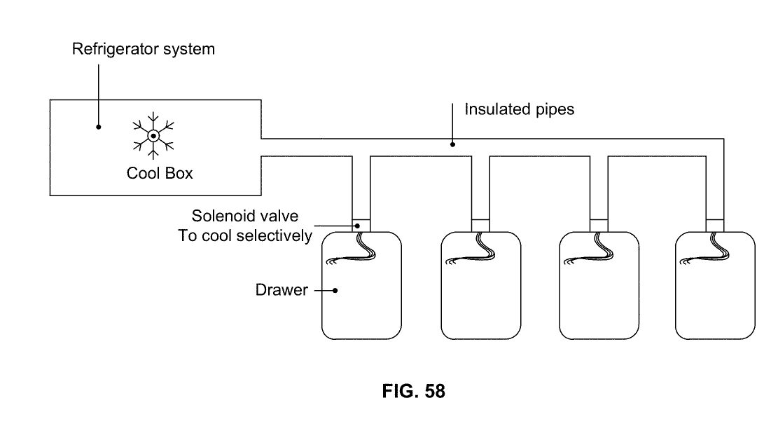

Referring now to FIGS. 57 and 58 of the accompanying drawings, in some embodiments, at least one of the storage units 46 is coupled thermally by an elongate heat transfer element 80 to a cooling unit 81. In this embodiment, the heat transfer element 80 is in the form of an insulated pipe. The heat transfer element 80 is coupled thermally to a cooling aperture 82 which is provided in a rear wall 83 of the storage unit 46.

In other embodiments, a heat transfer element is coupled thermally to a side wall of the storage unit 46 in addition to or instead of or in addition to the rear wall 83.

In this embodiment, the arrangement further comprises an electronically controlled valve in the form of a solenoid valve 84 which is positioned within the heat transfer element 80 in the vicinity of the storage unit 46.

When the solenoid valve 84 is activated to open, the solenoid valve 84 permits heat to be transferred from the storage unit 46, along the heat transfer element 80 to the cooling unit 81 to lower the temperature within the storage unit 46. When the solenoid valve 63 is not activated, the solenoid valve closes to restrict the transfer of heat from within the storage unit 46 to the heat transfer element 80 and the cooling unit 81.

A storage unit of some embodiments is configured to receive a container as described above. In these embodiments, the storage unit is provided with a modified cooling system. The cooling system comprises an electronically controlled cooling device which is preferably a Peltier module which is positioned adjacent to a rear wall or side of the storage unit. The cooling system further comprises a heatsink which is coupled thermally to the Peltier module. The cooling system preferably further comprises a fan and a cooling system housing.

The Peltier module is configured, when activated by a control unit, to transfer heat from the storage unit to the heatsink. The fan draws air across the fins of the heatsink to cool the heatsink and dissipate the thermal energy from the heatsink.

In some embodiments, the control unit is integrated with a central control unit within the kitchen module 1 and the container to provide a computer-controlled ingredient storage and/or preparation system. In some embodiments, the central control unit is configured to store machine readable instructions which, when executed by a processor within the central control unit, store data indicative of the temperature and/or humidity within at least one container based on the temperature and/or humidity sensed by the sensors

In some embodiments, the kitchen module 1 is configured to manage the storage of ingredients within the containers by reading a machine readable identifier provided on a container to identify the container to the control unit. The control unit is configured to use optimized storage data which is preferably stored within a memory in the control unit, for a particular ingredient in order to control the temperature and/or humidity within a container based on temperature and/or humidity data derived from the temperature and/or humidity sensors provided on a container to optimize the storage conditions for the ingredient within the container.

In other embodiments, the kitchen module 1 is configured to utilize ingredient preparation data which is preferably stored within a memory in the control unit, to control the heating, cooling and/or humidification of a container to prepare an ingredient within the container for cooking. In some embodiments, the ingredient preparation data is pre-recorded in the kitchen module 1 or in another identical or similar kitchen module 1. The control unit within the kitchen module 1 is configured to use the ingredient preparation data to prepare ingredients accurately such that the ingredients can be prepared repeatedly and consistently. This enables a robot cooking within the kitchen module 1 to use accurately prepared ingredients in a recipe while minimizing the risk of the recipe going wrong due to incorrectly prepared ingredients.

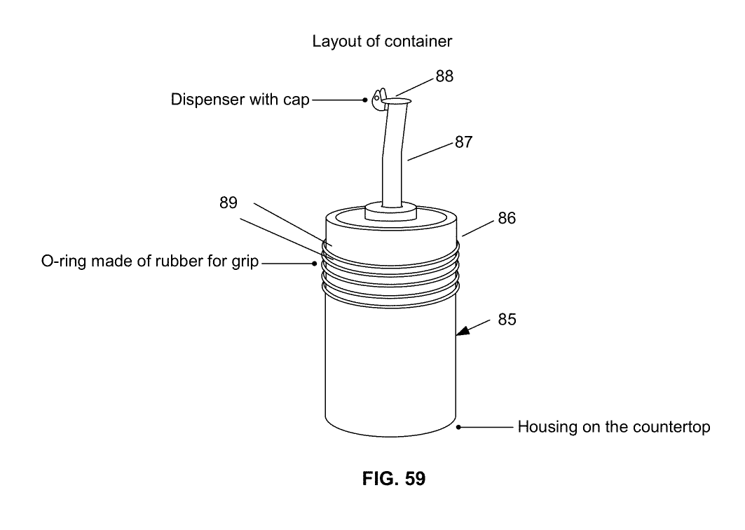

Referring now to FIG. 59 of the accompanying drawings, some embodiments of the invention comprise a modified container in the form of a liquid container 85. The liquid container 85 is preferably of generally circular cross-section and incorporates a liquid container body 86 and a dispenser spout 87. A dispenser cap 88 is provided at the distal end of the dispenser spout 87. The dispenser cap 88 is configured to open automatically as the liquid container 85 is inverted to enable a liquid to flow out from the liquid container 85 via the dispenser spout 87.

The liquid container 85 is provided with at least one or a plurality of grip elements 89. In this embodiment, the grip elements 89 are O-rings which extend around the periphery of the liquid container body 86. The grip elements 89 provide a frictional surface which is in contact with a robot hand holding the liquid container 85, as shown in FIG. 60. The grip elements 89 minimize the risk of the liquid container 85 slipping out from the robot's hand. The grip elements 89 thereby reduce the risk of the liquid container 85 moving within the robot's hand such that the robot can move the liquid container 85 precisely.

Referring now to FIG. 61 of the accompanying drawings, the liquid container 85 is configured to be received within a storage recess 90 which is preferably provided in the work surface 4 of the kitchen module 1. The storage recess 90 storage the liquid container 85 in a predetermined position so that the liquid container 85 can be located and picked up easily by a robot or by a human chef.

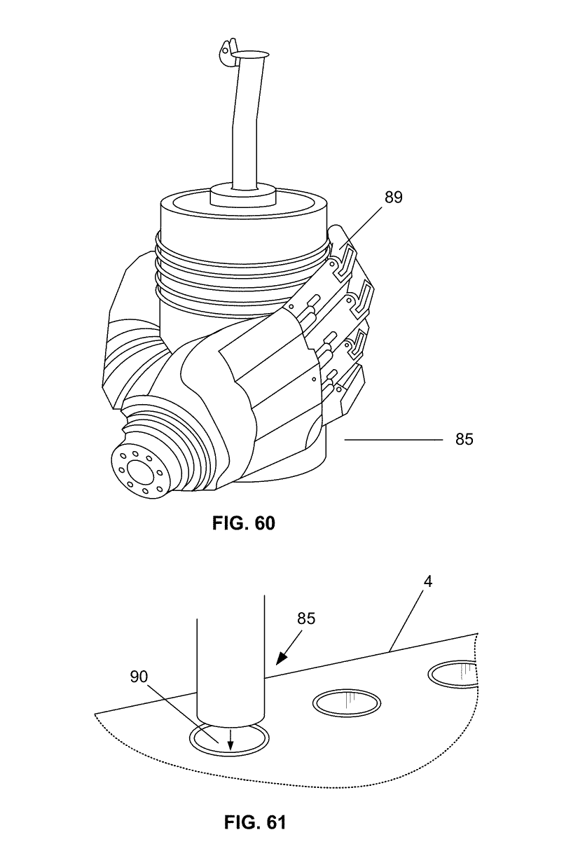

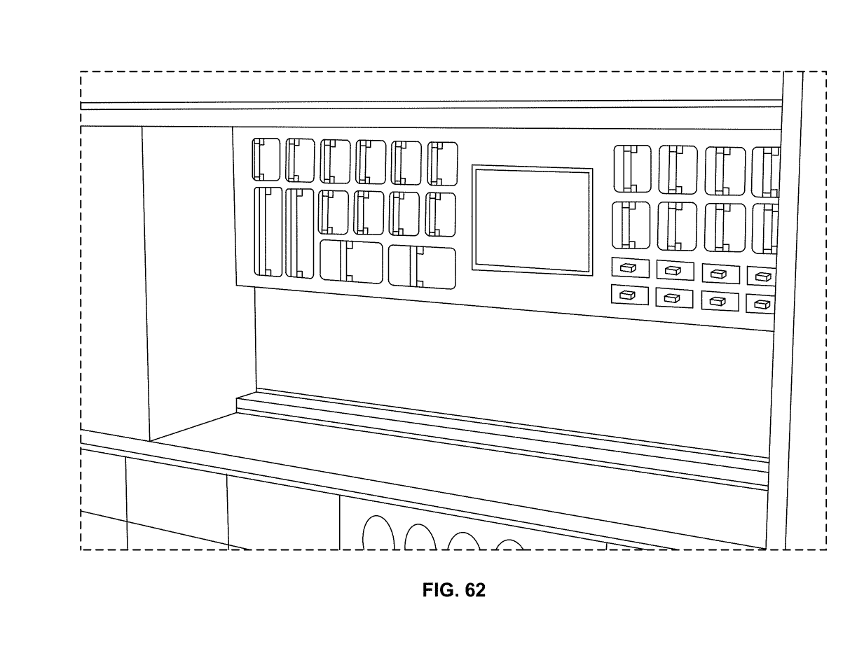

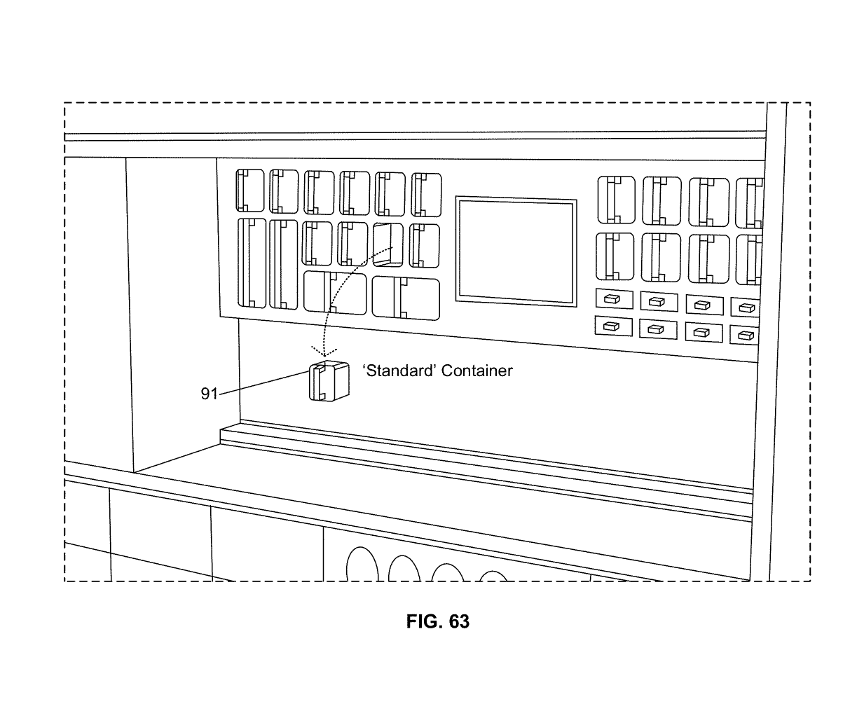

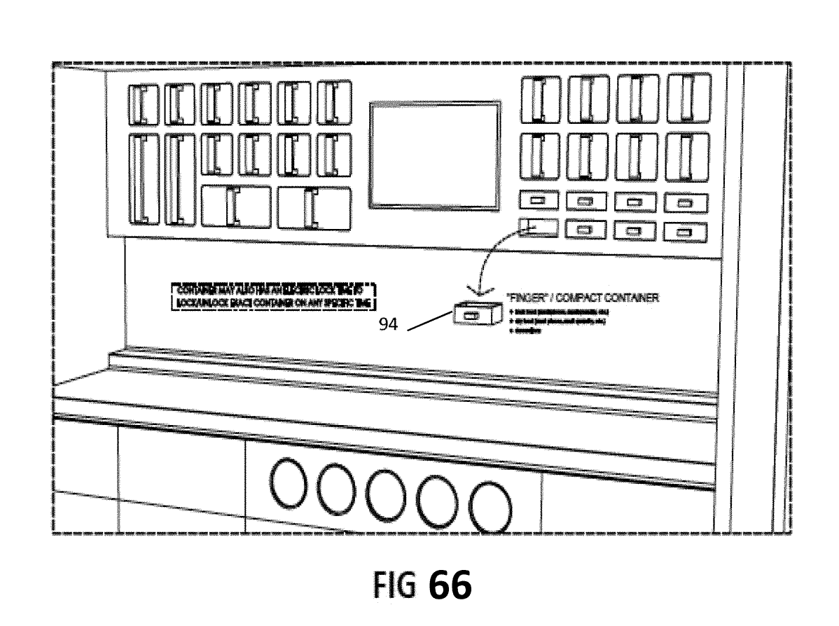

Referring now to FIGS. 62-66 of the accompanying drawings, a storage arrangement of some embodiments is for use with the kitchen module 1 and comprises a plurality of containers having different shapes and dimensions. In this embodiment, the storage arrangement comprises a standard container 91 which is substantially cuboid in shape. The standard container 91 is configured to store ingredients, such as dry food, fresh food or liquids.

The storage arrangement further comprises a large wide container 92 which is wider than the standard container 91. The large wide container 92 is configured to store fresh food, such as meat, fish, etc. or dry food.

The storage arrangement further comprises a tall container 93, which is taller than the standard container 91. The tall container 93 is configured to store fresh food that is elongate, such as asparagus or dry elongate food, such as spaghetti.

The storage arrangement further comprises a compact container 94 which is substantially the same width as the standard container 91 but of reduced height. The compact container 94 is configured to store small pieces and small quantities of fresh or dry food or decorations for use during cooking.

In some embodiments, at least one of the storage units which stores a respective container is provided with a locking arrangement. The locking arrangement is preferably computer-controlled to lock or unlock the container within the storage unit. In some embodiments, the kitchen module is configured to lock a container within a storage unit for a predetermined length of time. In other embodiments, the kitchen module is configured to unlock a container to permit the container to be removed from its storage unit at a predetermined time. The kitchen module can therefore control access to the containers selectively.

In some embodiments, the kitchen module is configured to monitor the freshness of an ingredient within a container, by sensing parameters within the container, such as temperature and humidity and/or by consulting data regarding to the length of time an ingredient is stored within the container and limit access to the container by locking the container within the storage unit to prevent the ingredient being used. This minimizes the risk of a robot or a human chef using ingredients that are past their best.

The electronic locks on the containers further minimize the risk of contamination of an ingredient within a container by restricting access to the container. Ingredients can therefore be stored safely within the storage arrangement to prevent tampering and possible contamination of the ingredients.

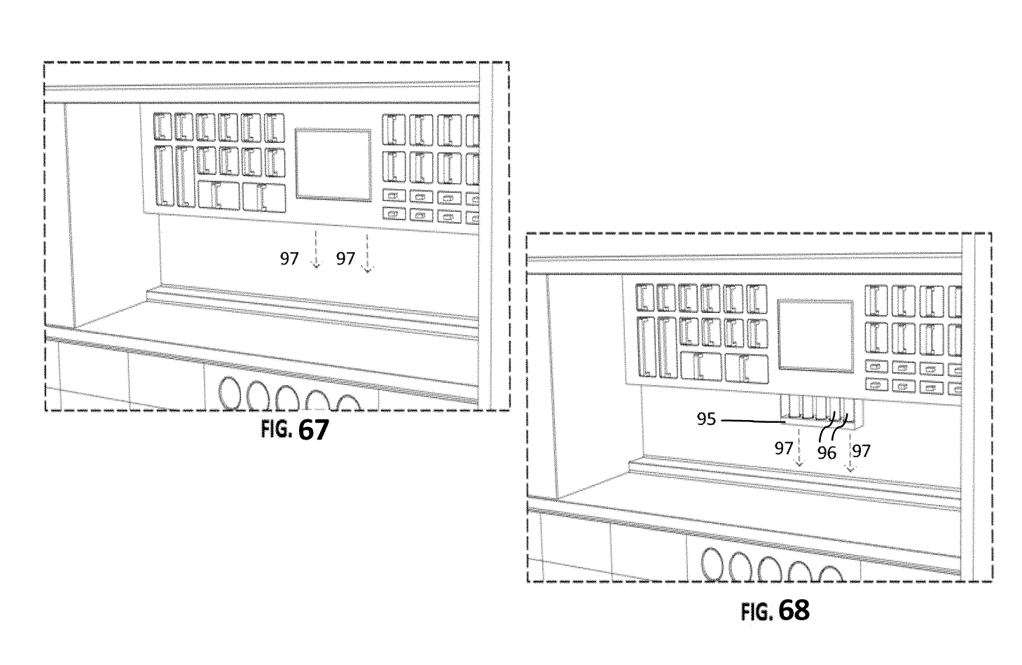

Referring now to FIGS. 67-69, some embodiments of the invention incorporate a movable platform 95 which is moveable from a storage position in which the movable platform 95 and items, such as bottles 96 on the movable platform 95 are concealed behind part of the kitchen module 1, as shown in FIG. 67. The platform 95 is configured to be moved by an electric motor in response to a signal from a control unit to move downwardly, as indicated generally by arrows 97 in FIGS. 67 and 68.

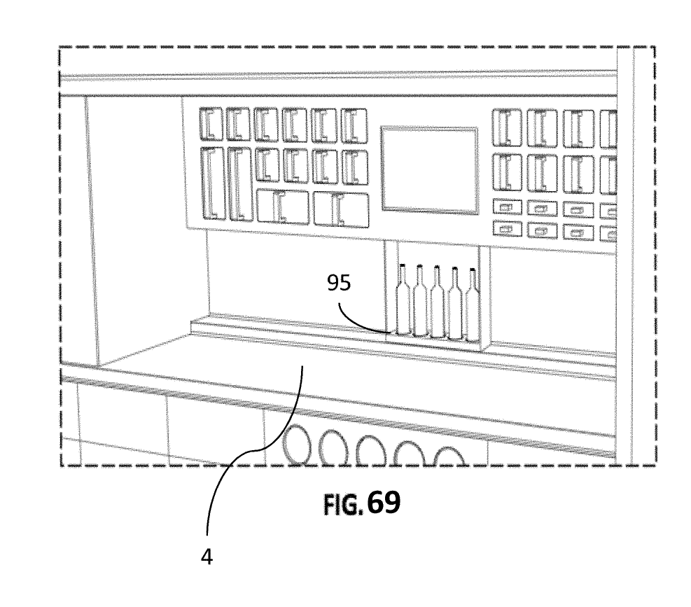

The platform 95 is configured to move downwardly to an accessible position, in which the platform 95 is in the vicinity of the work surface 4, as shown in FIG. 69. In these embodiments, the platform 95 enables ingredients, such as liquids stored within the bottles 96 to be moved between a storage position when the ingredients are not required and an accessible position when the ingredients are required.

In some embodiments, the platform 95 is configured to support a different category of ingredients from cooking ingredients, such as liquor, mixers and other ingredients for cocktails. The platform 95 provides selective access to the ingredients for a human chef and for a robot.

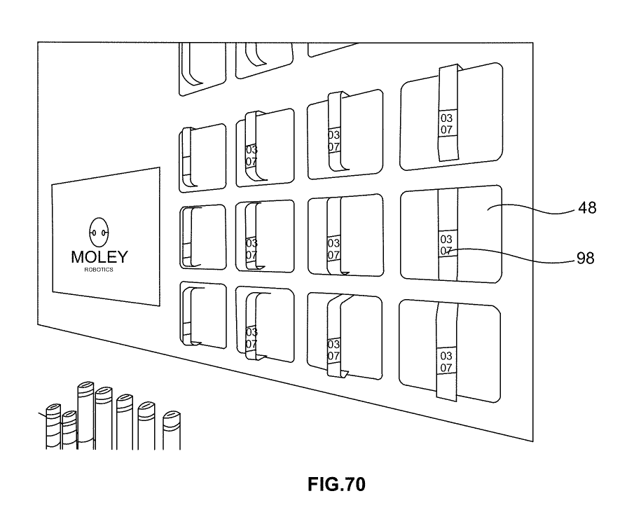

Referring now to FIG. 70 of the accompanying drawings, the containers 48 of some embodiments carry a machine readable identifier 98 which provides includes information about the container and/or the ingredient within the container. The machine readable identifier 98 could, for instance, identify an ingredient stored within the container 48. In some embodiments, the machine readable identifier 98 is a one or two dimensional bar code. In other embodiments, the machine readable identifier is a radio-frequency (RFID) tag.

In further embodiments, at least one of the containers 48 carries a computer-controlled signaling light. The signaling light is configured to identify a container 48 to a user or a robot in response to a signal from a central control unit. The signaling light can therefore indicate to a user or a robot a container which must be accessed or properties of ingredients within the container, such as the freshness of the ingredients or a low level of ingredient.

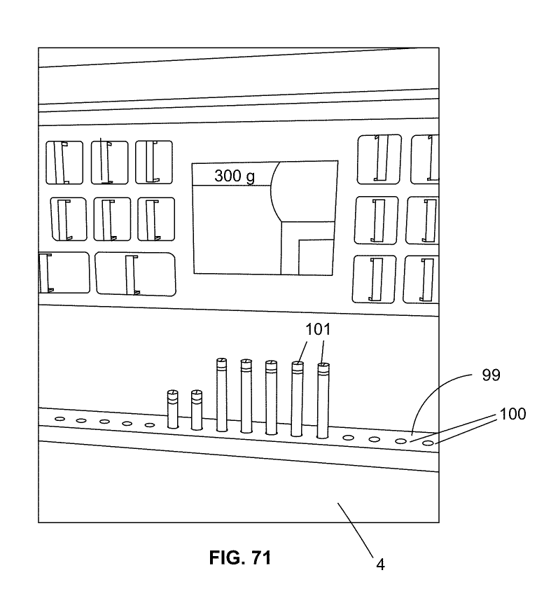

Referring now to FIG. 71 of the accompanying drawings, some embodiments comprise a spice rack 99 which is positioned adjacent to the work surface 4 within the kitchen module 1. The spice rack 99 comprises a plurality of spaced apart indentations 100 which are each configured to receive a respective spice container 101.

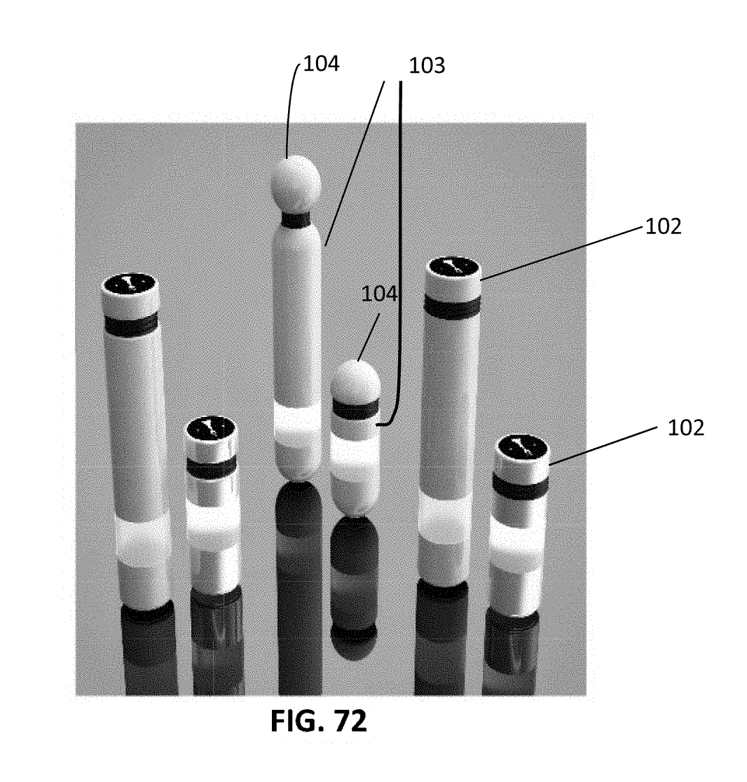

Referring now to FIG. 72 of the accompanying drawings, in some embodiments the spice containers 101 are different lengths. In a preferred embodiment, the spice containers 101 are generally cylindrical containers which are each provided with a lid 102. The lids 102 are configured to enable a robot or human hand to open the spice container 101. In this embodiment, further spice containers 103 are provided with modified lids 104. The modified lids 104 are shaped to facilitate the spice containers 103 being opened by a robot hand.

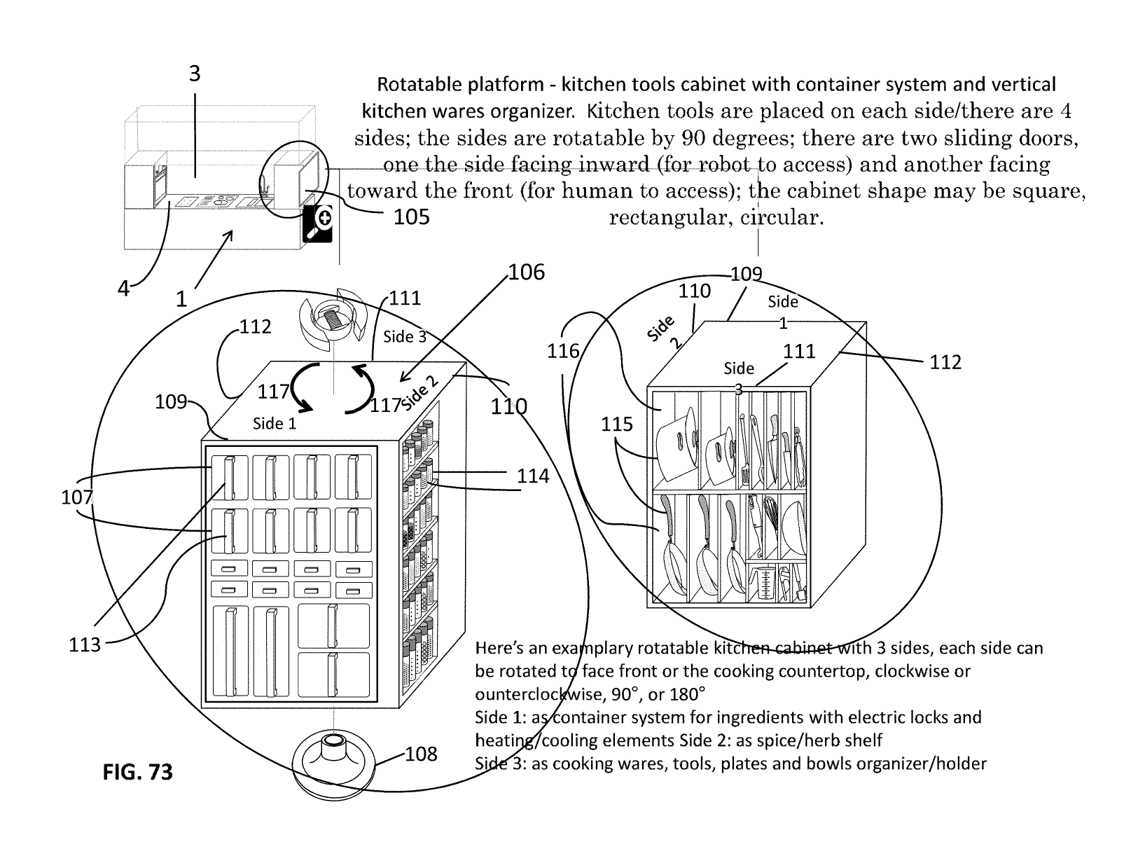

Referring now to FIG. 73 of the accompanying drawings, a storage arrangement 105 of some embodiments is a moveable storage arrangement that is configured to be moveably mounted within a kitchen module 1. The moveable storage arrangement 105 is preferably located at one end of the work surface 4 of the kitchen module 1, as shown in FIG. 73.

The moveable storage arrangement 105 comprises a housing 106 which incorporates a plurality of storage units 107. The storage arrangement 105 further comprises a rotatable mounting system 108 which is coupled to the housing 106 to enable the housing 106 to be rotatably mounted to a support structure, such as the work surface 4. The housing 106 comprises a plurality of sides. In this embodiment the housing 106 comprises four sides 109-112. At least one of the sides 109-112 comprises a plurality of storage units 107 which are each configured to carry a container 113.

In some embodiments, a side 110 of the housing 106 is configured to store cooking items, such as herbs 114. The herbs 114 are, for instance, stored in small containers that are positioned on shelves on a side 110 of the housing 106.

In this embodiment, the housing 106 further comprises a side 111 which is configured to store cooking utensils 115. The cooking utensils 115 are stored in a plurality of compartments 116 in the side 111 of the housing 106. The compartments 116 are preferably of different sizes and dimensions to receive a utensil of a corresponding size and dimension.

In other embodiments, the housing 116 is provided with a greater or smaller number of sides than the four sides indicated in the embodiment shown in FIG. 73. For instance, in some embodiments, the housing 106 has a substantially circular side wall, with a side of the housing 106 being a portion of the substantially circular side wall.

The storage arrangement 105 is configured to rotate about an axis, as indicated by arrows 117 in FIG. 73. The storage arrangement 105 is preferably driven by a computer-controlled electric motor. In some embodiments, the storage arrangement 105 is configured to rotate when moved by a human or robot hand.

The storage arrangement 105 is configured to rotate to present different sides 109-112 to a human chef or a robot. In the event that a robot is required to access a side 109-112 of the storage arrangement 105, the storage arrangement 105 is rotated such that the relevant side 109-112 is facing towards the recess 3 of the kitchen module 1 so that robot arms within the recess 3 can access the side 109-112 of the storage arrangement 105.

The storage arrangement 105 is configured to rotate clockwise or anti-clockwise by 90° or 180°. In a further embodiment, the storage arrangement 105 is configured to rotate by 360° to present any side of the storage arrangement 105 to a human or robot user.

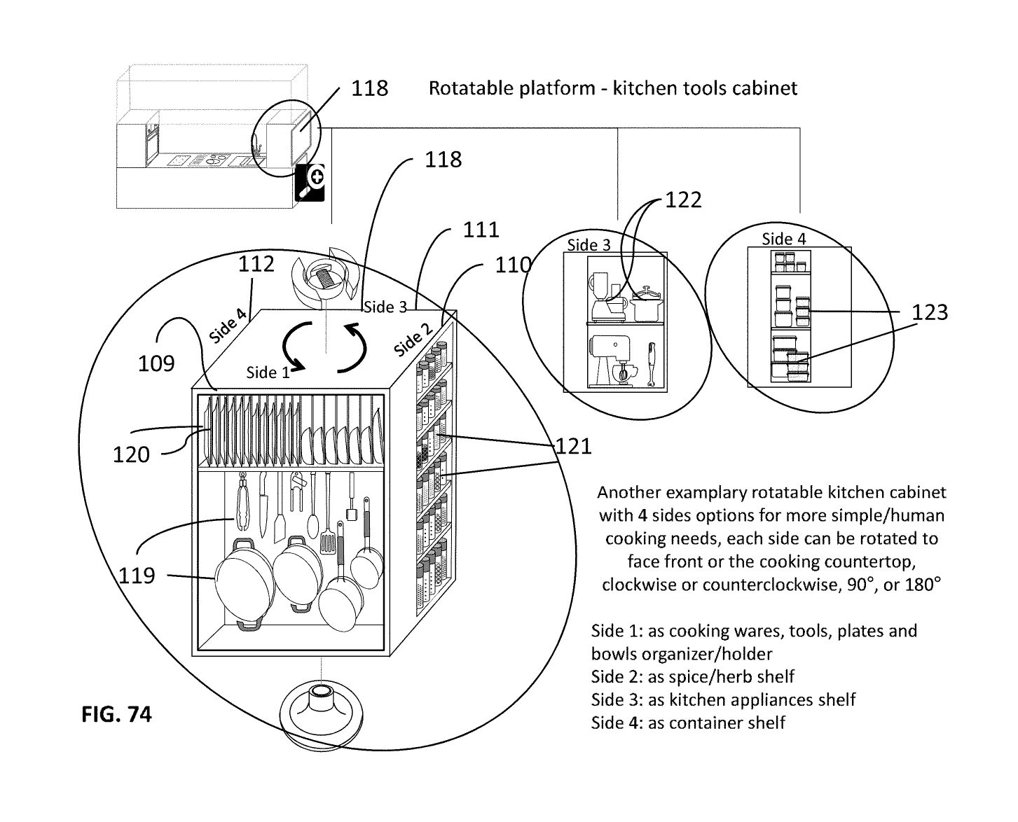

Referring now to FIG. 74 of the accompanying drawings, a storage arrangement 118 of further embodiments of the invention is similar to the storage arrangement 105 described above, except that the sides 109-112 of this storage arrangement 118 are configured to store different cooking utensils 119 and crockery 120 on one side 109, herbs 121 on a second side 110, kitchen appliances 122 on a third side 111 and storage containers 123 on a fourth side 112.

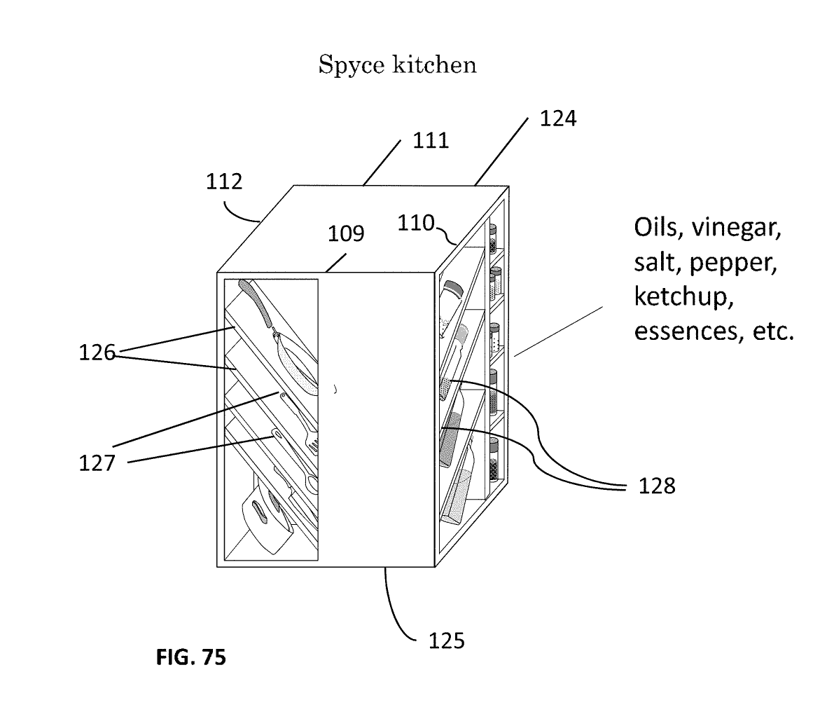

Referring now to FIG. 75 of the accompanying drawings, a storage arrangement 124 of other embodiments is similar to the storage arrangement 105 described above, except that the storage arrangement 124 comprises a substantially planar base 125 and at least one shelf element 126 which is fixed at an angle relative to the plane of the base 125. At least one of the sides 109-112 of the storage arrangement 124 comprises an angled shelf element 126. Each angled shelf element 126 is provided within a recess on one of the sides 109-112 of the storage arrangement 124. In preferred embodiments, the storage arrangement 124 comprises a plurality of spaced apart shelf elements 126 which are each substantially parallel to one another and at an angle relative to the plane of the base 125. In one embodiment, each shelf element is preferably fixed at approximately an angle between 30° and 50° relative to the plane of the base.

The shelf elements 126 retain items, such as the utensils 127 and the storage containers 128, in an angled configuration in the storage arrangement 124. The items rest at a lower end of each of the angled shelf elements 126 under the influence of gravity. The items on the shelf elements 126 therefore rest naturally at a known location at one end of the shelf element 126. This makes it easier for a robot to locate an item on one of the shelf elements 126.

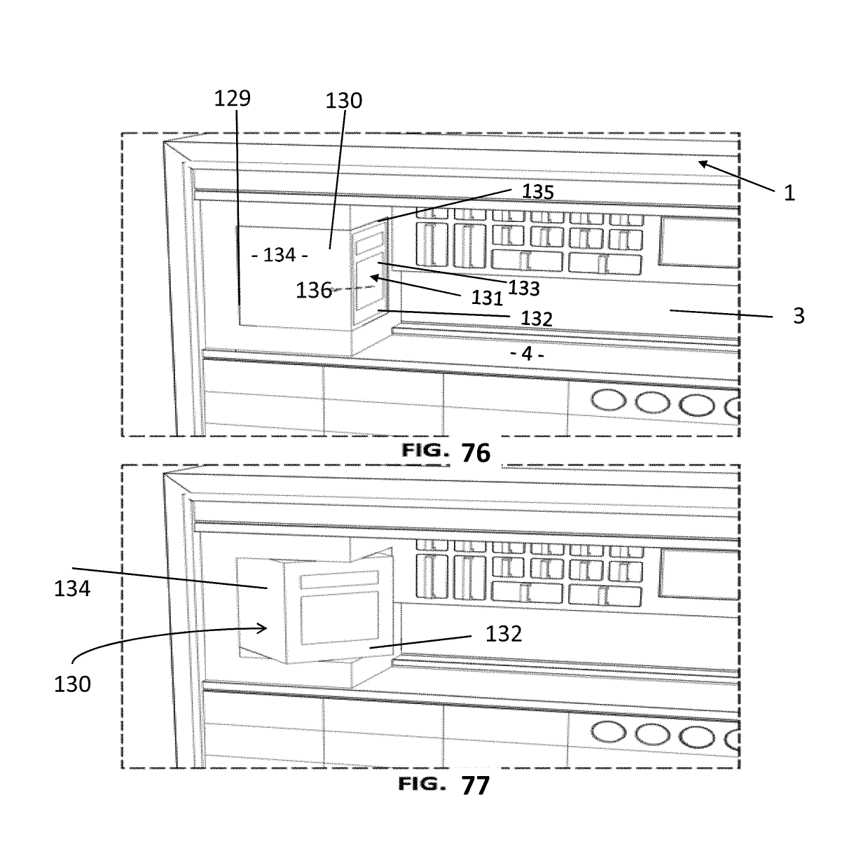

Referring now to FIG. 76 of the accompanying drawings, a kitchen module 1 of some embodiments of the invention comprises a cooking system 129. The cooking system 129 comprises a cooking appliance 130 having a heating chamber 131. In preferred embodiments, the cooking appliance is an oven. In further embodiments, the oven is a steam oven. In yet further embodiments, the cooking appliance 130 comprises a grill. For simplicity, the following description will refer to the cooking appliance as an oven 130.

The cooking system 129 further comprises a mounting arrangement (not shown) having a first support element that is carried by the oven 130 and a second support element that is configured to be attached to a support structure in a kitchen. The first and second support elements are moveably coupled to one another to permit the first support element and the oven 130 to move relative to the second support element between a first position and a second position.

In some embodiments, such as the embodiment shown in FIG. 76, the oven 130 is mounted at one end of the kitchen module 1, on top of the work surface 4 and at one end of the recess 3.

The oven 130 comprises a front face 132 which is provided with an oven door 133 which provides access to the heating chamber within the oven 130. The oven 130 further comprises opposing side walls 134, 135.

The oven 130 is configured to operate in a first position in which the front face 132 of the oven 130 faces towards the recess 3 of the kitchen module 1, as shown in FIG. 76. The first side wall 134 of the oven 130 faces outwardly from the kitchen module 1. In this first position, the front face 132 of the oven 130 is accessible by robot arms operating within the recess 3 of the kitchen module 1. The oven 130 is therefore configured for use by a robot that is operating in the kitchen module 1.

The oven 130 is configured to rotate about its central axis in a direction generally indicated by arrow 136 in FIG. 36.

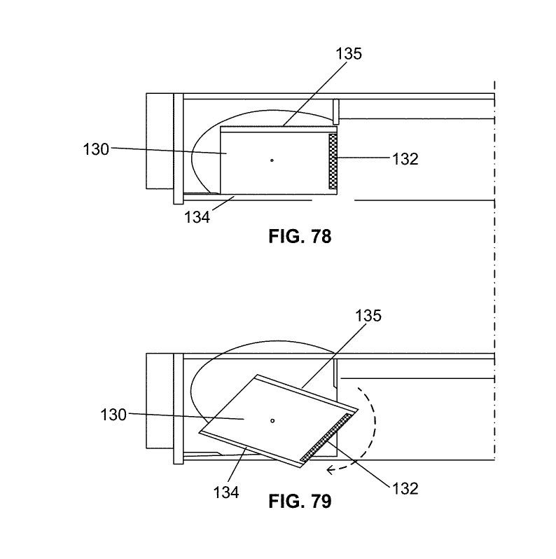

Referring now to FIGS. 77-79, the oven 130 is configured to rotate by substantially or exactly 45°, as shown in FIGS. 77 and 79. When the oven 130 is in the 45° rotated position, the oven 130 is in a second position in which the front face 132 of the oven 130 faces substantially outwardly from the kitchen module 1. In this second position, a human chef standing adjacent to the kitchen module 1 can gain access to the front face 132 of the oven 130 and use the oven 130 for cooking. In this second position, the oven 130 is not configured for use by robot arms operating within the recess 3 of the kitchen module 1.

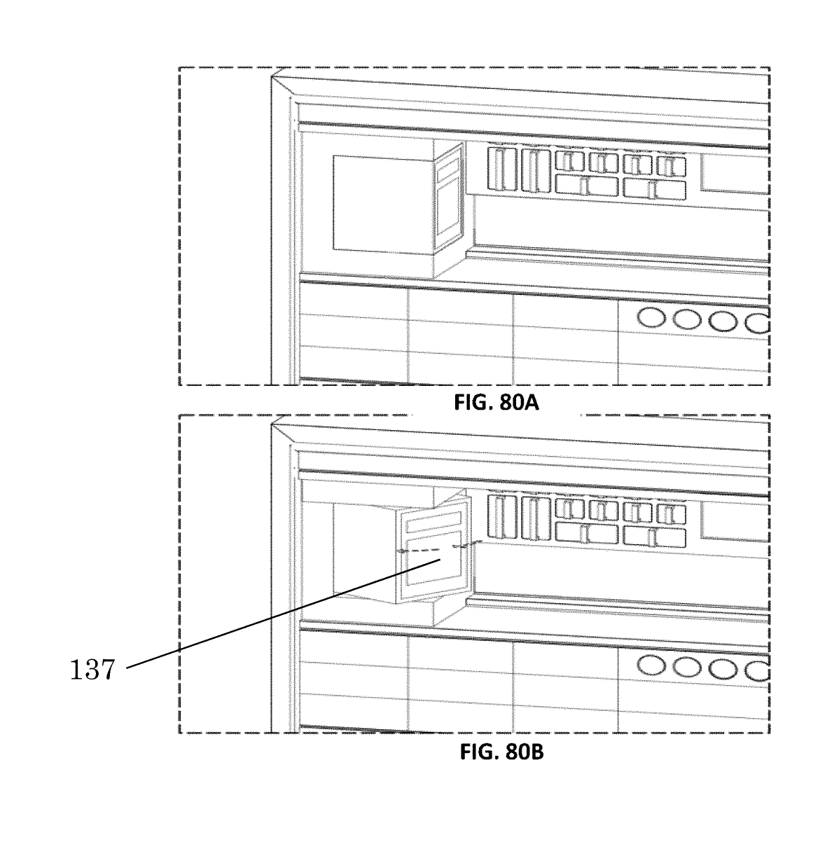

Referring now to FIGS. 80A-80B of the accompanying drawings, in some embodiments, the oven 130 is configured to rotate further beyond the 45° first position by rotating as indicated generally by arrows 137 in FIG. 80B. The oven 130 is configured to rotate by a further 45° to a further second position in which the front face 132 of the oven 130 is rotated by substantially or exactly 90° from the first position, as shown in FIGS. 81A-81B. In this further second position, the front face 132 of the oven 130 is accessible by a human chef standing adjacent to the kitchen module 1. In this further second position, the front face 132 of the oven 130 is not accessibly by robot arms operating within the recess 3 of the kitchen module 1.

While the oven 130 of embodiments described above is configured to rotate, in further embodiments, the oven 130 is configured to move transversely relative to the kitchen module 1 instead of or in addition to the rotational movement.

When the oven 130 is in the first position, as shown in FIG. 76, and configured for use by robot arms operating within the recess 3 of the kitchen module 1, the glass barrier 24 which substantially closes the recess 3 shields the front face 132 of the oven 130 from a human chef so that the human chef cannot use the oven 130. When the robot is using the oven 130, the robot and the front face 132 of the oven 130 are shielded by the glass barrier 24 from a human chef for safety purposes so that the human chef cannot access the oven 130 or the arms of the robot which might be carrying a hot item taken out from the oven 130.

In the embodiments described above, the kitchen module 1 provides a structured environment in which a robot, such as the robot arms 13 can operate. The storage arrangements in the kitchen module 1 store the plurality of containers in predetermined positions which are known to the robot. The positions of the other components of the kitchen module 1, such as the rotatable oven 130, the hob 5, sink 6 and the dishwasher unit 6A are all predetermined and their positions are known to the robot. A robot, such as the robot arms 13, can therefore perform operations within the kitchen module 1 and interact with the components of the kitchen module 1 easily and without error.

A robot can perform precise manipulations within the kitchen module 1 in order to follow a recipe and prepare food or drinks within the kitchen module 1 using ingredients stored within the containers. The predetermined layout of the containers within the kitchen module 1 minimizes the risk of an error occurring during the cooking process by ensuring that all of the components and ingredients required by the robot are in predetermined locations which can be accessed easily and quickly by the robot. The robot can therefore prepare food or drinks within the kitchen module 1 at a speed which is similar to or faster than a human preparing food or drinks within the kitchen module 1.

A robot within the kitchen module 1 is preferably configured to identify a container 48 by reading the machine readable identifier 98 on the container 48 to determine the ingredient stored within the container 48. The machine readable identifier 98 is preferably also configured to provide the robot with additional information regarding the ingredient, such as the volume or weight of the ingredient within the container 48. The robot can therefore use the information provided by the machine readable identifier 98 on each container 48 when the robot is preparing food or drink so that the robot can utilize the ingredient in a recipe without the robot having to measure out or analyze the ingredient within the container 48.

In embodiments of the invention, the robot is a computer-controlled robot which is configured to move and perform manipulations within the kitchen unit 1 in response to commands from a control unit. The control unit comprises a memory storing machine readable instructions which are configured for execution by a processor. The memory is configured to store recipe data for use by the robot. In some embodiments, the recipe data comprises at least a list of ingredients and preparation step that are to be used by the robot to follow the recipe. In some embodiments, all of the ingredients that are required for use by the robot are pre-prepared and stored within the containers within the kitchen module 1 so that the robot can follow the recipe and prepare food or drink using the pre-prepared ingredients.

In some embodiments, the manipulations that are to be performed by the robot are stored as predetermined manipulation data within the memory in the control unit. The predetermined robot manipulations are preferably pre-recorded manipulations that mimic or at least partly match the movements of a human chef operating within the kitchen module 1.

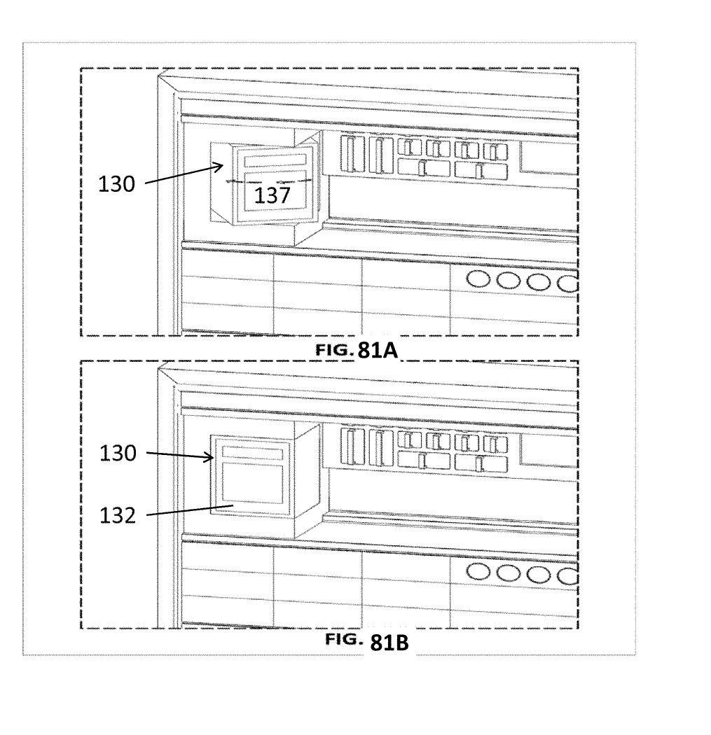

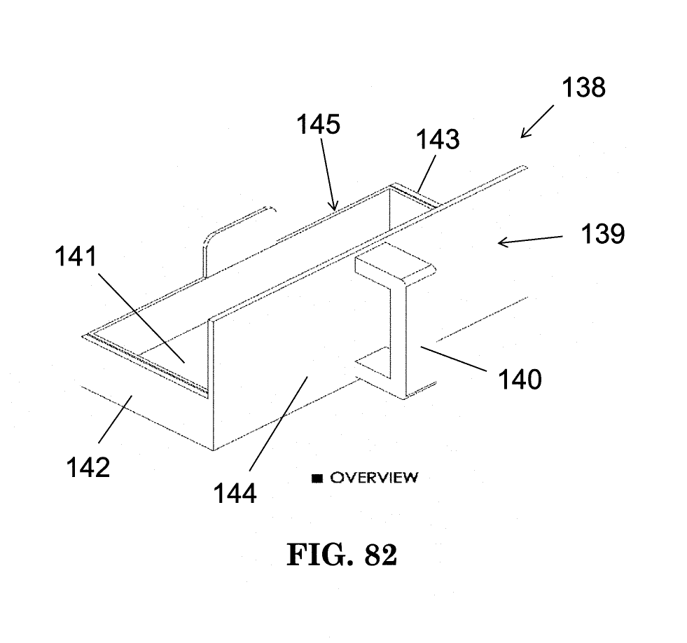

Referring now to FIG. 82 of the accompanying drawings, a container arrangement 138 of some embodiments is preferably configured for use as a container in the storage arrangement 8 described above. The container arrangement 138 comprises a first part 139 which carries a handle 140. The handle 140 is preferably the same configuration as the handles of the embodiments described above.

The first part 139 comprises a generally planar base 141. Two spaced apart side walls 142, 143 extend upwardly from the base 141 on opposing sides of the base 141. A front face 144 extends upwardly from a front edge of the base 141. The front face 144 is coupled to or formed integrally with the side walls 142, 143 and preferably extends upwardly above the upper edges of the side walls 142, 143, as shown in FIG. 82.

The container arrangement 138 further comprises a second part 145 which is movably mounted to the first part 139.

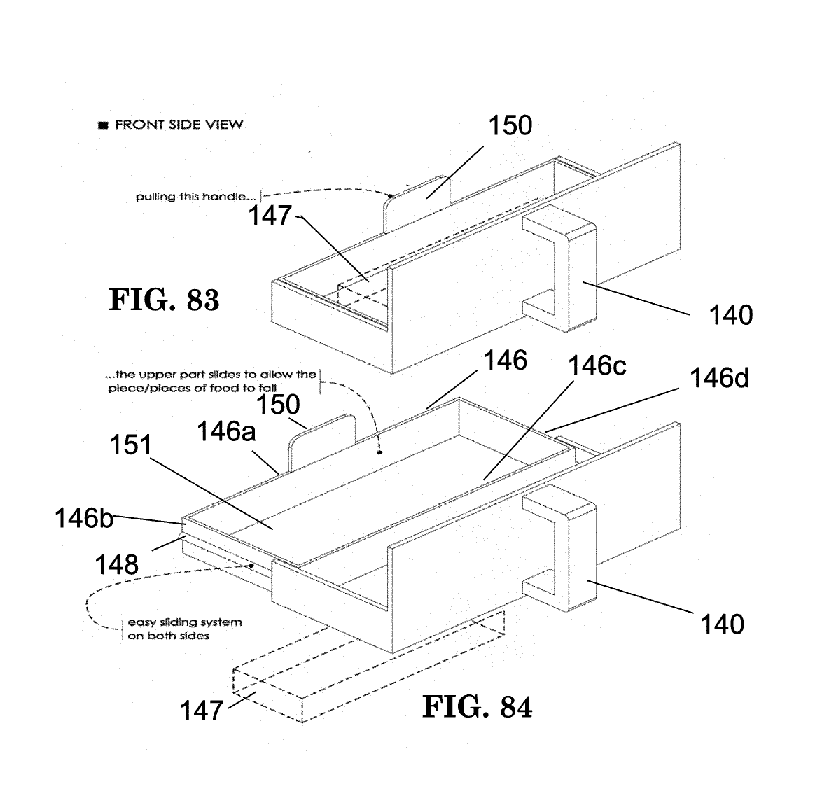

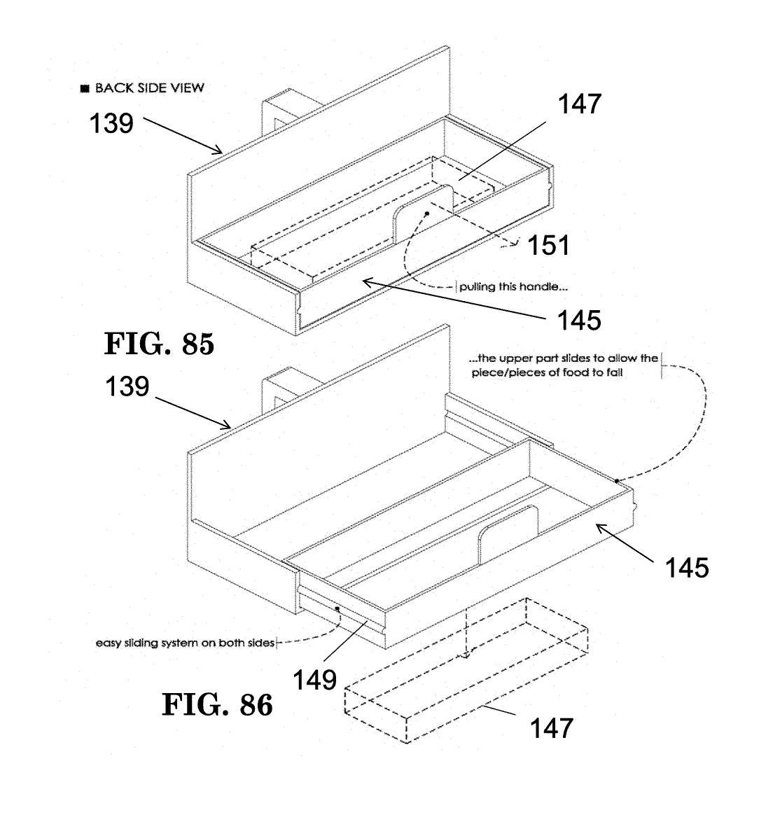

Referring now to FIGS. 83-86, the second part 145 of the container arrangement 138 comprises a wall 146 which is composed of four connected side walls 146a-d, as shown in FIG. 44. The side walls 146a-d are arranged preferably in a rectangular configuration. The side wall 146 of the second part 145 at least partly surrounds a food stuff 147 positioned on the base 141 of the first part 139, as shown in FIG. 43.

The opposing side walls 146b and 146d of the second part 145 are movably mounted to the side walls 142, 143 of the first part 139 by a moveable mounting arrangement. The moveable mounting arrangement preferably comprises rails 148, 149 which permit the second part 145 to slide and move easily relative to the first part 139.

The rear side wall 146a of the second part 145 is preferably provided with a handle element 150 which projects upwardly from the wall 146a.

In preferred embodiments, such as the embodiment shown in FIGS. 82-86, the second part 145 has an open lower aperture 151.

The container arrangement 138 is configured to contain or store a foodstuff 147. The foodstuff 147 rests on the base 141 of the first part 139 when the foodstuff 147 is stored within the container arrangement 138. When the foodstuff 147 is needed, for instance when the foodstuff 147 is to be used in a recipe, the container arrangement 138 is removed from the storage arrangement by a robot or human hand acting on the handle 140. For simplicity, the following description will refer to the use of the container arrangement 138 by a robot.

In order to position the foodstuff 147 at a desired location, a robot positions the container arrangement 138 above the desired location. The robot then pulls the handle element 150 in the direction generally indicated by arrow 151 in FIG. 83 to move the second part 145 of the container arrangement 138 away from the front face 144 of the first part 139 of the container arrangement 138. The second part 145 moves relative to the first part 139 and, in doing so, part of the second part 145 which, in this embodiment, is the side wall 146c acts on the foodstuff 147 to move the foodstuff 147 relative to the first part 139. As the second part 145 continues to be moved relative to the first part 139, the foodstuff 147 is pushed by the side wall 146c off the base 141. The foodstuff 147 then falls under the action of gravity through the opening 151 in the lower end of the second part 145, as shown in FIGS. 84 and 86.

The configuration of the moveable first and second parts 139, 145 of the container arrangement 138 is optimized for use by a robot by enabling the robot to remove a foodstuff 147 from within the container arrangement 138 easily. The configuration avoids the need for the hand of the robot to touch or attempt to pick a foodstuff out from within the container arrangement 138. The configuration provides an efficient arrangement for removing a foodstuff from within the container arrangement 138 without touching the foodstuff. Furthermore, the scraping effect of the second part 145 relative to the first part 139 removes the foodstuff from within the container arrangement 138 efficiently and minimizes waste to foodstuff that might otherwise remain within the container arrangement 138.

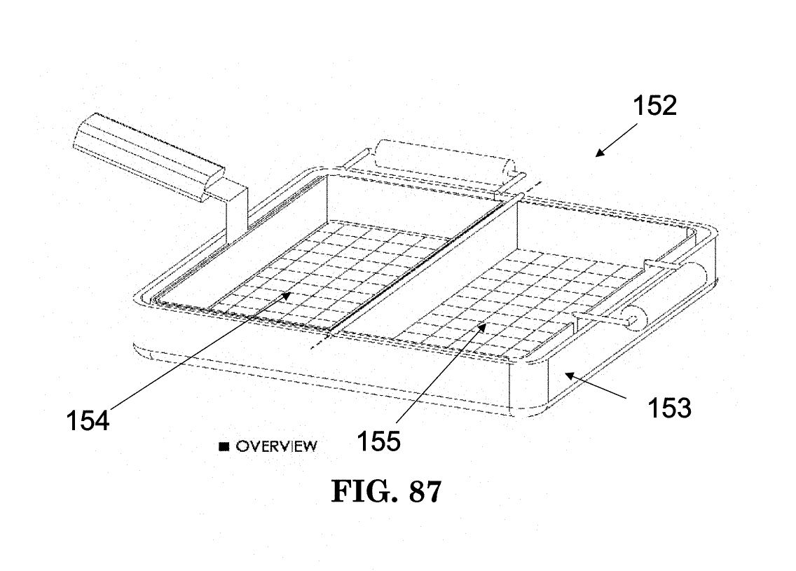

Referring now to FIGS. 87-89 of the accompanying drawings, a cooking arrangement 152 of some embodiments comprises a support frame 153, a container arrangement 154 and a cooking part 155. The three components of the cooking arrangement 152 are described below.

The support frame 153 preferably comprises a generally rectangular side wall 156 which is composed of two opposing side walls 156a-b and two opposing end walls 156c-d. The support frame 153 preferably comprises open upper and lower ends.

The support frame 153 preferably comprises a lower retaining lip 157 which extends around the periphery of the lower edge of the walls 156a-d of the support frame 153. The retaining lip 157 extends generally inwardly to support a lower portion of the container arrangement 154 and the cooking part 155 when the container arrangement 154 and the cooking part 155 are placed within the support frame 153, as shown in FIG. 87. It is, however, to be appreciated that in other embodiments, the retainer lip 157 is omitted from the support frame 153.

The cooking part 155 comprises a generally planar cooking base 158. The cooking base 158 is a smooth or non-stick surface in some embodiments. In other embodiments, the cooking base 158 provided with ridges so that the cooking base 158 functions as a griddle pan.

The cooking part 155 comprises an upstanding side wall 159 which at least partly surrounds the cooking base 158 to substantially surround and contain food cooking on the cooking base 158. The side wall, 159 is provided with a handle 160. The handle 160 is mounted to the side wall 159 by handle supports 161, 162. In a preferred embodiment, the handle 160 is rotatably mounted to the handle supports 161, 162.

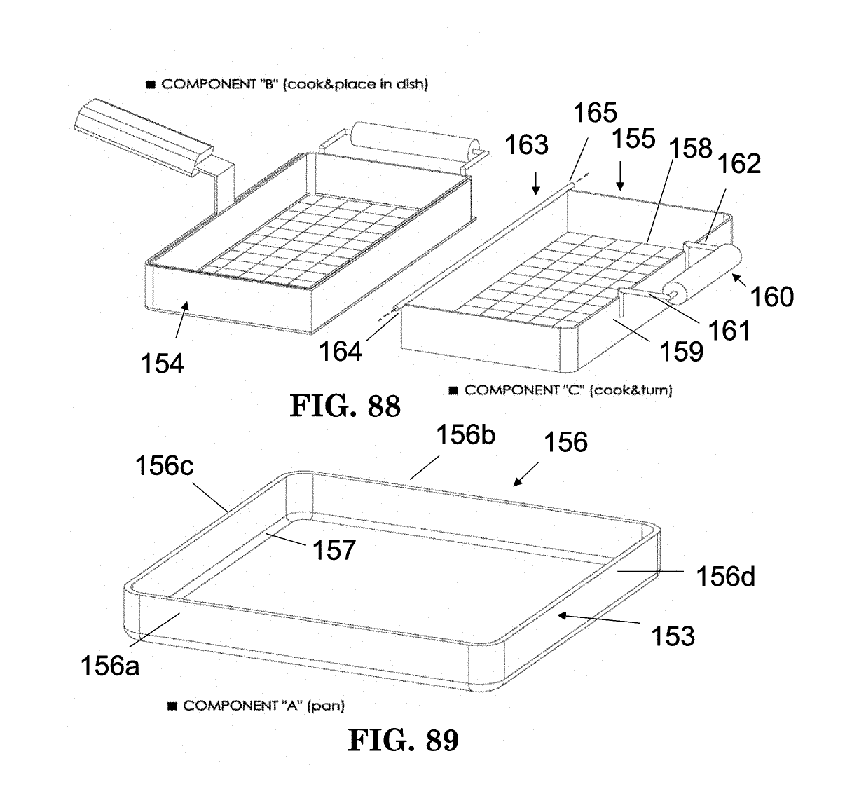

The cooking part 155 further comprises a pivot member 163 which is provided on the side wall 159 on an opposite side of the cooking part 155 to the handle 160. The pivot member 163 comprises two pivot elements 164, 165 which project outwardly from each side of the cooking part 155, as shown in FIG. 88.

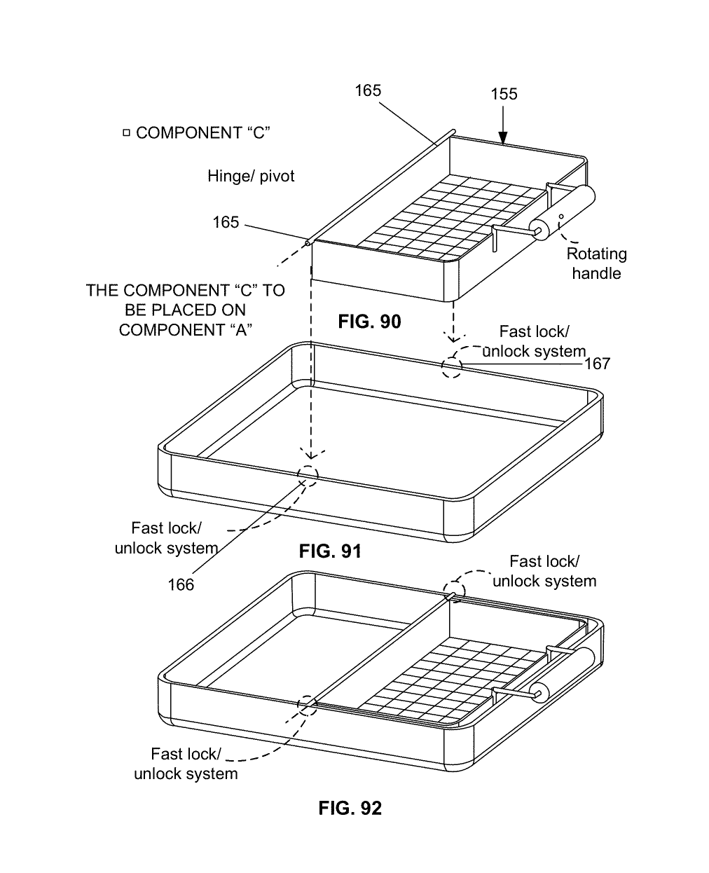

Referring now to FIGS. 90-92 of the accompanying drawings, the cooking part is configured to be retained within the support frame 153 by inserting the cooking part 155 into a portion of the support frame 153. When the cooking part 155 is fully inserted into the support frame 153, the pivot elements 164, 165 engage with respective retainer arrangements 166 and 167 which are provided adjacent to an upper edge of the side walls 156a-b of the support frame 153.

The retainer arrangements 166, 167 retain the pivot elements 164, 165 such that the cooking part 155 is retained within the support frame 153, as shown in FIG. 92. In some embodiments, the retainer arrangements 166, 167 are configured to releasably lock the pivot elements 164, 165 in engagement with the support frame 153. The retainer arrangements 166, 167 are preferably fast lock/unlock system to enable the cooking part 155 to be quickly locked into or released from the support frame 153.

As will be discussed in more detail below, the pivot elements 164, 165 are pivotally mounted by the retainer arrangements 166, 167 to the support frame 153 to enable the cooking part 155 to rotate about the pivot member 163 relative to the support frame 153.

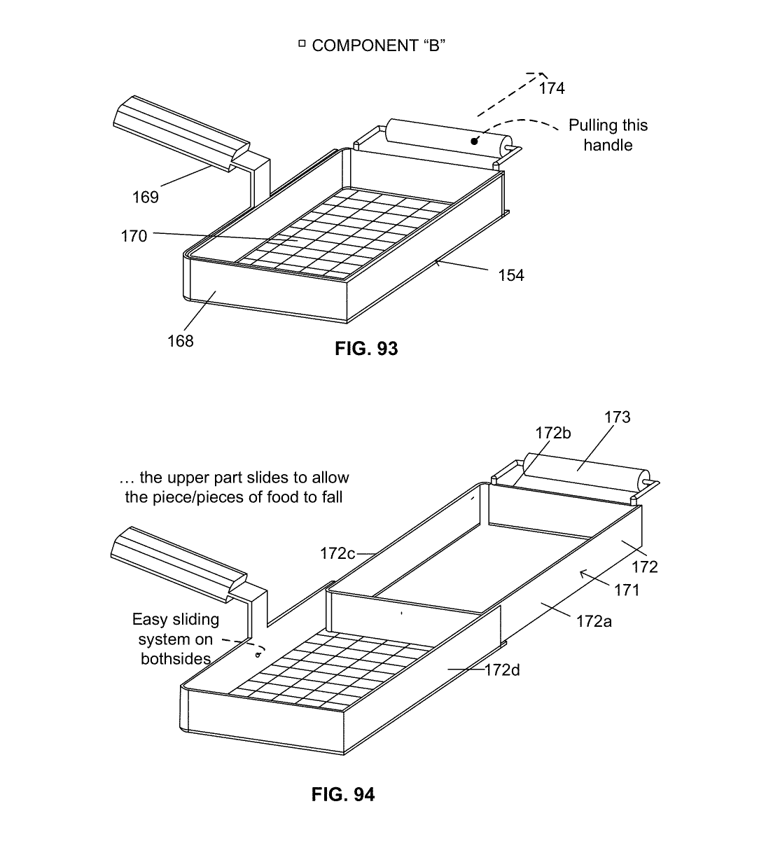

Referring now to FIGS. 93 and 94 of the accompanying drawings, the container arrangement 154 comprises a first part 168 which carries a handle 169. The first part 168 comprises a base 170 which is preferably a cooking surface.

The container arrangement 154 comprises a second part 171 which is moveably mounted to the first part 168. The moveable mounting is preferably a configuration of slide rails which permit low friction translational movement of the second part 171 relative to the first part 168.

The second part 171 comprises a generally rectangular wall 172 which is composed of our adjoined wall sections 172a-d. The wall 172 is configured to surround or substantially surround food resting on the base 170 of the first part 154 when the second part 171 of the container arrangement 154 is inserted into the first part 168 of the container arrangement 154, as shown in FIG. 93.

The end wall 172b of the second part 171 of the container arrangement 154 comprises a further handle 173. The handle 173 is configured to be pulled in a direction generally indicated by arrow 174 in FIG. 53 so that the second part 171 slides out from the first part 168. As the second part 171 slides out from the first part 168, the end wall 172d which is opposite to the wall 172b carrying the further handle 173 acts on food on the base 170 of the first part 168. The end wall 172d of the second part 171 pushes and scrapes the food off the base 170. The container arrangement 154 therefore allows a robot or a human to remove food from within the container arrangement 154 without touching the food. Furthermore, the translational scraping effect of the second part 171 relative to the first part 168 maximizes the food which is removed from the first part 168, thereby minimizing waste.

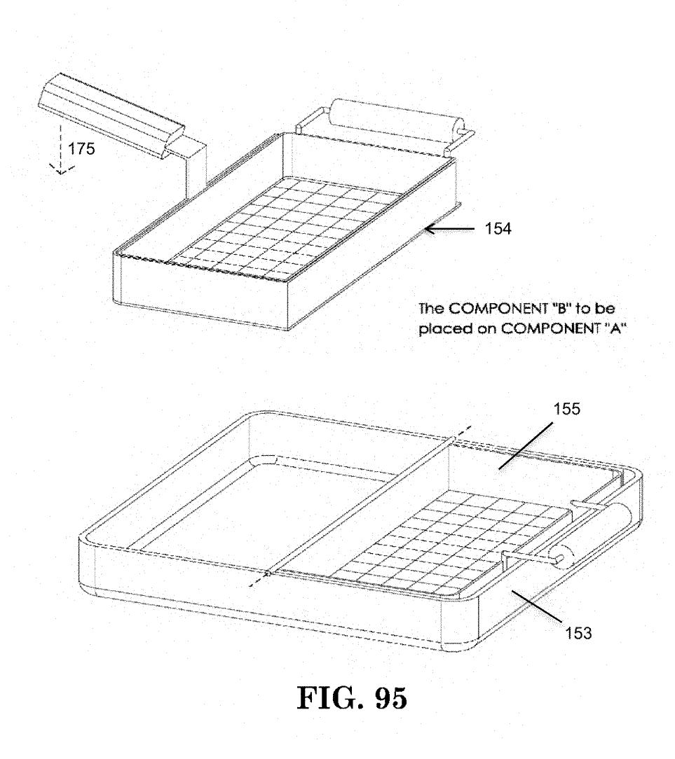

Referring now to FIG. 95 of the accompanying drawings, the container arrangement 154 is configured to be inserted downwardly in the direction generally indicated by arrow 175 into the support frame 153 so that the container arrangement 154 is positioned adjacent to the cooking part 155 within the support frame 153.

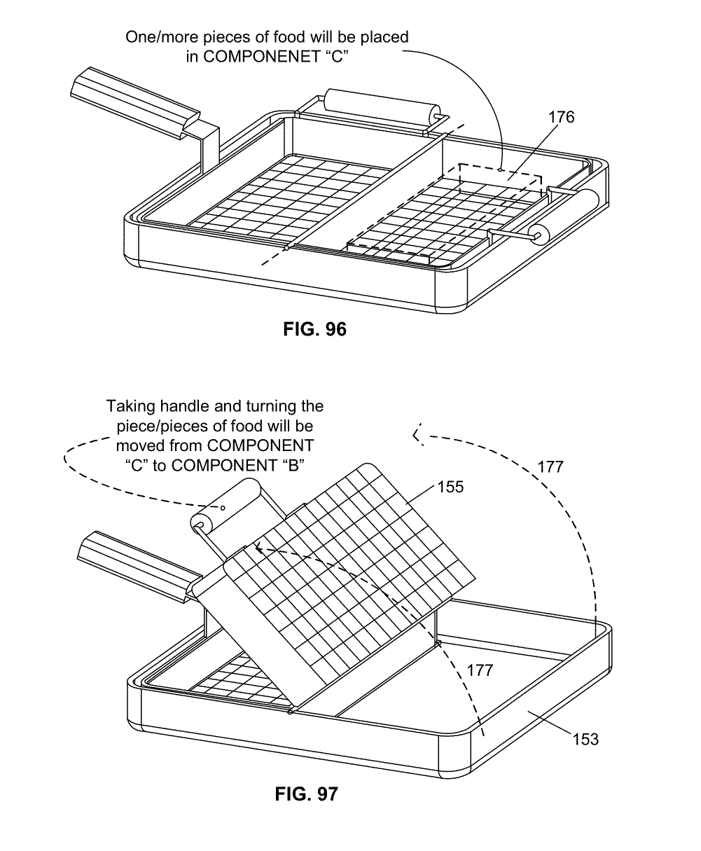

The operation of the cooking part 155 and the container arrangement 154 will now be described with reference to FIGS. 96-101 of the accompanying drawings.

A foodstuff 176 is placed initially on the cooking base 158 of the cooking part 155, as shown in FIG. 96. The foodstuff 176 is, for instance, a portion of meat which needs to be cooked on each side. While the foodstuff 176 is resting on the cooking base 158, the assembly of the cooking part 155 the container arrangement 154 and the support frame 153 are positioned on a source of heat, such as a cooking hob. The cooking hob heats the cooking base 158 to cook a first side of the foodstuff 176.

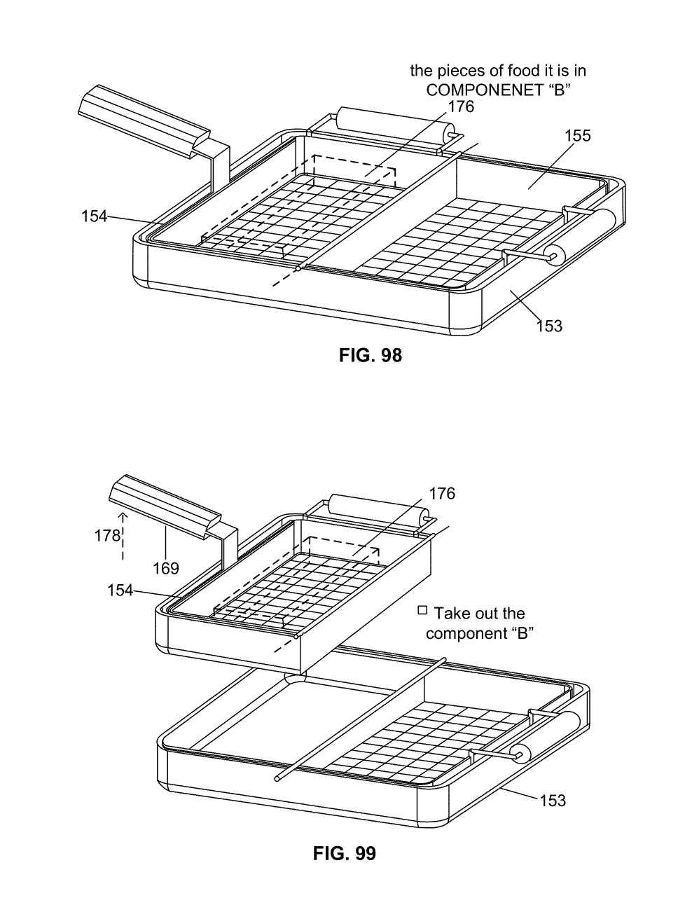

Once the foodstuff 176 has been cooked for a sufficient length of time, a robot or human chef holds the handle 160 on the cooking part 155 and raises the handle 160 to pivot the cooking part 155 about the pivot member 163 in the direction indicated generally by arrows 177 in FIG. 97. The cooking part 155 pivots such that the cooking base 158 is partly or completely superimposed on the base 170 of the container arrangement 154 so that the foodstuff 176 falls onto the base 170 of the container arrangement 154. The cooking part 155 is then pivoted back to the initial position, with the foodstuff 176 remaining on the base 170 of the container arrangement 154, as shown in FIG. 98. The other side of the foodstuff 176 is then cooked while resting on the base 170 of the container arrangement 154.

Once the second side of the foodstuff 176 has been cooked for a sufficient length of time, the container arrangement 154 is removed from the support frame 153 using the handle 169 by raising the container arrangement 154 in a vertical direction as indicated generally by arrow 178 in FIG. 99.

Referring now to FIGS. 100 and 101 of the accompanying drawings, the foodstuff 176 which, by now has been cooked on both sides, is removed from the container arrangement 154 by pulling the handle 173 of the second part 171 of the container arrangement 154 in the direction generally indicated by arrow 179 in FIG. 60. The end wall 172d of the second part 171 acts on the foodstuff 176 to pull or scrape the foodstuff 176 off the base 170. The foodstuff 176 then falls downwardly off the base 170, as indicated in FIG. 101.

The configuration of the cooking part 155, the container arrangement 154 and the support frame 153 enables a robot or human chef to cook a foodstuff on two sides without the robot or human having to use an additional utensil or having to make any contact with the foodstuff. The arrangement is therefore optimized for use by a robot cooking system.

Referring now to FIG. 102 of the accompanying drawings, a container arrangement 180 of some embodiments comprises a container body 181 having at least one side wall 182. In this embodiment, the side wall 182 is a generally cylindrical side wall. In other embodiments, the container arrangement 180 comprises at least one further side wall.

The container arrangement 180 comprises a storage chamber 183 which is provided within the container body 181.

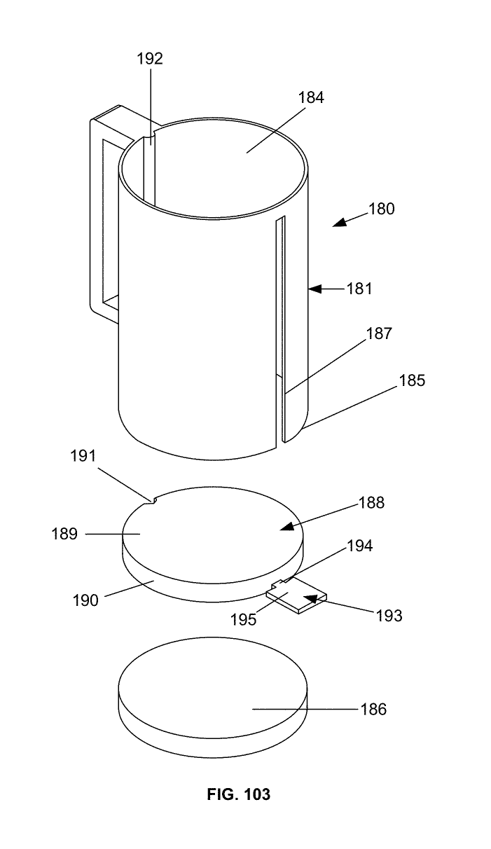

Referring now to FIG. 103 of the accompanying drawings, the container arrangement 180 has an open upper first end 184 which defines an opening in the storage chamber 183. The container body 181 further comprises an open second end 195 which is releasably closed by a closure element 186. In this embodiment, the releasable closure element 186 is a substantially circular disc-shaped element which is configured to be releasably attached to the container body 181. The closure element 186 in some embodiments is configured to releasably attach to the container body 181 by a locking arrangement, such as a screw or rotational locking arrangement which releasably locks the closure element to the container body 181. The closure element 186 is releasable from the container body 181 to facilitate cleaning of the container body 181 and the closure element 186.

The container body 181 incorporates an elongate guide channel 187 which is provided at least partly along the length of the container body 181. The purpose of the guide channel 187 will become clear from the description below.

The container arrangement 180 further comprises an ejection element 188 which is configured to be moveably coupled to the container body 181 with part of the ejection element 188 being provided within the storage chamber 183.

In this embodiment, the ejection element 188 is a generally circular disk-shaped element. The ejection element 188 comprises an ejection element body 189 which corporates an edge 190 that contacts and/or is positioned adjacent to the container body 181, around the periphery of the storage chamber 183. A substantially fluid-tight seal is preferably provided between the edge 190 of the ejection element 188 and the container body 181. The ejection element 188 functions as a divider element which extends substantially across the entire width or diameter of the storage chamber 183.

In this embodiment, the ejection element 188 is provided with a recess 191 in the edge 190 of the ejection element 188. The recess 191 is configured to receive at least part of a guide rail protrusion 192 which is provided on the container body 181. The recess 191 is configured to slide relative to the guide rail protrusion 192 such that the guide rail protrusion 192 guides the ejection element 188 to move along the length of the storage chamber 183 while minimizing rotation of the ejection element 188. However, in some embodiments, the recess 191 and the guide rail protrusion 192 are omitted.

In some embodiments, the ejection element 188 is provided with an ejection element handle 193. In this embodiment, the ejection element handle 193 comprises a narrow portion 194 which is carried by the edge 190 of the ejection 188. The ejection element handle 193 further comprises a wider portion 195 which is coupled to the narrow portion 194. When the ejection element 188 is at least partly positioned within the storage chamber 183, the ejection element handle 193, the ejection element handle 193 protrudes outwardly from the container body 181. The narrow portion 194 of the ejection element handle 193 fits slideably within the guide channel 187 in the container body 181.

When the ejection element 188 is positioned at a lower end of the storage chamber 183, as shown in FIG. 104, the ejection element 188 is in a first position. Cooking ingredients are placed within the storage chamber 183. The cooking ingredients are, for instance, high viscosity ingredients which are to be mixed or chopped within the storage chamber 183.

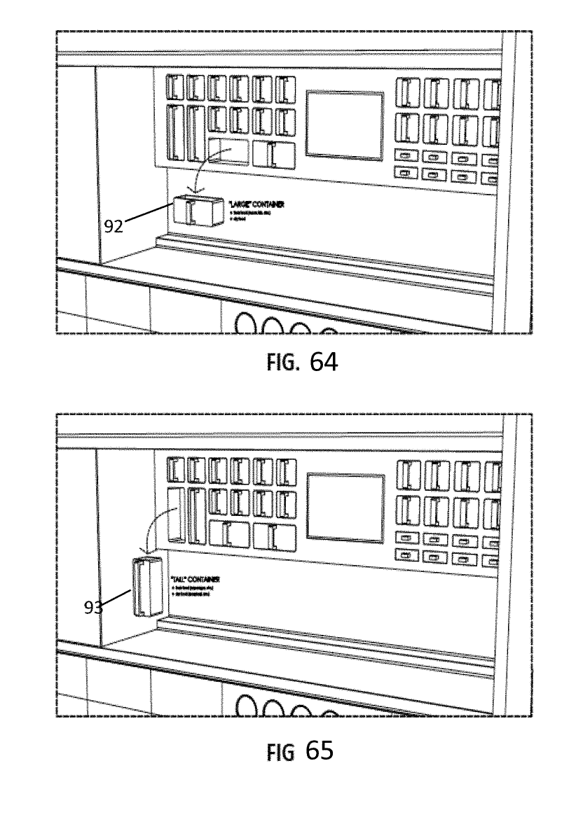

Referring now to FIG. 105 of the accompanying drawings, the ejection element 188 is moveable from the first position to a second position in which the ejection element 188 is positioned adjacent the first end of the container body 181. The ejection element 188 is configured to be moved from the first position to the second position by a human or robot hand moving the ejection element upwardly along the length of the container body 181 in a direction generally indicated by arrow 196 in FIG. 64.

Referring now to FIG. 106 of the accompanying drawings, when the container arrangement 180 is in use, the container arrangement 180 is configured to be inverted before the ejection element 188 is moved from the first position to the second position. The container body 181 is provided with an elongate handle 197 which is configured to be carried by a robot or human hand. The elongate nature of the handle 197 facilitates the orientation and the positioning of the container arrangement 180 by a robot.

Once the container arrangement 180 has been inverted, high viscosity ingredients are likely to remain within the storage chamber 183 as the ingredients adhere to the wall 181 of the storage chamber 183. If this is the case, a robot or human hand can act on the ejection element handle 193 to move the ejection element 188 from the first position to the second position to eject the ingredients out from the storage chamber 183. The configuration of the moveable ejection element 183 enables a robot or human to remove high viscosity ingredients from the storage chamber 183 easily, without the human or robot having to touch the ingredients.

Referring now to FIGS. 107 and 108 of the accompanying drawings, an end effector of a robot of some embodiments is in the form a robotic hand 205. The robotic hand 205 is a humanoid robotic hand which comprises four fingers 206 and a thumb 207. The fingers 206 and the thumb 207 comprise a plurality of moveable joints which enable portions of the fingers 206 and the thumb 207 to move relative to one another.

The portions of the fingers 206 and the thumb 207 are coupled to a respective tendon element 208-212. The tendon elements 208-212 are flexible elements which are configured to be pulled or pushed to move the portions of the fingers 206, 207. The tendon elements 208-211 of the fingers 206 are coupled via a connection plate 213. The connection plate 213 is coupled to control tendons 214, 215 which extend through pulleys 216 to a drive arrangement (not shown). In use, the drive arrangement drives the control tendons 214, 215 to pull and/or push the tendon elements 208, 212 to control the portions of the fingers 206 and the thumb 207 to move to hold or release an item.

Referring now to FIG. 109 of the accompanying drawings, the robotic hand 205 comprises a plurality interconnected ridged elements 217 which are at least partly covered by a soft layer resilient material 218. The resilient material 218 is preferably a resilient material, such as a sponge, gel or foam layer. An outer hard layer 219 at least partly covers the soft layer 218 to provide a resilient surface on the exterior of the robotic hand 205.

Referring now to FIG. 110 of the accompanying drawings, in some embodiments, a portion of the robotic hand 205 adjacent a palm section 220 and a thumb 221 is at least partly covered by a padded portion 222. In this embodiment, the padded portion 222 comprises a plurality of beads 223 which are retained beneath a skin layer 224. The skin layer 224, is, for instance, of silicone and flexible to permit the beads 223 to function as a shock absorbing structure. The structure of the skin layer 224 and the beads 223 also provides a deformable structure which is configures to deform partly around an item that is being held by the robotic hand 205 to maximize the frictional grip of the robotic hand 205.

Referring now to FIGS. 111 and 112 of the accompanying drawings, the robotic hand 205 of some embodiments is provided with at least one sensor 225. In this embodiment, the robotic hand 205 is provided with a plurality of sensors 225. The sensors 225 are carried at different positions on a palm section 220 of the robotic hand 205.

Each of the sensors 225 is, in some embodiments, a tri-access magnetic sensor which is configured to sense the magnetic field of a magnet 226 in three axes, X, Y and Z, as indicated in FIG. 111.

The sensors 225 are configured to sense the presence of an item 227 which is being held by the robotic hand 205, as indicated in FIG. 162. In this embodiment, each of the sensors 225 is configured to sense the magnetic field of at least one of a plurality of magnets 228, 229 provided on the item 227. The plurality of sensors 225 on the robotic hand 205 and the plurality of magnets 228, 229 on the item 227 enable a control unit analyzing an output from the sensors 225 to determine the strength of the sensed magnetic fields of the magnets 228, 229 and to determine the position of the item 227 relative to the robotic hand 205. The sensors 225 therefore provide signals which enable a control unit to determine the position or orientation of an item 227 that is being held by the robotic hand 205.

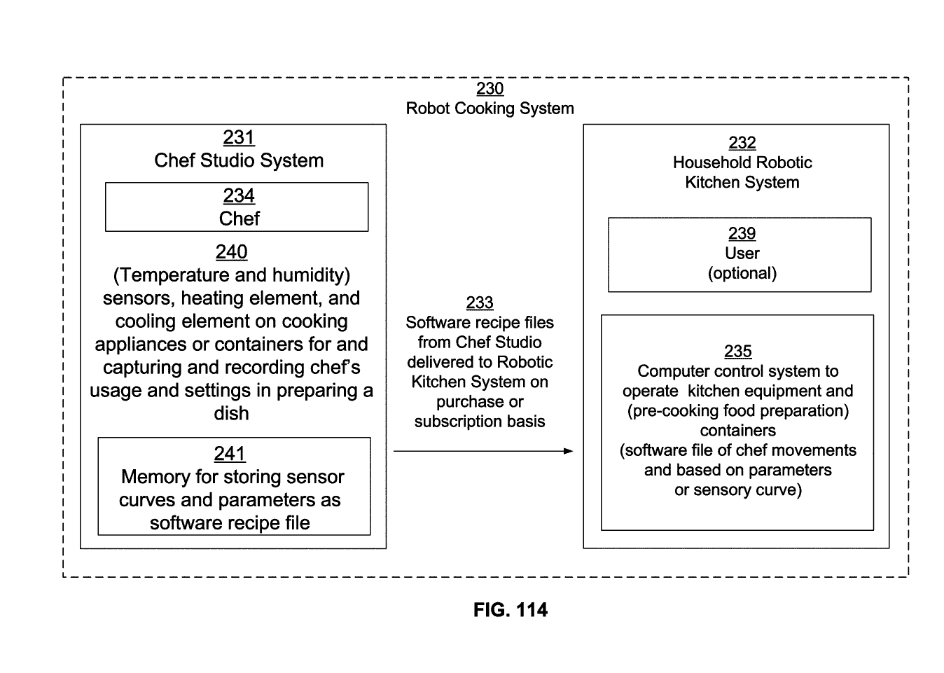

Referring now to FIG. 114 of the accompanying drawings, a food robot cooking system 230 of some embodiments includes a chef studio system 231 and a household robotic kitchen system 232 for preparing a dish by replicating a chef's recipe process and movements. In some embodiments, the household robotic kitchen system is the kitchen module of the embodiments described above.

The chef kitchen 231 (also referred to as “chef studio-kitchen”) is configured to transfer one or more software recorded recipe files 233 to the robotic kitchen 232 (also referred to as “household robotic kitchen”). In some embodiments, both the chef kitchen 231 and the robotic kitchen 232 use the same standardized robotic kitchen module as the kitchen module of the embodiments described above. This maximizes the precise replication of preparing a food dish, which reduces the variables that may contribute to deviations between the food dish prepared at the chef kitchen 231 and the one prepared by the robotic kitchen 232. A chef 234 wears robotic gloves or a costume with external sensory devices for capturing and recording the chef's cooking movements.

Referring now to FIG. 115 of the accompanying drawings, the robotic kitchen 232 comprises a computer 235 for controlling various computing functions, where the computer 235 includes a memory 236 for storing one or more software recipe files from the sensors of the gloves or costumes for capturing a chef's movements, and a robotic cooking engine 237. The robotic cooking engine is preferably a computer implemented method (software). The robotic cooking engine 237 includes a preparation cooking operating control module 238 which uses recorded sensory data.

The robotic kitchen 232 typically operates with a pair of robotic arms and hands, with an optional user 239 to turn on or program the robotic kitchen 232. The computer 235 in the robotic kitchen 232 includes a hard automation module for operating robotic arms and hands, and a recipe replication module for replicating a chef's movements from a software recipe (ingredients, sequence, process, etc.) file.

The robotic kitchen 231 is configured for detecting, recording and emulating a chef's cooking movements, controlling significant parameters such as temperature over time, and process execution at robotic kitchen stations with designated appliances, equipment and tools. The chef kitchen 231 provides a computing kitchen environment with gloves with sensors or a costume with sensors for recording and capturing a chef's 234 movements in the food preparation for a specific recipe.

The chef kitchen 231 comprises a parameter recording module 240 which is configured to receive and store temperature and/or humidity data indicative of the temperature and/or humidity within at least one container in the chef kitchen 231. The temperature and/or humidity data is derived from signals from at least one temperature and/or humidity sensor provided on a container. The parameter recording module 240 preferably also records data indicative of the operation of heating and/or cooling elements of at least one container in the chef kitchen 231. The parameter recording module 240 therefore captures and records the chef's 234 usage and settings of at least one container in the chef kitchen 231 in preparing a dish.

Upon recording the movements, parameters and recipe process of the chef 234 for a particular dish into a software recipe file in a memory 241, the software recipe file is transferred from the chef kitchen 231 to the robotic kitchen 232 via a communication network. The communication network includes a wireless network and/or a wired network preferably connected to the Internet, so that the user (optional) 239 can purchase one or more software recipe files or the user can be subscribed to the chef kitchen 231 as a member that receives new software recipe files or periodic updates of existing software recipe files.

The household robotic kitchen system 232 serves as a robotic computing kitchen environment at residential homes, restaurants, and other places in which the kitchen is built for the user 239 to prepare food. The household robotic kitchen system 232 includes the robotic cooking engine 237 with one or more robotic arms and hard-automation devices for replicating the chef's cooking actions, processes and movements based on a received software recipe file from the chef studio system 231.

The chef studio 231 and the robotic kitchen 232 represent an intricately linked teach-playback system, which has multiple levels of fidelity of execution. While the chef studio 231 generates a high-fidelity process model of how to prepare a professionally cooked dish, the robotic kitchen 232 is the execution/replication engine/process for the recipe-script created through the chef working in the chef studio.

The computer 235 of the robotic kitchen 232 is configured to receive signals from sensors 242 for inputting raw food data. The computer 235 is also configured to communicate with an operating control unit 243 which, in some embodiments, is a touch-screen display which is provided within the robotic kitchen 232. In other embodiments, the operating control unit 243 is another control unit which can, for instance, be implemented in software running on a device. The computer 235 of the robotic kitchen 232 is configured to communicate with a storage system 244, the kitchen worktop counter 245, the kitchen wash/cleaning counter 246 and the kitchen serving counter 247.

The computer 235 in the robotic kitchen 232 is further configured to communicate with cooking appliances and/or cooking wares 249 which comprise sensors. The cooking wares 249 are, for instance, stored within a cabinet or on a shelf within the robotic kitchen 232.

The computer 235 within the robotic kitchen 232 is further configured to communicate with containers 250 in the robotic kitchen 232, such as the containers of the embodiments described above. As described above, the containers 250 of some embodiments are provided with temperature and/or humidity sensors and with heating/cooling elements and a steam generator in order to sense the conditions within the container 250 and control the temperature and/or humidity within the container. The computer 235 is configured to control the temperature and/or humidity within each container 250 and the computer 235 is configured to record data in the memory 236 indicative of the temperature and/or humidity within a container 250.

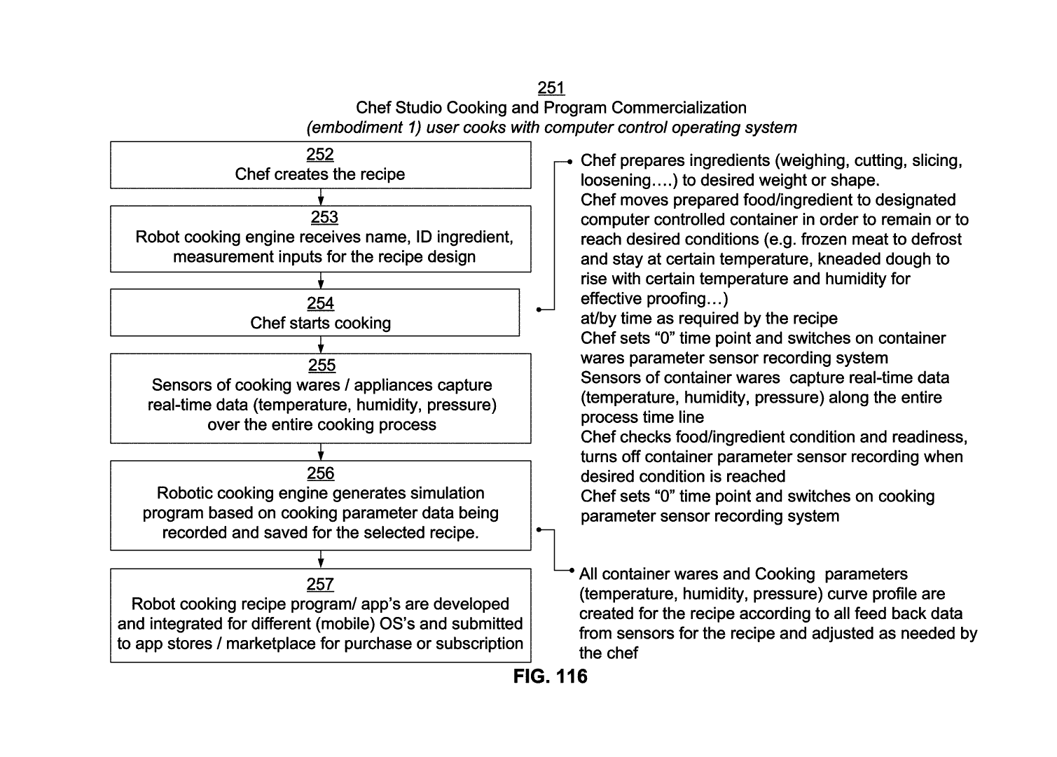

Referring now to FIG. 116 of the accompanying drawings, a chef studio cooking process 251 comprises steps which are performed by the chef 234 within the chef studio 231 and also steps which are performed by the robotic cooking engine 237 in the chef studio 231.

The chef 234 starts by creating 252 a recipe. The computer 235 in the robotic kitchen 232 receives 253 the recipe name, the IDs of the ingredients used in the recipe and measurement inputs for the recipe. The chef 234 then starts cooking 254 the recipe by preparing the ingredients (weighing, cutting, slicing, etc.) to a desired weight or shape. The chef 234 moves the prepared food/ingredients to a designated computer—controlled container 250 in order to store the ingredient or to prepare the ingredient by allowing the ingredient to reach a desired condition. For instance, the chef 234 can place frozen meat to defrost in a container 250 and then maintain the defrosted meat at a certain temperature. Alternatively, the chef 234 can place kneaded dough to rise at a certain temperature and humidity for effective proving at temperature and/or humidity conditions which are maintained in a container.

The chef 234 activates the computer 235 to record data in the memory 236 which is indicative of the sensed condition parameters within the containers 250. The computer 235 records temperature and/or humidity data indicative of the storage conditions of the ingredient within the container 250 and/or the conditions to prepare the ingredient for the recipe. The sensors of the containers 250 capture real-time data, such as temperature, humidity or pressure along the entire cooking process timeline.

The chef 234 checks the condition and readiness of an ingredient within a container and, if necessary, activates the computer 235 to stop recording sensor data from a container 250 when a desired condition is reached. The chef 234 sets a “0” time point and switches on the cooking parameter sensor recording system implemented in the computer 235. As the chef 234 proceeds with cooking the recipe, the computer 235 captures 255 real-time data (temperature, humidity, pressure) within at least one of the containers 250 throughout the entire cooking process and stores the data in the memory 236.

The robotic cooking engine 237 then generates 256 a simulation program based on the recorded cooking parameter data (temperature, humidity, pressure) and generates curve profiles for each container 250 and all cooking wares. The curve profiles indicate the cooking parameters within the containers 250 and the appliances within the robotic kitchen as the recipe is followed. The computer 235 records any adjustments made by the chef 234 to the cooking parameters during the process.

Once the recipe has been completed and the cooking parameter data stored in the memory 236, the chef studio 231 outputs 257 the recorded parameter data along with the cooking recipe program. The output 257 is, for instance, to a computer application development module which is configured to integrate the data. In some embodiments, the data is outputted 257 and integrated into an application and submitted to an electronic application store or marketplace for purchase or subscription.

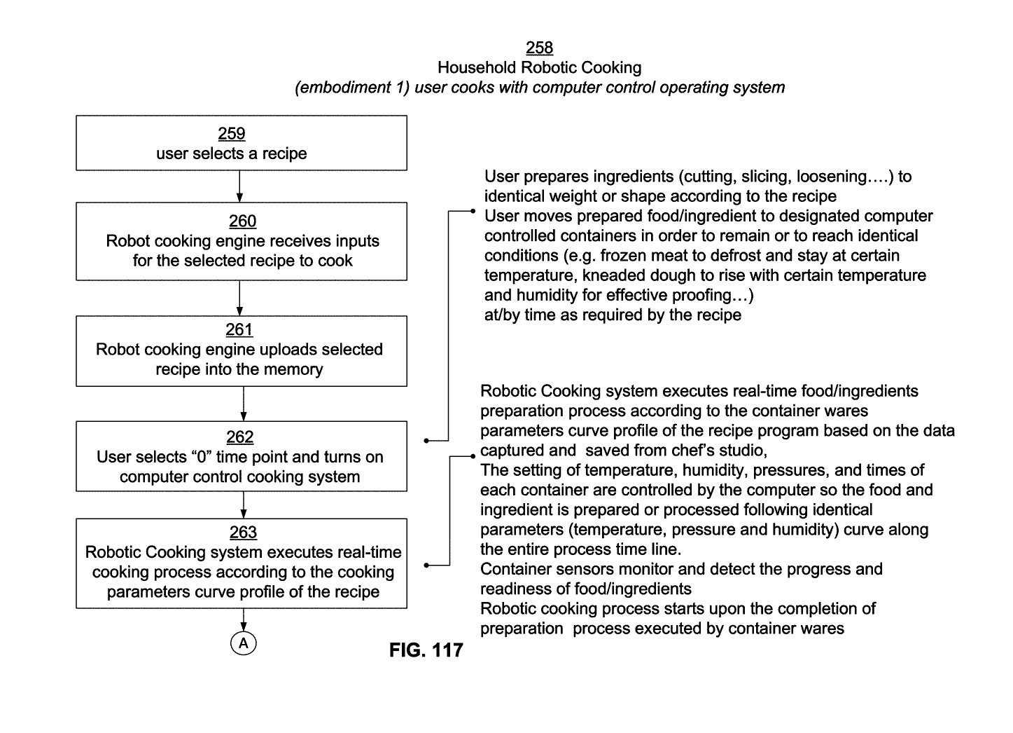

Referring now to FIG. 117 of the accompanying drawings, a robotic cooking process 258 of some embodiments is configured for a user to perform the robotic cooking process 258 at home within the robotic kitchen 232.

The user 239 initially selects 259 a recipe. In some embodiments, the user 239 selects 259 a recipe by accessing the recipe stored in the memory 236 of the computer 235 of the robotic kitchen 232. In other embodiments, the user 239 selects 259 a recipe by obtaining the recipe electronically from a remote computer, such as by downloading the recipe from an online resource.

Once a recipe has been selected, the robotic kitchen 232 receives 260 data indicative of the selected recipe to enable the robotic kitchen 232 to cook the recipe. The robotic cooking engine 237 uploads 261 the selected recipe into the memory 236.

Once the recipe has been loaded into the memory 236, the user 239 initiates 262 the computer 235 at a “0” time point to activate the robotic kitchen 232 to follow the recipe. In some embodiments, the user 239 prepares the ingredients (cutting, slicing, etc.) to the required weight or shape according to the recipe. The user 239 moves the prepared ingredient to designated computer-controlled containers 250 to store the ingredients at optimal conditions or to prepare the ingredients for cooking (e.g. to defrost frozen meat).

The robotic kitchen 232 then executes 263 the cooking process in real-time according to the recipe. The robotic kitchen 232 uses the curve profiles for the parameters (temperature/humidity) within the containers 250 that form part of the data provided to the robotic kitchen 232 with the recipe. The robotic kitchen 232 uses the parameter curve profiles to set the temperature, humidity and/or pressures within each container 250 and controls these parameters according to a timeline for the robotic kitchen 232 to prepare the recipe in accordance with the recipe that was performed in the chef studio 231 when the recipe was recorded.

The sensors within the containers 250 monitor and detect the process and readiness of ingredients within each container 250. For recipes which require the preparation of ingredients within a container 250, the robotic cooking process 258 starts upon the completion of the preparation process within the containers 250.

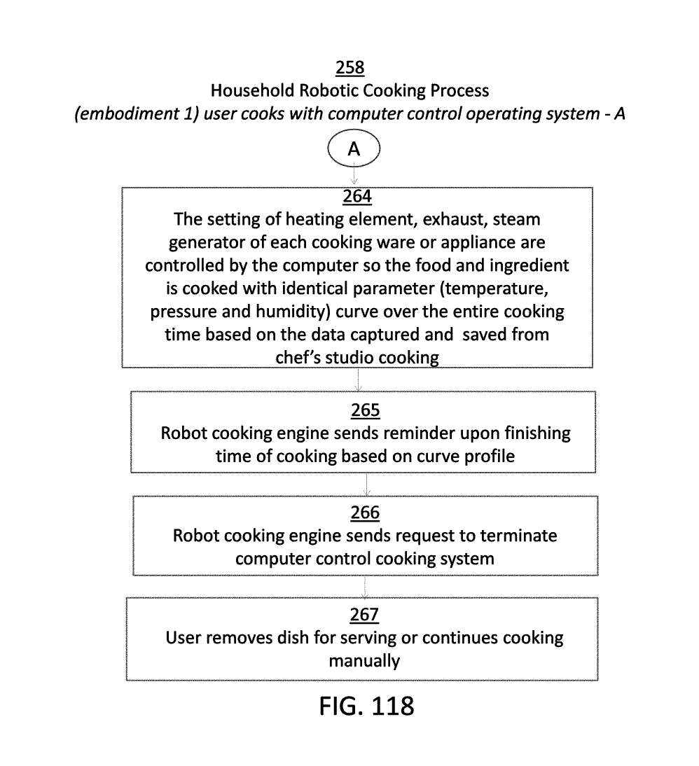

Referring now to FIG. 118 of the accompanying drawings, the cooking process continues with the computer 235 controlling 264 the cooking wares and appliances within the robotic kitchen 232 to cook the ingredients which are taken from the containers 250 and manipulated by robotic arms within the robotic kitchen 232 to cook the recipe. The robotic kitchen 232 uses the parameter curves (temperature, pressure and humidity) over the entire cooking time based on the data captured and saved from the chef studio 231 to ensure that the robotic kitchen 232 reproduces the recipe faithfully for the user 239.

Once the robotic cooking engine 237 has completed the recipe, the robotic cooking engine 237 sends 265 a notification to the user 239.

The robotic cooking engine 237 terminates 266 the cooking process by sending a request to terminate the process to the computer-controlled cooking system.

At a final step, the user 239 removes 267 the dish for serving or to continue cooking manually with the dish.

Referring now to FIG. 119 of the accompanying drawings, a further chef studio cooking process 268 of some embodiments is identical to the chef studio cooking process 251 of the embodiments described above in certain respects and like reference numerals will be used for common steps in the cooking processes 251, 268. However, while the chef studio cooking process 251 of the embodiments described above is used by a chef 234 cooking in a chef studio 231, the chef studio cooking program 268 of the embodiments shown in FIG. 79 additionally records the motion of a chef's 234 arms and hands within the chef studio 231. During the recording process, the chef 234 activates 269 a chef robot recorder module to record movement and measurements of the chef's 234 arms and fingers when performing the recipe.

Referring now to FIG. 120 of the accompanying drawings, the chef robot recorder module records 270 data indicative of the movement and action performed by the chef's 234 hands and fingers. In some embodiments, the chef robot recorder module captures and records the force exerted by the fingers of the chef 234 when cooking a recipe, for instance using pressure sensitive gloves worn by the chef 234. In some embodiments, the chef robot recorder module records the three dimensional positions of the hands and arms of the chef 234 within the kitchen (e.g. when slicing a fish). In other embodiments, the chef robot recorder module also records video data storing video images of the chef 234 preparing the dish and the ingredients for the recipe as well as other steps in the process or other interaction performed by the chef 234 to prepare the recipe. In some embodiments, the chef robot recorder module captures sounds within the kitchen while the chef 234 is cooking a dish according to the recipe, such as the human voice of the chef 234 or cooking sounds, such as a frying hiss.

The chef robot recorder module 271 saves all or substantially all of the real-time movement of the chef's 234 hands and fingers and other components within the robotic kitchen in real-time. The robot recorder module 271 saves the ingredient storage and/or preparation parameters (temperature, humidity, pressure) and curve profiles indicative of the parameters as described above. The robotic cooking engine 237 is configured to integrate the 3D real-time movement data and other recorded media along with the ingredient parameter curve profiles and saves 256 the data in the memory 236 for the selected recipe.

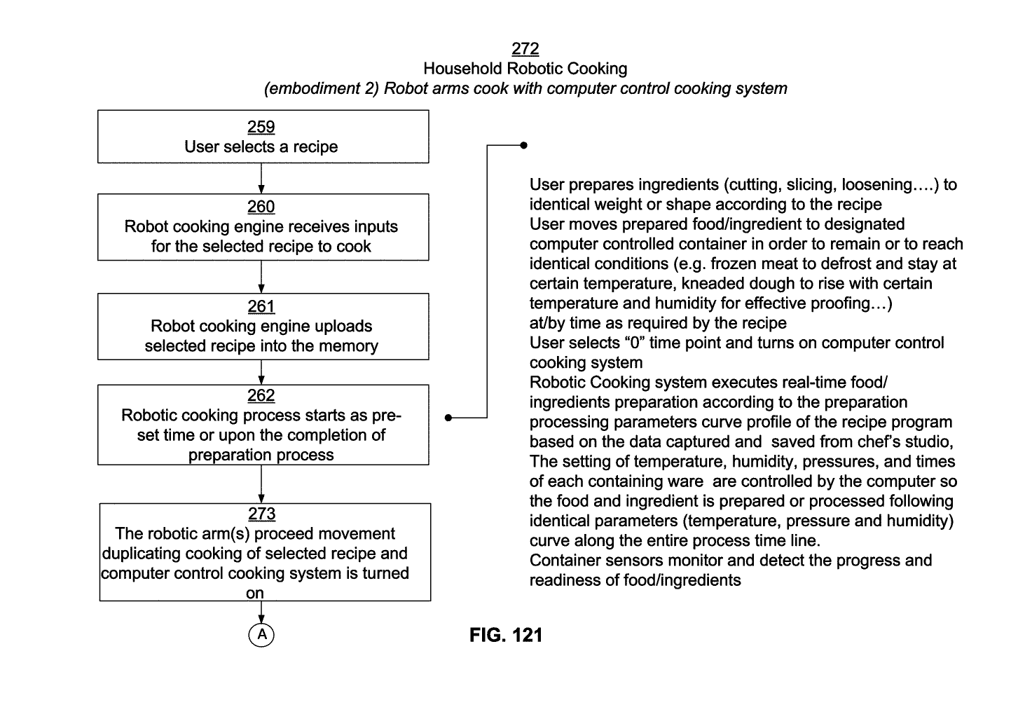

Referring now to FIG. 121 of the accompanying drawings, a robotic cooking process 272 of some embodiments is identical to the robotic cooking process 258 described above in certain aspects and the same reference numerals will be used for the same steps in the two processes 258, 272.

In the embodiment shown in FIG. 121, the robotic cooking process 272 activates 273 at least one robotic arm to perform manipulations within the robotic kitchen 232 so that the at least one robotic arm duplicates the movement of at least one arm of the chef 234 as recorded by the robot recorder module in the chef studio 231.

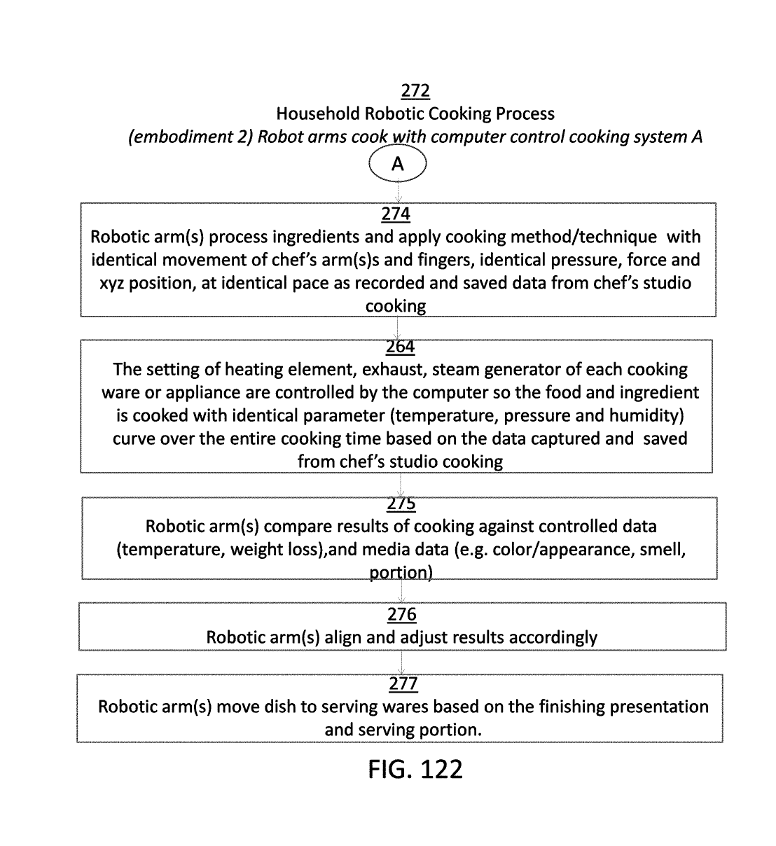

Referring now to FIG. 122 of the accompanying drawings, the at least one robotic arm processes 274 ingredients stored within the containers within the robotic kitchen 232 and performs cooking techniques with identical movements to the chef's 234 hands and fingers, identical pressures, forces and three-dimensional positioning as well as identical pace as recorded and saved by the chef robot recording module in the chef studio 231.

Once each robotic arm has completed a step in the recipe, the robotic cooking engine 237 compares 275 to the results of the cooking against control data (e.g. temperature or weight loss) and media data (e.g. color/appearance, smell, portion size, etc.). Each robotic arm aligns 276 itself and, if necessary, adjusts its position and/or configuration according to the cooking results obtained at the comparison step 275. Each robotic arm finally moves 277 the cooked dish to a serving ware based on the desired finished presentation and serving portion size. The robotic kitchen 232 uses each robotic arm, along with the storage and preparation ingredient parameter curves to recreate the dish of a recipe recorded in the chef studio 231 faithfully for an end user.

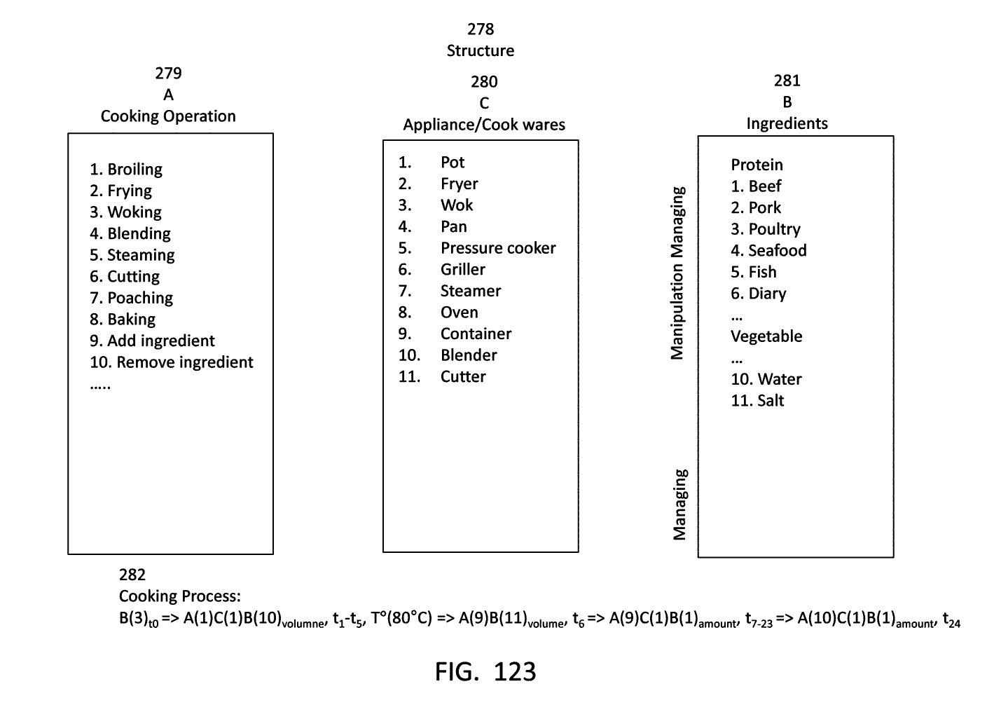

Referring now to FIG. 123 of the accompanying drawings, the robotic cooking engine 237 of the robotic kitchen 232 of some embodiments is a software implemented module which is configured to receive and process data stored in a cooking process structure 278. The cooking process structure 278 comprises a plurality of cooking operations 279 which are referenced in the cooking process structure 278 with the letter A. The cooking process structure 278 further comprises a plurality of appliances or cook wares 280 which are indicated with letter C in the cooking process structure 278. The cooking process structure 278 further comprises a plurality of ingredients 281 which are indicated with letter B in the cooking process structure 278.

By way of an example, a cooking process structure 282 indicates a step in a cooking process using the letters A, B and C to indicate the steps in a cooking process. The robotic kitchen 232 is configured to read and decode the cooking process structure 282 and to perform the indicated cooking operation A using the cooking appliance or cook wares C on the ingredients B. The cooking process structure 282 indicates the times and durations for performing the cooking operations A.

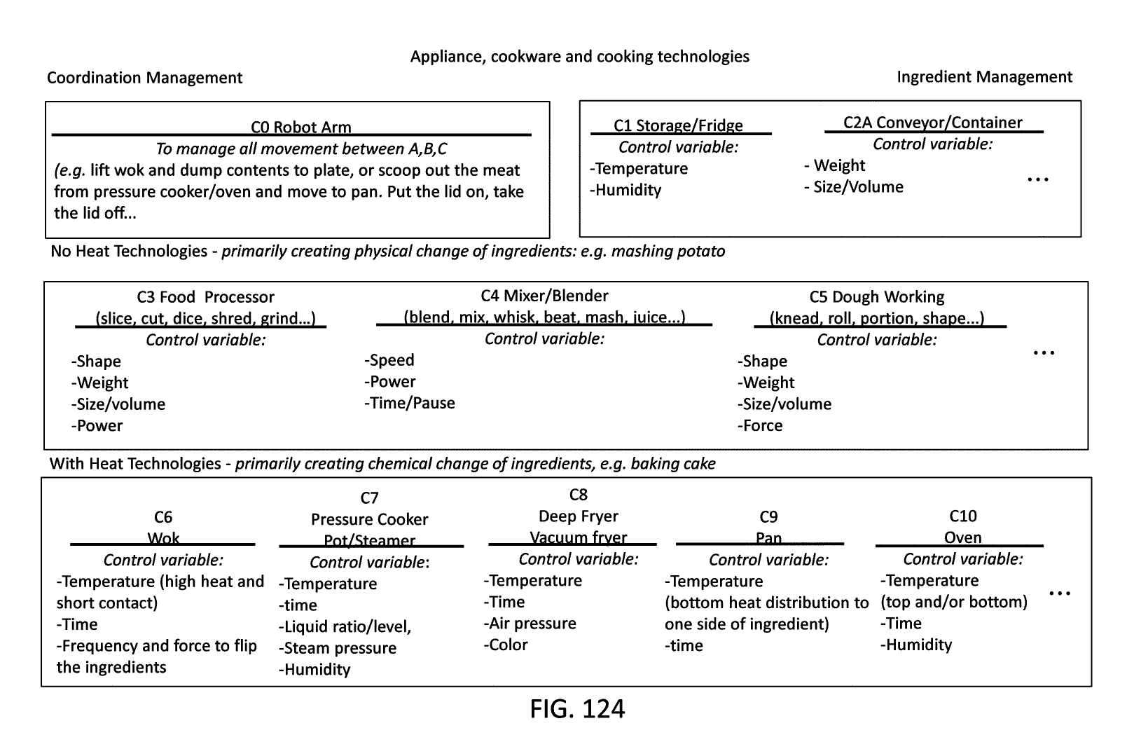

Referring now to FIG. 124 of the accompanying drawings, in some embodiments, the robotic cooking engine 237 is configured to utilize different categories of kitchen appliances or cook wares for coordination management and/or ingredient management by the robotic kitchen 232. The different categories of cooking appliance or cook wares are categorized using sub-categories for the cooking appliance or cook ware C, such as C1, C2, C3, etc.

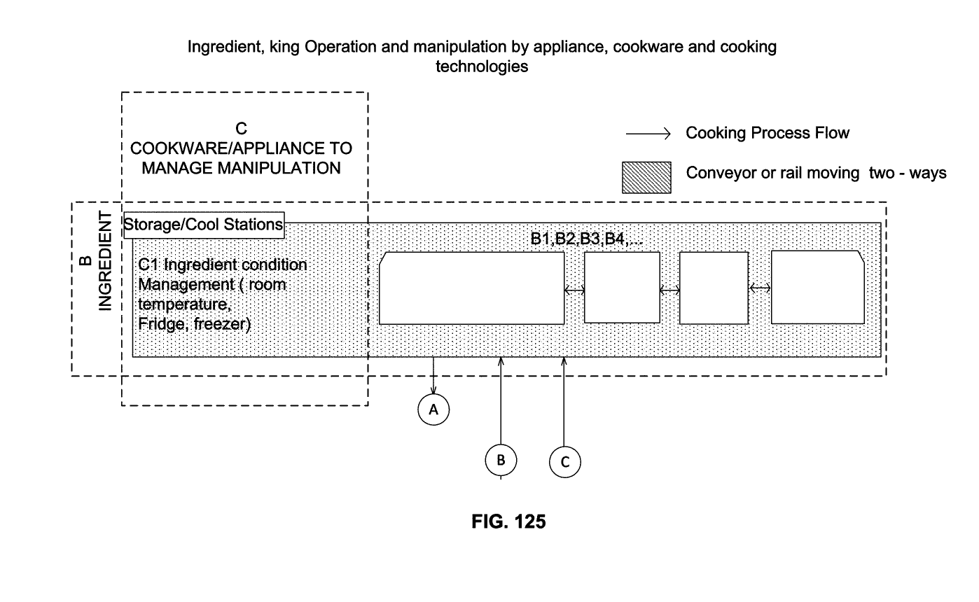

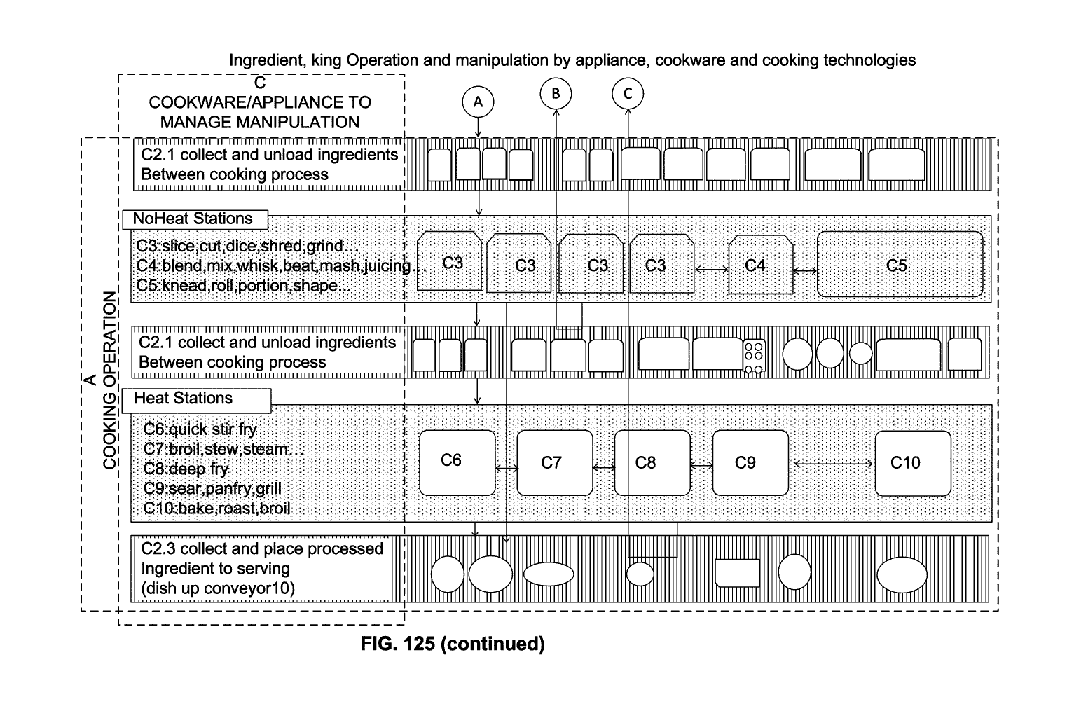

Referring now to FIG. 125 of the accompanying drawings, the robotic cooking engine 237 of some embodiments is configured to control a robotic kitchen to perform the steps of a recipe stored as a cooking process structure in memory based on the condition and management of the ingredients B and cooking operations A. The order and timing in which the steps of the cooking process are performed by the robotic kitchen are derived from the cooking process structure data and performed in sequence, for instance in the sequence indicated in FIG. 125.

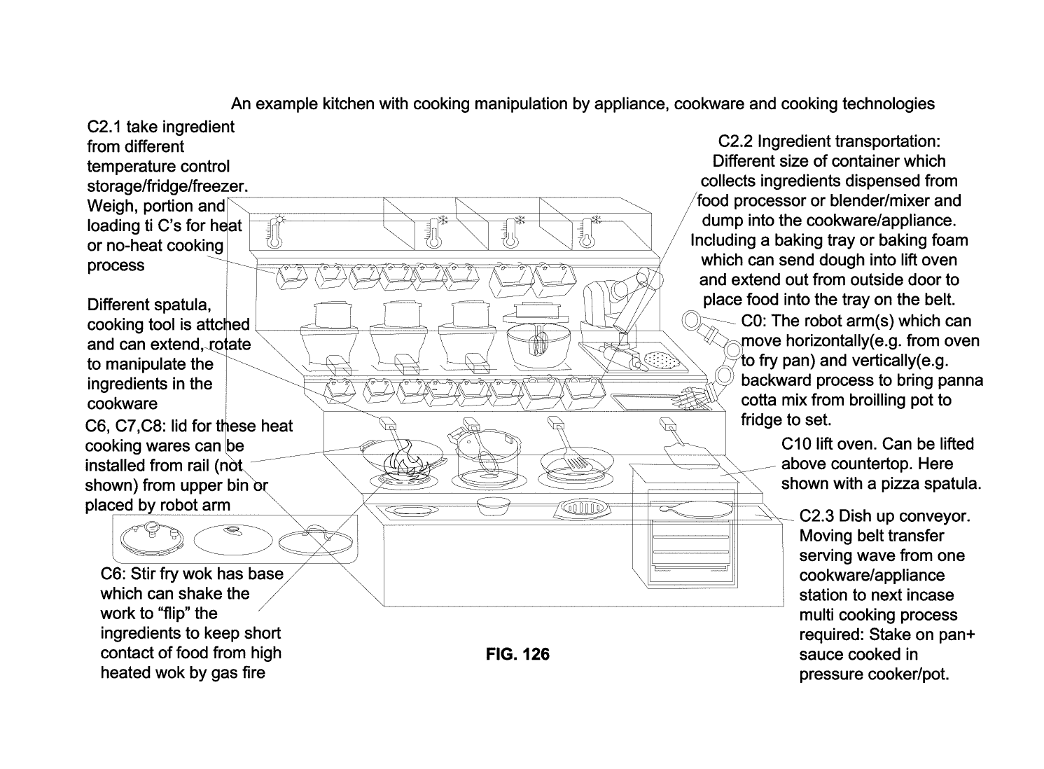

Referring now to FIG. 126 of the accompanying drawings, a robotic kitchen of further embodiments comprises a plurality of different cooking appliances/cook wares C which are configured for use in sequence by robotic arms. In FIG. 127 of the accompanying drawings, an example cooking process comprising only heating is indicated. As shown in FIG. 128 of the accompanying drawings, a cooking process involving multiple cooking technologies involving heating, cooling and no heating is indicated. As illustrated in FIG. 129 of the accompanying drawings, a further example of a cooking process involving no heat is indicated.

FIG. 130 of the accompanying drawings is a block diagram illustrating software elements for object-manipulation in the robotic kitchen of embodiments described above, which shows the structure and flow 283 of the object-manipulation portion of the robotic kitchen execution of a robotic script, using the notion of motion-replication coupled-with/aided-by mini-manipulation steps. In order for automated robotic-arm/-hand-based cooking to be viable, it is insufficient to simply monitor every single joint in the arm and hands/fingers. In many cases just the position and orientation of the hand/wrist are known (and able to be replicated), but then manipulating an object (identifying location, orientation, pose, grab-location, grabbing-strategy and task-execution) requires that local-sensing and learned behaviors and strategies for the hand and fingers be used to complete the grabbing/manipulating task successfully. These motion-profiles (sensor-based/-driven) behaviors and sequences are stored within the mini hand-manipulation library software repository in the robotic-kitchen system. The human chef could be wearing complete arm-exoskeleton or an instrumented/target-fitted motion-vest allowing the computer via built-in sensors or though camera-tracking to determine the exact 3D position of the hands and wrists at all times. Even if the ten fingers on both hands had all their joints instrumented (more than 30 DoFs [Degrees of Freedom] for both hands and very awkward to wear and use, and thus unlikely to be used), a simple motion-based playback of all joint positions would not guarantee successful (interactive) object manipulation.

The mini-manipulation library is a command-software repository, where motion behaviors and processes are stored based on an off-line learning process, where the arm/wrist/finger motions and sequences to successfully complete a particular abstract task (grab the knife and then slice; grab the spoon and then stir; grab the pot with one hand and then use other hand to grab spatula and get under meat and flip it inside the pan; etc.). This repository has been built up to contain the learned sequences of successful sensor-driven motion-profiles and sequenced behaviors for the hand/wrist (and sometimes also arm-position corrections), to ensure successful completions of object (appliance, equipment, tools) and ingredient manipulation tasks that are described in a more abstract language, such as “grab the knife and slice the vegetable”, “crack the egg into the bowl”, “flip the meat over in the pan”, etc. The learning process is iterative and is based on multiple trials of a chef-taught motion-profile from the chef studio, which is then executed and iteratively modified by the offline learning algorithm module, until an acceptable execution-sequence can be shown to have been achieved. The mini-manipulation library (command software repository) is intended to have been populated (a-priori and offline) with all the necessary elements to allow the robotic-kitchen system to successfully interact with all equipment (appliances, tools, etc.) and main ingredients that require processing (steps beyond just dispensing) during the cooking process. While the human chef wore gloves with embedded haptic sensors (proximity, touch, contact-location/-force) for the fingers and palm, the robotic hands are outfitted with similar sensor-types in locations to allow their data to be used to create, modify and adapt motion-profiles to successfully execute desired motion-profiles and handling-commands.

The object-manipulation portion of the robotic-kitchen cooking process (robotic recipe-script execution software module for the interactive manipulation and handling of objects in the kitchen environment) 283 is further elaborated below. Using the robotic recipe-script database 284 (which contains data in raw, abstracted cooking-sequence and machine-executable script forms), the recipe script executor module 285 steps through a specific recipe execution-step. The configuration playback module 286 selects and passes configuration commands through to the robot arm system (torso, arm, wrist and hands) controller 287, which then controls the physical system to emulate the required configuration (joint-positions/-velocities/-torques, etc.) values.

The notion of being able to faithfully carry out proper environment interaction manipulation and handling tasks is made possible through a real-time process-verification by way of (i) 3D world modeling as well as (ii) mini-manipulation. Both the verification and manipulation steps are carried out through the addition of the robot wrist and hand configuration modifier 288. This software module uses data from the 3D world configuration modeller 289, which creates a new 3D world model at every sampling step from sensory data supplied by the multimodal sensor(s) unit(s), in order to ascertain that the configuration of the robotic kitchen systems and process matches that required by the recipe script (database); if not, it enacts modifications to the commanded system-configuration values to ensure the task is completed successfully. Furthermore, the robot wrist and hand configuration modifier 288 also uses configuration-modifying input commands from the mini-manipulation motion profile executor 290. The hand/wrist (and potentially also arm) configuration modification data fed to the configuration modifier 288 are based on the mini-manipulation motion profile executor 290 knowing what the desired configuration playback should be from 286, but then modifying it based on its 3D object model library 291 and the a-priori learned (and stored) data from the configuration and sequencing library 292 (which was built based on multiple iterative learning steps for all main object handling and processing steps).

While the configuration modifier 288 continually feeds modified commanded configuration data to the robot arm system controller 287, it relies on the handling/manipulation verification software module 293 to verify not only that the operation is proceeding properly but also whether continued manipulation/handling is necessary. In the case of the latter (answer ‘N’ to the decision), the configuration modifier 288 re-requests configuration-modification (for the wrist, hands/fingers and potentially the arm and possibly even torso) updates from both the world modeller 289 and the mini-manipulation profile executor 290. The goal is simply to verify that a successful manipulation/handling step or sequence has been successfully completed. The handling/manipulation verification software module 293 carries out this check by using the knowledge of the recipe script database 284 and the 3D world configuration modeller 289 to verify the appropriate progress in the cooking step currently being commanded by the recipe script executor 285. Once progress has been deemed successful, the recipe script index increment process 294 notifies the recipe script executor 285 to proceed to the next step in the recipe-script execution.

The concept of a mini-manipulation of a hand is illustrated in FIG. 131. The concept is illustrated using a human hand, but it is to be appreciated that the concept applies equally to a robotic hand which is controlled in accordance with the structure and flow 283 of the robotic kitchen manipulation process shown in FIG. 130.

Referring again to FIG. 131 of the accompanying drawings, a mini-manipulation 295 comprises a first stage 296 in which a hand 297 is in an initial position. The mini-manipulation 295 comprises a second stage 298 in which the hand 297 is grasping an item 299 which, in this example is the handle of a jug. The mini-manipulation occurs as the hand 297 moves from the initial position to grasp the handle of the jug. The present disclosure introduces the concept of an emotional motion 300 which comprises at least part of the motion of the hand 297 as the hand moves from the initial position 296 to the final position 298.

FIG. 131 further illustrates a second motion 301 of the hand 297 when grasping the handle of the jug to pour out contents from the jug. During the second motion 301, the hand 297 undergoes a further emotional motion 302 as the hand 297 moves from a first position to a second position.

An example of the emotional motion 300 is illustrated in more detail in FIG. 132. Here it can be seen that the emotional motion 300 comprises an emotional trajectory of the hand 297 from the initial position to a first intermediate position 303 in which the hand 297 is raised and partially rotated, to a second intermediate position 304 in which the index and thumb fingers of the hand 297 are brought together to a third intermediate position 305 in which the index finger and thumb of the hand are moved apart to receive the handle of the jug.

The emotional motion of the hand 297 of some embodiments represents the intermediate motion of the hand, such as a robotic hand, between necessary initial and final positions when interacting with an item.

The emotional motion of a robotic hand is controlled by the mini-manipulation motion profile executor 290 which controls the robot wrist and hand configuration modifier 288 to modify the motion of the robot hand. The mine-hand manipulation motion profile executer 290 stores emotional motion data 306 which is indicative of the three-dimensional position of the tip of the forefinger and thumb of the hand along with the three-dimensional position of the coordinate of the wrist of the hand. The emotional motion data 306 represents the emotional motion of the hand 297 over a period of time which, in this example, is 0.25 seconds.

Referring now to FIG. 133 of the accompanying drawings, the emotional motion data 306 is, in other embodiments, configured to represent the emotional motion of the hand 297 over an extended period of N seconds 307.

Referring now to FIG. 134 of the accompanying drawings, in some embodiments, the emotional motion data 306 is configured to represent the emotional motion of the hand 297 in combination with mini-manipulations performed by the hand 297 over a period of time. In this example, the emotional motion data 306 is combined with mini-manipulation data to plot the trajectory of movement of the tips of the forefingers and thumb and the wrist of the hand 297 as the hand 297 moves from a starting position, to a second position, from the second position to a third position, to a subsequent position and to finally drop the object at a further position before returning the hand 297 to a final position.

The emotional motion of some embodiments of the robotic kitchen described above enables the robotic hand of the robotic kitchen to move in a manner which is perceived as more natural by a human than a purely functional mini-manipulation of the robotic hand. The emotional motion introduces a human element to the movement of the robotic hand to enable the robotic hand to mimic more faithfully the subtle movements of the hand of a human chief (creator) that the robotic hand is mimicking. The emotional motion introduces additional movements of the robotic hand which are appealing to a person watching the robotic hand in operation in a robotic kitchen.

Referring now to FIGS. 135 to 137 of the accompanying drawings, a kitchen module 1 of some embodiments comprises many of the same components as the kitchen 1 of the embodiments described above and like reference numerals will be used for corresponding components in the kitchen modules. The kitchen module 1 comprises at least one robotic arm. In this embodiment, the kitchen module 1 comprises two robotic arms 13.

The robotic arms 13 are configured to be controlled by a central control unit (not shown). The central control unit is a computer which comprises a processor and a memory which stores executable instructions for execution by the processor. The memory stores executable instructions which, when executed by the processor cause the processor to output control instructions which are communicated to the robot arms 13 to control the movement of the robot arms 13.

The robotic kitchen 1 of this embodiment comprises a two-dimensional (2D) camera which is preferably positioned adjacent to the robot arms 13. The 2D camera 308 is positioned to capture images of the work surface 4. In other embodiments, the 2D camera 308 is positioned else where within the robotic kitchen module 1. In some embodiments, the 2D camera 308 is positioned on a robotic arm within the kitchen module 1.

In this embodiment, the kitchen module 1 further comprises a three-dimensional (3D) camera 309. In this embodiment, the 3D camera 309 is positioned adjacent the robotic arms 13. In other embodiments, the 3D camera 309 is positioned elsewhere within the robotic kitchen 1. In some embodiments, the 3D camera 309 is positioned on a robotic arm within the kitchen module 1.

The 2D and 3D cameras 308, 309 are configured to capture images of at least the work surface 4 and items or utensils positioned on the work surface 4. In some embodiments, the cameras 308, 309 are configured to capture images of items, utensils or appliances positioned elsewhere in the kitchen module 1. In further embodiments, the 2D and/or 3D cameras 308, 309 are configured to capture images of a foreign object present in the kitchen module 1, such as a human face, a pet or other foreign object which is not usually present or not authorized to be present within the kitchen module 1.

The cameras 308, 309 are configured to capture images of reference markers provided within the kitchen module 1. In some embodiments, the reference markers are at least partly formed by visual features of the kitchen module 1, such as the edge of the hob, sink, a hook for a utensil or a retainer recess for a spice container. In some embodiments, the reference markers are specific markers that are positioned at spaced-apart positions on the work surface 4. The reference markers are each positioned at a predetermined position which is known to the kitchen module 1 so that the kitchen module 1 can use the images captured by the cameras 308, 309 to identify the position of the position of components within the kitchen module 1, such as utensils, appliances or the hands of a robot.

In some embodiments, the kitchen module 1 is configured to use the 2D camera 308 independently of the 3D camera. For example, the kitchen module 1 uses the 2D camera 308 to capture 2D images of the kitchen module 1 initially for processing. Once the 2D camera images have been processed, if required the images from the 3D camera 309 are used for further processing to identify items within the kitchen module 1.

FIG. 138 of the accompanying drawings is a block diagram illustrating software elements of an object recognition process 310 of some embodiments, such as the embodiments described above. The object recognition process 310 is a computer-implemented process which is executed by a computer within the robotic kitchen. The object recognition process 310 is stored as computer-readable instructions in a memory in the computer for execution by a processor within the computer.

The object recognition process 310 comprises receiving 2D images 311 at a 2D camera handler module 312. The 2D images 311 are captured by the 2D camera 308 within the robotic kitchen 1. The 2D camera handler module 312 processes the 2D images 311 and generates 2D shape data 313. The 2D shape data 313 is shape data which is indicative of a contour (2D shape) of an object seen by the 2D camera 308. The 2D camera handler module 312 outputs the 2D shape data 313 to a validator module 314.

The object recognition process 310 comprises receiving 3D images 315 from the 3D 309. The 3D images 315 are input to a 3D camera and a module 316. The 3D camera handler module 316 processes the 3D images 315 and generates 3D shape data 317 which indicates the three dimensional shape of an object seen by the 3D camera 309. The 3D camera handler module 316 outputs the 3D shape data 317 to the validator module 314.

The validator module 314 is configured to receive standard object data 318 from a standard object library module 318A which is, for instance, a database stored in a memory. The standard object data 318 comprises one or more of 2D or 3D shape data, visual signatures and/or image samples of standard objects which are used in the kitchen module 1. The standard objects are, for instance, objects that are to be expected to be present within the robotic kitchen module 1, such as dishes, tools, utensils and appliances.

The other data module 314 is configured to receive temporary object data 319 from a temporary object data library 320. The temporary object data 319 comprises data concerning objects which might temporarily be present within the robotic kitchen module 1, such as cooking ingredients. The temporary object data 319 preferable comprises visual data for identifying temporary objects, such as visual signatures or image samples.

A validator module 314 is configured to receive expected object data 321 which is preferably derived from recipe data 322. The expect object data 321 provides an indication of a standard or temporary object which are expected to be present within the kitchen module 1 when cooking a recipe in accordance with the recipe data 322. For instance, the expected object data 321 provides a list of utensils which are used to cook a recipe in accordance with the recipe data 322.

The validator module 314 is configured to output real object data 323 to a workspace dynamic model module 324. The real object data 323 comprises a list of one or more objects which have been identified by the object identification process 310 as being present within the kitchen module 1. The workspace dynamic model module 324 is integrated into the robotic kitchen module 1 and used to control a robot and/or appliances within the kitchen module 1 to enable the kitchen module 1 to be used to cook a recipe. For instance, the workspace dynamic model module 324 uses the list of real objects identified by the object recognition process 310 to identify the objects and positions of each object within the kitchen module 1 when cooking a recipe.

To recognize an object within the kitchen module 1, the validator module 314 receives 2D shape data 313 and compares the 2D shape data 313 with standard object data 318 to determine if the 2D shape data 313 matches standard object data 318 to enable the validator module 314 to identify a standard object within the kitchen module 1. The validator module 314 uses the expected object data 321 to facilitate the recognition of an object by initially checking the list of expected objects within the kitchen module 1.

If the validator module 314 identifies a standard object, the validator module 314 outputs real object data 323 indicative of the identified standard object to the workspace dynamic model module 324.

If the validator module 314 does not find a match for a standard object, the validator module compares the 2D shape data 313 with temporary objects data 319 to identify if the 2D shape data 313 relates to a temporary object. The validator module 314 is preferably also configured to use the expected objects data 321 when identifying an expected temporary object within the kitchen module 1. If the validator module 314 identifies a temporary object, the validator module 314 outputs the temporary object as real object data 323 to the workspace dynamic model module 324.

The validator module 314 is configured to use 3D shape data 314 of an object to facilitate the recognition of the object. In some embodiments, the validator module 314 uses the 3D shape data 317 after using the 2D shape data 313. In further embodiments, the validator module 314 uses the 3D shape data 317 in combination with the 2D shape data 313 to recognize an object.

The 2D shape data 313 is data which is indicative of the 2D shape of an object. In some embodiments, the 2D shape data 313 is indicative of the position of an object relative to at least one reference marker within the kitchen module 1 such that the 2D shape data 313 identifies the position of the object within the kitchen module 1. The 2D shape data 313 is, in some embodiments, an indication of the area of at least a portion of an object in two dimensions. In other embodiments, the 2D shape data 313 comprises data indicating the length and width and/or orientation of an object.

The object recognition process 310 is in some embodiments further configured to check a scene within the kitchen module 1 for compliance (quality check). In these embodiments, the object recognition system 310 is configured to identify objects within the kitchen module land to identify whether or not the objects are in their correct position. The compliance functionality can therefore be used to check the state of the kitchen module 1 to determine whether or not the kitchen module 1 is configured correctly for use by a robot.

Objects that have a known predetermined fixed shape, size or color are categorized as standard objects, tools, appliances and utensils are preferably categorized as standard objects so they can be categorized and pre-entered into the standard object library 319.

In some embodiments, the standard object library 319 is configured to store standard object data indicative of objects whose appearance and shape can vary but which nevertheless are desirable to identify. For instance, ingredients, such as a fish fillet, steak, tomato or apple.

In the object recognition process 310, the 2D subsystem comprising the 2D camera handler module 312 is responsible for the detection, determination of position, size, orientation and contour of objects lying on the work surface 4 for cooking or elsewhere within the kitchen module 1. The 3D subsystem, incorporating the 3D camera handler module 316, carries out a determination of a three dimensional shape of objects and is responsible for determining the shape and type of unknown objects.

In some embodiments, the object recognition process 310 is used to calibrate a robot or other computer-controlled components within the robotic kitchen module 1.

Referring now to FIG. 139 of the accompanying drawings, an object recorder process 325 comprises an object recorder module 326 which is configured to receive the 2D shape data 313 from the camera handler module 312. The recorder module 326 is configured to receive 3D shape data 317 from the 3D camera handler module 316.

In some embodiments, the recorder module 326 is also configured to receive position, shape and/or pressure data output from a robotic hand 327 which is holding an object.

The recorder module 326 receives the 2D and 3D shape data 313, 317 and preferably also the data from the robotic hand 329 and produces standard object data 318 if the object being recorded is a standard object and saves the standard object data 318 in the standard object data library 319. If the object is a temporary object, the recorder module 326 stores temporary object data 319 in the temporary object data library 320.

The recorder module 326 is further configured to output object data 330 which is indicative of co-ordinates, timings, fingertip trajectories and other recognized aspects of an object. The objects data 330 is then integrated into recipe data 322 for subsequent use when cooking a recipe within the robotic kitchen.

In some embodiments, the 2D camera 308 and/or the 3D camera 309 are configured to record video footage of operations or manipulations performed within the robotic kitchen module 1. The video footage is, for instance, for subsequent use for categorizing standard and known objects.

FIG. 140 shows a modified object recognition process of a further embodiment. This embodiment comprises a blob detector module which is configured to receive 2D video, calibration parameters and background parameters and to output blob position data to a validator module. The validator module uses the blob position data to assist the object validation process in the robotic kitchen.

FIGS. 141-145 show examples of three different techniques implemented in some embodiments for measuring an ingredient. The first uses tilt data obtained from a robotic arm, the second uses a measuring implement operated by robotic arms and the third uses dynamic weight sensing.

FIGS. 146-149 show a handle of an appliance or a utensil of some embodiments. The handle is optimized for use by a robot hand. The handle of some embodiments is an elongate handle that is shaped such that a robot's hand holds the handle in one position and orientation.

Each handle comprises a plurality of machine readable markers which are at spaced apart positions. In some embodiments the machine readable markers are magnets. Sensors on a robot hand detect the markers and check the position of the markers in the robot's hand to verify if they handle is being held correctly by the robot's hand.

Weight Sensing Capability (W.S.C.)

The Weight Sensing Capability 2700 provides the ability to measure the quantity, represented by an appropriate unit, of the food and other objects in the Cooking Automation including the Robotic Kitchen. From now on the acronym “W.S.C.” is used in place of “Weight Sensing Capability” 2705.

W.S.C.—Glossary 2710
CONTAINER: an object, can contain an ingredient
INGREDIENT: a material, can be used to create a recipe.
LOCATION: a place in the workspace, can be a source or a destination, can be a container.
at a location there can be one or more ingredients.
a location can be a carrier.
SOURCE: the location from where an ingredient is present.
CARRIER: an object, can be used to transport an ingredient. The carrier can be a utensil, a container or any other device where an ingredient can be held.
If there is no carrier, the robot is directly moving an ingredient.
DESTINATION: the goal location where a carrier or an ingredient will be moved
QUANTITY: the quantity of mass. The mass can be calculated using one or more sensors.
SENSOR: the set of one or more sensing devices used to measure the quantity.
UTENSIL: a tool use in the kitchen. EG: spoon, pan, fork, glass, cup, knife, bowl, dish
ROBOT: an automated device composed by a robot-base, one or more robot-arms, one or more end-effector mounted on a robot-wrist and other necessary minor components.
ROBOT-BASE: part of the robot, the robot-arms are connected to the robot-base.
ROBOT-JOINT: the actuated device, connects two or more robot-links in order to move one or more robot-links with respect to the other/s.
ROBOT-LINK: the mechanical part of a robot, is moved by a single robot-joint.
ROBOT-ARM: the aggregation of one or more small robot-links, interconnected in sequence through one or more robot-joints. The first robot-link of the sequence is connected to a robot-base through one or more robot-joints, the last robot-link of the sequence is connected to an end-effector, can be a robot-hand.
ROBOT-WRIST: the last robot-link of a robot-arm.
ARM-LINK: a robot-link, is part of a robot-arm.
END-EFFECTOR: the robotic tool mounted on the robot-wrist of a robot-arm
ROBOT-HAND: an end-effector composed by one or more robot-fingers. An example implementation is a robotic gripper.
ROBOT-FINGER: the aggregation of one or more small robot-links, interconnected in sequence through one or more robot-joints. The first robot-link of the sequence is connected to a robot-hand through one or more robot-joints.
SYSTEM: the central system, composed by hardware and software parts, will monitor and control the overall process.
DIRECT-INGREDIENT-MANIPULATION: the act of manipulating ingredients 4027 directly with robot-fingers, without a carrier 4060, nor utensil (4020,4021,4022), nor container (4025,4026).
WORKING AREA: The area reachable by the robot with any of the end-effectors.

In FIG. 150 represents: W.S.C.—Generic scenario representation 2715. In an example generic scenario of application, there is a table 4000, an ingredient 4027, can be loose ingredients 4028 or boxed ingredient 4029, empty containers 4025, filled containers 4026, utensils 4020, filled utensils 4022, one robot 4001 composed of one or more robotic-arms 4010 and other parts. Every robot-arm 4010 is mounted on a robot-base 4005. Every robot-arm 4010 is composed by one or more arm-links (4011, 4012, 4013). In the scenario there is one robot-arm 4010 composed by 3 robot-links (arm-link-1 4011, arm-link-2 4012, arm-link-3 4013) and the end-effector 4015.

The end-effector 4015 could hold a utensil 4020, can be an empty utensil 4023 or a filled utensil 4022.

Once a utensil 4020 is held by the end-effector 4015, the utensil becomes a “held utensil” 4021.

An ingredient 4027 could be inside a filled container 4026 inside a filled utensil 4022, or a loose ingredient 4028.

A container can be an empty container 4025.

A container containing a certain quantity of an ingredient is a filled container 4026. The sensor 4002 is not shown, but the sensor is integrated into the physical structure of the robot 4001.

### W.S.C.—Technical Outline 2720—(Summary)

The concept is the weight of a payload can be accurately measured by the robotic system (arm/s, grippers/hands, and potentially linear actuators—rail, telescopic mast).

The phrase “weighing a payload” means here “measuring the quantity of mass of a payload”.

In order to measure the quantity of mass of a static payload, force and/or torque sensors 4002 can be incorporated into the structure of the robot 4001. The sensor information combined with known robot-joint positions and a known physical structure of the robot 4001 can be utilized to calculate the force at the end-effector 4015 and therefore the weight of the payload.

Despite the payload not being shown in the FIG. 150, the payload can be comprised of a container (4026, 4025), a held utensil 4021, an ingredient (4027) or a composition, as explained here below.

The weighing action consists of measuring the quantity of mass of a payload.

If the end-effector 4015 is holding an ingredient 4028 with the robot-fingers, ingredient 4028 is the payload.

If the end-effector 4015 is holding an empty container 4025 with robot-fingers, container 4025 is the payload.

If the end-effector 4015 is holding a filled container 4026, and inside the non-empty-container 4026 there is a quantity of an ingredient 4029, then the payload is the composition of the filled-container 4026 plus the ingredient 4029.

If the end-effector 4015 is holding a utensil 4021, then the utensil 4021 is the payload.

If the end-effector 4015 is holding a utensil 4021, and the utensil 4021 contains a quantity of an ingredient 4027 (a filled utensil 4022) then the payload is the composition of the utensil 4021 plus the contained ingredient 4027.

There are commercial products available to give robots the ability to sense force and torque for a variety of reasons.

W.S.C.—Sensors 2725

Two kinds of measurement are considered: direct measurement and indirect measurement. In an example implementation of direct measurement, a range of different sensors could be used, such as: linear strain gauge, load cell, magnetostrictive torque sensing. The linear strain gauge is a common force sensor and a load cell sometimes consists of a strain gauge. The load cell can be based on different technologies such as: strain gauge, hydraulic and pneumatic. Magnetostrictive Torque sensing is a torque sensor based on the magnetostrictive property of ferromagnetic materials. With indirect measurement, force or torque information can be inferred from related information. An example implementation is where the electric current of the robot motors can be measured to calculate torque information, as the electric current in some motors is directly proportional to the torque applied on the motor axis.

W.S.C.—Sensors Location 2730

The sensor 4002 can be mounted in any part of the robot 4001 and accurately determine payload weight—dependent on the precision of the sensor 4002 and other factors.

The physical quantity to be measured is the quantity of mass of the payload.

As shown in FIG. 151A, 151B, 151C, 151D, the elements of the robot 4001 must have known position in order to calculate the robot configuration correctly and subsequently infer payload weight.

Inaccuracies in the positioning feedback would reduce the accuracy of the payload weight calculation. Inaccuracies can be introduced by robot-joint position, sensor precision, flex of the robot-links.

FIG. 151A represents the use case: W.S.C.—Sensor Mounted on the End-Effector 2731.

There is a robot-arm 4010, with the sensor 4002 mounted on the mounting location 4030 on the end-effector 4015.

The physical robot configuration 4040 to consider is shown.

FIG. 151B represents the use case: W.S.C.—Sensor Mounted on the 3rd link 2732. There is a robot-arm 4010, with the sensor 4002 mounted on the mounting location 4030 on the 3^{rd} link.

FIG. 151C represents the use case: W.S.C.—Sensor Mounted on the 2nd link 2733. There is a robot-arm 4010, with the sensor 4002 mounted on the mounting location 4030 on the 2^{nd} link.

FIG. 151D represents the use case: W.S.C.—Sensor Mounted on the base 2734. There is a robot-arm 4010, with the sensor 4002 mounted on the mounting location 4030 on the robot-base 4030.

FIG. 112 represents the Payload Mass Quantity Calculation Scenario 3061. The sensor 4002 is mounted on robot wrist. The sensor 4002 is generic: the signals provided by the sensor can be linear forces, accelerations, torques or angular velocities.

The possible measured physical values are show as vectors. The application point is P. The reference frame of the sensor is shown in the FIG. The reference frame of the sensor is composed by the axes X, Y, Z and the origin O.

In this example the application point P is equal to the origin O of the reference frame of the sensor.

The gravity force of the payload is Fgp, the gravity force of the end-effector is Fge.

The center of mass of the payload is C, the center of mass of the end-effector is Ce.

Fx, Fy, Fz are the measured linear forces applied along the axes X, Y, Z.

Mx, My, Mz are the torques measured around the axes X, Y, Z.

Ax, Ay, Az are the accelerations measured along the axes X, Y, Z.

Wx, Wy, Wz are the angular velocities measured around the axes X, Y, Z.

FIG. 112 represents a generic case. The sensor can provide only some of the signals Fx, Fy, Fz, Mx, My, Mz, Ax, Ay, Az, Wx, Wy, Wz.

Depending of the signals provided by the specific sensor/s used, the calculation of the center of mass is done in different ways.

In this example we show also the sum of the 3 forces sensed by the sensor 4002, the resulting force Fr.

Example of mass quantity calculation based on linear forces.

If the sensor provides the linear forces Fx, Fy, Fz, the resulting force vector is Fr=Fx+Fy+Fz.

The payload and the end effector constitute a rigid body called sensed body.

The only force applied to the sensed body is the gravity force, Fg=Fge+Fgp

The sensed body is not moving.

The resulting calculated force Fr is the gravity force plus some noise represented by the variable Fn, and the amount of the force Fr is proportional to the mass of the sensed body.

The final formula to calculate the mass of the sensed body is:

∥Fr+Fn∥=∥Fg∥=∥g∥*m

Where m is the mass of the sensed body, g is the gravity acceleration, Fr is the resulting force measured, Fn is the noise.

The amount of the noise Fn must be small with respect to the resulting force Fr in order to obtain accurate measurements.

Payload Mass Quantity Calculation and End Effector Mass Quantity

Let's call composite body the rigid body composed by the union of the end effector and the payload.

The mass of the payload is calculated as the mass of the composite body minus the mass of the end effector.

If the end effector is measured without a payload, the end effector is the sensed body.

If the composite body is measured, the composite body is the sensed body.

Mass Quantity Calculation and Center of Mass Localization

Given a specific mounting location of the generic sensor 4002, in order to calculate the mass quantity of the payload the position of the center of mass of the payload with respect to the end-effector reference frame must be known. The calculation of the position of the center of mass of the payload is based on the data coming from the sensor 4002.

The position of the center of mass of the payload is initially unknown.

Considering a constant robot configuration and two different payloads A and B, payload A and B can be held by the end-effector with different geometric transformations, in all instances with a different position of the center of mass with respect to the reference frame of the end-effector. Despite the two payloads having a different mass, there is the possibility the sensor values when holding payload A are the same values as when holding payload B, because the two payloads are held using two different transformations. Such is the case for the torque sensor. For example, the torque sensors give different results with different positions of the center of mass with respect to the point of application.

From another perspective, considering a constant robot configuration and only one payload A, with a specific mass, the mass can be held with different transformations. Considering two transformations transformation-A and transformation-B, the sensor values can likely be different if the transformations are different.

One method to solve the uncertainty about the center of mass position is to perform N different robot configurations, holding the payload with the same constant transformation between the end-effector and the payload, collecting the sensor data for the robot configurations. Using the N sensor data sets collected in N different robot configurations the position of the center of mass of the payload can be calculated with respect to the end-effector reference frame. In a robot configuration the robot can be moving, so the robot-links can have acceleration and velocity different from zero. Once the position of the center of mass of the payload, with respect to the end-effector reference frame, is known, the mass of the payload can be calculated.

With specific kind of sensors is also possible to measure the mass quantity without knowing the center of mass position. For example with a multi axis linear force sensor the resulting linear force vector can be calculated. For example in the following conditions is possible to use the resulting force vector to calculate the mass quantity of the payload: payload and gripper are tightly connected resulting in a rigid body, payload and gripper don't move, payload and gripper are under the gravity force and there are no other forces.

W.S.C.—Flowcharts Variables 2740:

### RS: Recipe Step Info

### SS: Step Status Info

### I: Ingredient Info

### C: Carrier Info

### L: Location Info

### S: Source Info

### D: Destination Info

### E: Environment Info

### X: Sensor Data

### RQ: Required Quantity

### GT: Generated Trajectory

### PAP: Pick Action Parameters

### FRB: Flow Regulator Block

### FCB: Flow Converter Block

### FBB: FeedBack Block

### FRQ: Final Requested Quantity

### FB: FeedBack Data

### RJV: Robot Joint Values

### CAC: Carrier Actuation Command

Flow: dispensing flow

### Q: Mass Quantity

### T: Transferred Quantity

### TQ: Tare Quantity

### SYS: System Data

W.S.C.—Flowchart Variables Dot Notation 2741

The dot “.” notation is used to express a sub-property of a specified variable. For example, given X (Sensor Data), and Q (Quantity Data), “X.Q” means “Sensor Quantity Data”, “S.Q” means “Source Quantity Data” and so on.

W.S.C.—Weighing Ingredients while Moving 2750

The task describes the process of transporting an ingredient (4027,4080) from the source 4050 to the destination 4070, using a carrier 4060, and at the same time measuring the mass quantity of the transported ingredient (4027,4080).

The source and the destination have a location, a position within the working area.

The source 4050 and the destination 4070 can be abstract and not represent any object, just a location on the table 4000.

The source 4050 can be any kind of container (4025,4026), a utensil (4020,4021) like a spoon, a pan or an appliance.

The destination 4070 can be any kind of container (4025,4026), a utensil (4020,4021) like a spoon, a pan or an appliance.

The carrier 4060 can be a container (4025, 4026), a utensil 4020, 4021 or not present. When the carrier 4060 is not present there is a direct food manipulation 3060.

FIG. 152A represents W.S.C.—Sensing capability when carrier 4060 is present and is not the source 2751.

The carrier 4060 is not the source 4050.

The ingredient 4080 is transported within a carrier 4060 from the location specified in the source 4050 to the location specified in the destination 4070.

FIG. 152B represents W.S.C.—Sensing capability when carrier 4060 is present and is the source 2752.

The carrier 4060 is the source 4050.

The ingredient 4080 is transported within a carrier 4060 from the location specified in the source 4050 to the location specified in the destination 4070.

FIG. 152C represents W.S.C.—Sensing capability when carrier 4060 is not present 2753.

The ingredient 4080 is transported without any carrier 4060, using direct food manipulation 3060, from the location specified in the source 4050 to the location specified in the destination 4070.

FIG. 153A is a flow chart and describes W.S.C.—Verify Correct Quantity—in container 2760.

The block 5018 gets the Recipe Data 5010 from the Recipe Data Storage 5016.

In the block 5019 the Recipe Data 5010 is used to make a query to the Status Data Storage 5017 and returns the Status Data 5011.

In the block 5020 a pickup action is executed, and the picked object is the ingredient container (4026, 4050) specified by the variable Source Info, extracted from the Status Data 5011 previously retrieved in the block 5019.

In the block 5021 the source quantity is measured and stored in S.Q by removing the tare quantity stored in S.TQ from the sensed quantity stored in X.Q and is returned as sensor data 5012A by the sensor 4002.

In the block 5022 there is the calculation of the difference DIFF between the quantity specified by the Recipe Step Quantity stored by RS.Q and the sensed quantity stored by S.Q.

When the difference DIFF is positive, there is not enough quantity in the source container 4050 defined by the variable Source Info.

The block 5023 is a decision block. In block 5023 the difference DIFF is checked. If the difference DIFF is positive then the next executed block will be 5015, otherwise block 5024 will be the next executed block.

The block 5024 is a decision block. In block 5024 the variable DIFF is tested, if the variable DIFF is negative then the next executed block will be 5013, otherwise the next executed block will be the block 5014

FIG. 153B is a flow chart and describes W.S.C.—Verify Correct Quantity—not in container 2761.

The block “Get Recipe Data” 5018 gets the Recipe Data 5010 from the Recipe Data Storage 5016.

In the block 5030 the robot 4001 is commanded to pick up the ingredient 4027 with the robot-fingers.

In the block 5031 the value of the quantity of mass of the raw ingredient 4027 is measured, while the ingredient is held by the robot-fingers. The value is stored in the variable S.X, and is part of the sensor data 5012B, generated by the sensor 4002.

In the block 5032 the difference between the recipe step quantity RS.Q and the sensed quantity X.Q is calculated.

If DIFF is positive, there is not enough quantity in the source container (4026,4025) defined by S.

The block 5023 is a decision block. In block 5023 the variable DIFF is tested, if DIFF is positive then the next executed block is 5015, otherwise the next executed block is 5024.

The block 5024 is a decision block. In block 5024 the variable DIFF is tested, if DIFF is negative then the next executed block is 5013, otherwise the next executed block is 5014.

FIG. 154 is a flow chart and describes the process “W.S.C.—High Level Transfer” 2800.

The block “Get Recipe Data” 5018 gets the Recipe Data 5010 from the Recipe Data Storage 5016.

The block 5040 gets the Status Data 5041 from Status Data Storage 5017, then an empty variable I is created to store the Ingredient Info and an empty variable SS to store the Step Status Info.

In the block 5042 there is the calculation of the thresholds ET (Excess Threshold) and DT (Deficit Threshold). The way the two thresholds are calculated is not explained here.

In the block 5043 the difference between RS.Q and SS.T is calculated. The difference is positive when the Recipe Step Quantity RS.Q is bigger than the Step Status Transferred Quantity SS.T. The difference is then tested against the Excess Threshold. So if the difference is bigger than the Excess Threshold ET, there is still the need of transferring a portion of ingredient (4080,4027) quantity from the source 4050 to the destination 4070. If the transfer has to be continued then the next block will be 5044, otherwise the next block will be 5048.

In the block 5044 the external procedure Low Level Transfer 2850 is executed, by inputting Data 5050A outputting and receiving Data 5051A.

In the block 5045 the external procedure Check Data 5047 is executed, by inputting Data 5050B and outputting Data 5051B. The external procedure Check Data performs checks on the quantity variations in the source, in the destination and in the carrier if is present. If any data incoherence is found, the procedure tries to identify the problem and the cause, informing the system.

In the block 5046 the Status Data Storage 5017 is updated by receiving Status Data 5051B.

In the block 5048 the difference between RS.Q and SS.T is calculated. The difference is positive when the Recipe Step Quantity RS.Q is bigger than the Step Status Transferred Quantity SS.T. The difference is then tested against the Deficit Threshold DT. So if the difference is less than the Deficit Threshold DT, the transferred quantity SS.T is more than the quantity specified by the recipe step quantity RS.Q, so there is an Excess Problem. So if there is an excess problem the next block will be 5049, otherwise the next block will be an End block.

In the block 5049 the system is informed about an Excess Problem, the handling of the Excess Problem by the system is not explained here.

FIG. 155 is a flow chart and describes the process “W.S.C.—Low Level Transfer” 2850.

The block 5090 gets the Input Data 5050A.

The block 5091 saves the initial values of the source 4050 and the destination 4070 into the variables ISQ and IDQ for future use within the flow chart. The saved values are the Initial Source Quantity ISQ and the Initial Destination Quantity IDQ. ISQ and IDQ are set to the values contained in the variables retrieved in the previous block. The variables are the Source Quantity S.Q and the Destination Quantity D.Q.

In the block 5092, the presence of a carrier 4060 is tested, using the information contained in the variable Carrier Info C. If the carrier 4060 is absent, a direct food manipulation 3060 is needed, so the next block is 5106, otherwise the next block is 5093.

In the block 5106 the data 5050A is sent to the external procedure Direct Food Manipulation 3060, then when the external procedure finishes the data 5165 is sent back to the block 5106.

In the block 5093 the robot 4001 is commanded to pick up the carrier 4060 specified in the variable Carrier Info C, contained in the Input Data retrieved previously.

In the block 5094 the carrier 4060 is checked for equality to the source 4050, using the information contained in the variable Carrier Info C and in the variable Source Info S. So if the carrier 4060 is the same as the source 4050, the source 4050 has to be transported to the destination 4070, so then the next block is 5095, otherwise the next block is 5098.

In the block 5095 the requested quantity to collect is calculated and stored in the variable RQ. The calculation is based on the recipe step quantity RS.Q and the Status Step Transferred Quantity SS.T. The quantity RQ will be exactly the difference between RS.Q and SS.T; the requested quantity RQ will be positive when RS.Q is greater than SS.T.

In the block 5096 the Source Info variable S is remapped to the Location Info variable L, in order to be passed as parameter to an external procedure. The data 5060A is sent to the external procedure “Collect desired quantity of ingredient with carrier from location” 2900.

In the block 5097 the external procedure “Collect desired quantity of ingredient with carrier into location” 2900 returns, sending Output Data 5061A to the block 5097. Then the source info variable S is unmapped from the location info variable L, in order to update S with the new value contained in L.

In the block 5104 the source info variable S is remapped to the Location Info variable L, in order to be passed as parameter to an external process. The data 5060B is sent to the external procedure “Dispense desired quantity of ingredient with carrier from location” 2950.

In the block 5105 the external procedure “Dispense desired quantity of ingredient with carrier into location” 2950 returns, sending Output Data 5061B to the block 5105. Then the source info variable S is unmapped from the location info variable L, in order to update S with the new value contained in L.

In the block 5098 the carrier 4060 defined by the variable Carrier Info C is moved to the location specified by the destination 4070 defined by the variable Destination Info D.

In the block 5099 there is the calculation of the required quantity RQ to dispense. The calculation is based on the recipe step quantity RS.Q and the Status Step Transferred Quantity SS.T. The quantity RQ is exactly the difference between RS.Q and SS.T; RQ is positive when RS.Q is greater than SS.T.

In the block 5100 the destination info variable D is remapped to the Location Info variable L, in order to be passed as parameter to an external process. The data 5060C is sent to the external process “Dispense desired quantity of ingredient with carrier from location” 2950.

In the block 5101 the external process “Dispense desired quantity of ingredient with carrier into location” 2950 returns, sending the Output Data 5061C to the block 5101. Then the destination info variable D is unmapped from the location info variable L, in order to update D with the new value contained in L.

In the block 5102 the Step Status Transferred Quantity is updated and stored in the variable SS.T. The update consists of adding the new transferred quantity to the existing variable SS.T. The new transferred quantity is calculated doing the average between source 4050 depletion and the destination 4070 increment. The source 4050 depletion is calculated as the difference Initial Source Quantity and the current Source Quantity, the difference is positive when Initial Source Quantity is bigger than the current Source Quantity. The destination 4070 increment is calculated as the difference between the Initial Destination Quantity and the current Destination Quantity. The difference is positive when the Initial Destination Quantity is smaller than the current Destination Quantity. So the average quantity is calculated as the sum of the depletion and the increment, divided by two.

In the block 5103 the Status Data 5051A is sent to output.

FIG. 156 is a flow chart and describes the process “W.S.C.—Collect desired quantity of ingredient with carrier from location” 2900.

The block 5110 gets Input Data 5060A and Environment Data 5070A.

The block 5111 cleans the carrier 4060 defined in the variable Carrier Info C. The cleaning process is not explained here.

The block 5112 measures the CarrierT are Quantity C.TQ and the value is set to equal to the value contained in the variable Sensor Quantity X.Q. The Sensor Quantity X.Q is returned by the sensor 4002 integrated into the robot structure.

In the block 5113 the Action Data 5071 is retrieved from the Action Storage 5018. The Action Data 5071 contains the Pick Action Parameters, stored in the variable PAP. The Pick Action Parameters define completely the pickup action to perform and is different based on the ingredient 4080 and the internal state, the carrier 4060, the required quantity RQ to collect, the Recipe Step Info RS, the environment data (stored in the variable E) like humidity, temperature, atmospheric pressure. So in order to get the correct Pick Action Parameters a query is sent to the Action Storage 5018, using Input Data 5060 and Environment Data E.

In the block 5114 a trajectory GT is generated, based on the Pick Action Parameters. The way the trajectory is generated is not explained here.

In the block 5115 the generated trajectory GT is sent to the robot controller 5151 then the robot controller 5151 will execute the generated trajectory GT. The generated trajectory is sent using Trajectory Data 5072.

In the block 5116 the CarrierQuantity is calculated. The quantity is the difference between the sensed quantity X.Q and the CarrierTare Quantity C.TQ. The difference is positive when the Sensed Quantity X.Q is bigger than the CarrierTare Quantity C.TQ. The sensed quantity X.Q is retrieved from the sensor 4002 using the Sensor Data 5012D.

In the block 5117 the location quantity, stored in L.Q, is updated by removing the Carrier Quantity C.Q. Then the data is sent out within the Output Data 5061A.

FIG. 157 is a flow chart and describes the process “W.S.C.—Dispense desired quantity of ingredient with carrier into location” 2950.

The block 5120 gets Input Data 5060B/C.

The block 5121 saves the Initial CarrierQuantity in a variable ICQ, and sets ICQ equal to the Carrier Quantity C.Q, contained in the Input Data.

In the block 5122 the data 5012E is retrieved from the sensor 4002, then the Final Required Quantity FRQ is calculated. The Final Requested Quantity is the quantity supposed to be contained into the carrier at the end of the process 2950 and so the Final Requested Quantity is also the quantity supposed to be sensed by the sensor 4002 at the end of the process. Note the Requested Quantity RQ is the quantity to remove from the location specified by Location Info L. So the value “Final Required Quantity” is calculated as the difference between the Sensed Quantity X.Q and the Requested Quantity RQ. The difference is positive when the sensed quantity X.Q. is bigger than the Requested Quantity RQ. The Sensed Quantity X.Q is contained in the sensor data 5012E.

In the block 5123 the data 5012F is retrieved from the sensor 4002, then the Feedback Data is calculated as the difference between the Final Requested Quantity and the sensed quantity. The difference will be positive when the Final Requested Quantity is bigger than the sensed quantity X.Q.

The sensed quantity is contained in the Sensor Data 5012F.

In the block 5124 the FeedBack Data FB is checked against the MaximumError ME. Maximum Error is the maximum allowed error, so at the end of the process the real transferred quantity differs from the Requested Quantity RQ by the amount defined by MaximumError. The value MaximumError is used here to stop the process. If the FeedBack Data, representing the error value of the closed loop system shown in FIG. 3000, is smaller than the Maximum Error, the process is stopped by exiting the loop 5185, otherwise the loop 5185 is continued. So if the check passes, the next block is the block pointed by the arrow tagged with Y, otherwise the next block is the block pointed by the arrow tagged with N.

The block 5125 updates the external blocks Flow Regulator Block 5141 and Flow Converter Block 5142 of the closed loop system 3000 by sending the Control Data 5129.

In the block 5126 the previously calculated FeedBack Data variable FB is sent to the system block Flow Regulator Block.

The block 5126 closes the loop 5185, so the next block will be the block 5123 again.

In the block 5127 the Carrier Quantity C.Q is updated by removing the Requested Quantity value and the Feedback Data value. The Feedback Data value represents the quantity missing from the carrier 4060, so the Feedback Data value is removed from the Carrier Quantity in order to obtain the correct value.

In the block 5128 the Location Quantity L.Q is updated by adding the Requested Quantity value and the Feedback Data FB value. The Feedback Data FB, has been transferred into the location defined by L because is the quantity missing from the carrier 4060, so FB is also the quantity in excess into the location defined by L. The excess quantity defined by FeedBack Data FB is added to the Location Quantity L.Q to obtain the correct value. Finally the data 5061B/C is sent as output to the caller procedure.

The block 5141 represents the external block Flow Regulator Block FRB. Flow Regulator Block is part of the Closed Loop System 3000 and receives environment data 5070B from the system.

The block 5142 represents the external block Flow Converter Block FRB. Flow Converter Block is part of the Closed Loop System 3000. The block receives environment data 5070B from the system.

The block 5051 represents the external macro block ROBOT-CARRIER-SENSOR-SUBSYSTEM shown in the Closed Loop System 3000.

The block 5143 represents the external block FeedBack Block FB. Feedback Block is part of the Closed Loop System 3000.

FIG. 158 is a flow chart and describes the process “W.S.C.—Closed Loop System for Ingredient Transfer with Utensil” 3000.

The block 5123 is the error calculation node of the closed loop system 3000. Here the error value is calculated, called FeedBack Data, and is stored in the variable FB. The value is calculated as the difference between Final Requested Quantity and the Sensed Quantity X.Q retrieved from the sensor 4002 as sensor data 5012F; the difference is positive when the Final Requested Quantity is greater than the Sensed Quantity.

The mass flow from the carrier 4060 to the location defined by L is affected not only by the robot manipulation, but also by the ingredient state (defined by the name, temperature, mass state, moisture, density, ph, etc.), the carrier 4060, the location (location could affect the flow). The mass flow can also be dependent on the information contained in the Recipe Step Info and in the Step Ingredient Info, so the data is received by the blocks FRB and FCB as input within the Control Data 5129.

Note: The mass flow from the carrier 4060 to the location defined by L is affected also by the environment state, (defined by the air temperature, humidity, pressure, light, air composition), so the data is received by the blocks FRB and FCB as input within the Environment Data 5070B.

The block 5141 is the Flow Regulator Block FRB and decides the Flow value of mass to flow from the carrier 4060 to the location defined by L, based on the current value of FeedBack Data FB, the Control Data 5129 and the environment data 5070B. The Flow value is then sent to the block 5142.

The block 5142 is the Flow Converter Block and performs a conversion on the commanded flow value, received from the previous block 5141, based on the control data 5129 and the environment data 5070B. The Flow value is converted to Robot Joint Values data and Carrier Actuation Command data. The Robot Joint Values data is then used to command the robot 4001 to manipulate the carrier 4060 in a way to produce the requested mass flow of the ingredient 4080 from the carrier 4060 to the location defined by L. If the carrier 4060 is an actuated carrier then a Carrier Actuation Command is sent to the carrier 4060. The Carrier Actuation Command controls the actuated carrier 4060 in order to produce more or less mass quantity flow of the ingredient 4080 from the carrier 4060 to the location defined by L. The Carrier Actuation Command transmitted without cables, using a wireless method not defined here.

The macro block 5150 is the ROBOT-CARRIER-SENSOR-SUBSYSTEM, and consists of the chain of blocks 5151, 5152, 5153, 5154. The input of the ROBOT-CARRIER-SENSOR-SUBSYSTEM is the robot 4001, the output is the signal from the sensor 4002.

The block 5151 is the robot controller 5151, and will convert the Robot Joint Values Data to the necessary electric power commands, providing the electric power commands to the robot block 5152, in order to ensure the desired joints configuration. The necessary electric power commands are sent by the robot controller 5151 to the actuators of the robot-joints.

The block 5152 represents the real robot 4001. The block receives the power commands from the block 5151 and sends the power commands directly to the motors, making the robot to perform the pose corresponding to the robot-joints configuration requested by the block 5142.

The block 5153 is the carrier 4060 and is manipulated by the robot 4001. Depending on the current robot manipulation, a different amount of mass flow is produced from the carrier 4060 to the destination 4070. A robot manipulation is composed by one or more robot poses, executed in a specific sequence, where the pose/s are executed at a specific time.

The block 5154 represents the interface with the real sensor 4002 on the robot 4001 and produces signals based on the perceived force or torque. The resulting signals are then sent to the next block 5143.

The block 5143 converts the sensor signals to sensor data 5012F and sends the sensor data back to the error calculation block 5123, closing the loop of the controlled system 3000.

FIG. 159 is a flow chart and describes W.S.C.—Sensor Measurement 3050.

The block 5081 calculates the sequence of end-effector poses needed to perform the measurement.

The block 5082 Extract the next pose in the sequence.

The block 5083 receives the Input Data 5080, containing the robot joint values and the robot model. Using Input Data 5080, the block 5083 subsequently calculates the current robot configuration, for use in the next blocks.

The block 5084 measures the physical values from the sensor 4002.

The block 5085 checks if the current pose is the last of the sequence, if the current pose is the last of the sequence the next block is 5086, otherwise the next block is 5082.

The node 5086 calculates the mass quantity X.Q based on the physical values read in the previous block 5082, and also based on the robot configurations calculated in the previous block 5081. The 5086 block then saves the calculated values in the variable Sensed Quantity X.Q, and then is output as Sensor Data 5012A/B/C/D/E/F/G.

The task requires a perfect grasp between the hand and the object, because the tridimensional geometric transformation between the robot-hand's reference frame and the position of the center of mass of the grasped object must be known with sufficient accuracy in order to ensure the required precision and repeatability of the measurement.

FIG. 160 is a flow chart and describes W.S.C.—Direct Ingredient Manipulation 3060

The block 5160 reads input data 5050A, the robot is commanded to pick up the ingredient, defined by the variable Ingredient Info, from the source, defined by the variable Source Info, using the robot-fingers.

In the block 5161 the robot is commanded to move the ingredient to the destination defined by the variable Destination Info.

The block 5162 the data 5012G is retrieved from the sensor 4002.

In the block 5163 the source quantity is updated and saved into the variable Source Info.

In the block 5164 the destination quantity is updated and saved into the variable Destination Info. Then data 5165 is sent as output to the caller procedure.

W.S.C.—Measured Data Format.

The data format used to store the Mass Information in the DB.

The Measurement Unit to use is the gram [g] as defined in SI.

The required resolution is 0.01 g.

The measurement range goes from 0.01 g to 500 g

W.S.C.—Measured Data Storage Format.

There are different choices for the Storage Format (DB).

The Storage Format can be a float type (size is 4 bytes), with a range from −3.4E+38 to +3.4E+38, the smallest representable number is +/−3.4E-38. Float type precision is up to 7 digits.

The Storage Format can be an unsigned short int type (size is 2 bytes), with a range from 0 to 65535. A conversion must be made on load/store operations on DB, in order to convert the integer value to a decimal value. Example: float range [0.01, 500], unsigned int range [1, 50000], the conversion factor is calculated as 100.

Object Interaction

As defined in the Weigh Sensing Capability

5017 is the reference number for the “Status Data Storage”.

5012 is the reference number for the “Mass Quantity Sensor Data” coming from the sensor 4002.

4002 is the reference number for the sensor used to measure the mass quantity.

Flowcharts Variables:

### X: Mass Quantity Sensor Data

### IR: Interaction Request

### OS: Object Status

### OOD: On Object Data

### GR: Grasp Request

### GI: Grasp Info

### IA: Interaction Answer

### GM: Grasp Manipulation Data

### X: Mass Quantity Sensor Data

### CMDU: Cleaning Manipulation Data for Utensil

### CMDO: Cleaning Manipulation Data for Object

### X: Mass Quantity Sensor Data

FIG. 162 is a flow chart and describes the task Object Interaction—Pick up object 6501.

The block 6001 receives Interaction Request data 6200A from the caller. The variable Interaction Request specifies the action to perform with the object.

The block 6002 performs a query on the Status Data Storage 5017, getting the variable Object Status. The variable Object Status contains the information about the status of the object, including the storage location of the object, the physical values measured the last time the object was accessed, the characteristics of the ingredient inside the object.

The block 6003 commands the robot to move the container to the location specified in the variable Interaction Request.

The block 6004 receives the On Object Data from the markers embedded into the object. The information transfer is facilitated using a wireless method.

The block 6005 performs checks based on the variables Interaction Request, On Object Data, Object Status. The correctness and state of the ingredient are checked. The sensors can measure temperature, humidity, volatile organic compounds. There can be other additional sensors not mentioned here. The sensor values are checked. The sensor values are contained in the variable On Object Data. The requirements about the ingredient are contained in the variable Interaction Request.

The block 6006 evaluates the results of the checks made in the block 6005. If checks pass then the next block is 6007, otherwise the next block is 6009.

The block 6007 sends Grasp Request data 6203A to the external procedure Grasp/Ungrasp object 6503.

The block 6008 receives Grasp Info data 6204A from the external procedure Grasp/Ungrasp object 6503.

The block 6009 outputs Interaction Answer data 6208A to the caller, then the procedure ends.

FIG. 163 is a flow chart and describes the task Object Interaction—Place object 6502

The block 6020 gets Interaction Request data 6200B containing the variable Interaction Request. The variable Interaction Request specifies the action to perform with the container.

The block 6021 receives the On Object Data from the markers embedded into the object.

The information transfer is facilitated using a wireless method. If the object has no markers embedded then the received data is empty and can be ignored.

The block 6022 performs a query on the status storage, getting the variable Object Status. The variable Object Status contains the information about the status of the container, including the storage location of the container, the physical values measured the last time the container was accessed, the characteristics of the ingredient inside the container.

The block 6023 performs checks based on the variables Interaction Request, On Object Data, Object Status. The correctness and state of the ingredient are checked. The temperature, humidity, ammonia and volatile organic compounds sensors values are checked. The sensor values are contained in the variable On Object Data. The requirements about the ingredient are contained in the variable Interaction Request.

The block 6024 evaluates the results of the checks made in the block 6023. If checks pass then the next block is 6025, otherwise the next block is 6028.

The block 6025 commands the robot to move the container to the location specified in the variable Object Request.

The block 6026 sends Grasp Request data 6203B to the external procedure Grasp/Ungrasp handle 6503.

The block 6027 receives Grasp Info data 6204B from the external procedure Grasp/Ungrasp handle 6503.

The block 6028 outputs Interaction Answer data 6208B to the caller, then the procedure ends.

FIG. 164 is a flow chart and describes the task Object Interaction—Grasp/Ungrasp handle 6503.

The flow chart explains the procedure used to perform a grasp or an ungrasp action with the robot-hand.

The block 6040 gets Grasp Request data 6203A/B. The Grasp Request data 6203A/B specifies the grasp action to perform on the handle.

The block 6041 performs a query on the Manipulation Storage 6050 using Grasp Request data 6203A/B. Then the block gets the requested Grasp Manipulation data 6205 from the Manipulation Storage 6050.

The block 6042 commands the robot using the Grasp Manipulation Data 6205, so the robot subsequently performs the commanded grasp/ungrasp manipulation.

The block 6043 reads sensor data. Sensors are not defined here. Sensors can be an external camera system, sensors inside the container, sensor on the hand. The sensor data is used to understand if the grasp is successful or not, and the information is stored in the Grasp Info data 6204A/B.

The block 6044 outputs Grasp Info data 6204A/B, then the procedure ends.

FIG. 165 is a flow chart and describes the task Object Interaction—Clean object 6504

The flow chart in the FIG. explains procedure used to clean an object.

The cleaning process can be done if the object is already grasped.

The cleaning process can be done by tilting the object in order to make the content fall. The cleaning process can be improved using a utensil in order to remove the ingredient from the object. During the cleaning process the content of the object falls into the waste location.

The action of using the object is encapsulated into the variable Cleaning Manipulation Data for Object 6207 and is stored in the Cleaning Manipulation Storage 6050.

The action of using the utensil is encapsulated in the variable Cleaning Manipulation Data for Utensil 6206 and is stored in the Cleaning Manipulation Storage 6050.

After the cleaning process the object is put into a specific storage space for storing dirty objects.

The block 6060 gets as input the Interaction Request data 6200C and the Object Status data 6201C. The Interaction Request data 6200C defines the cleaning action to perform. The Object Status data 6201C contains information about the object state.

The block 6061 reads On Object Data 6202C from the markers embedded into the object.

The block 6062 gets Mass Quantity Sensor data 50xx using the Weight Sensing Capability.

The block 6063 checks the Interaction Request data 6200C, the On Object Data 6202C, the Object Status data 6201C and the Mass Quantity Sensor data 50XX, in order to decide if the cleaning needs to be done or not and also to decide if a utensil is needed or not.

The block 6064 decides if the cleaning needs to be done or not. If the cleaning is needed then the next node is 6065, otherwise the next block is 6070.

The block 6065 decides if a utensil is needed or not. If an utensil is needed then the next block is 6066, otherwise is 6069.

The block 6066 calls the external procedure Pick up object 6501 sending Interaction Request data 6200D. The block then receives Interaction Answer data 6208A from the cal led procedure.

The block 6067 decides if the pick up action has been successful or not, based on Interaction Answer data 6208A.

The block 6068 receives cleaning manipulation data for utensil 6206 from the manipulation storage 6050.

The block 6069 receives cleaning manipulation data for object 6207 from the manipulation storage 6050.

The block 6070 commands the robot to clean the object, sending to the robot controller the manipulation data 6206 and 6207. A robot hand is controlled using cleaning manipulation data for object 6207. If the cleaning manipulation data for utensil 6206 has been retrieved then a robot hand is controlled using cleaning manipulation data for utensil 6202.

The block 6071 checks if the utensil is held or not. If the utensil is held then the next block is 6072, otherwise the next block is 6073.

The block 6072 calls the external procedure PlaceObject 6502, sending Interaction Request data 6200E to the called procedure. Then the block receives Interaction Answer data 6208B from the called procedure.

The block 6073 outputs Object Status data 6201D to the caller.

Security System

Flowcharts Variables:

### KSC: Kitchen Security Check

### FS: Fingerprint Sensor Data

### ID: Intrusion Sensor Data

### GPD: Geoposition Data

### KSA: Kitchen Security Access

### AID: Anti Intrusion Data

FIG. 166 is a flow chart explaining the procedure Security System—Security check 7501.

The purpose of the procedure is to check the user is allowed to use the robotic kitchen software, using sensor data coming from a geoposition sensor, a fingerprint sensor, one or more intrusion detection sensors.

The geoposition sensor is used to check the current geographical location of the robotic kitchen. If the robotic kitchen is detected to be in a place different from the location that the user registered the robotic kitchen, the user is not allowed to use the robotic kitchen. In an example implementation the geoposition information can come from a physical device such as a Global Positioning System (GPS) or through a geolocation service based on network data.

The fingerprint sensor is used to scan the fingerprint of the user's finger in order to check the user's identity. If the user is not the registered user for the robotic kitchen, the user is not allowed to use the robotic kitchen. In alternative implementations the user identifying data can come from other biometric sources such as voice or eye image analysis or through non-biometric means, such as a private password, a series of questions, a unique hardware key or through communication to a personal electronic device.

The intrusion detection sensors are used to detect a mechanical intrusion into some critical parts of the system.

An intrusion detection sensor can be located in the processing unit case in order to detect an attempt to open it.

Another intrusion detection sensor can be located in the control board case.

If an intrusion is detected, the Anti Intrusion System 7502 is informed.

The block 7001 receives Kitchen Security Check data 7101 from the caller procedure. The caller procedure sends Kitchen Security Check data 7101 to the procedure Security Check in order to ask access to the robotic kitchen, every time is needed.

The block 7002 receives Fingerprint sensor data 7102, Intrusion sensor data 7103, Geoposition data 7104 and performs some checks to see if the user is allowed to use the robotic kitchen or not.

The block 7003 decides if the user is allowed or not to use the robotic kitchen. If the user is allowed, the next block is 7004, otherwise the next block is 7005.

The block 7004 grants the access to the user by sending Kitchen Security Access data 7106 to the caller procedure, then the procedure exits.

The block 7005 sends Anti Intrusion Data 7105 to the Anti Intrusion Kitchen 7502, not giving access to the user, then the procedure exits.

The Anti Intrusion System 7502

The purpose of the Anti Intrusion System 7002 is to apply countermeasures in case of an intrusion attempt.

The Anti Intrusion System 7002 could erase or encrypt data inside the robotic kitchen, in order to protect the software from being copied and from reverse engineering.

The Anti Intrusion System 7002 could call the local authorities.

The Anti Intrusion System 7002 could disable the electric power to all the robotic kitchen boards and motors.

The Anti Intrusion System 7002 could disable the access to all sensor of the robotic kitchen.

The Anti Intrusion System 7002 could trigger electrical, physical or magnetic destruction of elements within the robotic kitchen.

In general terms, there may be considered a method of motion capture and analysis for a robotics system, comprising sensing a sequence of observations of a person's movements by a plurality of robotic sensors as the person prepares a product using working equipment; detecting in the sequence of observations minimanipulations corresponding to a sequence of movements carried out in each stage of preparing the product; transforming the sensed sequence of observations into computer readable instructions for controlling a robotic apparatus capable of performing the sequences of minimanipulations; storing at least the sequence of instructions for minimanipulations to electronic media for the product. This may be repeated for multiple products. The sequence of minimanipulations for the product is preferably stored as an electronic record. The minimanipulations may be abstraction parts of a multi-stage process, such as cutting an object, heating an object (in an oven or on a stove with oil or water), or similar. Then, the method may further comprise transmitting the electronic record for the product to a robotic apparatus capable of replicating the sequence of stored minimanipulations, corresponding to the original actions of the person. Moreover, the method may further comprise executing the sequence of instructions for minimanipulations for the product by the robotic apparatus 75, thereby obtaining substantially the same result as the original product prepared by the person.

In another general aspect, there may be considered a method of operating a robotics apparatus, comprising providing a sequence of pre-programmed instructions for standard minimanipulations, wherein each minimanipulation produces at least one identifiable result in a stage of preparing a product; sensing a sequence of observations corresponding to a person's movements by a plurality of robotic sensors as the person prepares the product using equipment; detecting standard minimanipulations in the sequence of observations, wherein a minimanipulation corresponds to one or more observations, and the sequence of minimanipulations corresponds to the preparation of the product; transforming the sequence of observations into robotic instructions based on software implemented methods for recognizing sequences of pre-programmed standard minimanipulations based on the sensed sequence of person motions, the minimanipulations each comprising a sequence of robotic instructions and the robotic instructions including dynamic sensing operations and robotic action operations; storing the sequence of minimanipulations and their corresponding robotic instructions in electronic media. Preferably, the sequence of instructions and corresponding minimanipulations for the product are stored as an electronic record for preparing the product. This may be repeated for multiple products. The method may further include transmitting the sequence of instructions (preferably in the form of the electronic record) to a robotics apparatus capable of replicating and executing the sequence of robotic instructions. The method may further comprise executing the robotic instructions for the product by the robotics apparatus, thereby obtaining substantially the same result as the original product prepared by the human. Where the method is repeated for multiple products, the method may additionally comprise providing a library of electronic descriptions of one or more products, including the name of the product, ingredients of the product and the method (such as a recipe) for making the product from ingredients.

Another generalized aspect provides a method of operating a robotics apparatus comprising receiving an instruction set for a making a product comprising of a series of indications of minimanipulations corresponding to original actions of a person, each indication comprising a sequence of robotic instructions and the robotic instructions including dynamic sensing operations and robotic action operations; providing the instruction set to a robotic apparatus capable of replicating the sequence of minimanipulations; executing the sequence of instructions for minimanipulations for the product by the robotic apparatus, thereby obtaining substantially the same result as the original product prepared by the person.

A further generalized method of operating a robotic apparatus may be considered in a different aspect, comprising executing a robotic instructions script for duplicating a recipe having a plurality of product preparation movements; determining if each preparation movement is identified as a standard grabbing action of a standard tool or a standard object, a standard hand-manipulation action or object, or a non-standard object; and for each preparation movement, one or more of: instructing the robotic cooking device to access a first database library if the preparation movement involves a standard grabbing action of a standard object; instructing the robotic cooking device to access a second database library if the food preparation movement involves a standard hand-manipulation action or object; and instructing the robotic cooking device to create a three-dimensional model of the non-standard object if the food preparation movement involves a non-standard object. The determining and/or instructing steps may be particularly implemented at or by a computer system. The computing system may have a processor and memory.

Another aspect may be found in a method for product preparation by robotic apparatus 75, comprising replicating a recipe by preparing a product (such as a food dish) via the robotic apparatus 75, the recipe decomposed into one or more preparation stages, each preparation stage decomposed into a sequence of minimanipulations and active primitives, each minimanipulation decomposed into a sequence of action primitives. Preferably, each minimanipulation has been (successfully) tested to produce an optimal result for that minimanipulation in view of any variations in positions, orientations, shapes of an applicable object, and one or more applicable ingredients.

A further method aspect may be considered in a method for recipe script generation, comprising receiving filtered raw data from sensors in the surroundings of a standardized working environment module, such as a kitchen environment; generating a sequence of script data from the filtered raw data; and transforming the sequence of script data into machine-readable and machine-executable commands for preparing a product, the machine-readable and machine-executable commands including commands for controlling a pair of robotic arms and hands to perform a function. The function may be from the group comprising one or more cooking stages, one or more minimanipulations, and one or more action primitives. A recipe script generation system comprising hardware and/or software features conFIG.d to operate in accordance with this method may also be considered.

In any of these aspects, the following may be considered. The preparation of the product normally uses ingredients. Executing the instructions typically includes sensing properties of the ingredients used in preparing the product. The product may be a food dish in accordance with a (food) recipe (which may be held in an electronic description) and the person may be a chef. The working equipment may comprise kitchen equipment. These methods may be used in combination with any one or more of the other features described herein. One, more than one or all of the features of the aspects may be combined, so a feature from one aspect may be combined with another aspect for example. Each aspect may be computer-implemented and there may be provided a computer program conFIG.d to perform each method when operated by a computer or processor. Each computer program may be stored on a computer-readable medium. Additionally or alternatively, the programs may be partially or fully hardware-implemented. The aspects may be combined. There may also be provided a robotics system conFIG.d to operate in accordance with the method described in respect of any of these aspects.

In another aspect, there may be provided a robotics system, comprising: a multi-modal sensing system capable of observing human motions and generating human motions data in a first instrumented environment; and a processor (which may be a computer), communicatively coupled to the multi-modal sensing system, for recording the human motions data received from the multi-modal sensing system and processing the human motions data to extract motion primitives, preferably such that the motion primitives define operations of a robotics system. The motion primitives may be minimanipulations, as described herein (for example in the immediately preceding paragraphs) and may have a standard format. The motion primitive may define specific types of action and parameters of the type of action, for example a pulling action with a defined starting point, end point, force and grip type. Optionally, there may be further provided a robotics apparatus, communicatively coupled to the processor and/or multi-modal sensing system. The robotics apparatus may be capable of using the motion primitives and/or the human motions data to replicate the observed human motions in a second instrumented environment.

In a further aspect, there may be provided a robotics system, comprising: a processor (which may be a computer), for receiving motion primitives defining operations of a robotics system, the motion primitives being based on human motions data captured from human motions; and a robotics system, communicatively coupled to the processor, capable of using the motion primitives to replicate human motions in an instrumented environment. It will be understood that these aspects may be further combined.

A further aspect may be found in a robotics system comprising: first and second robotic arms; first and second robotic hands, each hand having a wrist coupled to a respective arm, each hand having a palm and multiple articulated fingers, each articulated finger on the respective hand having at least one sensor; and first and second gloves, each glove covering the respective hand having a plurality of embedded sensors. Preferably, the robotics system is a robotic kitchen system.

There may further be provided, in a different but related aspect, a motion capture system, comprising: a standardized working environment module, preferably a kitchen; plurality of multi-modal sensors having a first type of sensors configured to be physically coupled to a human and a second type of sensors configured to be spaced away from the human. One or more of the following may be the case: the first type of sensors may be for measuring the posture of human appendages and sensing motion data of the human appendages; the second type of sensors may be for determining a spatial registration of the three-dimensional configurations of one or more of the environment, objects, movements, and locations of human appendages; the second type of sensors may be configured to sense activity data; the standardized working environment may have connectors to interface with the second type of sensors; the first type of sensors and the second type of sensors measure motion data and activity data, and send both the motion data and the activity data to a computer for storage and processing for product (such as food) preparation.

An aspect may additionally or alternatively be considered in a robotic hand coated with a sensing gloves, comprising: five fingers; and a palm connected to the five fingers, the palm having internal joints and a deformable surface material in three regions; a first deformable region disposed on a radial side of the palm and near the base of the thumb; a second deformable region disposed on a ulnar side of the palm, and spaced apart from the radial side; and a third deformable region disposed on the palm and extend across the base of the fingers. Preferably, the combination of the first deformable region, the second deformable region, the third deformable region, and the internal joints collectively operate to perform a minimanipulation, particularly for food preparation.

In respect of any of the above system, device or apparatus aspects, there may further be provided method aspects comprising steps to carry out the functionality of the system. Additionally or alternatively, optional features may be found based on any one or more of the features described herein with respect to other aspects.

One embodiment of the present disclosure illustrates a universal android-type robotic device that comprises the following features or components. A robotic software engine, such as the robotic food preparation engine 56, is configured to replicate any type of human hands movements and products in an instrumented or standardized environment. The resulting product from the robotic replication can be (1) physical, such as a food dish, a painting, a work of art, etc., and (2) non-physical, such as the robotic apparatus playing a musical piece on a musical instrument, a health care assistant procedure, etc.

Several significant elements in the universal android-type (or other software operating systems) robotic device may include some or all of the following, or in combination with other features. First, the robotic operating or instrumented environment operates a robotic device providing standardized (or “standard”) operating volume dimensions and architecture for Creator and Robotic Studios. Second, the robotic operating environment provides standardized position and orientation (xyz) for any standardized objects (tools, equipment, devices, etc.) operating within the environment. Third, the standardized features extend to, but are not limited by, standardized attendant equipment set, standardized attendant tools and devices set, two standardized robotic arms, and two robotic hands that closely resemble functional human hands with access to one or more libraries of minimanipulations, and standardized three-dimensional (3D) vision devices for creating dynamic virtual 3D-vision model of operation volume. This data can be used for hand motion capturing and functional result recognizing. Fourth, hand motion gloves with sensors are provided to capture precise movements of a creator. Fifth, the robotic operating environment provides standardized type/volume/size/weight of the required materials and ingredients during each particular (creator) product creation and replication process. Sixth, one or more types of sensors are used to capture and record the process steps for replication.

Software platform in the robotic operating environment includes the following subprograms. The software engine (e.g., robotic food preparation engine 56) captures and records arms and hands motion script subprograms during the creation process as human hands wear gloves with sensors to provide sensory data. One or more minimanipulations functional library subprograms are created. The operating or instrumented environment records three-dimensional dynamic virtual volume model subprogram based on a timeline of the hand motions by a human (or a robot) during the creation process. The software engine is configured to recognize each functional minimanipulation from the library subprogram during a task creation by human hands. The software engine defines the associated minimanipulations variables (or parameters) for each task creation by human hands for subsequent replication by the robotic apparatus. The software engine records sensor data from the sensors in an operating environment, which quality check procedure can be implemented to verify the accuracy of the robotic execution in replicating the creator's hand motions. The software engine includes an adjustment algorithms subprogram for adapting to any non-standardized situations (such as an object, volume, equipment, tools, or dimensions), which make a conversion from non-standardized parameters to standardized parameters to facilitate the execution of a task (or product) creation script. The software engine stores a subprogram (or sub software program) of a creator's hand motions (which reflect the intellectual property product of the creator) for generating a software script file for subsequent replication by the robotic apparatus. The software engine includes a product or recipe search engine to locate the desirable product efficiently. Filters to the search engine are provided to personalize the particular requirements of a search. An e-commerce platform is also provided for exchanging, buying, and selling any IP script (e.g., software recipe files), food ingredients, tools, and equipment to be made available on a designated website for commercial sale. The e-commerce platform also provides a social network page for users to exchange information about a particular product of interest or zone of interest.

One purpose of the robotic apparatus replicating is to produce the same or substantially the same product result, e.g., the same food dish, the same painting, the same music, the same writing, etc. as the original creator through the creator's hands. A high degree of standardization in an operating or instrumented environment provides a framework, while minimizing variance between the creator's operating environment and the robotic apparatus operating environment, which the robotic apparatus is able to produce substantially the same result as the creator, with some additional factors to consider. The replication process has the same or substantially the same timeline, with preferable the same sequence of minimanipulations, the same initial start time, the same time duration and the same ending time of each minimanipulation, while the robotic apparatus autonomously operates at the same speed of moving an object between minimanipulations. The same task program or mode is used on the standardized kitchen and standardized equipment during the recording and execution of the minimanipulation. A quality check mechanism, such as a three-dimensional vision and sensors, can be used to minimize or avoid any failed result, which adjustments to variables or parameters can be made to cater to non-standardized situations. An omission to use a standardized environment (i.e., not the same kitchen volume, not the same kitchen equipment, not the same kitchen tools, and not the same ingredients between the creator's studio and the robotic kitchen) increases the risk of not obtaining the same result when a robotic apparatus attempts to replicate a creator's motions in hopes of obtaining the same result.

The robotic kitchen can operate in at least two modes, a computer mode and a manual mode. During the manual mode, the kitchen equipment includes buttons on an operating console (without the requirement to recognize information from a digital display or without the requirement to input any control data through touchscreen to avoid any entering mistake, during either recording or execution). In case of touchscreen operation, the robotic kitchen can provide a three-dimensional vision capturing system for recognizing current information of the screen to avoid incorrect operation choice. The software engine is operable with different kitchen equipment, different kitchen tools, and different kitchen devices in a standardized kitchen environment. A creator's limitation is to produce hand motions on sensor gloves that are capable of replication by the robotic apparatus in executing mini-manipulations. Thus, in on embodiment, the library (or libraries) of minimanipulations that are capable of execution by the robotic apparatus serves as functional limitations to the creator's motion movements. The software engine creates an electronic library of three-dimensional standardized objects, including kitchen equipment, kitchen tools, kitchen containers, kitchen devices, etc. The pre-stored dimensions and characteristics of each three-dimensional standardized object conserve resources and reduce the amount of time to generate a three-dimensional modeling of the object from the electronic library, rather than having to create a three-dimensional modeling in real time. In one embodiment, the universal android-type robotic device is capable to create a plurality of functional results. The functional results make success or optimal results from the execution of minimanipulations from the robotic apparatus, such as the humanoid walking, the humanoid running, the humanoid jumping, the humanoid (or robotic apparatus) playing musical composition, the humanoid (or robotic apparatus) painting a picture, and the humanoid (or robotic apparatus) making dish. The execution of minimanipulations can occur sequentially, in parallel, or one prior minimanipulation must be completed before the start of the next minimanipulation. To make humans more comfortable with a humanoid, the humanoid would make the same motions (or substantially the same) as a human and at a pace comfortable to the surrounding human(s). For example, if a person likes the way that a Hollywood actor or a model walks, the humanoid can operate with minimanipulations that exhibits the motion characteristics of the Hollywood actor (e.g., Angelina Jolie). The humanoid can also be customized with a standardized human type, including skin-looking cover, male humanoid, female humanoid, physical, facial characteristics, and body shape. The humanoid covers can be produced using three-dimensional printing technology at home.

One example operating environment for the humanoid is a person's home; while some environments are fixed, others are not. The more that the environment of the house can be standardized, the less risk in operating the humanoid. If the humanoid is instructed to bring a book, which does not relate to a creator's intellectual property/intellectual thinking (IP), it requires a functional result without the IP, the humanoid would navigate the pre-defined household environment and execute one or more minimanipulations to bring the book and give the book to the person. Some three-dimensional objects, such as a sofa, have been previously created in the standardized household environment when the humanoid conducts its initial scanning or perform three-dimensional quality check. The humanoid may necessitate creating a three-dimensional modeling for an object that the humanoid does not recognized or that was not previously defined.

FIG. 167 is a block diagram illustrating an example of a computer device, as shown in 3624, on which computer-executable instructions to perform the methodologies discussed herein may be installed and run. As alluded to above, the various computer-based devices discussed in connection with the present disclosure may share similar attributes. Each of the computer devices or computers 16 is capable of executing a set of instructions to cause the computer device to perform any one or more of the methodologies discussed herein. The computer devices 16 may represent any or the entire server, or any network intermediary devices. Further, while only a single machine is illustrated, the term “machine” shall also be taken to include any collection of machines that individually or jointly execute a set (or multiple sets) of instructions to perform any one or more of the methodologies discussed herein. The example computer system 3624 includes a processor 3626 (e.g., a central processing unit (CPU), a graphics processing unit (GPU), or both), a main memory 3628 and a static memory 3630, which communicate with each other via a bus 3632. The computer system 3624 may further include a video display unit 3634 (e.g., a liquid crystal display (LCD)). The computer system 3624 also includes an alphanumeric input device 3636 (e.g., a keyboard), a cursor control device 3638 (e.g., a mouse), a disk drive unit 3640, a signal generation device 3642 (e.g., a speaker), and a network interface device 3648.

The disk drive unit 3640 includes a machine-readable medium 244 on which is stored one or more sets of instructions (e.g., software 3646) embodying any one or more of the methodologies or functions described herein. The software 3646 may also reside, completely or at least partially, within the main memory 3644 and/or within the processor 3626 during execution thereof the computer system 3624, the main memory 3628, and the instruction-storing portions of processor 3626 constituting machine-readable media. The software 3646 may further be transmitted or received over a network 3650 via the network interface device 3648.

While the machine-readable medium 3644 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any tangible medium that is capable of storing a set of instructions for execution by the machine and that cause the machine to perform any one or more of the methodologies of the present disclosure. The term “machine-readable medium” shall accordingly be taken to include, but not be limited to, solid-state memories, and optical and magnetic media.

In general, a robotic control platform comprises one or more robotic sensors; one or more robotic actuators; a mechanical robotic structure including at least a robotic head with mounted sensors on an articulated neck, two robotic arms with actuators and force sensors; an electronic library database, communicatively coupled to the mechanical robotic structure, of minimanipulations, each including a sequence of steps to achieve a predefined functional result, each step comprising a sensing operation or a parameterized actuator operation; and a robotic planning module, communicatively coupled to the mechanical robotic structure and the electronic library database, configured for combining a plurality of minimanipulations to achieve one or more domain-specific applications; a robotic interpreter module, communicatively coupled to the mechanical robotic structure and the electronic library database, configured for reading the minimanipulation steps from the minimanipulation library and converting to a machine code; and a robotic execution module, communicatively coupled to the mechanical robotic structure and the electronic library database, configured for executing the minimanipulation steps by the robotic platform to accomplish a functional result associated with the minimanipulation steps.

Another generalized aspect provides a humanoid having a robot computer controller operated by robot operating system (ROS) with robotic instructions comprises a database having a plurality of electronic minimanipulation libraries, each electronic minimanipulation library including a plurality of minimanipulation elements, the plurality of electronic minimanipulation libraries can be combined to create one or more machine executable application-specific instruction sets, the plurality of minimanipulation elements within an electronic minimanipulation library can be combined to create one or more machine executable application-specific instruction sets; a robotic structure having an upper body and a lower body connected to a head through an articulated neck, the upper body including torso, shoulder, arms and hands; and a control system, communicatively coupled to the database, a sensory system, a sensor data interpretation system, a motion planner, and actuators and associated controllers, the control system executing application-specific instruction sets to operate the robotic structure.

A further generalized computer-implemented method for operating a robotic structure through the use of one more controllers, one more sensors, and one more actuators to accomplish one or more tasks comprises providing a database having a plurality of electronic minimanipulation libraries, each electronic minimanipulation library including a plurality of minimanipulation elements, the plurality of electronic minimanipulation libraries can be combined to create one or more machine executable task-specific instruction sets, the plurality of minimanipulation elements within an electronic minimanipulation library can be combined to create one or more machine executable task-specific instruction sets; executing task-specific instruction sets to cause the robotic structure to perform a commanded task, the robotic structure having an upper body connected to a head through an articulated neck, the upper body including torso, shoulder, arms and hands; sending time-indexed high-level commands for position, velocity, force, and torque to the one or more physical portions of the robotic structure; and receiving sensory data from one or more sensors for factoring with the time-indexed high-level commands to generate low-level commands to control the one or more physical portions of the robotic structure.

Another generalized computer-implemented method for generating and executing a robotic task of a robot comprises generating a plurality minimanipulations in combination with parametric minimanipulation (MM) data sets, each minimanipulation being associated with at least one particular parametric MM data set which defines the required constants, variables and time-sequence profile associated with each minimanipulation; generating a database having a plurality of electronic minimanipulation libraries, the plurality of electronic minimanipulation libraries having MM data sets, MM command sequencing, one or more control libraries, one or more machine-vision libraries, and one or more inter-process communication libraries; executing high-level robotic instructions by a high-level controller for performing a specific robotic task by selecting, grouping and organizing the plurality of electronic minimanipulation libraries from the database thereby generating a task-specific command instruction set, the executing step including decomposing high-level command sequences, associated with the task-specific command instruction set, into one more individual machine-executable command sequences for each actuator of a robot; and executing low-level robotic instructions, by a low-level controller, for executing individual machine-executable command sequences for each actuator of a robot, the individual machine-executable command sequences collectively operating the actuators on the robot to carry out the specific robot task.

A generalized computer-implemented method for controlling a robotic apparatus, comprises composing one or more minimanipulation behavior data, each minimanipulation behavior data including one or more elementary minimanipulation primitives for building one or more ever-more complex behaviors, each minimanipulation behavior data having a correlated functional result and associated calibration variables for describing and controlling each minimanipulation behavior data; linking one or more behavior data to a physical environment data from one or more databases to generate a linked minimanipulation data, the physical environment data including physical system data, controller data to effect robotic movements, and sensory data for monitoring and controlling the robotic apparatus 75; and converting the linked minimanipulation (high-level) data from the one or more databases to a machine-executable (low-level) instruction code for each actuator (A₁ thru Aₙ,) controller for each time-period (t₁ thru tₘ) to send commands to the robot apparatus for executing one or more commanded instructions in a continuous set of nested loops.

In any of these aspects, the following may be considered. The preparation of the product normally uses ingredients. Executing the instructions typically includes sensing properties of the ingredients used in preparing the product. The product may be a food dish in accordance with a (food) recipe (which may be held in an electronic description) and the person may be a chef. The working equipment may comprise kitchen equipment. These methods may be used in combination with any one or more of the other features described herein. One, more than one, or all of the features of the aspects may be combined, so a feature from one aspect may be combined with another aspect for example. Each aspect may be computer-implemented and there may be provided a computer program configured to perform each method when operated by a computer or processor. Each computer program may be stored on a computer-readable medium. Additionally or alternatively, the programs may be partially or fully hardware-implemented. The aspects may be combined. There may also be provided a robotics system configured to operate in accordance with the method described in respect of any of these aspects.

In another aspect, there may be provided a robotics system, comprising: a multi-modal sensing system capable of observing human motions and generating human motions data in a first instrumented environment; and a processor (which may be a computer), communicatively coupled to the multi-modal sensing system, for recording the human motions data received from the multi-modal sensing system and processing the human motions data to extract motion primitives, preferably such that the motion primitives define operations of a robotics system. The motion primitives may be minimanipulations, as described herein (for example in the immediately preceding paragraphs) and may have a standard format. The motion primitive may define specific types of action and parameters of the type of action, for example a pulling action with a defined starting point, end point, force and grip type. Optionally, there may be further provided a robotics apparatus, communicatively coupled to the processor and/or multi-modal sensing system. The robotics apparatus may be capable of using the motion primitives and/or the human motions data to replicate the observed human motions in a second instrumented environment.

In a further aspect, there may be provided a robotics system, comprising: a processor (which may be a computer), for receiving motion primitives defining operations of a robotics system, the motion primitives being based on human motions data captured from human motions; and a robotics system, communicatively coupled to the processor, capable of using the motion primitives to replicate human motions in an instrumented environment. It will be understood that these aspects may be further combined.

A further aspect may be found in a robotics system comprising: first and second robotic arms; first and second robotic hands, each hand having a wrist coupled to a respective arm, each hand having a palm and multiple articulated fingers, each articulated finger on the respective hand having at least one sensor; and first and second gloves, each glove covering the respective hand having a plurality of embedded sensors. Preferably, the robotics system is a robotic kitchen system.

There may further be provided, in a different but related aspect, a motion capture system, comprising: a standardized working environment module, preferably a kitchen; plurality of multi-modal sensors having a first type of sensors configured to be physically coupled to a human and a second type of sensors configured to be spaced away from the human. One or more of the following may be the case: the first type of sensors may be for measuring the posture of human appendages and sensing motion data of the human appendages; the second type of sensors may be for determining a spatial registration of the three-dimensional configurations of one or more of the environment, objects, movements, and locations of human appendages; the second type of sensors may be configured to sense activity data; the standardized working environment may have connectors to interface with the second type of sensors; the first type of sensors and the second type of sensors measure motion data and activity data, and send both the motion data and the activity data to a computer for storage and processing for product (such as food) preparation.

An aspect may additionally or alternatively be considered in a robotic hand coated with a sensing gloves, comprising: five fingers; and a palm connected to the five fingers, the palm having internal joints and a deformable surface material in three regions; a first deformable region disposed on a radial side of the palm and near the base of the thumb; a second deformable region disposed on a ulnar side of the palm, and spaced apart from the radial side; and a third deformable region disposed on the palm and extend across the base of the fingers. Preferably, the combination of the first deformable region, the second deformable region, the third deformable region, and the internal joints collectively operate to perform a minimanipulation, particularly for food preparation.

In respect of any of the above system, device or apparatus aspects there may further be provided method aspects comprising steps to carry out the functionality of the system. Additionally or alternatively, optional features may be found based on any one or more of the features described herein with respect to other aspects.

The present disclosure has been described in particular detail with respect to possible embodiments. Those skilled in the art will appreciate that the disclosure may be practiced in other embodiments. The particular naming of the components, capitalization of terms, the attributes, data structures, or any other programming or structural aspect is not mandatory or significant, and the mechanisms that implement the disclosure or its features may have different names, formats, or protocols. The system may be implemented via a combination of hardware and software, as described, or entirely in hardware elements, or entirely in software elements. The particular division of functionality between the various systems components described herein is merely example and not mandatory; functions performed by a single system component may instead be performed by multiple components, and functions performed by multiple components may instead be performed by a single component.

In various embodiments, the present disclosure can be implemented as a system or a method for performing the above-described techniques, either singly or in any combination. The combination of any specific features described herein is also provided, even if that combination is not explicitly described. In another embodiment, the present disclosure can be implemented as a computer program product comprising a computer-readable storage medium and computer program code, encoded on the medium, for causing a processor in a computing device or other electronic device to perform the above-described techniques.

As used herein, any reference to “one embodiment” or to “an embodiment” means that a particular feature, structure, or characteristic described in connection with the embodiments is included in at least one embodiment of the disclosure. The appearances of the phrase “in one embodiment” in various places in the specification are not necessarily all referring to the same embodiment.

Some portions of the above are presented in terms of algorithms and symbolic representations of operations on data bits within a computer memory. These algorithmic descriptions and representations are the means used by those skilled in the data processing arts to convey most effectively the substance of their work to others skilled in the art. An algorithm is generally perceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared, transformed, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that, throughout the description, discussions utilizing terms such as “processing” or “computing” or “calculating” or“displaying” or“determining” or the like refer to the action and processes of a computer system, or similar electronic computing module and/or device, that manipulates and transforms data represented as physical (electronic) quantities within the computer system memories or registers or other such information storage, transmission, or display devices.

Certain aspects of the present disclosure include process steps and instructions described herein in the form of an algorithm. It should be noted that the process steps and instructions of the present disclosure could be embodied in software, firmware, and/or hardware, and, when embodied in software, it can be downloaded to reside on, and operated from, different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers and/or other electronic devices referred to in the specification may include a single processor or may be architectures employing multiple processor designs for increased computing capability.

The algorithms and displays presented herein are not inherently related to any particular computer, virtualized system, or other apparatus. Various general-purpose systems may also be used with programs, in accordance with the teachings herein, or the systems may prove convenient to construct more specialized apparatus needed to perform the required method steps. The required structure for a variety of these systems will be apparent from the description provided herein. In addition, the present disclosure is not described with reference to any particular programming language. It will be appreciated that a variety of programming languages may be used to implement the teachings of the present disclosure as described herein, and any references above to specific languages are provided for disclosure of enablement and best mode of the present disclosure.

In various embodiments, the present disclosure can be implemented as software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the disclosure include a mobile phone, personal digital assistant, smartphone, kiosk, desktop computer, laptop computer, consumer electronic device, television, set-top box, or the like. An electronic device for implementing the present disclosure may use an operating system such as, for example, iOS available from Apple Inc. of Cupertino, Calif., Android available from Google Inc. of Mountain View, Calif., Microsoft Windows 7 available from Microsoft Corporation of Redmond, Wash., webOS available from Palm, Inc. of Sunnyvale, Calif., or any other operating system that is adapted for use on the device. In some embodiments, the electronic device for implementing the present disclosure includes functionality for communication over one or more networks, including for example a cellular telephone network, wireless network, and/or computer network such as the Internet.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The terms “a” or “an,” as used herein, are defined as one as or more than one. The term “plurality,” as used herein, is defined as two or as more than two. The term “another,” as used herein, is defined as at least a second or more.

A storage arrangement for use with a robotic kitchen, the arrangement comprising a housing incorporating a plurality of storage units; a rotatable mounting system coupled to the housing to enable the housing to be rotatably mounted to a support structure, the housing comprising a plurality of sides with at least one side comprising a plurality of storage units that are each configured to carry a container, the housing being configured to rotate to present a different side of the plurality of sides to an operative. The arrangement further comprises a moveable support element which is moveable relative to the housing, the moveable support element comprising at least one storage unit which is configured to receive a respective one of the containers.

A storage arrangement for use with a robotic kitchen, the arrangement comprising a housing incorporating a plurality of storage units; a rotatable mounting system coupled to the housing to enable the housing to be rotatably mounted to a support structure, the housing comprising a plurality of sides with at least one side comprising a plurality of storage units that are each configured to carry a container, the housing being configured to rotate to present a different side of the plurality of sides to an operative. The moveable support element is rotatable relative to the housing, the moveable support element having a plurality of sides with at least one of the sides comprising at least one storage unit, the moveable support element being configured to rotate to present different faces of the moveable support element to an operative.

A storage arrangement for use with a robotic kitchen, the arrangement comprising a housing incorporating a plurality of storage units; a rotatable mounting system coupled to the housing to enable the housing to be rotatably mounted to a support structure, the housing comprising a plurality of sides with at least one side comprising a plurality of storage units that are each configured to carry a container, the housing being configured to rotate to present a different side of the plurality of sides to an operative.

In the storage arrangement, at least one of the plurality of sides has a shape which is one of the square and rectangular.

In the storage arrangement, the housing comprises three sides.

In the storage arrangement, the housing comprises four sides.

In the storage arrangement, at least part of the housing has a substantially circular sidewall, each one of the plurality of sides being a portion of the substantially circular side wall.

In the storage arrangement, the storage arrangement is configured to store one or more of cook wares, tools, crockery, spices and herbs.

The arrangement of any one of the above, wherein at least one of the containers comprises a first part which carries the handle; and a second part which is moveably mounted to the first part such that when the second part of the container is moved relative to the first part of the container, the second part of the container acts on part of a foodstuff within the container to move the foodstuff relative to the first part of the container.

A container arrangement, the arrangement comprising a first part which carries a handle; and a second part which is moveably mounted to the first part such that when the second part of the part of the container is moved relative to the first part of the container, the second part of the container acts on part of a foodstuff within the container to move the foodstuff relative to the first part of the container.

In the container arrangement, the second part carries a further handle to be used to move the second part relative to the first part.

In the container arrangement, the second part comprises a wall that at least partly surrounds a foodstuff within the container.

In the container arrangement, the first part comprises a planar base which is configured to support a foodstuff within the container.

In the container arrangement, the second part is configured to move in a direction substantially parallel to the plane of the base such that the second part acts on the foodstuff to move the foodstuff off the base.

In the container arrangement, the base is a cooking surface which is configured to be heated to cook a foodstuff positioned on the base.

A cooking arrangement, the arrangement comprising a support frame; a cooking part which incorporates a base and an upstanding side wall that at least partly surrounds the base; and a handle which is carried by the side wall, wherein the cooking part is configured to be rotatably mounted to the support frame so that the cooking part can be rotated relative to the support frame about an axis to at least partly turn a foodstuff positioned on the base.

In the cooking arrangement, the cooking part is releasably attached to the support frame.

In the cooking arrangement, the arrangement comprises a locking system which is configured to selectively lock and restrict rotation of the cooking part relative to the support frame.

In the cooking arrangement, the support frame is configured to receive the container arrangement and the cooking part, wherein the rotation of the cooking part relative to the support frame turns a foodstuff positioned on the base of the cooking part onto at least part of the container arrangement.

The storage arrangement as noted above, wherein the arrangement comprises a further storage housing that incorporates a substantially planar base and at least one shelf element, the at least one shelf element being fixed at an angle relative to the plane of the base.

The storage arrangement as noted above, wherein the at least one shelf element is fixed at an angle between 30° and 50° relative to the plane of the base.

The storage arrangement as noted above, wherein the arrangement comprises a plurality of spaced apart shelf elements which are each substantially parallel to one another.

A storage arrangement for use with a robotic kitchen, the arrangement comprising a further storage housing which comprises a substantially planar base and at least one shelf element, the at least one shelf element being fixed at an angle relative to the plane of the base.

In the storage arrangement, each shelf element is fixed at an angle of between 30° and 50° relative to the plane of the base.

In the storage arrangement, the arrangement comprises a plurality of spaced apart shelf elements which are each substantially parallel to one another.

A cooking system, the system comprising a cooking appliance having a heating chamber; and a mounting arrangement having a first support element that is carried by the cooking appliance and a second support element that is configured to be attached to a support structure in a kitchen, the first and second support elements being moveably coupled to one another to permit the first support element and the cooking appliance to move relative to the second support element between a first position and a second position.

In the cooking system, the cooking appliance is an oven.

In the cooking system, the oven is a steam oven.

In the cooking system, the cooking appliance comprises a grill.

In the cooking system, the support elements are configured to rotate relative to one another.

In the cooking system, the first support element is configured to rotate by substantially 90° relative to the second support element.

In the cooking system, the support elements are configured to move transversely relative to one another.

In the cooking system, the system comprises an electric motor which is configured to drive the first support element to move relative to the second support element.

In the cooking system, the cooking system is configured for use by a human when the cooking appliance is in the first position and for use by a robot when the cooking appliance is in the second position, and wherein the cooking appliance is at least partly shielded by a screen when the cooking appliance is in the second position.

A container arrangement for storing a cooking ingredient, the arrangement comprising a container body having at least one side wall; a storage chamber provided within the container body; and an ejection element which is moveably coupled to the container body, part of the ejection element being provided within the storage chamber, the ejection element being moveable relative to the container body to act on a cooking ingredient in the storage chamber to eject at least part of the cooking ingredient out from the storage chamber.

In the container arrangement, the container body has a substantially circular cross-section.

In the container arrangement, the ejection element is moveable between a first position in which the ejection element is positioned substantially at one end of the storage chamber to a second position in which the ejection element is positioned substantially at a further end of the storage chamber.

In the container arrangement, the ejection element comprises an ejection element body which has an edge that contacts the container body around the periphery of the storage chamber.

In the container arrangement, the ejection element is provided with a recess in a portion of the edge of the ejection element body, and wherein the recess is configured to receive at least part of a guide rail protrusion provided on the container body within the storage chamber.

In the container arrangement, the ejection element is coupled to a handle which protrudes outwardly from the container body through an aperture in the container body.

In the container arrangement, the container body comprises an open first end through which the cooking ingredient is ejected by the ejection element an a substantially closed section end which retains the cooking ingredient within the storage chamber.

In the container arrangement, the second end of the container body is releasably closed by a removable closure element.

In the container arrangement, the container body is provided with an elongate handle which is configured to be carried by a robot.

An end effector for a robot, the end effector comprising a grabber which is configured to hold an item; and at least one sensor which is carried by the grabber, the at least one sensor being configured to sense the presence of an item being held by the grabber and to provide a signal to a control unit in response to the sensed presence of the item being held by the grabber.

In the end effector, the grabber is a robotic hand.

In the end effector, the at least one sensor is a magnetic sensor which is configured to sense a magnet provided on an item.

In the end effector, the magnetic sensor is a tri-axis magnetic sensor which is configured to sense the position of a magnet in three axes which is relative to the magnetic sensor.

In the end effector, the grabber comprises a plurality of magnetic sensors which are provided at a plurality of different positions on the grabber to sense a plurality of magnets provided on an item.

A recording method for use with a robotic kitchen module, the robotic kitchen module comprising a container, the container being configured to store an ingredient and the container being provided with a sensor to sense a parameter indicative of a condition within the container, wherein the method comprises receiving a signal from a sensor on the container indicative of a condition within the container; deriving parameter data from the signal which is indicative of the sensed condition within the container; storing the parameter data in a memory; and repeating steps a-c over a period of time to store a parameter data record in the memory that provides a data record of the condition within the container over the period of time.

In the recording method, the method comprises receiving a signal from a temperature sensor on the container indicative of the temperature within the container.

In the recording method, the container is provided with a temperature control element to control the temperature within the container and method further comprises recording temperature control data which indicates the of the control of the temperature control element over the period of time.

In the recording method, the method comprises receiving a signal from a humidity sensor on a container indicative of the humidity within the container.

In the recording method, wherein the container is provided with a humidity control device to control the humidity within the container and method further comprises recording humidity control data which indicates the of the control of the humidity control device over the period of time.

In the recording method, the method further comprises recording the movement of at least one hand of a chef cooking in the robotic kitchen over the period of time.

In the recording method, the period of time is the period of time required to prepare an ingredient for use when cooking a dish in accordance with a recipe.

In the recording method, the period of time is the period of time required to cook a dish in accordance with a recipe.

In the recording method, the method further comprises integrating the parameter data record with recipe data and storing the integrated data in a recipe data file.

In the recording method, the method further comprises transmitting the recipe data file via a computer network to a remote server.

In the recording method, the remote server forms part of an online repository that is configured to provide the recipe data file to a plurality of client devices.

In the recording method, the online repository is an online application store.

A computer readable medium storing instructions which, when executed by a processor, cause the processor to perform the recording method noted above.

A method of operating a robotic kitchen module, the robotic kitchen module comprising a container, the container being configured to store an ingredient and the container being provided with a sensor to sense a parameter indicative of a condition within the container and a condition control device which is configured to control the condition within the container, wherein the method comprises receiving a parameter data record which provides a data record of the condition within the container over the period of time; receiving a signal from a sensor on a container indicative of a condition within the container; deriving parameter data from the signal which is indicative of the sensed condition within the container; comparing using the robotic kitchen engine module the parameter data with the parameter data record; and controlling a condition control device to control the condition within the container so that the condition within the container at least partly matches the condition indicated by the parameter data record.

The method of operating a robotic kitchen module, wherein the method comprises receiving a signal from a temperature sensor on the container indicative of the temperature within the container.

The method of operating a robotic kitchen module, wherein the method comprises controlling a temperature control element provided on the container to control the temperature within the container to at least partly match a temperature indicated by the parameter data record.

The method of operating a robotic kitchen module, wherein the method comprises receiving a signal from a humidity sensor on the container indicative of the humidity within the container.

The method of operating a robotic kitchen module, wherein the method comprises controlling a humidity control device provided on the container to control the humidity within the container to at least partly match a humidity indicated by the parameter data record.

The method of operating a robotic kitchen module, wherein the method comprises storing a prepared ingredient in the container over a period of time and controlling the condition within the container over the period of time to at least partly match a predetermined storage condition for the ingredient.

The method of operating a robotic kitchen module, wherein the method comprises storing a prepared ingredient in the container over a period of time and controlling the condition within the container to prepare the ingredient for use in a recipe according to a predetermined preparation routine.

The method of operating a robotic kitchen module, wherein the method comprises receiving a recipe data file and extracting the parameter data record from the recipe data file.

A computer readable medium storing instructions which, when executed by a processor, cause the processor to perform the method of operating a robotic kitchen module.

A robotics system comprising a computer; and a robotic hand coupled to the computer, the robotic hand being configured to receive a sequence of movement instructions from the computer and perform a manipulation according to the sequence of standardized movement instructions, wherein the robotic hand is configured to perform at least one intermediate movement during the manipulation in response to at least one intermediate movement instruction received from the computer, wherein the intermediate movement modifies the trajectory of at least part of the robotic hand during the movement sequence.

The robotics system, wherein the robotic hand comprises a plurality of fingers and a thumb and the system is configured to modify the trajectory of a tip of at least one of the fingers and thumb in response to the intermediate movement instruction.

The robotics system, wherein the intermediate movement instruction causes the robotic hand to perform an emotional movement which at least partly mimics an emotional movement of a human hand.

A robotic kitchen module comprising the robotics system noted above.

A computer-implemented method for operating a robotic hand, the method comprising identifying a movement sequence for a robotic hand to perform a manipulation; providing movement instructions to the robotic hand to cause the robotic hand to perform the manipulation; and providing at least one intermediate movement instruction to the robotic hand to cause the robotic hand to perform at least one intermediate movement during the manipulation, the intermediate movement being a movement of the robotic hand which modifies the trajectory of at least part of the robotic hand during the manipulation.

The method of operating a robotic hand, wherein the method comprises providing at least one intermediate movement instruction to the robotic hand to cause the robotic hand to modify the trajectory of a tip of at least one of a finger and thumb of the robotic hand.

The method of operating a robotic hand, wherein the intermediate movement instruction causes the robotic hand to perform an emotional movement which at least partly mimics an emotional movement of a human hand.

A computer readable medium storing instructions which, when executed by a processor, cause the processor to perform the method of operating a robotic hand.

A computer implemented object recognition method for use with a robotic kitchen, the method comprising receiving expected object data indicating at least one predetermined object that is expected within the robotic kitchen; receiving shape data indicating the shape of at least part of an object; receiving predetermined object data indicating the shape of a plurality of predetermined objects; determining a subset of predetermined objects by matching at least one predetermined object identified by the predetermined object data with the at least one predetermined object identified by the expected object data; comparing the shape data with the subset of predetermined objects; and outputting real object data indicative of a predetermined object in the subset of predetermined objects that matches the shape data.

The object recognition method for use with a robotic kitchen, wherein the shape data is two-dimensional (2D) shape data.

The object recognition method for use with a robotic kitchen, wherein the shape data is three-dimensional (3D) shape data.

The object recognition method for use with a robotic kitchen, wherein the method comprises extracting the expected object data from recipe data, the recipe data providing instructions for use within the robotic kitchen module to cook a dish.

The object recognition method for use with a robotic kitchen, wherein the method comprises outputting real object data to a workspace dynamic model module which is configured to provide manipulation instructions to a robot within the robotic kitchen module.

The object recognition method for use with a robotic kitchen, wherein the predetermined object data comprises standard object data indicating at least one of a 2D shape, 3D shape, visual signature or image sample of at least one predetermined object.

The object recognition method for use with a robotic kitchen, wherein the at least one predetermined object is at least one of a dish, utensil or appliance.

The object recognition method for use with a robotic kitchen, wherein the predetermined object data comprises temporary object data indicating at least one of a visual signature or an image sample of at least one predetermined object.

The object recognition method for use with a robotic kitchen, wherein the at least one predetermined object is an ingredient.

The object recognition method for use with a robotic kitchen, wherein the method comprises storing position data indicative of the position of an object within the robotic kitchen relative to at least one reference marker provided within the robotic kitchen.

A computer readable medium storing instructions which, when executed by a processor, cause the processor to perform the object recognition method for use with a robotic kitchen.

A computer implemented object recognition method for use with a robotic kitchen, the method comprising receiving shape data indicating the shape of a plurality of objects; storing the shape data in a shape data library with a respective object identifier for each of the plurality of objects; an outputting recipe data comprising a list of the object identifiers.

The object recognition method for use with a robotic kitchen, wherein the shape data comprises at least one of 2D shape data and 3D shape data.

The object recognition method for use with a robotic kitchen, wherein the shape data comprises at shape data obtained from a robotic hand.

A computer readable medium storing instructions which, when executed by a processor, cause the processor to perform the object recognition method for use with a robotic kitchen.

A robotic system comprising a control unit; a robotic arm configured to be controlled by the control unit; an end effector coupled to the robotic arm, the end effector being configured to hold an item; and a sensor arrangement coupled to part of the robotic arm, the sensor arrangement being configured to provide a signal to the control unit which is indicative of a modifying force acting on the robotic arm that is caused by the mass of an item being held by the end effector, wherein the control unit is configured to process the signal and to calculate the mass of the item using the signal.

In the robotic system, the sensor arrangement comprises at least one of a strain gauge, load cell or torque sensor.

In the robotic system, the signal provided by the sensor arrangement indicates at least one of a linear force, acceleration, torque or angular velocity of part of the robotic arm.

In the robotic system, the sensor arrangement is provided at a base carrying the robotic arm.

In the robotic system, the sensor arrangement is provided on the robotic arm at a joint between two moveable links of the robotic arm.

In the robotic system, sensor arrangement comprises a current sensor which is coupled to an electric motor which controls the movement of the robotic arm, the current sensor being configured to output the signal to the control unit, with the signal being indicative of a current flowing through the electric motor, wherein the control unit is configured to calculate the torque of the electric motor using the signal from the current sensor and to use the calculated torque when calculating the mass of the item held by the end effector.

In the robotic system of any one of the above, the control unit is configured to calculate the mass of a container held by the end effector and configured to calculate a change in the mass of the container as the container is moved by the robotic arm when part of an ingredient is tipped out from the container by the robotic arm.

In the robotic system of any one of the above, the end effector is configured to sense the presence of at least one marker provided on an item when the item is being held by the end effector.

In the robotic system, the control unit is configured to use the sensed presence of the marker to detect whether the end effector is holding the item in a predetermined position.

In the robotic system, the end effector is a robotic hand comprising four fingers and a thumb.

A robotic kitchen module comprising the robotic system as noted above.

A method of sensing the weight of an item held by an end effector coupled to a robotic arm, the method comprising receiving a signal from a sensor arrangement which is indicative of a modifying force acting on the robotic arm that is caused by the mass of an item being held by an end effector coupled to the robotic arm; and processing the signal to calculate the mass of the item using the signal.

The method of sensing the weight of an item held by an end effector coupled to a robotic arm, wherein the sensor arrangement comprises at least one of a strain gauge, load cell or torque sensor.

The method of sensing the weight of an item held by an end effector coupled to a robotic arm, wherein the signal provided by the sensor arrangement indicates at least one of a linear force, acceleration, torque or angular velocity of part of the robotic arm.

The method of sensing the weight of an item held by an end effector coupled to a robotic arm, wherein the sensor arrangement comprises a current sensor which is coupled to an electric motor which controls the movement of the robotic arm, the current sensor being configured to output the signal to the control unit, with the signal being indicative of a current flowing through the electric motor, and the method comprises calculate the torque of the electric motor using the signal from the current sensor; and using the calculated torque when calculating the mass of the item held by the end effector.

The method of sensing the weight of an item held by an end effector coupled to a robotic arm, wherein the method further comprises calculating the mass of a container held by the end effector; and calculating a change in the mass of the container as the container is moved by the robotic arm when part of an ingredient is tipped out from the container by the robotic arm.

A computer readable medium storing instructions which, when executed by a processor, cause the processor to perform the method of sensing the weight of an item held by an end effector coupled to a robotic arm.

A robotic kitchen module comprising a control unit for controlling components of the robotic kitchen module; an intrusion detection sensor which is coupled to the control unit, the intrusion detection sensor being configured to receive a sensor input and to provide the sensor input to the control unit, wherein the control unit is configured to determine if the sensor input is an authorized sensor input and, if the sensor input is an authorized sensor input to enable the robotic kitchen module for use by a user, and if the sensor input is not an authorized sensor input to at least partly disable the robotic kitchen module.

In the robotic kitchen module, the robotic kitchen module comprises at least one robotic arm and the robotic kitchen module is configured to disable the robotic kitchen module by disabling the at least one robotic arm.

In the robotic kitchen module, the robotic kitchen module is configured to disable the robotic kitchen module by preventing user access to a computer in the robotic kitchen module.

In the robotic kitchen module, the intrusion detection sensor is at least one of a geo-position sensor, a fingerprint sensor or a mechanical intrusion sensor.

In the robotic kitchen module, the robotic kitchen module is configured to provide an alert signal to a remote location in response to the control unit determining that the sensor input is not an authorized sensor input.

In the robotic kitchen module, the robotic kitchen module is configured to destroy physical or magnetic elements of the robotic kitchen module to at least partly disable the robotic kitchen module.

An ordinary artisan should require no additional explanation in developing the methods and systems described herein but may find some possibly helpful guidance in the preparation of these methods and systems by examining standardized reference works in the relevant art.

While the disclosure has been described with respect to a limited number of embodiments, those skilled in the art, having benefit of the above description, will appreciate that other embodiments may be devised which do not depart from the scope of the present disclosure as described herein. It should be noted that the language used in the specification has been principally selected for readability and instructional purposes, and may not have been selected to delineate or circumscribe the inventive subject matter. The terms used should not be construed to limit the disclosure to the specific embodiments disclosed in the specification and the claims, but the terms should be construed to include all methods and systems that operate under the claims set forth herein below. Accordingly, the disclosure is not limited by the disclosure, but instead its scope is to be determined entirely by the following claims.

What is claimed and desired to be secured by Letters Patent of the United States is:

1. A storage arrangement for use with a robotic kitchen, the arrangement comprising:
a housing incorporating a plurality of storage units;
a plurality of containers which are each configured to be carried by at least one of the storage units, wherein each of the containers comprises a container body for receiving an ingredient and each of the containers is provided with an elongate handle which is configured to be carried by a robot, wherein the elongate handle facilitates orientation and movement of the container by the robot.

2. The arrangement of claim 1, wherein the plurality of containers are different sizes.

3. The arrangement of claim 1, wherein each of the handles comprises at least one support leg having a first end which is carried by the container body and a second end which is coupled to a handle element such that the handle element is spaced apart from the container body.

4. The arrangement of claim 1, wherein at least one of the containers carries a machine readable identifier.

5. The arrangement of claim 4, wherein the machine readable identifier includes a bar code.

6. The arrangement of claim 4, wherein the machine readable identifier includes a radio-frequency (RFID) tag.

7. The arrangement of claim 1, wherein at least one of the containers carries a computer-controlled signaling light.

8. The arrangement of claim 1, further comprising a locking arrangement, wherein the locking arrangement is provided on at least one of the storage units, the locking arrangement being configured, when activated, to lock a container of the containers at least partly within one of the storage units.

9. The arrangement of claim 8, wherein the at least one locking arrangement is configured to lock the container at least partly within one of the storage units for a predetermined period of time.

10. The arrangement of claim 1, wherein the arrangement further comprises:
a cooling system for cooling at least one of the storage units to cool at least part of a container positioned within that storage unit, wherein the containers include the container.

11. The arrangement of claim 10, wherein the cooling system is configured to cool at least one of a rear and an underside of that storage unit.

12. The arrangement of claim 10, wherein the cooling system comprises:
a cooling unit; and
a plurality of elongate heat transfer elements, each of the heat transfer elements being coupled at one end to a respective one of the storage units and coupled at another end to the cooling unit such that the heat transfer elements transfer heat away from the respective storage units to the cooling unit to lower the temperature within the storage units.

13. The arrangement of claim 12, wherein at least one of the heat transfer elements comprises an electronically controlled valve, the electronically controlled valve being configured, when activated, to permit heat to be transferred from a storage unit of the storage units along part of a respective heat transfer element and configured, when not activated, to restrict the transfer of heat from the storage unit along part of a respective heat transfer element.

14. The arrangement of claim 1, further comprising a heating system which is configured to heat at least one of the storage units to raise the temperature of at least part of a container of the containers within the storage unit.

15. The arrangement of claim 14, wherein the heating system comprises a heating element which is positioned adjacent to part of the storage unit.

16. The arrangement of claim 10, further comprising a temperature control unit which is configured to control at least one of the heating and cooling systems, wherein at least one of the storage units is provided with a temperature sensor which is coupled to the temperature control unit such that the temperature control unit can detect the temperature within a storage unit and control the temperature within the storage unit by activating at least one of the heating and cooling systems.

17. The arrangement of claim 1, wherein at least one of the storage units is provided with a humidity sensor to sense the humidity within that storage unit.

18. The arrangement of claim 1, wherein at least one of the storage units is coupled to a steam generator such that the steam generator can inject steam into that storage unit to humidify that storage unit.

19. The arrangement of claim 1, wherein at least one of the containers comprises a volume indicator which indicates a volume of an ingredient within that container.

20. The arrangement of claim 1, wherein at least one of the containers includes a bottle for holding a liquid, the bottle having an opening which is configured to be closed selectively by a closure element.
